(19) United States
(12) Patent Application Publication
(10) Pub. No.: US 2010/0048400 A1
(43) Pub. Date: Feb. 25, 2010

(54) HERBICIDE COMBINATION

(75) Inventors: Hansjoerg Kraehmer, Hofheim (DE); Martin Jeffrey Hills, Idstein (DE); Klaus Trabold, Heidelberg (DE); Erwin Hacker, Hochheim (DE)

Correspondence Address: Baker Donelson Bearman, Caldwell & Berkowitz, PC, 555 Eleventh Street, NW, Sixth Floor, Washington, DC, 20004, US

(73) Assignee: BAYER CROPSCIENCE AG, MONHEIM (DE)

(21) Appl. No.: 12/527,729

(22) PCT Filed: Jan. 30, 2008
(86) PCT No.: PCT/EP2008/000691

§ 371 Date: Oct. 9, 2009

(30) Foreign Application Priority Data
Feb. 19, 2007 (EP) 07003390.7

(51) Int. Cl. A01N 43/66; A01P 13/00

(52) U.S. Cl. 504/134

(57) ABSTRACT

The present invention relates to a herbicide combination comprising components (A) and (B), where (A) is one or more herbicides from the group of the compounds of the formula (I) or salts thereof

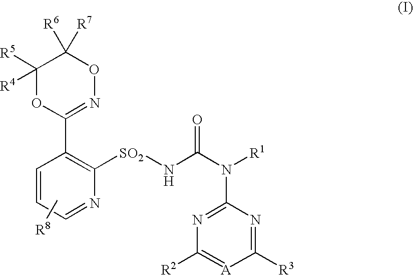

in which R¹, R², R³, R⁴, R⁵, R⁶, R⁷, R⁸ and A are as defined in claim 1; and (B) is one or more herbicides from the group of the 2,4-diamino-s-triazines which are N-substituted at an amino group with a (hetero)aryl(hetero)alkyl group, and to its use for the non-selective control of unwanted vegetation in plantation crops, in forest plant rearings, on roadsides, on squares and industrial sites, airfields or railway installations, or for burn-down applications.

The present invention relates to the technical field of the crop protection compositions which can be used against unwanted vegetation, for example in plantation crops, in forest plant rearings, on roadsides, on squares and industrial sites, airfields or railway installations, or for burn-down applications. The invention relates in particular to a herbicide combination comprising at least two herbicides and their use for controlling unwanted vegetation.

The publication U.S. Pat. No. 5,476,936 discloses certain herbicidally effective sulfonylureas. The effectiveness of these herbicides against harmful plants is at a high level; however, it depends in general on the application rate, the formulation in question, the harmful plants or the spectrum of harmful plants to be controlled in each case, the climatic and soil conditions, etc. A further criterion is the duration of action, or the rate of degradation of the herbicide. Also to be taken into account are, if appropriate, changes in the susceptibility of harmful plants which may occur on prolonged or geographically restricted use of the herbicides. Activity losses in individual plants can only be compensated to a certain extent by higher application rates of the herbicides, for example because this reduces the selectivity of the herbicides, or an improvement in activity is not observed, not even at a higher application rate. WO 2005/092104 also discloses the non-selective use of some of the herbicidally active N-azinyl-N′-(het)arylsulfonylureas described in U.S. Pat. No. 5,476,963

It was an object of the present invention to provide an improved crop protection composition.

Compounds from the group of the 2,4-diamino-s-triazines which are N-substituted at an amino group with a (hetero)aryl(hetero)alkyl group are known as herbicidally active compounds for controlling unwanted vegetation, for example harmful plants in crops, plantations or on non-crop land, see, for example, WO-A-97/08156, WO-A-97/31904, WO-A-98/15536, WO-A-98/15537, WO-A-98/15539 and also WO-A-99/65882, WO-A-00/16627, WO-A-01/43546 WO-A-03/070710, WO-A-04/069814 and the literature cited in these publications.

Surprisingly, it has now been found that herbicides from the group of the N-azinyl-N′-(het)arylsulfonylureas described in the publication U.S. Pat. No. 5,476,936 or salts thereof interact in a particularly favorable manner in combination with structurally different herbicides from the group of the 2,4-diamino-s-triazines which are N-substituted at an amino group with a (hetero)aryl(hetero)alkyl group, for example when they are used for controlling unwanted vegetation in plantation crops, in forest plant rearings, on roadsides, on squares and industrial sites, airfields or railway installations, or for burn-down applications.

Accordingly, the present invention provides a herbicide combination comprising herbicides (A) and (B), where
(A) is one or more herbicides from the group of the compounds of the formula (I) or salts thereof

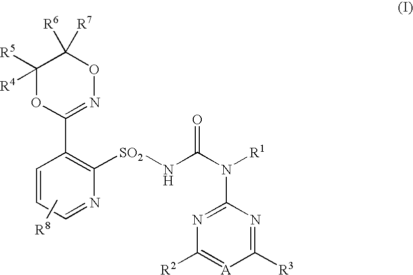

in which
A is nitrogen or a CR¹¹ grouping,
   where
   R¹¹ is hydrogen, alkyl, halogen or haloalkyl,
R¹ is hydrogen or an optionally substituted radical from the group consisting of alkyl, alkoxy, alkoxyalkyl, alkenyl, alkynyl, cycloalkyl, cycloalkylalkyl, aralkyl and aryl,
R² is hydrogen, halogen or is in each case optionally halogen-substituted alkyl, alkoxy, alkylthio, alkylamino or dialkylamino having in each case 1 to 6 carbon atoms,
R³ is hydrogen, halogen or is in each case optionally halogen-substituted alkyl, alkoxy, alkylthio, alkylamino or dialkylamino having in each case 1 to 6 carbon atoms,
R⁴-R⁷ independently of one another are hydrogen, halogen, cyano, thiocyanato or are in each case optionally halogen-substituted alkyl, alkoxy, alkylthio, alkylsulfinyl, alkylsulfonyl, alkylamino, alkylcarbonyl, alkoxycarbonyl, alkylaminocarbonyl having in each case 1 to 3 carbon atoms,
R⁸ is hydrogen, halogen, cyano, thiocyanato or is in each case optionally halogen-substituted alkyl, alkoxy, alkylthio, alkylsulfinyl, alkylsulfonyl, alkylamino, alkylcarbonyl, alkoxycarbonyl, alkylaminocarbonyl having in each case 1 to 3 carbon atoms,
   where in the radicals mentioned above the alkyl and alkylene groups may in each case contain 1 to 6 carbon atoms, the alkenyl and alkynyl groups may in each case contain 2 to 6 carbon atoms, the cycloalkyl groups may in each case contain 3 to 6 carbon atoms and the aryl groups may in each case contain 6 or 10 carbon atoms; and
(B) is one or more herbicides from the group of the 2,4-diamino-s-triazines which are N-substituted at an amino group with a (hetero)aryl(hetero)alkyl group.

In short, “(hetero)aryl(hetero)alkyl group” refers to groups which are radicals composed of aryl- or heteroaryl groups and (cyclo)aliphatic bridges. They include heteroarylalkyl groups, heteroarylalkenyl groups, heteroalkynyl groups, arylalkyl groups, arylalkenyl groups and arylalkynyl groups which may also contain heteroatom from the group consisting of O, S and N in the alkyl, alkenyl or alkynyl bridge, where the bridge in question may also bridge the (hetero)aryl radical in a cyclic manner and thus also form bicyclic radicals with the (hetero)aromatic.

Preferred herbicides (A) are compounds of the formula (I) and salts thereof, in which
A is nitrogen or a CH grouping,
R¹ is hydrogen or an optionally halogen-substituted radical from the group consisting of alkyl, alkoxy, alkoxyalkyl, alkenyl and alkynyl having in each case up to 3 carbon atoms,
R² is hydrogen, halogen or is in each case optionally halogen-substituted alkyl, alkoxy, alkylthio, alkylamino or dialkylamino having in each case 1 to 3 carbon atoms in the alkyl radicals,
R³ is hydrogen, halogen or is in each case optionally halogen-substituted alkyl, alkoxy, alkylthio, alkylamino or dialkylamino having in each case 1 to 3 carbon atoms in the alkyl radicals,
R⁴-R⁷ independently of one another are hydrogen, halogen, cyano, thiocyanato or are in each case optionally halogen-substituted alkyl, alkoxy, alkylthio, alkylsulfinyl, alkylsulfonyl, alkylamino, alkylcarbonyl, alkoxycarbonyl or alkylaminocarbonyl having in each case 1 to 3 carbon atoms in the alkyl radicals,
R⁸ is hydrogen, halogen, cyano, thiocyanato or is in each case optionally halogen-substituted alkyl, alkoxy, alkylthio, alkylsulfinyl, alkylsulfonyl, alkylamino, alkylcarbonyl, alkoxycarbonyl or alkylaminocarbonyl having in each case 1 to 3 carbon atoms in the alkyl radicals.

Also preferred as herbicide (A) are salts obtained by customary processes from compounds of the formula (I) and bases, such as, for example, sodium hydroxide, potassium hydroxide or calcium hydroxide, sodium hydrid, potassium hydride or calcium hydride, sodium amide, potassium amide or calcium amide and sodium carbonate, potassium carbonate or calcium carbonate, sodium C₁-C₄-alkoxides or potassium C₁-C₄-alkoxides, ammonia, C₁-C₄-alkylamines, di-(C₁-C₄-alkyl)-amines or tri-(C₁-C₄-alkyl)-amines.

Particularly preferred as herbicide (A) are compounds of the formula (I) and salts thereof,

in which
A is nitrogen or a CH grouping,
R¹ is hydrogen, methyl, ethyl, methoxy, methoxymethyl or ethoxy,
R² is hydrogen, chlorine, methyl, ethyl, trifluoromethyl, methoxy, ethoxy, difluoromethoxy, methylthio, methylamino or dimethylamino,
R³ is hydrogen, chlorine, methyl, ethyl, trifluoromethyl, methoxy, ethoxy, difluoromethoxy, methylthio, methylamino or dimethylamino,
R⁴-R⁷ independently of one another are hydrogen, fluorine, chlorine, cyano, or are in each case optionally chlorine- or fluorine-substituted methyl, methylthio, methylsulfinyl, methylsulfonyl, methoxycarbonyl and ethoxy-carbonyl, preferably hydrogen,
R⁸ is hydrogen, fluorine, chlorine, bromine, cyano or is in each case optionally chlorine- or fluorine-substituted methyl, methoxy, ethoxy, methylthio, ethylthio, methylsulfinyl, ethylsulfinyl, methylsulfonyl, ethylsulfonyl, methyl- or dimethylamino, preferably hydrogen.

Particularly preferred as herbicide (A) are compounds of the formula (I) and salts thereof, in particular alkali metal salts thereof,

in which
A is nitrogen,
R¹ is hydrogen or methyl,
R² is hydrogen, chlorine, methyl, ethyl, trifluoromethyl, methoxy, ethoxy, difluoromethoxy, methylthio, methylamino or dimethylamino,
R³ is hydrogen, chlorine, methyl, ethyl, trifluoromethyl, methoxy, ethoxy, difluoromethoxy, methylthio, methylamino or dimethylamino,
R⁴-R⁷ are hydrogen,
R⁸ is hydrogen.

Likewise particularly preferred as herbicide (A) are compounds of the formula (I) and salts thereof, in particular alkali metal salts thereof,

in which
A is a CH grouping,
R¹ is hydrogen or methyl,
R² is hydrogen, chlorine, methyl, ethyl, trifluoromethyl, methoxy, ethoxy, difluoromethoxy, methylthio, methylamino or dimethylamino,
R³ is hydrogen, chlorine, methyl, ethyl, trifluoromethyl, methoxy, ethoxy, difluoromethoxy, methylthio, methylamino or dimethylamino,
R⁴-R⁷ are hydrogen,
R⁸ is hydrogen.

The general or preferred radical definitions given above can be combined with one another as desired, i.e. including combinations between the given preferred ranges.

The hydrocarbon radicals mentioned in the definitions, such as alkyl, alkenyl or alkynyl, also in combinations with heteroatoms, such as in alkoxy, alkylthio, haloalkyl or alkylamino, are straight-chain or branched, even if this is not explicitly mentioned.

If appropriate, it is possible to prepare salts from the compounds of the general formula (I), for example metal salts such as alkali (for example Na, K) salts or alkaline earth (for example Mg, Ca) salts or ammonium salts or amine salts. Such salts are obtained in a simple manner by customary methods of forming salts, for example by dissolving or dispersing a compound of the formula (I) in a suitable diluent, such as, for example, methylene chloride, acetone, tert-butyl methyl ether or toluene, and adding a suitable base. The salts can then—if appropriate after prolonged stirring—be isolated by concentration or filtration with suction.

Examples of compounds used as herbicide (A) are mentioned in Table A below, where the following abbreviations are used:
m.p.:=melting point
decomp.=with decomposition
(⁺)=the stated melting point (M.p.) refers in each case to the corresponding sodium salt, i.e. the corresponding compound in which the hydrogen of the —SO₂—NH— group is replaced by sodium.

TABLE A
Examples of compounds of the formula (I) where
R⁴ = R⁵ = R⁶ = R⁷ = R⁸ = H:

| Ex. | | | | | m.p. |
|---|---|---|---|---|---|
| No. | R¹ | A | R² | R³ | (° C.) |
| A-1 | H | CH | OCH₃ | OC₂H₅ | 154 |
| A-2 | H | CH | OCH₃ | CH₃ | |
| A-3 | H | CH | OHC₃ | CH₃ | 180-181⁽⁺⁾ |
| A-4 | H | CH | OCH₃ | C₂H₅ | |
| A-5 | H | CH | OCH₃ | CF₃ | |
| A-6 | H | CH | OCH₃ | OCF₂H | |
| A-7 | H | CH | OCH₃ | NHCH₃ | |
| A-8 | H | CH | OCH₃ | N(CH₃)2 | 199.5 |
| A-9 | H | CH | OCH₃ | Cl | 110-111 |
| A-10 | H | CH | OCH₃ | Cl | 175-178⁽⁺⁾ |
| A-11 | H | CH | OCH₃ | OCH₃ | 167-168 |
| A-12 | H | CH | OCH₃ | OCH₃ | 171-172⁽⁺⁾ |
| A-13 | H | CH | OC₂H₅ | OC₂H₅ | |
| A-14 | H | CH | OC₂H₅ | OC₂H₅ | 152-154⁽⁺⁾ |
| A-15 | H | CH | OC₂H₅ | CH₃ | |
| A-16 | H | CH | OC₂H₅ | C₂H₅ | |
| A-17 | H | CH | OC₂H₅ | CF₃ | |
| A-18 | H | CH | OC₂H₅ | OCF₂H | |
| A-19 | H | CH | OC₂H₅ | NHCH₃ | |
| A-20 | H | CH | OC₂H₅ | N(CH₃)₂ | |
| A-21 | H | CH | OC₂H₅ | Cl | 158-159 |
| A-22 | H | CH | OC₂H₅ | Cl | 213⁽⁺⁾ |
| A-23 | H | CH | CH₃ | CH₃ | 153 |
| A-24 | H | CH | CH₃ | C₂H₅ | |
| A-25 | H | CH | CH₃ | CF₃ | |
| A-26 | H | CH | CH₃ | OCF₂H | |
| A-27 | H | CH | CH₃ | NHCH₃ | |
| A-28 | H | CH | CH₃ | N(CH₃)₂ | |
| A-29 | H | CH | CH₃ | Cl | 108-109 |
| A-30 | H | CH | CH₃ | Cl | >300⁽⁺⁾ |
| A-31 | H | CH | C₂H₅ | C₂H₅ | |
| A-32 | H | CH | C₂H₅ | CF₃ | |
| A-33 | H | CH | C₂H₅ | OCF₂H | |
| A-34 | H | CH | C₂H₅ | NHCH₃ | |
| A-35 | H | CH | C₂H₅ | Cl | |
| A-36 | H | CH | CF₃ | CF₃ | |
| A-37 | H | CH | CF₃ | OCF₂H | |
| A-38 | H | CH | CF₃ | NHCH₃ | |
| A-39 | H | CH | CF₃ | N(CH₃)₂ | |
| A-40 | H | CH | CF₃ | Cl | |
| A-41 | H | CH | OCF₂H | OCF₂H | |
| A-42 | H | CH | OCF₂H | NHCH₃ | |
| A-43 | H | CH | OCF₂H | N(CH₃)₂ | |
| A-44 | H | CH | OCF₂H | Cl | |
| A-45 | H | CH | NHCH₃ | NHCH₃ | |
| A-46 | H | CH | NHCH₃ | N(CH₃)₂ | |
| A-47 | H | CH | NHCH₃ | Cl | |
| A-48 | H | CH | N(CH₃)₂ | N(CH₃)₂ | |
| A-49 | H | CH | N(CH₃)₂ | Cl | |
| A-50 | H | CH | Cl | Cl | |
| A-51 | H | N | OCH₃ | OCH₃ | 255 |
| A-52 | H | N | OCH₃ | OCH₃ | 159-162⁽⁺⁾ |
| A-53 | H | N | OCH₃ | OC₂H₅ | |
| A-54 | H | N | OCH₃ | CH₃ | |
| A-55 | H | N | OCH₃ | C₂H₅ | |
| A-56 | H | N | OCH₃ | CF₃ | |
| A-57 | H | N | OCH₃ | OCF₂H | |
| A-58 | H | N | OCH₃ | NHCH₃ | |
| A-59 | H | N | OCH₃ | N(CH₃)₂ | |
| A-60 | H | N | OCH₃ | N(CH₃)₂ | 156⁽⁺⁾ |
| A-61 | H | N | OCH₃ | Cl | |
| A-62 | H | N | OC₂H₅ | OC₂H₅ | |
| A-63 | H | N | OC₂H₅ | CH₃ | |
| A-64 | H | N | OC₂H₅ | C₂H₅ | |
| A-65 | H | N | OC₂H₅ | CF₃ | |
| A-66 | H | N | OC₂H₅ | OCF₂H | |
| A-67 | H | N | OC₂H₅ | NHCH₃ | |
| A-68 | H | N | OC₂H₅ | N(CH₃)₂ | |
| A-69 | H | N | OC₂H₅ | Cl | |
| A-70 | H | N | OC₂H₅ | Cl | 213⁽⁺⁾ |
| A-71 | H | N | CH₃ | CH₃ | |
| A-72 | H | N | CH₃ | C₂H₅ | |
| A-73 | H | N | CH₃ | CF₃ | |
| A-74 | H | N | CH₃ | OCF₂H | |
| A-75 | H | N | CH₃ | NHCH₃ | |
| A-76 | H | N | CH₃ | N(CH₃)₂ | |
| A-77 | H | N | CH₃ | Cl | |
| A-78 | H | N | C₂H₅ | C₂H₅ | |
| A-79 | H | N | C₂H₅ | CF₃ | |
| A-80 | H | N | C₂H₅ | OCF₂H | |
| A-81 | H | N | C₂H₅ | NHCH₃ | |
| A-82 | H | N | C₂H₅ | Cl | |
| A-83 | H | N | CF₃ | CF₃ | |
| A-84 | H | N | CF₃ | OCF₂H | |
| A-85 | H | N | CF₃ | NHCH₃ | |
| A-86 | H | N | CF₃ | N(CH₃)₂ | |
| A-87 | H | N | CF₃ | Cl | |
| A-88 | H | N | OCF₂H | OCF₂H | |
| A-89 | H | N | OCF₂H | NHCH₃ | |
| A-90 | H | N | OCF₂H | N(CH₃)₂ | |
| A-91 | H | N | OCF₂H | Cl | |
| A-92 | H | N | NHCH₃ | NHCH₃ | |
| A-93 | H | N | NHCH₃ | N(CH₃)₂ | |
| A-94 | H | N | NHCH₃ | Cl | |
| A-95 | H | N | N(CH₃)₂ | N(CH₃)₂ | |
| A-96 | H | N | N(CH₃)₂ | Cl | |
| A-97 | H | N | Cl | Cl | |
| A-98 | CH₃ | N | OCH₃ | OCH₃ | |
| A-99 | CH₃ | N | OCH₃ | OC₂H₅ | |
| A-100 | CH₃ | N | OCH₃ | CH₃ | |
| A-101 | CH₃ | N | OCH₃ | C₂H₅ | |
| A-102 | CH₃ | N | OCH₃ | CF₃ | |
| A-103 | CH₃ | N | OCH₃ | OCF₂H | |
| A-104 | CH₃ | N | OCH₃ | NHCH₃ | |
| A-105 | CH₃ | N | OCH₃ | N(CH₃)₂ | |
| A-106 | CH₃ | N | OCH₃ | Cl | |
| A-107 | CH₃ | N | OC₂H₅ | OC₂H₅ | |
| A-108 | CH₃ | N | OC₂H₅ | CH₃ | |
| A-109 | CH₃ | N | OC₂H₅ | C₂H₅ | |
| A-110 | CH₃ | N | OC₂H₅ | CF₃ | |
| A-111 | CH₃ | N | OC₂H₅ | OCF₂H | |
| A-112 | CH₃ | N | OC₂H₅ | NHCH₃ | |
| A-113 | CH₃ | N | OC₂H₅ | N(CH₃)₂ | |
| A-114 | CH₃ | N | OC₂H₅ | Cl | |
| A-115 | CH₃ | N | CH₃ | CH₃ | |
| A-116 | CH₃ | N | CH₃ | C₂H₅ | |
| A-117 | CH₃ | N | CH₃ | CF₃ | |
| A-118 | CH₃ | N | CH₃ | OCF₂H | |
| A-119 | CH₃ | N | CH₃ | NHCH₃ | |
| A-120 | CH₃ | N | CH₃ | N(CH₃)₂ | |
| A-121 | CH₃ | N | CH₃ | Cl | |
| A-122 | CH₃ | N | C₂H₅ | C₂H₅ | |
| A-123 | CH₃ | N | C₂H₅ | CF₃ | |
| A-124 | CH₃ | N | C₂H₅ | OCF₂H | |
| A-125 | CH₃ | N | C₂H₅ | NHCH₃ | |
| A-126 | CH₃ | N | C₂H₅ | Cl | |
| A-127 | CH₃ | N | CF₃ | CF₃ | |
| A-128 | CH₃ | N | CF₃ | OCF₂H | |
| A-129 | CH₃ | N | CF₃ | NHCH₃ | |
| A-130 | CH₃ | N | CF₃ | N(CH₃)₂ | |
| A-131 | CH₃ | N | CF₃ | Cl | |
| A-132 | CH₃ | N | OCF₂H | OCF₂H | |
| A-133 | CH₃ | N | OCF₂H | NHCH₃ | |
| A-134 | CH₃ | N | OCF₂H | N(CH₃)₂ | |
| A-135 | CH₃ | N | OCF₂H | Cl | |
| A-136 | CH₃ | N | NHCH₃ | NHCH₃ | |
| A-137 | CH₃ | N | NHCH₃ | N(CH₃)₂ | |
| A-138 | CH₃ | N | NHCH₃ | Cl | |
| A-139 | CH₃ | N | N(CH₃)₂ | N(CH₃)₂ | |
| A-140 | CH₃ | N | N(CH₃)₂ | Cl | |
| A-141 | CH₃ | N | Cl | Cl | |
| A-142 | H | N | N(CH₃)₂ | OCH₂CF₃ | 158 |
| A-143 | H | CH | Cl | OCH₂CF₃ | 204-205 |
| A-144 | H | CH | Cl | OCH₂CF₃ | |
| A-145 | H | CH | Cl | OCH₂CF₃ | 207⁽⁺⁾ |

Suitable compounds of group (B), i.e. the 2,4-diamino-s-triazines, are the active compounds known from the patent publications already cited above, in particular 2,4-diamino-6-(halo)(cyclo)alkyl-s-triazine compounds substituted at an amino group by arylalkyl radicals, heteroarylalkyl radicals, aryloxyalkyl radicals, heteroaryloxyalkyl radicals, arylalkoxyalkyl radicals, heteroarylalkoxyalkyl radicals or bicyclic radicals, preferably bicyclic radicals in which the cycle further from the point of attachment is aromatic or heteroaromatic.

Preferred compounds of group (B) are one or more 2,4-diamino-s-triazines comprising compounds having the formulae (II), (III), (IV) and (V) mentioned below, or salts thereof, i.e.

T1. compounds of the formula (II) and salts thereof,

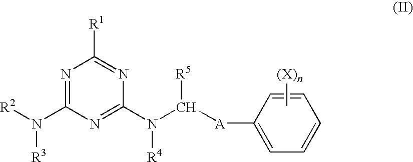

in which
R¹ is (C₁-C₆)-alkyl, which is unsubstituted or substituted by one or more radicals from the group consisting of halogen, cyano, nitro, thiocyanato, (C₁-C₄)-alkoxy, (C₁-C₄)-alkylthio, (C₁-C₄)-alkylsulfinyl, (C₁-C₄)-alkylsulfonyl, (C₂-C₄)-alkenyl, (C₂-C₄)-alkynyl, phenyl, which is unsubstituted or substituted, and heterocyclyl having 3 to 6 ring atoms and 1 to 3 ring heteroatoms from the group consisting of N, O and S, where the ring is unsubstituted or substituted,
R² and R³ are each independently of one another hydrogen, amino or alkylamino or dialkylamino having in each case 1 to 6 carbon atoms in the alkyl radical, an acyclic or cyclic hydrocarbon radical or hydrocarbonoxy radical having in each case 1 to 10 carbon atoms or a heterocyclyl radical, heterocyclyloxy radical or heterocyclylamino radical having in each case 3 to 6 ring atoms and 1 to 3 ring heteroatoms from the group consisting of N, O and S, where each of the five last-mentioned radicals is unsubstituted or substituted, or an acyl radical, or
   R² and R³ together with the nitrogen atom of the group NR²R³ are a heterocyclic radical having 3 to 6 ring atoms and 1 to 4 ring heteroatoms, where in addition to the nitrogen atom any further ring heteroatoms are selected from the group consisting of N, O and S and where the radical is unsubstituted or substituted,
R⁴ is hydrogen, amino, alkylamino or dialkylamino having in each case 1 to 6 carbon atoms in the alkyl radical, an acyclic or cyclic hydrocarbon radical or hydrocarbonoxy radical having in each case 1 to 10 carbon atoms, preferably having 1 to 6 carbon atoms, or a heterocyclyl radical, heterocyclyloxy radical or heterocyclylamino radical having in each case 3 to 6 ring atoms and 1 to 3 ring heteroatoms from the group consisting of N, O and S, where each of the five last-mentioned radicals is unsubstituted or substituted, or an acyl radical,
R⁵ is hydrogen, halogen, nitro, cyano, thiocyanato or a radical of the formula —B¹—Y¹, where B¹ and Y¹ are as defined below,
A is an alkylene radical having 1 to 5 straight-chain carbon atoms or alkenylene or alkynylene having in each case 2 to 5 straight-chain carbon atoms, where each of the three last-mentioned diradicals is unsubstituted or substituted by one or more radicals from the group consisting of halogen, nitro, cyano, thiocyanato and a radical of the formula —B²—Y²,
(X)ₙ are n substituents X, where each X independently of the others is halogen, (C₁-C₆)-alkyl, (C₂-C₆)-alkenyl, (C₂-C₆)-alkynyl, (C₁-C₆)-alkoxy, (C₂-C₆)-alkenyloxy, (C₂-C₆)-alkynyloxy, [(C₁-C₄)-alkyl]-carbonyl, [(C₁-C₄)-alkoxy]-carbonyl or [(C₁-C₄)-alkylthio]-carbonyl, where the hydrocarbon-containing parts in the 9 last-mentioned radicals are unsubstituted or substituted, or a radical of the formula —B^{o}—R^{o}, where B^{o} is as defined below and R^{o} is an aromatic, saturated or partially saturated carbocyclic or heterocyclic radical, where the cyclic radical is substituted or unsubstituted,
   or two adjacent radicals X together are a fused-on cyclus having 4 to 6 ring atoms which is carbocyclic or contains ring heteroatoms from the group consisting of O, S and N and which is unsubstituted or substituted by one or more radicals from the group consisting of halogen, (C₁-C₄)-alkyl and oxo,
n is 0, 1, 2, 3, 4 or 5,
B^{o}, B¹, B² are each independently of one another a direct bond or a divalent group of the formula —O—, —S(O)ₚ—, —S(O)ₚ—O—, —O—S(O)ₚ—, —CO—, —O—CO—, —CO—O—, —NR′—, —O—NR′—, —NR′—O—, —NR′—CO—, —CO—NR′—, where p=0, 1 or 2 and R′ is hydrogen, alkyl having 1 to 6 carbon atoms, phenyl, benzyl, cycloalkyl having 3 to 6 carbon atoms or alkanoyl having 1 to 6 carbon atoms,
Y¹, Y² are each independently of one another H or an acyclic hydrocarbon radical having, for example, in each case 1 to 20 carbon atoms or a cyclic hydrocarbon radical having 3 to 8 carbon atoms or a heterocyclic radical having 3 to 9 ring atoms and 1 to 3 ring heteroatoms from the group consisting of N, O and S, where each of the three last-mentioned radicals is unsubstituted or substituted;

T2. compounds of the formula (III) or salts thereof,

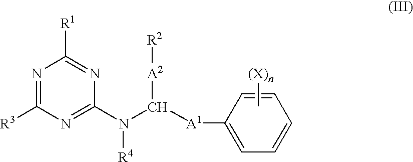

in which
R¹ is aryl which is unsubstituted or substituted, or (C₃-C₉)-cycloalkyl which is unsubstituted or substituted, or heterocyclyl which is substituted or unsubstituted, or
   (C₁-C₆)-alkyl, (C₂-C₆)-alkenyl or (C₂-C₆)-alkynyl,
   where each of the 3 last-mentioned radicals is unsubstituted or substituted by one or more radicals from the group consisting of halogen, hydroxy, cyano, nitro, thiocyanato, (C₁-C₄)-alkoxy, (C₁-C₄)-haloalkoxy, (C₂-C₄)-alkenyloxy, (C₂-C₄)-haloalkenyloxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl and (C₃-C₉)-cycloalkyl which is unsubstituted or substituted, and phenyl which is unsubstituted or substituted, and heterocyclyl which is unsubstituted or substituted, and radicals of the formulae R′—C(═Z′)—, R′—C(═Z′)—Z—, R′—Z—C(═Z′)—, R′R″N—C(═Z′)—, R′—Z—C(═Z′)—O—, R′R″N—C(═Z′)—Z—, R′—C(═Z′)—NR″— and R′R″N—C(═Z′)—NR′″—, in which R′, R″ and R′″ are each independently of one another (C₁-C₆)-alkyl, aryl, aryl-(C₁-C₆)alkyl, (C₃-C₉)-cycloalkyl or (C₃-C₉)-cycloalkyl-(C₁-C₆)alkyl, where each of the 5 last-mentioned radicals is unsubstituted or substituted and in which Z and Z′ independently of one another are each an oxygen or sulfur atom,
R² is (C₃-C₉)-cycloalkyl which is unsubstituted or substituted, (C₄-C₉)-cycloalkenyl which is unsubstituted or substituted, heterocyclyl which is unsubstituted or substituted, or phenyl which is unsubstituted or substituted, or
R³ is a radical of the formula —N(B¹-D¹)(B²-D²) or —NR′—N(B¹-D¹)(B²-D²), in which in each case B¹, B², D¹ and D² are as defined below and R′ is hydrogen, (C₁-C₆)-alkyl or [(C₁-C₄)-alkyl]-carbonyl,
R⁴ is a radical of the formula —B³-D³, where B³ and D³ are as defined below, A¹ is straight-chain alkylene having 1 to 5 carbon atoms or straight-chain alkenylene or alkynylene having in each case 2 to 5 carbon atoms, where each of the three last-mentioned diradicals is unsubstituted or substituted by one or more radicals from the group consisting of halogen, nitro, cyano, thiocyanato and radicals of the formula —B⁴-D⁴, where B⁴ and D⁴ are as defined below,
A² is a direct bond or straight-chain alkylene having 1 to 4 carbon atoms or straight-chain alkenylene or alkynylene having in each case 2 to 5 carbon atoms, where each of the three last-mentioned diradicals is unsubstituted or substituted by one or more radicals from the group consisting of halogen, nitro, cyano, thiocyanato and radicals of the formula —B⁵-D⁵, or a divalent radical of the formula VI¹, VI², VI³, VI⁴ or VI⁵,

—CR⁶R⁷-W*-CR⁸R⁹- (VI¹)

—CR¹⁰R¹¹-W*-CR¹²R¹³—CR¹⁴R¹⁵— (VI²)

—CR¹⁶R¹⁷—CR¹⁸R¹⁹W*-CR²⁰R²¹— (VI³)

—CR²²R²³—CR²⁴R²⁵—W*- (VI⁴)

—CR²⁶R²⁷—W*- (VI⁵)
where each of the radicals R⁶ to R²⁷ in each case independently of the others is hydrogen, halogen, nitro, cyano, thiocyanato or a radical of the formula —B⁶-D⁶,
W* is in each case an oxygen atom, a sulfur atom or a group of the formula N(B⁷-D⁷) and
B⁵, B⁶, B⁷, D⁵, D⁶ and D⁷ are as defined below,
B¹, B², B³ and B⁷ are each independently of one another a direct bond or a divalent group of the formula —C(═Z*)—, —C(═Z*)—Z**—, —C(═Z*)-NH— or —C(═Z*)-NR*—, where Z*=an oxygen or sulfur atom, Z**=an oxygen or sulfur atom and R*=(C₁-C₆)-alkyl, aryl, aryl-(C₁-C₆)alkyl, (C₃-C₉)-cycloalkyl or (C₃-C₉)-cycloalkyl-(C₁-C₆)alkyl, where each of the 5 last-mentioned radicals is unsubstituted or substituted,
B⁴, B⁵ and B⁶ are each independently of one another a direct bond or a divalent group of the formula —O—, —S(O)ₚ—, —S(O)ₚ—O—, —O—S(O)ₚ—, —CO—, —O—CO—, —CO—O—, —S—CO—, —CO—S—, —S—CS—, —CS—S—, —O—CO—O—, —NR^{O}—, —O—NR^{O}—, —NR^{O}—O—, —NR^{O}—CO—, —CO—NR^{O}—, —O—CO—NR^{O}— or —NR^{O}—CO—O—, where p is the integer 0, 1 or 2 and R^{O} is hydrogen, (C₁-C₆)-alkyl, aryl, aryl-(C₁-C₆)alkyl, (C₃-C₉)-cycloalkyl or (C₃-C₉)-cycloalkyl-(C₁-C₆)alkyl, where each of the 5 last-mentioned radicals is unsubstituted or substituted,
D¹, D², D³, D⁴, D⁵ D⁶ and D⁷ are each independently of one another hydrogen, (C₁-C₆)-alkyl, aryl, aryl-(C₁-C₆)alkyl, (C₃-C₉)-cycloalkyl or (C₃-C₉)-cycloalkyl-(C₁-C₆)alkyl, where each of the 5 last-mentioned radicals is unsubstituted or substituted, or in each case two radicals D⁵ of two groups B⁵-D⁵ attached to a carbon atom are linked to one another forming an alkylene group which has 2 to 4 carbon atoms and is unsubstituted or substituted by one or more radicals from the group consisting of (C₁-C₄)alkyl and (C₁-C₄)alkoxy,
(X)ₙ are n substituents X, where each X independently of the others is halogen, hydroxy, amino, nitro, formyl, carboxy, cyano, thiocyanato, aminocarbonyl or (C₁-C₆)-alkyl, (C₁-C₆)-alkoxy, (C₁-C₆)-alkylthio, mono(C₁-C₆)alkylamino, di(C₁-C₄)alkylamino, (C₂-C₆)-alkenyl, (C₂-C₆)-alkynyl, [(C₁-C₆)-alkyl]carbonyl, [(C₁-C₆)-alkoxy]carbonyl, mono(C₁-C₆)alkylamino-carbonyl di(C₁-C₄)alkylamino-carbonyl, N—(C₁-C₆)-alkanoyl-amino or N—(C₁-C₄)-alkanoyl-N—(C₁-C₄)alkyl-amino, where each of the 13 last-mentioned radicals is unsubstituted or substituted, preferably unsubstituted or substituted by one or more radicals from the group consisting of halogen, hydroxy, amino, nitro, formyl, carboxy, cyano, thiocyanato, (C₁-C₄)-alkoxy, (C₁-C₄)-haloalkoxy, (C₁-C₄)-alkylthio, (C₁-C₄)-haloalkylthio, mono(C₁-C₄)alkylamino, di(C₁-C₄)alkylamino, (C₃-C₉)-cycloalkyl, (C₃-C₉)-cycloalkyl-amino, [(C₁-C₄)-alkyl]carbonyl, [(C₁-C₄)-alkoxy]carbonyl, aminocarbonyl, mono(C₁-C₄)alkylamino-carbonyl, di(C₁-C₄)alkylamino-carbonyl, phenyl, phenoxy, phenylthio, phenylcarbonyl, heterocyclyl, heterocyclyloxy, heterocyclylthio and heterocyclylamino, where each of the 8 last-mentioned radicals is unsubstituted or has one or more substituents from the group consisting of halogen, nitro, cyano, (C₁-C₄)-alkyl, (C₁-C₄)-alkoxy, (C₁-C₄)-alkylthio, (C₁-C₄)-haloalkyl, (C₁-C₄)-haloalkoxy, formyl, (C₁-C₄)-alkyl-carbony and (C₁-C₄)-alkoxy-carbonyl,
   or (C₃-C₉)-cycloalkyl, (C₃-C₉)-cycloalkoxy, (C₃-C₉)-cycloalkylamino, phenyl, phenoxy, phenylthio, phenylcarbonyl, heterocyclyl, heterocyclyloxy, heterocyclylthio or heterocyclylamino, where each of the 11 last-mentioned radicals is unsubstituted or substituted, or two adjacent radicals X together are a fused-on cycle having 4 to 6 ring atoms which is carbocyclic or contains ring heteroatoms from the group consisting of O, S and N and which is unsubstituted or substituted by one or more radicals from the group consisting of halogen, (C₁-C₄)-alkyl and oxo,
n is 0, 1, 3, 4 or 5 and
   “heterocyclyl” in the radicals mentioned above is independently of the others in each case a heterocyclic radical having 3 to 7 ring atoms and 1 to 3 heteroatoms from the group consisting of N, O and S,
   where preferably
a) the total sum of the carbon atoms in the radicals A¹ and A²-R² is at least 6 carbon atoms or
b) the total sum of the carbon atoms in the radicals A¹ and A²—R² is 5 carbon atoms and A¹=a group of the formula —CH₂— or —CH₂CH₂— and R¹═(C₁-C₄)-alkyl, (C₁-C₄)-haloalkyl, (C₂-C₆)-haloalkenyl or (C₃-C₉)-cycloalkyl which is unsubstituted or substituted

T3. compounds of the formula (IV) or salts thereof,

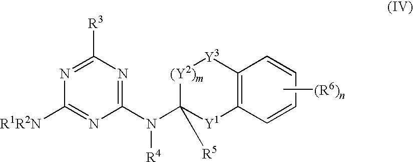

in which
R¹ and R² are each independently of one another hydrogen, amino, alkylamino or dialkylamino having in each case 1 to 6 carbon atoms in the alkyl radical, an acyclic or cyclic hydrocarbon radical or hydrocarbonoxy radical having in each case 1 to 10 carbon atoms or a heterocyclyl radical, heterocyclyloxy radical, heterocyclylthio radical or heterocyclylamino radical having in each case 3 to 6 ring atoms and 1 to 3 ring heteroatoms from the group consisting of N, O and S, where each of the five last-mentioned radicals is unsubstituted or substituted, or an acyl radical or
R¹ and R² together with the nitrogen atom of the group NR¹R² are a heterocyclic radical having 3 to 6 ring atoms and 1 to 4 ring heteroatoms, where in addition to the nitrogen atom any further ring heteroatoms are selected from the group consisting of N, O and S and where the radical unsubstituted or substituted,
R³ is halogen, cyano, thiocyanato, nitro or a radical of the formula —Z¹—R⁷,
R⁴ is hydrogen, amino, alkylamino or dialkylamino having in each case 1 to 6 carbon atoms in the alkyl radical, an acyclic or cyclic hydrocarbon radical or hydrocarbonoxy radical having in each case 1 to 10 carbon atoms or a heterocyclyl radical, heterocyclyloxy radical or heterocyclylamino radical having in each case 3 to 6 ring atoms and 1 to 3 ring heteroatoms from the group consisting of N, O and S, where each of the five last-mentioned radicals is unsubstituted or substituted, or an acyl radical,
R⁵ is halogen, cyano, thiocyanato, nitro or a radical of the formula —Z²—R⁸,
R⁶, if n=1, or the radicals R⁶ each independently of one another, if n is greater than 1, is/are halogen, cyano, thiocyanato, nitro or a group of the formula —Z³—R⁹,
R⁷, R⁸, R⁹ are each independently of one another
   hydrogen or
   an acyclic hydrocarbon radical, where carbon atoms in the chain may be replaced by heteroatoms from the group consisting of N, O and S, or
   a cyclic hydrocarbon radical or
   a heterocyclic radical,

where each of the last-mentioned 3 radicals is unsubstituted or substituted,
Z¹, Z², Z³ are each independently of one another
   a direct bond or
   a divalent group of the formula —O—, —S(O)ₚ—, —S(O)ₚ—O—, —O—S(O)ₚ—, —CO—, —CS—, —S—CO—, —CO—S—, —O—CS—, —CS—O—, —S—CS—, —CS—S—, —OCO—, —CO—O—, —NR′—, —O—NR′—, —NR′—O—, —NR′—CO— or —CO—NR′—, where p=0, 1 or 2 ist and R′ is hydrogen, alkyl having 1 to 6 carbon atoms, phenyl, benzyl, cycloalkyl having 3 to 6 carbon atoms or alkanoyl having 1 to 6 carbon atoms,
Y¹, Y², Y³ and further groups Y², if m is 2, 3 or 4, each independently of one another are
   a divalent group of the formula CR^{a}R^{b}, where R^{a} and R^{b} are identical or different and are each a radical from the group consisting of the radicals possible for R⁷ to R⁹, or
   a divalent group of the formula —O—, —CO—, —C(═NR*)—, —S(O)_{q}—, —NR*- or —N(O)—, where q=0, 1 or 2 and R* is hydrogen or alkyl having 1 to 4 carbon atoms, or
   Y¹ or Y³ is a direct bond,

where two oxygen atoms of the groups Y² and Y³ are not adjacent,
m is 1, 2, 3 or 4,
n is 0, 1, 2, 3 or 4;

T4. substituted 2,4-diamino-1,3,5-triazines of the general formula (V),

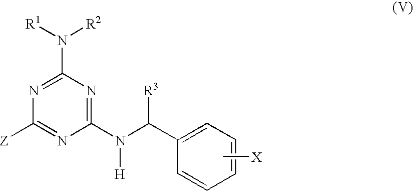

in which
R¹ is hydrogen or is optionally hydroxyl-, cyano-, halogen- or C₁-C₄-alkoxy-substituted alkyl having 1 to 6 carbon atoms,
R² is hydrogen, is formyl, is in each case optionally cyano-, halogen- or C₁-C₄-alkoxy-substituted alkyl, alkylcarbonyl, alkoxycarbonyl or alkylsulfonyl having in each case 1 to 6 carbon atoms in the alkyl groups, or is in each case optionally cyano-, halo-C₁-C₄-alkyl-, C₁-C₄-alkoxy-, halo-C₁-C₄-alkoxy- or C₁-C₄-alkoxy-carbonyl-substituted phenylcarbonyl, naphthylcarbonyl, phenylsulfonyl or naphthylsulfonyl,
R³ is optionally cyano-, halogen- or C₁-C₄-alkoxy-substituted alkyl having 1 to 6 carbon atoms or is optionally cyano-, halogen- or C₁-C₄-alkyl-substituted cycloalkyl having 3 to 6 carbon atoms,
X is a substituent from the group below:
   hydroxyl, cyano, nitro, halogen, in each case optionally hydroxyl-, cyano- or halogen-substituted alkyl or alkoxy having in each case 1 to 6 carbon atoms, in each case optionally halogen-substituted alkylcarbonyl, alkoxycarbonyl, alkylthio, alkylsulfinyl or alkylsulfonyl having in each case 1 to 6 carbon atoms in the alkyl groups, in each case optionally hydroxyl-, cyano-, nitro-, halogen-, C₁-C₄-alkyl-, C₁-C₄-haloalkyl-, C₁-C₄-alkoxy- or C₁-C₄-haloalkoxy-substituted phenyl or phenoxy, and
Z is hydrogen, hydroxy, halogen, is in each case optionally hydroxyl-, cyano-, nitro-, halogen-, C₁-C₄-alkoxy-, C₁-C₄-alkyl-carbonyl-, C₁-C₄-alkoxy-carbonyl-, C₁-C₄-alkylthio-, C₁-C₄-alkylsulfinyl- or C₁-C₄-alkylsulfonyl-substituted alkyl, alkoxy, alkylcarbonyl, alkoxycarbonyl, alkylthio, alkylsulfinyl or alkylsulfonyl having in each case 1 to 6 carbon atoms in the alkyl groups, is in each case optionally halogen-substituted alkenyl or alkynyl having in each case 2 to 6 carbon atoms or is optionally cyano-, halogen- or C₁-C₄-alkyl-substituted cycloalkyl having 3 to 6 carbon atoms.

Particularly preferred compounds of group (B) are the 2,4-diamino-s-triazines mentioned of the formulae (II) to (V) which are substituted in position 6 at the triazine ring by radicals from the group consisting of hydrogen, (C₁-C₆)-alkyl, (C₁-C₆)-haloalkyl, (C₃-C₆)-cycloalkyl and (C₃-C₆)-cycloalkyl-(C₁-C₄)-alkyl, preferably (C₁-C₄)-alkyl and (C₁-C₄)-haloalkyl.

Here, halogen-substituted alkyl (=haloalkyl) is to be understood as meaning alkyl which is substituted by one or more halogen atoms from the group consisting of fluorine, chlorine, bromine and iodine, preferably from the group consisting of fluorine, chlorine and bromine, in particular from the group consisting of fluorine and chlorine.

Preference is also given to compounds of the formulae (II) to (V) in which one amino group is unsubstituted, i.e. NH₂, and the other amino group carries a hydrogen atom and the (hetero)aryl(hetero)alkyl radical.

Also preferred as active compounds are, for example, 2,4-diamino-s-triazines of group T5, such as compounds of the formula (IIa)

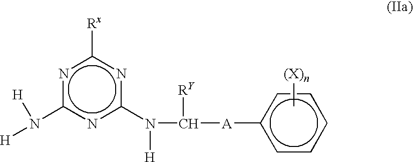

in which
R^{X} is (C₁-C₄)-alkyl or (C₁-C₄)-haloalkyl;
R^{Y} is (C₁-C₄)-alkyl, (C₃-C₆)-cycloalkyl or (C₃-C₆)-cycloalkyl-(C₁-C₄)-alkyl and
A is —CH₂—, —CH₂CH₂—, —CH₂CH₂—CH₂, —O—, —CH₂—CH₂—O—, —CH₂—CH₂-CH₂—O—.
X is (C₁-C₄)-alkyl and
n is 0, 1, 2, 3, 4 or 5, preferably 1 or 2.

The general or preferred radical definitions given above can be combined with one another as desired, i.e. including combinations between the given preferred ranges.

The hydrocarbon radicals mentioned in the definitions, such as alkyl, alkenyl or alkynyl, also in combinations with heteroatoms, such as in alkoxy, alkylthio, haloalkyl or alkylamino, are straight-chain or branched, even if this is not explicitly mentioned.

Preference is also given to compounds of the formula (IV) having bicyclic radicals as known from WO-A-97/31904 or WO-A-04/069814, in particular as listed in Table B below:

Preferred active compounds from the group consisting of the 2,4-diamino-s-triazines are listed, for example, in Table B below.

TABLE B

| No. | Chemical name |
|---|---|
| B-1 | (RS)-2-amino-4-(4-phenyl-1-cyclopropylbutylamino)-6-(1-fluoro-1-methyl-ethyl)- |
| | 1,3,5-triazine, |
| B-2 | (R)-2-amino-4-(4-phenyl-1-cyclopropylbutylamino)-6-(1-fluoro-1-methyl-ethyl)- |
| | 1,3,5-triazine, |
| B-3 | 2-amino-4-[(1RS)-4-phenyl-1-cyclopropylbutylamino]-6-[(1RS)-1- |
| | fluoroethyl]-1,3,5-triazine, |
| B-4 | 2-amino-4-[(1R)-4-phenyl-1-cyclopropylbutylamino]-6-[(1RS)-1- |
| | fluoroethyl]-1,3,5-triazine, |
| B-5 | 2-amino-4-[(1RS)-3-phenyl-1-cyclobutylpropylamino]-6-[(1RS)-1- |
| | fluoroethyl]-1,3,5-triazine, |
| B-6 | 2-amino-4-[(1R)-3-phenyl-1-cyclobutylpropylamino]-6-[(1RS)-1- |
| | fluoroethyl]-1,3,5-triazine, |
| B-7 | 2-amino-4-[(1R)-3-phenyl-1-cyclobutylpropylamino]-6-[(1R)-1-fluoroethyl]- |
| | 1,3,5-triazine, |
| B-8 | (RS)-2-amino-6-(1-fluoro-1-methylethyl)-4-[1-(3,5-dimethylphenoxy)prop- |
| | 2-ylamino)-1,3,5-triazine, |
| B-9 | (R)-2-amino-4-(3-phenyl-1-cyclobutylpropylamino)-6-(1-fluoro-1-methyl- |
| | ethyl)-1,3,5-triazine, |
| B-10 | 2-amino-4-[(4RS)-chroman-4-ylamino]-6-(1-fluoro-1-methylethyl)-1,3,5- |
| | triazine, |
| B-11 | 2-amino-4-[(4R)-chroman-4-ylamino]-6-(1-fluoro-1-methylethyl)-1,3,5- |
| | triazine, |
| B-12 | 2-amino-4-[(4R)-chroman-4-ylamino]-6-[(1RS)-1-fluoroethyl]-1,3,5- |
| | triazine, |
| B-13 | 2-amino-4-[(4R)-chroman-4-ylamino]-6-[(1R)-1-fluoroethyl]-1,3,5-triazine, |
| B-14 | 2-amino-4-[(4R)-chroman-4-ylamino]-6-[(1S)-1-fluoroethyl]-1,3,5-triazine, |
| B-15 | 2-amino-4-[(4RS)-7,8-dimethylchroman-4-ylamino]-6-(1-fluoro-1- |
| | methylethyl)-1,3,5-triazine, |
| B-16 | 2-amino-4-[(4R)-7,8-dimethylchroman-4-ylamino]-6-(1-fluoro-1- |
| | methylethyl)-1,3,5-triazine, |
| B-17 | 2-amino-4-[(1RS)-indan-1-ylamino]-6-(1-fluoro-1-methylethyl]-1,3,5- |
| | triazine, |
| B-18 | 2-amino-4-[(1R)-indan-1-ylamino]-6-(1-fluoro-1-methylethyl]-1,3,5- |
| | triazine, |
| B-19 | 2-amino-4-[(1RS)-6-methylindan-1-ylamino]-6-(1-methylethyl]-1,3,5- |
| | triazine, |
| B-20 | 2-amino-4-[(1RS)-6-methylindan-1-ylamino]-6-[(1RS)-1-fluoroethyl]-1,3,5- |
| | triazine, |
| B-21 | 2-amino-4-[(1R)-6-methylindan-1-ylamino]-6-[(1RS)-1-fluoroethyl]-1,3,5- |
| | triazine, |
| B-22 | 2-amino-4-[(1R)-6-methylindan-1-ylamino]-6-[(1R)-1-fluoroethyl]-1,3,5- |
| | triazine, |
| B-23 | 2-amino-4-[(1R)-6-methylindan-1-ylamino]-6-[(1S)-1-fluoroethyl]-1,3,5- |
| | triazine, |
| B-24 | 2-amino-4-[(1R)-6-methylindan-1-ylamino]-6-(1-methylethyl]-1,3,5- |
| | triazine, |
| B-25 | 2-amino-4-[(1RS)-6-fluoroindan-1-ylamino]-6-(1-fluoro-1-methylethyl]- |
| | 1,3,5-triazine, |
| B-26 | 2-amino-4-[(1R)-6-fluoroindan-1-ylamino]-6-(1-fluoro-1-methylethyl]-1,3,5- |
| | triazine, |
| B-27 | 2-amino-4-[(1RS,2RS)-2-methylindan-1-ylamino]-6-(1-fluoro-1- |
| | methylethyl]-1,3,5-triazine, |
| B-28 | 2-amino-4-[(1R,2RS)-2-methylindan-1-ylamino]-6-(1-fluoro-1- |
| | methylethyl]-1,3,5-triazine, |
| B-29 | 2-amino-4-[(1R,2S)-2-methylindan-1-ylamino]-6-(1-fluoro-1-methylethyl]- |
| | 1,3,5-triazine, |
| B-30 | 2-amino-4-[(1R,2R)-2-methylindan-1-ylamino]-6-(1-fluoro-1-methylethyl]- |
| | 1,3,5-triazine, |
| B-31 | 2-amino-4-[(1RS,2RS)-2,6-dimethylindan-1-ylamino]-6-(1-fluoro-1- |
| | methylethyl]-1,3,5-triazine, |
| B-32 | 2-amino-4-[(1R,2S)-2,6-dimethylindan-1-ylamino]-6-(1-fluoro-1- |
| | methylethyl]-1,3,5-triazine, |
| B-33 | 2-amino-4-[(1R,2R)-2,6-dimethylindan-1-ylamino]-6-(1-fluoro-1- |
| | methylethyl]-1,3,5-triazine, |
| B-34 | 2-amino-4-[(1RS,2RS)-6-fluoro-2-methylindan-1-ylamino]-6-(1-fluoro-1- |
| | methylethyl]-1,3,5-triazine, |
| B-35 | 2-amino-4-[(1R,2S)-6-fluoro-2-methylindan-1-ylamino]-6-(1-fluoro-1- |
| | methylethyl]-1,3,5-triazine, |
| B-36 | 2-amino-4-[(1R,2R)-6-fluoro-2-methylindan-1-ylamino]-6-(1-fluoro-1- |
| | methylethyl]-1,3,5-triazine, |
| B-37 | 2-amino-4-[(1RS,2RS)-6-fluoro-2-methylindan-1-ylamino]-6-[(1RS)-1- |
| | fluoroethyl]-1,3,5-triazine, |
| B-38 | 2-amino-4-[(1R,2S)-6-fluoro-2-methylindan-1-ylamino]-6-[(1RS)-1- |
| | fluoroethyl]-1,3,5-triazine, |
| B-39 | 2-amino-4-[(1R,2R)-6-fluoro-2-methylindan-1-ylamino]-6-[(1RS)-1- |
| | fluorethyl]-1,3,5-triazine, |
| B-40 | 2-amino-4-[(1R,2S)-6-fluoro-2-methylindan-1-ylamino]-6-[(1R)-1- |
| | fluorethyl]-1,3,5-triazine, |
| B-41 | 2-amino-4-[(1R,2R)-6-fluoro-2-methylindan-1-ylamino]-6-[(1R)-1- |
| | fluorethyl]-1,3,5-triazine, |
| B-42 | 2-amino-4-[(1R,2S)-6-fluoro-2-methylindan-1-ylamino]-6-[(1S)-1- |
| | fluorethyl]-1,3,5-triazine, |
| B-43 | 2-amino-4-[(1R,2R)-6-fluoro-2-methylindan-1-ylamino]-6-[(1S)-1- |
| | fluorethyl]-1,3,5-triazine, |
| B-44 | 2-amino-4-[(1RS,2RS)-2,6-dimethylindan-1-ylamino]-6-[(1RS)-1- |
| | fluorethyl]-1,3,5-triazine, |
| B-45 | 2-amino-4-[(1R,2S)-2,6-dimethylindan-1-ylamino]-6-[(1RS)-1-fluorethyl]- |
| | 1,3,5-triazine, |
| B-46 | 2-amino-4-[(1R,2R)-2,6-dimethylindan-1-ylamino]-6-[(1RS)-1-fluorethyl]- |
| | 1,3,5-triazine, |
| B-47 | 2-amino-4-[(1R,2S)-2,6-dimethylindan-1-ylamino]-6-[(1R)-1-fluoroethyl]- |
| | 1,3,5-triazine, |
| B-48 | 2-amino-4-[(1R,2R)-2,6-dimethylindan-1-ylamino]-6-[(1R)-1-fluoroethyl]- |
| | 1,3,5-triazine, |
| B-49 | 2-amino-4-[(1R,2S)-2,6-dimethylindan-1-ylamino]-6-[(1S)-1-fluoroethyl]- |
| | 1,3,5-triazine, |
| B-50 | 2-amino-4-[(1R,2R)-2,6-dimethylindan-1-ylamino]-6-[(1S)-1-fluoroethyl]- |
| | 1,3,5-triazine, |
| B-51 | 2-amino-4-[(1RS)-4,6-dimethylindan-1-ylamino]-6-(1-fluoro-1- |
| | methylethyl)-1,3,5-triazine, |
| B-52 | 2-amino-4-[(1R)-4,6-dimethylindan-1-ylamino]-6-(1-fluoro-1-methylethyl)- |
| | 1,3,5-triazine, |
| B-53 | 2-amino-4-[(1RS)-4,6-dimethylindan-1-ylamino]-6-[(1RS)-1-fluorethyl]- |
| | 1,3,5-triazine, |
| B-54 | 2-amino-4-[(1R)-4,6-dimethylindan-1-ylamino]-6-[(1RS)-1-fluorethyl]- |
| | 1,3,5-triazine, |
| B-55 | 2-amino-4-[(1R)-4,6-dimethylindan-1-ylamino]-6-[(1R)-1-fluorethyl]-1,3,5- |
| | triazine, |
| B-56 | 2-amino-4-[(1R)-4,6-dimethylindan-1-ylamino]-6-[(1S)-1-fluoroethyl]-1,3,5- |
| | triazine, |
| B-57 | 2-amino-4-[(1RS)-5,6-dimethylindan-1-ylamino]-6-(1-fluoro-1- |
| | methylethyl)-1,3,5-triazine, |
| B-58 | 2-amino-4-[(1R)-5,6-dimethylindan-1-ylamino]-6-(1-fluoro-1-methylethyl)- |
| | 1,3,5-triazine, |
| B-59 | 2-amino-4-[(1RS)-5,6-dimethylindan-1-ylamino]-6-[(1RS)-1-fluorethyl]- |
| | 1,3,5-triazine, |
| B-60 | 2-amino-4-[(1R)-5,6-dimethylindan-1-ylamino]-6-[(1RS)-1-fluorethyl]- |
| | 1,3,5-triazine, |
| B-61 | 2-amino-4-[(1R)-5,6-dimethylindan-1-ylamino]-6-[(1R)-1-fluorethyl]-1,3,5- |
| | triazine, |
| B-62 | 2-amino-4-[(1R)-5,6-dimethylindan-1-ylamino]-6-[(1S)-1-fluoroethyl]-1,3,5- |
| | triazine, |
| B-63 | 2-amino-4-[(1RS)-indan-1-ylamino]-1,3,5-triazine, |
| B-64 | 2-amino-4-[(1R)-indan-1-ylamino]-1,3,5-triazine, |
| B-65 | 2-amino-4-[(1RS)-6-methylindan-1-ylamino]-1,3,5-triazine, |
| B-66 | 2-amino-4-[(1R)-6-methylindan-1-ylamino]-1,3,5-triazine, |
| B-67 | 2-amino-4-[(1RS)-6-fluorindan-1-ylamino]-1,3,5-triazine, |
| B-68 | 2-amino-4-[(1R)-6-fluorindan-1-ylamino]-1,3,5-triazine, |
| B-69 | 2-amino-4-[(1RS,2RS)-2-methylindan-1-ylamino]-1,3,5-triazine, |
| B-70 | 2-amino-4-[(1RS,2RS)-2,6-dimethylindan-1-ylamino]-1,3,5-triazine, |
| B-71 | 2-amino-4-[(1RS)-5,6-dimethylindan-1-ylamino]-1,3,5-triazine, |
| B-72 | 2-amino-4-[(1RS)-4,6-dimethylindan-1-ylamino]-1,3,5-triazine, |
| B-73 | 2-amino-4-[(1RS)-5-fluoro-6-methylindan-1-ylamino]-1,3,5-triazine, |
| B-74 | 2-amino-4-[(1RS)-1,2,3,4-tetrahydronaphthalen-1-ylamino]-6-(1-fluoro-1- |
| | methylethyl)-1,3,5-triazine, |
| B-75 | 2-amino-4-[(1RS)-1,2,3,4-tetrahydronaphthalen-1-ylamino]-6-[(1RS)-1- |
| | fluorethyl]-1,3,5-triazine, |
| B-76 | 2-amino-4-[(1RS,2RS)-2-methyl-1,2,3,4-tetrahydronaphthalen-1-ylamino]- |
| | 6-(1-fluoro-1-methylethyl)-1,3,5-triazine, |
| B-77 | 2-amino-4-[(1RS,2RS)-2-methyl-1,2,3,4-tetrahydronaphthalen-1-ylamino]- |
| | 6-[(1RS)-1-fluorethyl]-1,3,5-triazine, |
| B-78 | 2-amino-4-[(1RS,2RS)-2,6-dimethyl-1,2,3,4-tetrahydronaphthalen-1- |
| | ylamino]-6-(1-fluoro-1-methylethyl)-1,3,5-triazine, |
| B-79 | 2-amino-4-[(1RS)-1,2,3,4-tetrahydronaphthalen-1-ylamino]-6-ethyl-1,3,5- |
| | triazine, |
| B-80 | 2-amino-4-[(1RS)-1,2,3,4-tetrahydronaphthalen-1-ylamino]-1,3,5-triazine, |

If appropriate, it is possible to prepare salts from the compounds of the general formulae (I)-(V), for example metal salts such as alkali (for example Na, K) salts or alkaline earth (for example Mg, Ca) salts or ammonium salts or amine salts. Such salts are obtained in a simple manner by customary methods of forming salts, for example by dissolving or dispersing a compound of the formula (I)-(V) in a suitable diluent, such as, for example, methylene chloride, acetone, tert-butyl methyl ether or toluene, and adding a suitable base. The salts can then—if appropriate after prolonged stirring—be isolated by concentration or filtration with suction.

The herbicide combinations according to the invention may comprise further components, for example agrochemically active compounds of a different type, additives customary in crop protection and formulation auxiliaries, or they may be used together with these.

In a preferred embodiment, the herbicide combinations according to the invention comprise an effective amount of the herbicides (A) and (B) and/or have synergistic actions. The synergistic actions can be observed, for example, when the herbicides (A) and (B) are applied, for example, as a co-formulation or as a tank-mix; however, they can also be observed when the active compounds are applied at different times (splitting). It is also possible to apply the individual herbicides or the herbicide combinations in a plurality of portions (sequential application), for example pre-emergence applications followed by post-emergence applications or early post-emergence applications followed by medium or late post-emergence applications. Preference is given here to the joint or almost simultaneous application of the active compounds of the herbicide combination according to the invention.

The synergistic effects permit a reduction of the application rates of the individual active compounds, a higher efficacy at the same application rate, the control of species which are as yet uncontrolled (gaps), an extension of the period of application and/or a reduction in the number of individual applications required and—as a result for the user—weed control systems which are more advantageous economically and ecologically.

For example, the combinations according to the invention of herbicides (A)+(B) allow a synergistic enhancement of activity which exceeds by far and in an unexpected manner the activities achieved with the individual herbicides (A) and (B).

The formula (I) mentioned embraces all stereoisomers and their mixtures, in particular also racemic mixtures, and—if enantiomers are possible—in each case the biologically active enantiomers.

The compounds of the formula (I) and their salts are known, as is their preparation, for example from U.S. Pat. No. 5,476,936.

The compounds of the formulae (II)-(V) and their salts are known, as is their preparation, for example from WO-A-97/08156, WO-A-97/31904, WO-A-98/15536, WO-A-98/15537, WO-A-98/15539 and also WO-A-99/65882, WO-A-00/16627, WO-A-01/43546 WO-A-03/070710, WO-A-04/069814 and the literature cited in the publications, which is hereby expressly incorporated into the present description.

The herbicides of group (A) inhibit the enzyme acetolactate synthase (ALS) and thus the protein synthesis in plants. The application rate of the herbicides (A) may vary within a wide range, for example between 0.001 g and 500 g of AS/ha (hereinbelow, AS/ha means “active substance per hectare”=based on 100% pure active compound). On applications using application rates of from 0.01 g to 200 g of AS/ha of the herbicides (A), preferably of the compounds A-1 to A-145, a relatively broad spectrum of harmful plants, for example annual and perennial monocotyledonous or dicotyledonous weeds and also unwanted crop plants is controlled by the pre-emergence and the post-emergence method. In the combinations according to the invention, the application rates are generally lower, for example in the range from 0.001 g to 100 g of AS/ha, preferably from 0.005 g to 50 g of AS/ha, particularly preferably from 0.01 g to 9 g of AS/ha.

The herbicides of group (B) modulate the cellulose biosynthesis in plants and also suppress cell wall formation, and they are suitable for use both by the pre-emergence and the post-emergence method. The application rate of the herbicides (B) may vary within a wide range, for example between 0.001 g and 500 g of AS/ha (hereinbelow, AS/ha means “active substance per hectare”=based on 100% pure active compound). On applications using application rates of from 0.01 g to 200 g of AS/ha of the herbicides (B), preferably of the compounds B-1 to B-80, a relatively broad spectrum of harmful plants, for example annual and perennial monocotyledonous or dicotyledonous weeds and also unwanted crop plants is controlled by the pre-emergence and the post-emergence method. In the combinations according to the invention, the application rates are generally lower, for example in the range from 0.001 g to 100 g of AS/ha, preferably from 0.005 g to 50 g of AS/ha, particularly preferably from 0.01 g to 25 g of AS/ha.

The herbicides (A) and the herbicides (B) can be employed non-selectively for controlling unwanted vegetation, for example in permanent crops and plantation crops, such as, for example, pome fruit and stone fruit, berry fruit, grapevine, Hevea, bananas, sugar cane, coffee, tea, citrus fruits, nut plantations, in forest plant rearings, on roadsides, on squares and industrial sites, airfields or railway installations, or for the burn-down application, for example in farm crops, for example monocotyledonous farm crops, such as cereals (for example wheat, barley, rye, oats), rice, corn, millet, or dicotyledonous farm crops, such as sugar beet, oilseed rape, cotton, sunflowers and leguminous plants, for example of the genera Glycine (for example Glycine max. (soybean), such as non-transgenic Glycine max. (for example conventional cultivars, such as STS cultivars) or transgenic Glycine max. (for example RR soybeans or LL soybeans) and crossbreeds thereof), Phaseolus, Pisum, Vicia and Arachis, or vegetable crops from various botanical groups, such as potato, leek, cabbage, carrot, tomato, onion.

Preference is given to herbicide combinations of one or more herbicides (A) with one or more herbicides (B). More preference is given to combinations of herbicides (A) with one or more herbicides (B) according to the scheme: (A1)+(B1), (A1)+(B2), (A1)+(B3), (A1)+(B4), (A2)+(B1), (A2)+(B2), (A2)+(B3), or (A2)+(B4).

Also according to the invention are those combinations which comprise one or more agrochemically active compounds which are different from the herbicides (A) and (B) and also act as a non-selective herbicide.

The preferred conditions illustrated below in particular for two-component combinations according to the invention apply primarily also to combinations comprising three or more active compounds, if they comprise the two-component combinations according to the invention.

Ranges of suitable ratios of the compounds (A) and (B) follow, for example, from the application rates mentioned for the individual compounds. In general, in the combinations according to the invention, the application rates may be reduced. Preferred mixing ratios (A):(B) for the combinations according to the invention are listed below:

(A):(B)=10:1 to 1:100, preferably 6:1 to 1:50.

Of particular interest is the use of herbicidal compositions comprising the following compounds (A)+(B):

(A-1)+(B-1), (A-1)+(B-2), (A-1)+(B-3), (A-1)+(B-4), (A-1)+(B-5), (A-1)+(B-6), (A-1)+(B-7), (A-1)+(B-8), (A-1)+(B-9), (A-1)+(B-10), (A-1)+(B-11), (A-1)+(B-12), (A-1)+(B-13), (A-1)+(B-14), (A-1)+(B-15), (A-1)+(B-16), (A-1)+(B-17), (A-1)+(B-18), (A-1)+(B-19), (A-1)+(B-20), (A-1)+(B-21), (A-1)+(B-22), (A-1)+(B-23), (A-1)+(B-24), (A-1)+(B-25), (A-1)+(B-26), (A-1)+(B-27), (A-1)+(B-28), (A-1)+(B-29), (A-1)+(B-30), (A-1)+(B-31), (A-1)+(B-32), (A-1)+(B-33), (A-1)+(B-34), (A-1)+(B-35), (A-1)+(B-36), (A-1)+(B-37), (A-1)+(B-38), (A-1)+(B-39), (A-1)+(B-40), (A-1)+(B-41), (A-1)+(B-42), (A-1)+(B-43), (A-1)+(B-44), (A-1)+(B-45), (A-1)+(B-46), (A-1)+(B-47), (A-1)+(B-48), (A-1)+(B-49), (A-1)+(B-50), (A-1)+(B-51), (A-1)+(B-52), (A-1)+(B-53), (A-1)+(B-54), (A-1)+(B-55), (A-1)+(B-56), (A-1)+(B-57), (A-1)+(B-58), (A-1)+(B-59), (A-1)+(B-60), (A-1)+(B-61), (A-1)+(B-62), (A-1)+(B-63), (A-1)+(B-64), (A-1)+(B-65), (A-1)+(B-66), (A-1)+(B-67), (A-1)+(B-68), (A-1)+(B-69), (A-1)+(B-70), (A-1)+(B-71), (A-1)+(B-72), (A-1)+(B-73), (A-1)+(B-74), (A-1)+(B-75), (A-1)+(B-76), (A-1)+(B-77), (AI-1)+(B-78), (A-1)+(B-79), (A-1)+(B-80).

(A-2)+(B-1), (A-2)+(B-2), (A-2)+(B-3), (A-2)+(B-4), (A-2)+(B-5), (A-2)+(B-6), (A-2)+(B-7), (A-2)+(B-8), (A-2)+(B-9), (A-2)+(B-10), (A-2)+(B-11), (A-2)+(B-12), (A-2)+(B-13), (A-2)+(B-14), (A-2)+(B-15), (A-2)+(B-16), (A-2)+(B-17), (A-2)+(B-18), (A-2)+(B-19), (A-2)+(B-20), (A-2)+(B-21), (A-2)+(B-22), (A-2)+(B-23), (A-2)+(B-24), (A-2)+(B-25), (A-2)+(B-26), (A-2)+(B-27), (A-2)+(B-28), (A-2)+(B-29), (A-2)+(B-30), (A-2)+(B-31), (A-2)+(B-32), (A-2)+(B-33), (A-2)+(B-34), (A-2)+(B-35), (A-2)+(B-36), (A-2)+(B-37), (A-2)+(B-38), (A-2)+(B-39), (A-2)+(B-40), (A-2)+(B-41), (A-2)+(B-42), (A-2)+(B-43), (A-2)+(B-44), (A-2)+(B-45), (A-2)+(B-46), (A-2)+(B-47), (A-2)+(B-48), (A-2)+(B-49), (A-2)+(B-50), (A-2)+(B-51), (A-2)+(B-52), (A-2)+(B-53), (A-2)+(B-54), (A-2)+(B-55), (A-2)+(B-56), (A-2)+(B-57), (A-2)+(B-58), (A-2)+(B-59), (A-2)+(B-60), (A-2)+(B-61), (A-2)+(B-62), (A-2)+(B-63), (A-2)+(B-64), (A-2)+(B-65), (A-2)+(B-66), (A-2)+(B-67), (A-2)+(B-68), (A-2)+(B-69), (A-2)+(B-70), (A-2)+(B-71), (A-2)+(B-72), (A-2)+(B-73), (A-2)+(B-74), (A-2)+(B-75), (A-2)+(B-76), (A-2)+(B-77), (AI-1)+(B-78), (A-2)+(B-79), (A-2)+(B-80).

(A-3)+(B-1), (A-3)+(B-2), (A-3)+(B-3), (A-3)+(B-4), (A-3)+(B-5), (A-3)+(B-6), (A-3)+(B-7), (A-3)+(B-8), (A-3)+(B-9), (A-3)+(B-10), (A-3)+(B-11), (A-3)+(B-12), (A-3)+(B-13), (A-3)+(B-14), (A-3)+(B-15), (A-3)+(B-16), (A-3)+(B-17), (A-3)+(B-18), (A-3)+(B-19), (A-3)+(B-20), (A-3)+(B-21), (A-3)+(B-22), (A-3)+(B-23), (A-3)+(B-24), (A-3)+(B-25), (A-3)+(B-26), (A-3)+(B-27), (A-3)+(B-28), (A-3)+(B-29), (A-3)+(B-30), (A-3)+(B-31), (A-3)+(B-32), (A-3)+(B-33), (A-3)+(B-34), (A-3)+(B-35), (A-3)+(B-36), (A-3)+(B-37), (A-3)+(B-38), (A-3)+(B-39), (A-3)+(B-40), (A-3)+(B-41), (A-3)+(B-42), (A-3)+(B-43), (A-3)+(B-44), (A-3)+(B-45), (A-3)+(B-46), (A-3)+(B-47), (A-3)+(B-48), (A-3)+(B-49), (A-3)+(B-50), (A-3)+(B-51), (A-3)+(B-52), (A-3)+(B-53), (A-3)+(B-54), (A-3)+(B-55), (A-3)+(B-56), (A-3)+(B-57), (A-3)+(B-58), (A-3)+(B-59), (A-3)+(B-60), (A-3)+(B-61), (A-3)+(B-62), (A-3)+(B-63), (A-3)+(B-64), (A-3)+(B-65), (A-3)+(B-66), (A-3)+(B-67), (A-3)+(B-68), (A-3)+(B-69), (A-3)+(B-70), (A-3)+(B-71), (A-3)+(B-72), (A-3)+(B-73), (A-3)+(B-74), (A-3)+(B-75), (A-3)+(B-76), (A-3)+(B-77), (AI-1)+(B-78), (A-3)+(B-79), (A-3)+(B-80).

(A-4)+(B-1), (A-4)+(B-2), (A-4)+(B-3), (A-4)+(B-4), (A-4)+(B-5), (A-4)+(B-6), (A-4)+(B-7), (A-4)+(B-8), (A-4)+(B-9), (A-4)+(B-10), (A-4)+(B-11), (A-4)+(B-12), (A-4)+(B-13), (A-4)+(B-14), (A-4)+(B-15), (A-4)+(B-16), (A-4)+(B-17), (A-4)+(B-18), (A-4)+(B-19), (A-4)+(B-20), (A-4)+(B-21), (A-4)+(B-22), (A-4)+(B-23), (A-4)+(B-24), (A-4)+(B-25), (A-4)+(B-26), (A-4)+(B-27), (A-4)+(B-28), (A-4)+(B-29), (A-4)+(B-30), (A-4)+(B-31), (A-4)+(B-32), (A-4)+(B-33), (A-4)+(B-34), (A-4)+(B-35), (A-4)+(B-36), (A-4)+(B-37), (A-4)+(B-38), (A-4)+(B-39), (A-4)+(B-40), (A-4)+(B-41), (A-4)+(B-42), (A-4)+(B-43), (A-4)+(B-44), (A-4)+(B-45), (A-4)+(B-46), (A-4)+(B-47), (A-4)+(B-48), (A-4)+(B-49), (A-4)+(B-50), (A-4)+(B-51), (A-4)+(B-52), (A-4)+(B-53), (A-4)+(B-54), (A-4)+(B-55), (A-4)+(B-56), (A-4)+(B-57), (A-4)+(B-58), (A-4)+(B-59), (A-4)+(B-60), (A-4)+(B-61), (A-4)+(B-62), (A-4)+(B-63), (A-4)+(B-64), (A-4)+(B-65), (A-4)+(B-66), (A-4)+(B-67), (A-4)+(B-68), (A-4)+(B-69), (A-4)+(B-70), (A-4)+(B-71), (A-4)+(B-72), (A-4)+(B-73), (A-4)+(B-74), (A-4)+(B-75), (A-4)+(B-76), (A-4)+(B-77), (AI-1)+(B-78), (A-4)+(B-79), (A-4)+(B-80).

(A-5)+(B-1), (A-5)+(B-2), (A-5)+(B-3), (A-5)+(B-4), (A-5)+(B-5), (A-5)+(B-6), (A-5)+(B-7), (A-5)+(B-8), (A-5)+(B-9), (A-5)+(B-10), (A-5)+(B-11), (A-5)+(B-12), (A-5)+(B-13), (A-5)+(B-14), (A-5)+(B-15), (A-5)+(B-16), (A-5)+(B-17), (A-5)+(B-18), (A-5)+(B-19), (A-5)+(B-20), (A-5)+(B-21), (A-5)+(B-22), (A-5)+(B-23), (A-5)+(B-24), (A-5)+(B-25), (A-5)+(B-26), (A-5)+(B-27), (A-5)+(B-28), (A-5)+(B-29), (A-5)+(B-30), (A-5)+(B-31), (A-5)+(B-32), (A-5)+(B-33), (A-5)+(B-34), (A-5)+(B-35), (A-5)+(B-36), (A-5)+(B-37), (A-5)+(B-38), (A-5)+(B-39), (A-5)+(B-40), (A-5)+(B-41), (A-5)+(B-42), (A-5)+(B-43), (A-5)+(B-44), (A-5)+(B-45), (A-5)+(B-46), (A-5)+(B-47), (A-5)+(B-48), (A-5)+(B-49), (A-5)+(B-50), (A-5)+(B-51), (A-5)+(B-52), (A-5)+(B-53), (A-5)+(B-54), (A-5)+(B-55), (A-5)+(B-56), (A-5)+(B-57), (A-5)+(B-58), (A-5)+(B-59), (A-5)+(B-60), (A-5)+(B-61), (A-5)+(B-62), (A-5)+(B-63), (A-5)+(B-64), (A-5)+(B-65), (A-5)+(B-66), (A-5)+(B-67), (A-5)+(B-68), (A-5)+(B-69), (A-5)+(B-70), (A-5)+(B-71), (A-5)+(B-72), (A-5)+(B-73), (A-5)+(B-74), (A-5)+(B-75), (A-5)+(B-76), (A-5)+(B-77), (AI-1)+(B-78), (A-5)+(B-79), (A-5)+(B-80).

(A-6)+(B-1), (A-6)+(B-2), (A-6)+(B-3), (A-6)+(B-4), (A-6)+(B-5), (A-6)+(B-6), (A-6)+(B-7), (A-6)+(B-8), (A-6)+(B-9), (A-6)+(B-10), (A-6)+(B-11), (A-6)+(B-12), (A-6)+(B-13), (A-6)+(B-14), (A-6)+(B-15), (A-6)+(B-16), (A-6)+(B-17), (A-6)+(B-18), (A-6)+(B-19), (A-6)+(B-20), (A-6)+(B-21), (A-6)+(B-22), (A-6)+(B-23), (A-6)+(B-24), (A-6)+(B-25), (A-6)+(B-26), (A-6)+(B-27), (A-6)+(B-28), (A-6)+(B-29), (A-6)+(B-30), (A-6)+(B-31), (A-6)+(B-32), (A-6)+(B-33), (A-6)+(B-34), (A-6)+(B-35), (A-6)+(B-36), (A-6)+(B-37), (A-6)+(B-38), (A-6)+(B-39), (A-6)+(B-40), (A-6)+(B-41), (A-6)+(B-42), (A-6)+(B-43), (A-6)+(B-44), (A-6)+(B-45), (A-6)+(B-46), (A-6)+(B-47), (A-6)+(B-48), (A-6)+(B-49), (A-6)+(B-50), (A-6)+(B-51), (A-6)+(B-52), (A-6)+(B-53), (A-6)+(B-54), (A-6)+(B-55), (A-6)+(B-56), (A-6)+(B-57), (A-6)+(B-58), (A-6)+(B-59), (A-6)+(B-60), (A-6)+(B-61), (A-6)+(B-62), (A-6)+(B-63), (A-6)+(B-64), (A-6)+(B-65), (A-6)+(B-66), (A-6)+(B-67), (A-6)+(B-68), (A-6)+(B-69), (A-6)+(B-70), (A-6)+(B-71), (A-6)+(B-72), (A-6)+(B-73), (A-6)+(B-74), (A-6)+(B-75), (A-6)+(B-76), (A-6)+(B-77), (AI-1)+(B-78), (A-6)+(B-79), (A-6)+(B-80).

(A-7)+(B-1), (A-7)+(B-2), (A-7)+(B-3), (A-7)+(B-4), (A-7)+(B-5), (A-7)+(B-6), (A-7)+(B-7), (A-7)+(B-8), (A-7)+(B-9), (A-7)+(B-10), (A-7)+(B-11), (A-7)+(B-12), (A-7)+(B-13), (A-7)+(B-14), (A-7)+(B-15), (A-7)+(B-16), (A-7)+(B-17), (A-7)+(B-18), (A-7)+(B-19), (A-7)+(B-20), (A-7)+(B-21), (A-7)+(B-22), (A-7)+(B-23), (A-7)+(B-24), (A-7)+(B-25), (A-7)+(B-26), (A-7)+(B-27), (A-7)+(B-28), (A-7)+(B-29), (A-7)+(B-30), (A-7)+(B-31), (A-7)+(B-32), (A-7)+(B-33), (A-7)+(B-34), (A-7)+(B-35), (A-7)+(B-36), (A-7)+(B-37), (A-7)+(B-38), (A-7)+(B-39), (A-7)+(B-40), (A-7)+(B-41), (A-7)+(B-42), (A-7)+(B-43), (A-7)+(B-44), (A-7)+(B-45), (A-7)+(B-46), (A-7)+(B-47), (A-7)+(B-48), (A-7)+(B-49), (A-7)+(B-50), (A-7)+(B-51), (A-7)+(B-52), (A-7)+(B-53), (A-7)+(B-54), (A-7)+(B-55), (A-7)+(B-56), (A-7)+(B-57), (A-7)+(B-58), (A-7)+(B-59), (A-7)+(B-60), (A-7)+(B-61), (A-7)+(B-62), (A-7)+(B-63), (A-7)+(B-64), (A-7)+(B-65), (A-7)+(B-66), (A-7)+(B-67), (A-7)+(B-68), (A-7)+(B-69), (A-7)+(B-70), (A-7)+(B-71), (A-7)+(B-72), (A-7)+(B-73), (A-7)+(B-74), (A-7)+(B-75), (A-7)+(B-76), (A-7)+(B-77), (AI-1)+(B-78), (A-7)+(B-79), (A-7)+(B-80).

(A-8)+(B-1), (A-8)+(B-2), (A-8)+(B-3), (A-8)+(B-4), (A-8)+(B-5), (A-8)+(B-6), (A-8)+(B-7), (A-8)+(B-8), (A-8)+(B-9), (A-8)+(B-10), (A-8)+(B-11), (A-8)+(B-12), (A-8)+(B-13), (A-8)+(B-14), (A-8)+(B-15), (A-8)+(B-16), (A-8)+(B-17), (A-8)+(B-18), (A-8)+(B-19), (A-8)+(B-20), (A-8)+(B-21), (A-8)+(B-22), (A-8)+(B-23), (A-8)+(B-24), (A-8)+(B-25), (A-8)+(B-26), (A-8)+(B-27), (A-8)+(B-28), (A-8)+(B-29), (A-8)+(B-30), (A-8)+(B-31), (A-8)+(B-32), (A-8)+(B-33), (A-8)+(B-34), (A-8)+(B-35), (A-8)+(B-36), (A-8)+(B-37), (A-8)+(B-38), (A-8)+(B-39), (A-8)+(B-40), (A-8)+(B-41), (A-8)+(B-42), (A-8)+(B-43), (A-8)+(B-44), (A-8)+(B-45), (A-8)+(B-46), (A-8)+(B-47), (A-8)+(B-48), (A-8)+(B-49), (A-8)+(B-50), (A-8)+(B-51), (A-8)+(B-52), (A-8)+(B-53), (A-8)+(B-54), (A-8)+(B-55), (A-8)+(B-56), (A-8)+(B-57), (A-8)+(B-58), (A-8)+(B-59), (A-8)+(B-60), (A-8)+(B-61), (A-8)+(B-62), (A-8)+(B-63), (A-8)+(B-64), (A-8)+(B-65), (A-8)+(B-66), (A-8)+(B-67), (A-8)+(B-68), (A-8)+(B-69), (A-8)+(B-70), (A-8)+(B-71), (A-8)+(B-72), (A-8)+(B-73), (A-8)+(B-74), (A-8)+(B-75), (A-8)+(B-76), (A-8)+(B-77), (AI-1)+(B-78), (A-8)+(B-79), (A-8)+(B-80).

(A-9)+(B-1), (A-9)+(B-2), (A-9)+(B-3), (A-9)+(B-4), (A-9)+(B-5), (A-9)+(B-6), (A-9)+(B-7), (A-9)+(B-8), (A-9)+(B-9), (A-9)+(B-10), (A-9)+(B-11), (A-9)+(B-12), (A-9)+(B-13), (A-9)+(B-14), (A-9)+(B-15), (A-9)+(B-16), (A-9)+(B-17), (A-9)+(B-18), (A-9)+(B-19), (A-9)+(B-20), (A-9)+(B-21), (A-9)+(B-22), (A-9)+(B-23), (A-9)+(B-24), (A-9)+(B-25), (A-9)+(B-26), (A-9)+(B-27), (A-9)+(B-28), (A-9)+(B-29), (A-9)+(B-30), (A-9)+(B-31), (A-9)+(B-32), (A-9)+(B-33), (A-9)+(B-34), (A-9)+(B-35), (A-9)+(B-36), (A-9)+(B-37), (A-9)+(B-38), (A-9)+(B-39), (A-9)+(B-40), (A-9)+(B-41), (A-9)+(B-42), (A-9)+(B-43), (A-9)+(B-44), (A-9)+(B-45), (A-9)+(B-46), (A-9)+(B-47), (A-9)+(B-48), (A-9)+(B-49), (A-9)+(B-50), (A-9)+(B-51), (A-9)+(B-52), (A-9)+(B-53), (A-9)+(B-54), (A-9)+(B-55), (A-9)+(B-56), (A-9)+(B-57), (A-9)+(B-58), (A-9)+(B-59), (A-9)+(B-60), (A-9)+(B-61), (A-9)+(B-62), (A-9)+(B-63), (A-9)+(B-64), (A-9)+(B-65), (A-9)+(B-66), (A-9)+(B-67), (A-9)+(B-68), (A-9)+(B-69), (A-9)+(B-70), (A-9)+(B-71), (A-9)+(B-72), (A-9)+(B-73), (A-9)+(B-74), (A-9)+(B-75), (A-9)+(B-76), (A-9)+(B-77), (AI-1)+(B-78), (A-9)+(B-79), (A-9)+(B-80).

(A-10)+(B-1), (A-10)+(B-2), (A-10)+(B-3), (A-10)+(B-4), (A-10)+(B-5), (A-10)+(B-6), (A-10)+(B-7), (A-10)+(B-8), (A-10)+(B-9), (A-10)+(B-10), (A-10)+(B-11), (A-10)+(B-12), (A-10)+(B-13), (A-10)+(B-14), (A-10)+(B-15), (A-10)+(B-16), (A-10)+(B-17), (A-10)+(B-18), (A-10)+(B-19), (A-10)+(B-20), (A-10)+(B-21), (A-10)+(B-22), (A-10)+(B-23), (A-10)+(B-24), (A-10)+(B-25), (A-10)+(B-26), (A-10)+(B-27), (A-10)+(B-28), (A-10)+(B-29), (A-10)+(B-30), (A-10)+(B-31), (A-10)+(B-32), (A-10)+(B-33), (A-10)+(B-34), (A-10)+(B-35), (A-10)+(B-36), (A-10)+(B-37), (A-10)+(B-38), (A-10)+(B-39), (A-10)+(B-40), (A-10)+(B-41), (A-10)+(B-42), (A-10)+(B-43), (A-10)+(B-44), (A-10)+(B-45), (A-10)+(B-46), (A-10)+(B-47), (A-10)+(B-48), (A-10)+(B-49), (A-10)+(B-50), (A-10)+(B-51), (A-10)+(B-52), (A-10)+(B-53), (A-10)+(B-54), (A-10)+(B-55), (A-10)+(B-56), (A-10)+(B-57), (A-10)+(B-58), (A-10)+(B-59), (A-10)+(B-60), (A-10)+(B-61), (A-10)+(B-62), (A-10)+(B-63), (A-10)+(B-64), (A-10)+(B-65), (A-10)+(B-66), (A-10)+(B-67), (A-10)+(B-68), (A-10)+(B-69), (A-10)+(B-70), (A-10)+(B-71), (A-10)+(B-72), (A-10)+(B-73), (A-10)+(B-74), (A-10)+(B-75), (A-10)+(B-76), (A-10)+(B-77), (AI-1)+(B-78), (A-10)+(B-79), (A-10)+(B-80).

(A-11)+(B-1), (A-11)+(B-2), (A-11)+(B-3), (A-11)+(B-4), (A-11)+(B-5), (A-11)+(B-6), (A-11)+(B-7), (A-11)+(B-8), (A-11)+(B-9), (A-11)+(B-10), (A-11)+(B-11), (A-11)+(B-12), (A-11)+(B-13), (A-11)+(B-14), (A-11)+(B-15), (A-11)+(B-16), (A-11)+(B-17), (A-11)+(B-18), (A-11)+(B-19), (A-11)+(B-20), (A-11)+(B-21), (A-11)+(B-22), (A-11)+(B-23), (A-11)+(B-24), (A-11)+(B-25), (A-11)+(B-26), (A-11)+(B-27), (A-11)+(B-28), (A-11)+(B-29), (A-11)+(B-30), (A-11)+(B-31), (A-11)+(B-32), (A-11)+(B-33), (A-11)+(B-34), (A-11)+(B-35), (A-11)+(B-36), (A-11)+(B-37), (A-11)+(B-38), (A-11)+(B-39), (A-11)+(B-40), (A-11)+(B-41), (A-11)+(B-42), (A-11)+(B-43), (A-11)+(B-44), (A-11)+(B-45), (A-11)+(B-46), (A-11)+(B-47), (A-11)+(B-48), (A-11)+(B-49), (A-11)+(B-50), (A-11)+(B-51), (A-11)+(B-52), (A-11)+(B-53), (A-11)+(B-54), (A-11)+(B-55), (A-11)+(B-56), (A-11)+(B-57), (A-11)+(B-58), (A-11)+(B-59), (A-11)+(B-60), (A-11)+(B-61), (A-11)+(B-62), (A-11)+(B-63), (A-11)+(B-64), (A-11)+(B-65), (A-11)+(B-66), (A-11)+(B-67), (A-11)+(B-68), (A-11)+(B-69), (A-11)+(B-70), (A-11)+(B-71), (A-11)+(B-72), (A-11)+(B-73), (A-11)+(B-74), (A-11)+(B-75), (A-11)+(B-76), (A-11)+(B-77), (AI-1)+(B-78), (A-11)+(B-79), (A-11)+(B-80).

(A-12)+(B-1), (A-12)+(B-2), (A-12)+(B-3), (A-12)+(B-4), (A-12)+(B-5), (A-12)+(B-6), (A-12)+(B-7), (A-12)+(B-8), (A-12)+(B-9), (A-12)+(B-10), (A-12)+(B-11), (A-12)+(B-12), (A-12)+(B-13), (A-12)+(B-14), (A-12)+(B-15), (A-12)+(B-16), (A-12)+(B-17), (A-12)+(B-18), (A-12)+(B-19), (A-12)+(B-20), (A-12)+(B-21), (A-12)+(B-22), (A-12)+(B-23), (A-12)+(B-24), (A-12)+(B-25), (A-12)+(B-26), (A-12)+(B-27), (A-12)+(B-28), (A-12)+(B-29), (A-12)+(B-30), (A-12)+(B-31), (A-12)+(B-32), (A-12)+(B-33), (A-12)+(B-34), (A-12)+(B-35), (A-12)+(B-36), (A-12)+(B-37), (A-12)+(B-38), (A-12)+(B-39), (A-12)+(B-40), (A-12)+(B-41), (A-12)+(B-42), (A-12)+(B-43), (A-12)+(B-44), (A-12)+(B-45), (A-12)+(B-46), (A-12)+(B-47), (A-12)+(B-48), (A-12)+(B-49), (A-12)+(B-50), (A-12)+(B-51), (A-12)+(B-52), (A-12)+(B-53), (A-12)+(B-54), (A-12)+(B-55), (A-12)+(B-56), (A-12)+(B-57), (A-12)+(B-58), (A-12)+(B-59), (A-12)+(B-60), (A-12)+(B-61), (A-12)+(B-62), (A-12)+(B-63), (A-12)+(B-64), (A-12)+(B-65), (A-12)+(B-66), (A-12)+(B-67), (A-12)+(B-68), (A-12)+(B-69), (A-12)+(B-70), (A-12)+(B-71), (A-12)+(B-72), (A-12)+(B-73), (A-12)+(B-74), (A-12)+(B-75), (A-12)+(B-76), (A-12)+(B-77), (AI-1)+(B-78), (A-12)+(B-79), (A-12)+(B-80).

(A-13)+(B-1), (A-13)+(B-2), (A-13)+(B-3), (A-13)+(B-4), (A-13)+(B-5), (A-13)+(B-6), (A-13)+(B-7), (A-13)+(B-8), (A-13)+(B-9), (A-13)+(B-10), (A-13)+(B-11), (A-13)+(B-12), (A-13)+(B-13), (A-13)+(B-14), (A-13)+(B-15), (A-13)+(B-16), A-13)+(B-17), (A-13)+(B-18), (A-13)+(B-19), (A-13)+(B-20), (A-13)+(B-21), (A-13)+(B-22), (A-13)+(B-23), (A-13)+(B-24), (A-13)+(B-25), (A-13)+(B-26), (A-13)+(B-27), (A-13)+(B-28), (A-13)+(B-29), (A-13)+(B-30), (A-13)+(B-31), (A-13)+(B-32), (A-13)+(B-33), (A-13)+(B-34), (A-13)+(B-35), (A-13)+(B-36), (A-13)+(B-37), (A-13)+(B-38), (A-13)+(B-39), (A-13)+(B-40), (A-13)+(B-41), (A-13)+(B-42), (A-13)+(B-43), (A-13)+(B-44), (A-13)+(B-45), (A-13)+(B-46), (A-13)+(B-47), (A-13)+(B-48), (A-13)+(B-49), (A-13)+(B-50), (A-13)+(B-51), (A-13)+(B-52), (A-13)+(B-53), (A-13)+(B-54), (A-13)+(B-55), (A-13)+(B-56), (A-13)+(B-57), (A-13)+(B-58), (A-13)+(B-59), (A-13)+(B-60), (A-13)+(B-61), (A-13)+(B-62), (A-13)+(B-63), (A-13)+(B-64), (A-13)+(B-65), (A-13)+(B-66), (A-13)+(B-67), (A-13)+(B-68), (A-13)+(B-69), (A-13)+(B-70), (A-13)+(B-71), (A-13)+(B-72), (A-13)+(B-73), (A-13)+(B-74), (A-13)+(B-75), (A-13)+(B-76), (A-13)+(B-77), (AI-1)+(B-78), (A-13)+(B-79), (A-13)+(B-80).

(A-14)+(B-1), (A-14)+(B-2), (A-14)+(B-3), (A-14)+(B-4), (A-14)+(B-5), (A-14)+(B-6), (A-14)+(B-7), (A-14)+(B-8), (A-14)+(B-9), (A-14)+(B-10), (A-14)+(B-11), (A-14)+(B-12), (A-14)+(B-13), (A-14)+(B-14), (A-14)+(B-15), (A-14)+(B-16), (A-14)+(B-17), (A-14)+(B-18), (A-14)+(B-19), (A-14)+(B-20), (A-14)+(B-21), (A-14)+(B-22), (A-14)+(B-23), (A-14)+(B-24), (A-14)+(B-25), (A-14)+(B-26), (A-14)+(B-27), (A-14)+(B-28), (A-14)+(B-29), (A-14)+(B-30), (A-14)+(B-31), (A-14)+(B-32), (A-14)+(B-33), (A-14)+(B-34), (A-14)+(B-35), (A-14)+(B-36), (A-14)+(B-37), (A-14)+(B-38), (A-14)+(B-39), (A-14)+(B-40), (A-14)+(B-41), (A-14)+(B-42), (A-14)+(B-43), (A-14)+(B-44), (A-14)+(B-45), (A-14)+(B-46), (A-14)+(B-47), (A-14)+(B-48), (A-14)+(B-49), (A-14)+(B-50), (A-14)+(B-51), (A-14)+(B-52), (A-14)+(B-53), (A-14)+(B-54), (A-14)+(B-55), (A-14)+(B-56), (A-14)+(B-57), (A-14)+(B-58), (A-14)+(B-59), (A-14)+(B-60), (A-14)+(B-61), (A-14)+(B-62), (A-14)+(B-63), (A-14)+(B-64), (A-14)+(B-65), (A-14)+(B-66), (A-14)+(B-67), (A-14)+(B-68), (A-14)+(B-69), (A-14)+(B-70), (A-14)+(B-71), (A-14)+(B-72), (A-14)+(B-73), (A-14)+(B-74), (A-14)+(B-75), (A-14)+(B-76), (A-14)+(B-77), (AI-1)+(B-78), (A-14)+(B-79), (A-14)+(B-80).

(A-15)+(B-1), (A-15)+(B-2), (A-15)+(B-3), (A-15)+(B-4), (A-15)+(B-5), (A-15)+(B-6), (A-15)+(B-7), (A-15)+(B-8), (A-15)+(B-9), (A-15)+(B-10), (A-15)+(B-11), (A-15)+(B-12), (A-15)+(B-13), (A-15)+(B-14), (A-15)+(B-15), (A-15)+(B-16), (A-15)+(B-17), (A-15)+(B-18), (A-15)+(B-19), (A-15)+(B-20), (A-15)+(B-21), (A-15)+(B-22), (A-15)+(B-23), (A-15)+(B-24), (A-15)+(B-25), (A-15)+(B-26), (A-15)+(B-27), (A-15)+(B-28), (A-15)+(B-29), (A-15)+(B-30), (A-15)+(B-31), (A-15)+(B-32), (A-15)+(B-33), (A-15)+(B-34), (A-15)+(B-35), (A-15)+(B-36), (A-15)+(B-37), (A-15)+(B-38), (A-15)+(B-39), (A-15)+(B-40), (A-15)+(B-41), (A-15)+(B-42), (A-15)+(B-43), (A-15)+(B-44), (A-15)+(B-45), (A-15)+(B-46), (A-15)+(B-47), (A-15)+(B-48), (A-15)+(B-49), (A-15)+(B-50), (A-15)+(B-51), (A-15)+(B-52), (A-15)+(B-53), (A-15)+(B-54), (A-15)+(B-55), (A-15)+(B-56), (A-15)+(B-57), (A-15)+(B-58), (A-15)+(B-59), (A-15)+(B-60), (A-15)+(B-61), (A-15)+(B-62), (A-15)+(B-63), (A-15)+(B-64), (A-15)+(B-65), (A-15)+(B-66), (A-15)+(B-67), (A-15)+(B-68), (A-15)+(B-69), (A-15)+(B-70), (A-15)+(B-71), (A-15)+(B-72), (A-15)+(B-73), (A-15)+(B-74), (A-15)+(B-75), (A-15)+(B-76), (A-15)+(B-77), (AI-1)+(B-78), (A-15)+(B-79), (A-15)+(B-80).

(A-16)+(B-1), (A-16)+(B-2), (A-16)+(B-3), (A-16)+(B-4), (A-16)+(B-5), (A-16)+(B-6), (A-16)+(B-7), (A-16)+(B-8), (A-16)+(B-9), (A-16)+(B-10), (A-16)+(B-11), (A-16)+(B-12), (A-16)+(B-13), (A-16)+(B-14), (A-16)+(B-15), (A-16)+(B-16), (A-16)+(B-17), (A-16)+(B-18), (A-16)+(B-19), (A-16)+(B-20), (A-16)+(B-21), (A-16)+(B-22), (A-16)+(B-23), (A-16)+(B-24), (A-16)+(B-25), (A-16)+(B-26), (A-16)+(B-27), (A-16)+(B-28), (A-16)+(B-29), (A-16)+(B-30), (A-16)+(B-31), (A-16)+(B-32), (A-16)+(B-33), (A-16)+(B-34), (A-16)+(B-35), (A-16)+(B-36), (A-16)+(B-37), (A-16)+(B-38), (A-16)+(B-39), (A-16)+(B-40), (A-16)+(B-41), (A-16)+(B-42), (A-16)+(B-43), (A-16)+(B-44), (A-16)+(B-45), (A-16)+(B-46), (A-16)+(B-47), (A-16)+(B-48), (A-16)+(B-49), (A-16)+(B-50), (A-16)+(B-51), (A-16)+(B-52), (A-16)+(B-53), (A-16)+(B-54), (A-16)+(B-55), (A-16)+(B-56), (A-16)+(B-57), (A-16)+(B-58), (A-16)+(B-59), (A-16)+(B-60), (A-16)+(B-61), (A-16)+(B-62), (A-16)+(B-63), (A-16)+(B-64), (A-16)+(B-65), (A-16)+(B-66), (A-16)+(B-67), (A-16)+(B-68), (A-16)+(B-69), (A-16)+(B-70), (A-16)+(B-71), (A-16)+(B-72), (A-16)+(B-73), (A-16)+(B-74), (A-16)+(B-75), (A-16)+(B-76), (A-16)+(B-77), (AI-1)+(B-78), (A-16)+(B-79), (A-16)+(B-80).

(A-17)+(B-1), (A-17)+(B-2), (A-17)+(B-3), (A-17)+(B-4), (A-17)+(B-5), (A-17)+(B-6), (A-17)+(B-7), (A-17)+(B-8), (A-17)+(B-9), (A-17)+(B-10), (A-17)+(B-11), (A-17)+(B-12), (A-17)+(B-13), (A-17)+(B-14), (A-17)+(B-15), (A-17)+(B-16), (A-17)+(B-17), (A-17)+(B-18), (A-17)+(B-19), (A-17)+(B-20), (A-17)+(B-21), (A-17)+(B-22), (A-17)+(B-23), (A-17)+(B-24), (A-17)+(B-25), (A-17)+(B-26), (A-17)+(B-27), (A-17)+(B-28), (A-17)+(B-29), (A-17)+(B-30), (A-17)+(B-31), (A-17)+(B-32), (A-17)+(B-33), (A-17)+(B-34), (A-17)+(B-35), (A-17)+(B-36), (A-17)+(B-37), (A-17)+(B-38), (A-17)+(B-39), (A-17)+(B-40), (A-17)+(B-41), (A-17)+(B-42), (A-17)+(B-43), (A-17)+(B-44), (A-17)+(B-45), (A-17)+(B-46), (A-17)+(B-47), (A-17)+(B-48), (A-17)+(B-49), (A-17)+(B-50), (A-17)+(B-51), (A-17)+(B-52), (A-17)+(B-53), (A-17)+(B-54), (A-17)+(B-55), (A-17)+(B-56), (A-17)+(B-57), (A-17)+(B-58), (A-17)+(B-59), (A-17)+(B-60), (A-17)+(B-61), (A-17)+(B-62), (A-17)+(B-63), (A-17)+(B-64), (A-17)+(B-65), (A-17)+(B-66), (A-17)+(B-67), (A-17)+(B-68), (A-17)+(B-69), (A-17)+(B-70), (A-17)+(B-71), (A-17)+(B-72), (A-17)+(B-73), (A-17)+(B-74), (A-17)+(B-75), (A-17)+(B-76), (A-17)+(B-77), (AI-1)+(B-78), (A-17)+(B-79), (A-17)+(B-80).

(A-18)+(B-1), (A-18)+(B-2), (A-18)+(B-3), (A-18)+(B-4), (A-18)+(B-5), (A-18)+(B-6), (A-18)+(B-7), (A-18)+(B-8), (A-18)+(B-9), (A-18)+(B-10), (A-18)+(B-11), (A-18)+(B-12), (A-18)+(B-13), (A-18)+(B-14), (A-18)+(B-15), (A-18)+(B-16), (A-18)+(B-17), (A-18)+(B-18), (A-18)+(B-19), (A-18)+(B-20), (A-18)+(B-21), (A-18)+(B-22), (A-18)+(B-23), (A-18)+(B-24), (A-18)+(B-25), (A-18)+(B-26), (A-18)+(B-27), (A-18)+(B-28), (A-18)+(B-29), (A-18)+(B-30), (A-18)+(B-31), (A-18)+(B-32), (A-18)+(B-33), (A-18)+(B-34), (A-18)+(B-35), (A-18)+(B-36), (A-18)+(B-37), (A-18)+(B-38), (A-18)+(B-39), (A-18)+(B-40), (A-18)+(B-41), (A-18)+(B-42), (A-18)+(B-43), (A-18)+(B-44), (A-18)+(B-45), (A-18)+(B-46), (A-18)+(B-47), (A-18)+(B-48), (A-18)+(B-49), (A-18)+(B-50), (A-18)+(B-51), (A-18)+(B-52), (A-18)+(B-53), (A-18)+(B-54), (A-18)+(B-55), (A-18)+(B-56), (A-18)+(B-57), (A-18)+(B-58), (A-18)+(B-59), (A-18)+(B-60), (A-18)+(B-61), (A-18)+(B-62), (A-18)+(B-63), (A-18)+(B-64), (A-18)+(B-65), (A-18)+(B-66), (A-18)+(B-67), (A-18)+(B-68), (A-18)+(B-69), (A-18)+(B-70), (A-18)+(B-71), (A-18)+(B-72), (A-18)+(B-73), (A-18)+(B-74), (A-18)+(B-75), (A-18)+(B-76), (A-18)+(B-77), (AI-1)+(B-78), (A-18)+(B-79), (A-18)+(B-80).

(A-19)+(B-1), (A-19)+(B-2), (A-19)+(B-3), (A-19)+(B-4), (A-19)+(B-5), (A-19)+(B-6), (A-19)+(B-7), (A-19)+(B-8), (A-19)+(B-9), (A-19)+(B-10), (A-19)+(B-11), (A-19)+(B-12), (A-19)+(B-13), (A-19)+(B-14), (A-19)+(B-15), (A-19)+(B-16), (A-19)+(B-17), (A-19)+(B-18), (A-19)+(B-19), (A-19)+(B-20), (A-19)+(B-21), (A-19)+(B-22), (A-19)+(B-23), (A-19)+(B-24), (A-19)+(B-25), (A-19)+(B-26), (A-19)+(B-27), (A-19)+(B-28), (A-19)+(B-29), (A-19)+(B-30), (A-19)+(B-31), (A-19)+(B-32), (A-19)+(B-33), (A-19)+(B-34), (A-19)+(B-35), (A-19)+(B-36), (A-19)+(B-37), (A-19)+(B-38), (A-19)+(B-39), (A-19)+(B-40), (A-19)+(B-41), (A-19)+(B-42), (A-19)+(B-43), (A-19)+(B-44), (A-19)+(B-45), (A-19)+(B-46), (A-19)+(B-47), (A-19)+(B-48), (A-19)+(B-49), (A-19)+(B-50), (A-19)+(B-51), (A-19)+(B-52), (A-19)+(B-53), (A-19)+(B-54), (A-19)+(B-55), (A-19)+(B-56), (A-19)+(B-57), (A-19)+(B-58), (A-19)+(B-59), (A-19)+(B-60), (A-19)+(B-61), (A-19)+(B-62), (A-19)+(B-63), (A-19)+(B-64), (A-19)+(B-65), (A-19)+(B-66), (A-19)+(B-67), (A-19)+(B-68), (A-19)+(B-69), (A-19)+(B-70), (A-19)+(B-71), (A-19)+(B-72), (A-19)+(B-73), (A-19)+(B-74), (A-19)+(B-75), (A-19)+(B-76), (A-19)+(B-77), (AI-1)+(B-78), (A-19)+(B-79), (A-19)+(B-80).

(A-20)+(B-1), (A-20)+(B-2), (A-20)+(B-3), (A-20)+(B-4), (A-20)+(B-5), (A-20)+(B-6), (A-20)+(B-7), (A-20)+(B-8), (A-20)+(B-9), (A-20)+(B-10), (A-20)+(B-11), (A-20)+(B-12), (A-20)+(B-13), (A-20)+(B-14), (A-20)+(B-15), (A-20)+(B-16), (A-20)+(B-17), (A-20)+(B-18), (A-20)+(B-19), (A-20)+(B-20), (A-20)+(B-21), (A-20)+(B-22), (A-20)+(B-23), (A-20)+(B-24), (A-20)+(B-25), (A-20)+(B-26), (A-20)+(B-27), (A-20)+(B-28), (A-20)+(B-29), (A-20)+(B-30), (A-20)+(B-31), (A-20)+(B-32), (A-20)+(B-33), (A-20)+(B-34), (A-20)+(B-35), (A-20)+(B-36), (A-20)+(B-37), (A-20)+(B-38), (A-20)+(B-39), (A-20)+(B-40), (A-20)+(B-41), (A-20)+(B-42), (A-20)+(B-43), (A-20)+(B-44), (A-20)+(B-45), (A-20)+(B-46), (A-20)+(B-47), (A-20)+(B-48), (A-20)+(B-49), (A-20)+(B-50), (A-20)+(B-51), (A-20)+(B-52), (A-20)+(B-53), (A-20)+(B-54), (A-20)+(B-55), (A-20)+(B-56), (A-20)+(B-57), (A-20)+(B-58), (A-20)+(B-59), (A-20)+(B-60), (A-20)+(B-61), (A-20)+(B-62), (A-20)+(B-63), (A-20)+(B-64), (A-20)+(B-65), (A-20)+(B-66), (A-20)+(B-67), (A-20)+(B-68), (A-20)+(B-69), (A-20)+(B-70), (A-20)+(B-71), (A-20)+(B-72), (A-20)+(B-73), (A-20)+(B-74), (A-20)+(B-75), (A-20)+(B-76), (A-20)+(B-77), (AI-1)+(B-78), (A-20)+(B-79), (A-20)+(B-80).

(A-21)+(B-1), (A-21)+(B-2), (A-21)+(B-3), (A-21)+(B-4), (A-21)+(B-5), (A-21)+(B-6), (A-21)+(B-7), (A-21)+(B-8), (A-21)+(B-9), (A-21)+(B-10), (A-21)+(B-11), (A-21)+(B-12), (A-21)+(B-13), (A-21)+(B-14), (A-21)+(B-15), (A-21)+(B-16), (A-21)+(B-17), (A-21)+(B-18), (A-21)+(B-19), (A-21)+(B-20), (A-21)+(B-21), (A-21)+(B-22), (A-21)+(B-23), (A-21)+(B-24), (A-21)+(B-25), (A-21)+(B-26), (A-21)+(B-27), (A-21)+(B-28), (A-21)+(B-29), (A-21)+(B-30), (A-21)+(B-31), (A-21)+(B-32), (A-21)+(B-33), (A-21)+(B-34), (A-21)+(B-35), (A-21)+(B-36), (A-21)+(B-37), (A-21)+(B-38), (A-21)+(B-39), (A-21)+(B-40), (A-21)+(B-41), (A-21)+(B-42), (A-21)+(B-43), (A-21)+(B-44), (A-21)+(B-45), (A-21)+(B-46), (A-21)+(B-47), (A-21)+(B-48), (A-21)+(B-49), (A-21)+(B-50), (A-21)+(B-51), (A-21)+(B-52), (A-21)+(B-53), (A-21)+(B-54), (A-21)+(B-55), (A-21)+(B-56), (A-21)+(B-57), (A-21)+(B-58), (A-21)+(B-59), (A-21)+(B-60), (A-21)+(B-61), (A-21)+(B-62), (A-21)+(B-63), (A-21)+(B-64), (A-21)+(B-65), (A-21)+(B-66), (A-21)+(B-67), (A-21)+(B-68), (A-21)+(B-69), (A-21)+(B-70), (A-21)+(B-71), (A-21)+(B-72), (A-21)+(B-73), (A-21)+(B-74), (A-21)+(B-75), (A-21)+(B-76), (A-21)+(B-77), (AI-1)+(B-78), (A-21)+(B-79), (A-21)+(B-80).

(A-22)+(B-1), (A-22)+(B-2), (A-22)+(B-3), (A-22)+(B-4), (A-22)+(B-5), (A-22)+(B-6), (A-22)+(B-7), (A-22)+(B-8), (A-22)+(B-9), (A-22)+(B-10), (A-22)+(B-11), (A-22)+(B-12), (A-22)+(B-13), (A-22)+(B-14), (A-22)+(B-15), (A-22)+(B-16), (A-22)+(B-17), (A-22)+(B-18), (A-22)+(B-19), (A-22)+(B-20), (A-22)+(B-21), (A-22)+(B-22), (A-22)+(B-23), (A-22)+(B-24), (A-22)+(B-25), (A-22)+(B-26), (A-22)+(B-27), (A-22)+(B-28), (A-22)+(B-29), (A-22)+(B-30), (A-22)+(B-31), (A-22)+(B-32), (A-22)+(B-33), (A-22)+(B-34), (A-22)+(B-35), (A-22)+(B-36), (A-22)+(B-37), (A-22)+(B-38), (A-22)+(B-39), (A-22)+(B-40), (A-22)+(B-41), (A-22)+(B-42), (A-22)+(B-43), (A-22)+(B-44), (A-22)+(B-45), (A-22)+(B-46), (A-22)+(B-47), (A-22)+(B-48), (A-22)+(B-49), (A-22)+(B-50), (A-22)+(B-51), (A-22)+(B-52), (A-22)+(B-53), (A-22)+(B-54), (A-22)+(B-55), (A-22)+(B-56), (A-22)+(B-57), (A-22)+(B-58), (A-22)+(B-59), (A-22)+(B-60), (A-22)+(B-61), (A-22)+(B-62), (A-22)+(B-63), (A-22)+(B-64), (A-22)+(B-65), (A-22)+(B-66), (A-22)+(B-67), (A-22)+(B-68), (A-22)+(B-69), (A-22)+(B-70), (A-22)+(B-71), (A-22)+(B-72), (A-22)+(B-73), (A-22)+(B-74), (A-22)+(B-75), (A-22)+(B-76), (A-22)+(B-77), (AI-1)+(B-78), (A-22)+(B-79), (A-22)+(B-80).

(A-23)+(B-1), (A-23)+(B-2), (A-23)+(B-3), (A-23)+(B-4), (A-23)+(B-5), (A-23)+(B-6), (A-23)+(B-7), (A-23)+(B-8), (A-23)+(B-9), (A-23)+(B-10), (A-23)+(B-11), (A-23)+(B-12), (A-23)+(B-13), (A-23)+(B-14), (A-23)+(B-15), (A-23)+(B-16), (A-23)+(B-17), (A-23)+(B-18), (A-23)+(B-19), (A-23)+(B-20), (A-23)+(B-21), (A-23)+(B-22), (A-23)+(B-23), (A-23)+(B-24), (A-23)+(B-25), (A-23)+(B-26), (A-23)+(B-27), (A-23)+(B-28), (A-23)+(B-29), (A-23)+(B-30), (A-23)+(B-31), (A-23)+(B-32), (A-23)+(B-33), (A-23)+(B-34), (A-23)+(B-35), (A-23)+(B-36), (A-23)+(B-37), (A-23)+(B-38), (A-23)+(B-39), (A-23)+(B-40), (A-23)+(B-41), (A-23)+(B-42), (A-23)+(B-43), (A-23)+(B-44), (A-23)+(B-45), (A-23)+(B-46), (A-23)+(B-47), (A-23)+(B-48), (A-23)+(B-49), (A-23)+(B-50), (A-23)+(B-51), (A-23)+(B-52), (A-23)+(B-53), (A-23)+(B-54), (A-23)+(B-55), (A-23)+(B-56), (A-23)+(B-57), (A-23)+(B-58), (A-23)+(B-59), (A-23)+(B-60), (A-23)+(B-61), (A-23)+(B-62), (A-23)+(B-63), (A-23)+(B-64), (A-23)+(B-65), (A-23)+(B-66), (A-23)+(B-67), (A-23)+(B-68), (A-23)+(B-69), (A-23)+(B-70), (A-23)+(B-71), (A-23)+(B-72), (A-23)+(B-73), (A-23)+(B-74), (A-23)+(B-75), (A-23)+(B-76), (A-23)+(B-77), (AI-1)+(B-78), (A-23)+(B-79), (A-23)+(B-80).

(A-24)+(B-1), (A-24)+(B-2), (A-24)+(B-3), (A-24)+(B-4), (A-24)+(B-5), (A-24)+(B-6), (A-24)+(B-7), (A-24)+(B-8), (A-24)+(B-9), (A-24)+(B-10), (A-24)+(B-11), (A-24)+(B-12), (A-24)+(B-13), (A-24)+(B-14), (A-24)+(B-15), (A-24)+(B-16), (A-24)+(B-17), (A-24)+(B-18), (A-24)+(B-19), (A-24)+(B-20), (A-24)+(B-21), (A-24)+(B-22), (A-24)+(B-23), (A-24)+(B-24), (A-24)+(B-25), (A-24)+(B-26), (A-24)+(B-27), (A-24)+(B-28), (A-24)+(B-29), (A-24)+(B-30), (A-24)+(B-31), (A-24)+(B-32), (A-24)+(B-33), (A-24)+(B-34), (A-24)+(B-35), (A-24)+(B-36), (A-24)+(B-37), (A-24)+(B-38), (A-24)+(B-39), (A-24)+(B-40), (A-24)+(B-41), (A-24)+(B-42), (A-24)+(B-43), (A-24)+(B-44), (A-24)+(B-45), (A-24)+(B-46), (A-24)+(B-47), (A-24)+(B-48), (A-24)+(B-49), (A-24)+(B-50), (A-24)+(B-51), (A-24)+(B-52), (A-24)+(B-53), (A-24)+(B-54), (A-24)+(B-55), (A-24)+(B-56), (A-24)+(B-57), (A-24)+(B-58), (A-24)+(B-59), (A-24)+(B-60), (A-24)+(B-61), (A-24)+(B-62), (A-24)+(B-63), (A-24)+(B-64), (A-24)+(B-65), (A-24)+(B-66), (A-24)+(B-67), (A-24)+(B-68), (A-24)+(B-69), (A-24)+(B-70), (A-24)+(B-71), (A-24)+(B-72), (A-24)+(B-73), (A-24)+(B-74), (A-24)+(B-75), (A-24)+(B-76), (A-24)+(B-77), (AI-1)+(B-78), (A-24)+(B-79), (A-24)+(B-80).

(A-25)+(B-1), (A-25)+(B-2), (A-25)+(B-3), (A-25)+(B-4), (A-25)+(B-5), (A-25)+(B-6), (A-25)+(B-7), (A-25)+(B-8), (A-25)+(B-9), (A-25)+(B-10), (A-25)+(B-11), (A-25)+(B-12), (A-25)+(B-13), (A-25)+(B-14), (A-25)+(B-15), (A-25)+(B-16), (A-25)+(B-17), (A-25)+(B-18), (A-25)+(B-19), (A-25)+(B-20), (A-25)+(B-21), (A-25)+(B-22), (A-25)+(B-23), (A-25)+(B-24), (A-25)+(B-25), (A-25)+(B-26), (A-25)+(B-27), (A-25)+(B-28), (A-25)+(B-29), (A-25)+(B-30), (A-25)+(B-31), (A-25)+(B-32), (A-25)+(B-33), (A-25)+(B-34), (A-25)+(B-35), (A-25)+(B-36), (A-25)+(B-37), (A-25)+(B-38), (A-25)+(B-39), (A-25)+(B-40), (A-25)+(B-41), (A-25)+(B-42), (A-25)+(B-43), (A-25)+(B-44), (A-25)+(B-45), (A-25)+(B-46), (A-25)+(B-47), (A-25)+(B-48), (A-25)+(B-49), (A-25)+(B-50), (A-25)+(B-51), (A-25)+(B-52), (A-25)+(B-53), (A-25)+(B-54), (A-25)+(B-55), (A-25)+(B-56), (A-25)+(B-57), (A-25)+(B-58), (A-25)+(B-59), (A-25)+(B-60), (A-25)+(B-61), (A-25)+(B-62), (A-25)+(B-63), (A-25)+(B-64), (A-25)+(B-65), (A-25)+(B-66), (A-25)+(B-67), (A-25)+(B-68), (A-25)+(B-69), (A-25)+(B-70), (A-25)+(B-71), (A-25)+(B-72), (A-25)+(B-73), (A-25)+(B-74), (A-25)+(B-75), (A-25)+(B-76), (A-25)+(B-77), (AI-1)+(B-78), (A-25)+(B-79), (A-25)+(B-80).

(A-26)+(B-1), (A-26)+(B-2), (A-26)+(B-3), (A-26)+(B-4), (A-26)+(B-5), (A-26)+(B-6), (A-26)+(B-7), (A-26)+(B-8), (A-26)+(B-9), (A-26)+(B-10), (A-26)+(B-11), (A-26)+(B-12), (A-26)+(B-13), (A-26)+(B-14), (A-26)+(B-15), (A-26)+(B-16), (A-26)+(B-17), (A-26)+(B-18), (A-26)+(B-19), (A-26)+(B-20), (A-26)+(B-21), (A-26)+(B-22), (A-26)+(B-23), (A-26)+(B-24), (A-26)+(B-25), (A-26)+(B-26), (A-26)+(B-27), (A-26)+(B-28), (A-26)+(B-29), (A-26)+(B-30), (A-26)+(B-31), (A-26)+(B-32), (A-26)+(B-33), (A-26)+(B-34), (A-26)+(B-35), (A-26)+(B-36), (A-26)+(B-37), (A-26)+(B-38), (A-26)+(B-39), (A-26)+(B-40), (A-26)+(B-41), (A-26)+(B-42), (A-26)+(B-43), (A-26)+(B-44), (A-26)+(B-45), (A-26)+(B-46), (A-26)+(B-47), (A-26)+(B-48), (A-26)+(B-49), (A-26)+(B-50), (A-26)+(B-51), (A-26)+(B-52), (A-26)+(B-53), (A-26)+(B-54), (A-26)+(B-55), (A-26)+(B-56), (A-26)+(B-57), (A-26)+(B-58), (A-26)+(B-59), (A-26)+(B-60), (A-26)+(B-61), (A-26)+(B-62), (A-26)+(B-63), (A-26)+(B-64), (A-26)+(B-65), (A-26)+(B-66), (A-26)+(B-67), (A-26)+(B-68), (A-26)+(B-69), (A-26)+(B-70), (A-26)+(B-71), (A-26)+(B-72), (A-26)+(B-73), (A-26)+(B-74), (A-26)+(B-75), (A-26)+(B-76), (A-26)+(B-77), (AI-1)+(B-78), (A-26)+(B-79), (A-26)+(B-80).

(A-27)+(B-1), (A-27)+(B-2), (A-27)+(B-3), (A-27)+(B-4), (A-27)+(B-5), (A-27)+(B-6), (A-27)+(B-7), (A-27)+(B-8), (A-27)+(B-9), (A-27)+(B-10), (A-27)+(B-11), (A-27)+(B-12), (A-27)+(B-13), (A-27)+(B-14), (A-27)+(B-15), (A-27)+(B-16), (A-27)+(B-17), (A-27)+(B-18), (A-27)+(B-19), (A-27)+(B-20), (A-27)+(B-21), (A-27)+(B-22), (A-27)+(B-23), (A-27)+(B-24), (A-27)+(B-25), (A-27)+(B-26), (A-27)+(B-27), (A-27)+(B-28), (A-27)+(B-29), (A-27)+(B-30), (A-27)+(B-31), (A-27)+(B-32), (A-27)+(B-33), (A-27)+(B-34), (A-27)+(B-35), (A-27)+(B-36), (A-27)+(B-37), (A-27)+(B-38), (A-27)+(B-39), (A-27)+(B-40), (A-27)+(B-41), (A-27)+(B-42), (A-27)+(B-43), (A-27)+(B-44), (A-27)+(B-45), (A-27)+(B-46), (A-27)+(B-47), (A-27)+(B-48), (A-27)+(B-49), (A-27)+(B-50), (A-27)+(B-51), (A-27)+(B-52), (A-27)+(B-53), (A-27)+(B-54), (A-27)+(B-55), (A-27)+(B-56), (A-27)+(B-57), (A-27)+(B-58), (A-27)+(B-59), (A-27)+(B-60), (A-27)+(B-61), (A-27)+(B-62), (A-27)+(B-63), (A-27)+(B-64), (A-27)+(B-65), (A-27)+(B-66), (A-27)+(B-67), (A-27)+(B-68), (A-27)+(B-69), (A-27)+(B-70), (A-27)+(B-71), (A-27)+(B-72), (A-27)+(B-73), (A-27)+(B-74), (A-27)+(B-75), (A-27)+(B-76), (A-27)+(B-77), (AI-1)+(B-78), (A-27)+(B-79), (A-27)+(B-80).

(A-28)+(B-1), (A-28)+(B-2), (A-28)+(B-3), (A-28)+(B-4), (A-28)+(B-5), (A-28)+(B-6), (A-28)+(B-7), (A-28)+(B-8), (A-28)+(B-9), (A-28)+(B-10), (A-28)+(B-11), (A-28)+(B-12), (A-28)+(B-13), (A-28)+(B-14), (A-28)+(B-15), (A-28)+(B-16), (A-28)+(B-17), (A-28)+(B-18), (A-28)+(B-19), (A-28)+(B-20), (A-28)+(B-21), (A-28)+(B-22), (A-28)+(B-23), (A-28)+(B-24), (A-28)+(B-25), (A-28)+(B-26), (A-28)+(B-27), (A-28)+(B-28), (A-28)+(B-29), (A-28)+(B-30), (A-28)+(B-31), (A-28)+(B-32), (A-28)+(B-33), (A-28)+(B-34), (A-28)+(B-35), (A-28)+(B-36), (A-28)+(B-37), (A-28)+(B-38), (A-28)+(B-39), (A-28)+(B-40), (A-28)+(B-41), (A-28)+(B-42), (A-28)+(B-43), (A-28)+(B-44), (A-28)+(B-45), (A-28)+(B-46), (A-28)+(B-47), (A-28)+(B-48), (A-28)+(B-49), (A-28)+(B-50), (A-28)+(B-51), (A-28)+(B-52), (A-28)+(B-53), (A-28)+(B-54), (A-28)+(B-55), (A-28)+(B-56), (A-28)+(B-57), (A-28)+(B-58), (A-28)+(B-59), (A-28)+(B-60), (A-28)+(B-61), (A-28)+(B-62), (A-28)+(B-63), (A-28)+(B-64), (A-28)+(B-65), (A-28)+(B-66), (A-28)+(B-67), (A-28)+(B-68), (A-28)+(B-69), (A-28)+(B-70), (A-28)+(B-71), (A-28)+(B-72), (A-28)+(B-73), (A-28)+(B-74), (A-28)+(B-75), (A-28)+(B-76), (A-28)+(B-77), (AI-1)+(B-78), (A-28)+(B-79), (A-28)+(B-80).

(A-29)+(B-1), (A-29)+(B-2), (A-29)+(B-3), (A-29)+(B-4), (A-29)+(B-5), (A-29)+(B-6), (A-29)+(B-7), (A-29)+(B-8), (A-29)+(B-9), (A-29)+(B-10), (A-29)+(B-11), (A-29)+(B-12), (A-29)+(B-13), (A-29)+(B-14), (A-29)+(B-15), (A-29)+(B-16), (A-29)+(B-17), (A-29)+(B-18), (A-29)+(B-19), (A-29)+(B-20), (A-29)+(B-21), (A-29)+(B-22), (A-29)+(B-23), (A-29)+(B-24), (A-29)+(B-25), (A-29)+(B-26), (A-29)+(B-27), (A-29)+(B-28), (A-29)+(B-29), (A-29)+(B-30), (A-29)+(B-31), (A-29)+(B-32), (A-29)+(B-33), (A-29)+(B-34), (A-29)+(B-35), (A-29)+(B-36), (A-29)+(B-37), (A-29)+(B-38), (A-29)+(B-39), (A-29)+(B-40), (A-29)+(B-41), (A-29)+(B-42), (A-29)+(B-43), (A-29)+(B-44), (A-29)+(B-45), (A-29)+(B-46), (A-29)+(B-47), (A-29)+(B-48), (A-29)+(B-49), (A-29)+(B-50), (A-29)+(B-51), (A-29)+(B-52), (A-29)+(B-53), (A-29)+(B-54), (A-29)+(B-55), (A-29)+(B-56), (A-29)+(B-57), (A-29)+(B-58), (A-29)+(B-59), (A-29)+(B-60), (A-29)+(B-61), (A-29)+(B-62), (A-29)+(B-63), (A-29)+(B-64), (A-29)+(B-65), (A-29)+(B-66), (A-29)+(B-67), (A-29)+(B-68), (A-29)+(B-69), (A-29)+(B-70), (A-29)+(B-71), (A-29)+(B-72), (A-29)+(B-73), (A-29)+(B-74), (A-29)+(B-75), (A-29)+(B-76), (A-29)+(B-77), (AI-1)+(B-78), (A-29)+(B-79), (A-29)+(B-80).

(A-30)+(B-1), (A-30)+(B-2), (A-30)+(B-3), (A-30)+(B-4), (A-30)+(B-5), (A-30)+(B-6), (A-30)+(B-7), (A-30)+(B-8), (A-30)+(B-9), (A-30)+(B-10), (A-30)+(B-11), (A-30)+(B-12), (A-30)+(B-13), (A-30)+(B-14), (A-30)+(B-15), (A-30)+(B-16), (A-30)+(B-17), (A-30)+(B-18), (A-30)+(B-19), (A-30)+(B-20), (A-30)+(B-21), (A-30)+(B-22), (A-30)+(B-23), (A-30)+(B-24), (A-30)+(B-25), (A-30)+(B-26), (A-30)+(B-27), (A-30)+(B-28), (A-30)+(B-29), (A-30)+(B-30), (A-30)+(B-31), (A-30)+(B-32), (A-30)+(B-33), (A-30)+(B-34), (A-30)+(B-35), (A-30)+(B-36), (A-30)+(B-37), (A-30)+(B-38), (A-30)+(B-39), (A-30)+(B-40), (A-30)+(B-41), (A-30)+(B-42), (A-30)+(B-43), (A-30)+(B-44), (A-30)+(B-45), (A-30)+(B-46), (A-30)+(B-47), (A-30)+(B-48), (A-30)+(B-49), (A-30)+(B-50), (A-30)+(B-51), (A-30)+(B-52), (A-30)+(B-53), (A-30)+(B-54), (A-30)+(B-55), (A-30)+(B-56), (A-30)+(B-57), (A-30)+(B-58), (A-30)+(B-59), (A-30)+(B-60), (A-30)+(B-61), (A-30)+(B-62), (A-30)+(B-63), (A-30)+(B-64), (A-30)+(B-65), (A-30)+(B-66), (A-30)+(B-67), (A-30)+(B-68), (A-30)+(B-69), (A-30)+(B-70), (A-30)+(B-71), (A-30)+(B-72), (A-30)+(B-73), (A-30)+(B-74), (A-30)+(B-75), (A-30)+(B-76), (A-30)+(B-77), (AI-1)+(B-78), (A-30)+(B-79), (A-30)+(B-80).

(A-31)+(B-1), (A-31)+(B-2), (A-31)+(B-3), (A-31)+(B-4), (A-31)+(B-5), (A-31)+(B-6), (A-31)+(B-7), (A-31)+(B-8), (A-31)+(B-9), (A-31)+(B-10), (A-31)+(B-11), (A-31)+(B-12), (A-31)+(B-13), (A-31)+(B-14), (A-31)+(B-15), (A-31)+(B-16), (A-31)+(B-17), (A-31)+(B-18), (A-31)+(B-19), (A-31)+(B-20), (A-31)+(B-21), (A-31)+(B-22), (A-31)+(B-23), (A-31)+(B-24), (A-31)+(B-25), (A-31)+(B-26), (A-31)+(B-27), (A-31)+(B-28), (A-31)+(B-29), (A-31)+(B-30), (A-31)+(B-31), (A-31)+(B-32), (A-31)+(B-33), (A-31)+(B-34), (A-31)+(B-35), (A-31)+(B-36), (A-31)+(B-37), (A-31)+(B-38), (A-31)+(B-39), (A-31)+(B-40), (A-31)+(B-41), (A-31)+(B-42), (A-31)+(B-43), (A-31)+(B-44), (A-31)+(B-45), (A-31)+(B-46), (A-31)+(B-47), (A-31)+(B-48), (A-31)+(B-49), (A-31)+(B-50), (A-31)+(B-51), (A-31)+(B-52), (A-31)+(B-53), (A-31)+(B-54), (A-31)+(B-55), (A-31)+(B-56), (A-31)+(B-57), (A-31)+(B-58), (A-31)+(B-59), (A-31)+(B-60), (A-31)+(B-61), (A-31)+(B-62), (A-31)+(B-63), (A-31)+(B-64), (A-31)+(B-65), (A-31)+(B-66), (A-31)+(B-67), (A-31)+(B-68), (A-31)+(B-69), (A-31)+(B-70), (A-31)+(B-71), (A-31)+(B-72), (A-31)+(B-73), (A-31)+(B-74), (A-31)+(B-75), (A-31)+(B-76), (A-31)+(B-77), (AI-1)+(B-78), (A-31)+(B-79), (A-31)+(B-80).

(A-32)+(B-1), (A-32)+(B-2), (A-32)+(B-3), (A-32)+(B-4), (A-32)+(B-5), (A-32)+(B-6), (A-32)+(B-7), (A-32)+(B-8), (A-32)+(B-9), (A-32)+(B-10), (A-32)+(B-11), (A-32)+(B-12), (A-32)+(B-13), (A-32)+(B-14), (A-32)+(B-15), (A-32)+(B-16), (A-32)+(B-17), (A-32)+(B-18), (A-32)+(B-19), (A-32)+(B-20), (A-32)+(B-21), (A-32)+(B-22), (A-32)+(B-23), (A-32)+(B-24), (A-32)+(B-25), (A-32)+(B-26), (A-32)+(B-27), (A-32)+(B-28), (A-32)+(B-29), (A-32)+(B-30), (A-32)+(B-31), (A-32)+(B-32), (A-32)+(B-33), (A-32)+(B-34), (A-32)+(B-35), (A-32)+(B-36), (A-32)+(B-37), (A-32)+(B-38), (A-32)+(B-39), (A-32)+(B-40), (A-32)+(B-41), (A-32)+(B-42), (A-32)+(B-43), (A-32)+(B-44), (A-32)+(B-45), (A-32)+(B-46), (A-32)+(B-47), (A-32)+(B-48), (A-32)+(B-49), (A-32)+(B-50), (A-32)+(B-51), (A-32)+(B-52), (A-32)+(B-53), (A-32)+(B-54), (A-32)+(B-55), (A-32)+(B-56), (A-32)+(B-57), (A-32)+(B-58), (A-32)+(B-59), (A-32)+(B-60), (A-32)+(B-61), (A-32)+(B-62), (A-32)+(B-63), (A-32)+(B-64), (A-32)+(B-65), (A-32)+(B-66), (A-32)+(B-67), (A-32)+(B-68), (A-32)+(B-69), (A-32)+(B-70), (A-32)+(B-71), (A-32)+(B-72), (A-32)+(B-73), (A-32)+(B-74), (A-32)+(B-75), (A-32)+(B-76), (A-32)+(B-77), (AI-1)+(B-78), (A-32)+(B-79), (A-32)+(B-80).

(A-33)+(B-1), (A-33)+(B-2), (A-33)+(B-3), (A-33)+(B-4), (A-33)+(B-5), (A-33)+(B-6), (A-33)+(B-7), (A-33)+(B-8), (A-33)+(B-9), (A-33)+(B-10), (A-33)+(B-11), (A-33)+(B-12), (A-33)+(B-13), (A-33)+(B-14), (A-33)+(B-15), (A-33)+(B-16), (A-33)+(B-17), (A-33)+(B-18), (A-33)+(B-19), (A-33)+(B-20), (A-33)+(B-21), (A-33)+(B-22), (A-33)+(B-23), (A-33)+(B-24), (A-33)+(B-25), (A-33)+(B-26), (A-33)+(B-27), (A-33)+(B-28), (A-33)+(B-29), (A-33)+(B-30), (A-33)+(B-31), (A-33)+(B-32), (A-33)+(B-33), (A-33)+(B-34), (A-33)+(B-35), (A-33)+(B-36), (A-33)+(B-37), (A-33)+(B-38), (A-33)+(B-39), (A-33)+(B-40), (A-33)+(B-41), (A-33)+(B-42), (A-33)+(B-43), (A-33)+(B-44), (A-33)+(B-45), (A-33)+(B-46), (A-33)+(B-47), (A-33)+(B-48), (A-33)+(B-49), (A-33)+(B-50), (A-33)+(B-51), (A-33)+(B-52), (A-33)+(B-53), (A-33)+(B-54), (A-33)+(B-55), (A-33)+(B-56), (A-33)+(B-57), (A-33)+(B-58), (A-33)+(B-59), (A-33)+(B-60), (A-33)+(B-61), (A-33)+(B-62), (A-33)+(B-63), (A-33)+(B-64), (A-33)+(B-65), (A-33)+(B-66), (A-33)+(B-67), (A-33)+(B-68), (A-33)+(B-69), (A-33)+(B-70), (A-33)+(B-71), (A-33)+(B-72), (A-33)+(B-73), (A-33)+(B-74), (A-33)+(B-75), (A-33)+(B-76), (A-33)+(B-77), (AI-1)+(B-78), (A-33)+(B-79), (A-33)+(B-80).

(A-34)+(B-1), (A-34)+(B-2), (A-34)+(B-3), (A-34)+(B-4), (A-34)+(B-5), (A-34)+(B-6), (A-34)+(B-7), (A-34)+(B-8), (A-34)+(B-9), (A-34)+(B-10), (A-34)+(B-11), (A-34)+(B-12), (A-34)+(B-13), (A-34)+(B-14), (A-34)+(B-15), (A-34)+(B-16), (A-34)+(B-17), (A-34)+(B-18), (A-34)+(B-19), (A-34)+(B-20), (A-34)+(B-21), (A-34)+(B-22), (A-34)+(B-23), (A-34)+(B-24), (A-34)+(B-25), (A-34)+(B-26), (A-34)+(B-27), (A-34)+(B-28), (A-34)+(B-29), (A-34)+(B-30), (A-34)+(B-31), (A-34)+(B-32), (A-34)+(B-33), (A-34)+(B-34), (A-34)+(B-35), (A-34)+(B-36), (A-34)+(B-37), (A-34)+(B-38), (A-34)+(B-39), (A-34)+(B-40), (A-34)+(B-41), (A-34)+(B-42), (A-34)+(B-43), (A-34)+(B-44), (A-34)+(B-45), (A-34)+(B-46), (A-34)+(B-47), (A-34)+(B-48), (A-34)+(B-49), (A-34)+(B-50), (A-34)+(B-51), (A-34)+(B-52), (A-34)+(B-53), (A-34)+(B-54), (A-34)+(B-55), (A-34)+(B-56), (A-34)+(B-57), (A-34)+(B-58), (A-34)+(B-59), (A-34)+(B-60), (A-34)+(B-61), (A-34)+(B-62), (A-34)+(B-63), (A-34)+(B-64), (A-34)+(B-65), (A-34)+(B-66), (A-34)+(B-67), (A-34)+(B-68), (A-34)+(B-69), (A-34)+(B-70), (A-34)+(B-71), (A-34)+(B-72), (A-34)+(B-73), (A-34)+(B-74), (A-34)+(B-75), (A-34)+(B-76), (A-34)+(B-77), (AI-1)+(B-78), (A-34)+(B-79), (A-34)+(B-80).

(A-35)+(B-1), (A-35)+(B-2), (A-35)+(B-3), (A-35)+(B-4), (A-35)+(B-5), (A-35)+(B-6), (A-35)+(B-7), (A-35)+(B-8), (A-35)+(B-9), (A-35)+(B-10), (A-35)+(B-11), (A-35)+(B-12), (A-35)+(B-13), (A-35)+(B-14), (A-35)+(B-15), (A-35)+(B-16), (A-35)+(B-17), (A-35)+(B-18), (A-35)+(B-19), (A-35)+(B-20), (A-35)+(B-21), (A-35)+(B-22), (A-35)+(B-23), (A-35)+(B-24), (A-35)+(B-25), (A-35)+(B-26), (A-35)+(B-27), (A-35)+(B-28), (A-35)+(B-29), (A-35)+(B-30), (A-35)+(B-31), (A-35)+(B-32), (A-35)+(B-33), (A-35)+(B-34), (A-35)+(B-35), (A-35)+(B-36), (A-35)+(B-37), (A-35)+(B-38), (A-35)+(B-39), (A-35)+(B-40), (A-35)+(B-41), (A-35)+(B-42), (A-35)+(B-43), (A-35)+(B-44), (A-35)+(B-45), (A-35)+(B-46), (A-35)+(B-47), (A-35)+(B-48), (A-35)+(B-49), (A-35)+(B-50), (A-35)+(B-51), (A-35)+(B-52), (A-35)+(B-53), (A-35)+(B-54), (A-35)+(B-55), (A-35)+(B-56), (A-35)+(B-57), (A-35)+(B-58), (A-35)+(B-59), (A-35)+(B-60), (A-35)+(B-61), (A-35)+(B-62), (A-35)+(B-63), (A-35)+(B-64), (A-35)+(B-65), (A-35)+(B-66), (A-35)+(B-67), (A-35)+(B-68), (A-35)+(B-69), (A-35)+(B-70), (A-35)+(B-71), (A-35)+(B-72), (A-35)+(B-73), (A-35)+(B-74), (A-35)+(B-75), (A-35)+(B-76), (A-35)+(B-77), (AI-1)+(B-78), (A-35)+(B-79), (A-35)+(B-80).

(A-36)+(B-1), (A-36)+(B-2), (A-36)+(B-3), (A-36)+(B-4), (A-36)+(B-5), (A-36)+(B-6), (A-36)+(B-7), (A-36)+(B-8), (A-36)+(B-9), (A-36)+(B-10), (A-36)+(B-11), (A-36)+(B-12), (A-36)+(B-13), (A-36)+(B-14), (A-36)+(B-15), (A-36)+(B-16), (A-36)+(B-17), (A-36)+(B-18), (A-36)+(B-19), (A-36)+(B-20), (A-36)+(B-21), (A-36)+(B-22), (A-36)+(B-23), (A-36)+(B-24), (A-36)+(B-25), (A-36)+(B-26), (A-36)+(B-27), (A-36)+(B-28), (A-36)+(B-29), (A-36)+(B-30), (A-36)+(B-31), (A-36)+(B-32), (A-36)+(B-33), (A-36)+(B-34), (A-36)+(B-35), (A-36)+(B-36), (A-36)+(B-37), (A-36)+(B-38), (A-36)+(B-39), (A-36)+(B-40), (A-36)+(B-41), (A-36)+(B-42), (A-36)+(B-43), (A-36)+(B-44), (A-36)+(B-45), (A-36)+(B-46), (A-36)+(B-47), (A-36)+(B-48), (A-36)+(B-49), (A-36)+(B-50), (A-36)+(B-51), (A-36)+(B-52), (A-36)+(B-53), (A-36)+(B-54), (A-36)+(B-55), (A-36)+(B-56), (A-36)+(B-57), (A-36)+(B-58), (A-36)+(B-59), (A-36)+(B-60), (A-36)+(B-61), (A-36)+(B-62), (A-36)+(B-63), (A-36)+(B-64), (A-36)+(B-65), (A-36)+(B-66), (A-36)+(B-67), (A-36)+(B-68), (A-36)+(B-69), (A-36)+(B-70), (A-36)+(B-71), (A-36)+(B-72), (A-36)+(B-73), (A-36)+(B-74), (A-36)+(B-75), (A-36)+(B-76), (A-36)+(B-77), (AI-1)+(B-78), (A-36)+(B-79), (A-36)+(B-80).

(A-37)+(B-1), (A-37)+(B-2), (A-37)+(B-3), (A-37)+(B-4), (A-37)+(B-5), (A-37)+(B-6), (A-37)+(B-7), (A-37)+(B-8), (A-37)+(B-9), (A-37)+(B-10), (A-37)+(B-11), (A-37)+(B-12), (A-37)+(B-13), (A-37)+(B-14), (A-37)+(B-15), (A-37)+(B-16), (A-37)+(B-17), (A-37)+(B-18), (A-37)+(B-19), (A-37)+(B-20), (A-37)+(B-21), (A-37)+(B-22), (A-37)+(B-23), (A-37)+(B-24), (A-37)+(B-25), (A-37)+(B-26), (A-37)+(B-27), (A-37)+(B-28), (A-37)+(B-29), (A-37)+(B-30), (A-37)+(B-31), (A-37)+(B-32), (A-37)+(B-33), (A-37)+(B-34), (A-37)+(B-35), (A-37)+(B-36), (A-37)+(B-37), (A-37)+(B-38), (A-37)+(B-39), (A-37)+(B-40), (A-37)+(B-41), (A-37)+(B-42), (A-37)+(B-43), (A-37)+(B-44), (A-37)+(B-45), (A-37)+(B-46), (A-37)+(B-47), (A-37)+(B-48), (A-37)+(B-49), (A-37)+(B-50), (A-37)+(B-51), (A-37)+(B-52), (A-37)+(B-53), (A-37)+(B-54), (A-37)+(B-55), (A-37)+(B-56), (A-37)+(B-57), (A-37)+(B-58), (A-37)+(B-59), (A-37)+(B-60), (A-37)+(B-61), (A-37)+(B-62), (A-37)+(B-63), (A-37)+(B-64), (A-37)+(B-65), (A-37)+(B-66), (A-37)+(B-67), (A-37)+(B-68), (A-37)+(B-69), (A-37)+(B-70), (A-37)+(B-71), (A-37)+(B-72), (A-37)+(B-73), (A-37)+(B-74), (A-37)+(B-75), (A-37)+(B-76), (A-37)+(B-77), (AI-1)+(B-78), (A-37)+(B-79), (A-37)+(B-80).

(A-38)+(B-1), (A-38)+(B-2), (A-38)+(B-3), (A-38)+(B-4), (A-38)+(B-5), (A-38)+(B-6), (A-38)+(B-7), (A-38)+(B-8), (A-38)+(B-9), (A-38)+(B-10), (A-38)+(B-11), (A-38)+(B-12), (A-38)+(B-13), (A-38)+(B-14), (A-38)+(B-15), (A-38)+(B-16), (A-38)+(B-17), (A-38)+(B-18), (A-38)+(B-19), (A-38)+(B-20), (A-38)+(B-21), (A-38)+(B-22), (A-38)+(B-23), (A-38)+(B-24), (A-38)+(B-25), (A-38)+(B-26), (A-38)+(B-27), (A-38)+(B-28), (A-38)+(B-29), (A-38)+(B-30), (A-38)+(B-31), (A-38)+(B-32), (A-38)+(B-33), (A-38)+(B-34), (A-38)+(B-35), (A-38)+(B-36), (A-38)+(B-37), (A-38)+(B-38), (A-38)+(B-39), (A-38)+(B-40), (A-38)+(B-41), (A-38)+(B-42), (A-38)+(B-43), (A-38)+(B-44), (A-38)+(B-45), (A-38)+(B-46), (A-38)+(B-47), (A-38)+(B-48), (A-38)+(B-49), (A-38)+(B-50), (A-38)+(B-51), (A-38)+(B-52), (A-38)+(B-53), (A-38)+(B-54), (A-38)+(B-55), (A-38)+(B-56), (A-38)+(B-57), (A-38)+(B-58), (A-38)+(B-59), (A-38)+(B-60), (A-38)+(B-61), (A-38)+(B-62), (A-38)+(B-63), (A-38)+(B-64), (A-38)+(B-65), (A-38)+(B-66), (A-38)+(B-67), (A-38)+(B-68), (A-38)+(B-69), (A-38)+(B-70), (A-38)+(B-71), (A-38)+(B-72), (A-38)+(B-73), (A-38)+(B-74), (A-38)+(B-75), (A-38)+(B-76), (A-38)+(B-77), (AI-1)+(B-78), (A-38)+(B-79), (A-38)+(B-80).

(A-39)+(B-1), (A-39)+(B-2), (A-39)+(B-3), (A-39)+(B-4), (A-39)+(B-5), (A-39)+(B-6), (A-39)+(B-7), (A-39)+(B-8), (A-39)+(B-9), (A-39)+(B-10), (A-39)+(B-11), (A-39)+(B-12), (A-39)+(B-13), (A-39)+(B-14), (A-39)+(B-15), (A-39)+(B-16), (A-39)+(B-17), (A-39)+(B-18), (A-39)+(B-19), (A-39)+(B-20), (A-39)+(B-21), (A-39)+(B-22), (A-39)+(B-23), (A-39)+(B-24), (A-39)+(B-25), (A-39)+(B-26), (A-39)+(B-27), (A-39)+(B-28), (A-39)+(B-29), (A-39)+(B-30), (A-39)+(B-31), (A-39)+(B-32), (A-39)+(B-33), (A-39)+(B-34), (A-39)+(B-35), (A-39)+(B-36), (A-39)+(B-37), (A-39)+(B-38), (A-39)+(B-39), (A-39)+(B-40), (A-39)+(B-41), (A-39)+(B-42), (A-39)+(B-43), (A-39)+(B-44), (A-39)+(B-45), (A-39)+(B-46), (A-39)+(B-47), (A-39)+(B-48), (A-39)+(B-49), (A-39)+(B-50), (A-39)+(B-51), (A-39)+(B-52), (A-39)+(B-53), (A-39)+(B-54), (A-39)+(B-55), (A-39)+(B-56), (A-39)+(B-57), (A-39)+(B-58), (A-39)+(B-59), (A-39)+(B-60), (A-39)+(B-61), (A-39)+(B-62), (A-39)+(B-63), (A-39)+(B-64), (A-39)+(B-65), (A-39)+(B-66), (A-39)+(B-67), (A-39)+(B-68), (A-39)+(B-69), (A-39)+(B-70), (A-39)+(B-71), (A-39)+(B-72), (A-39)+(B-73), (A-39)+(B-74), (A-39)+(B-75), (A-39)+(B-76), (A-39)+(B-77), (AI-1)+(B-78), (A-39)+(B-79), (A-39)+(B-80).

(A-40)+(B-1), (A-40)+(B-2), (A-40)+(B-3), (A-40)+(B-4), (A-40)+(B-5), (A-40)+(B-6), (A-40)+(B-7), (A-40)+(B-8), (A-40)+(B-9), (A-40)+(B-10), (A-40)+(B-11), (A-40)+(B-12), (A-40)+(B-13), (A-40)+(B-14), (A-40)+(B-15), (A-40)+(B-16), (A-40)+(B-17), (A-40)+(B-18), (A-40)+(B-19), (A-40)+(B-20), (A-40)+(B-21), (A-40)+(B-22), (A-40)+(B-23), (A-40)+(B-24), (A-40)+(B-25), (A-40)+(B-26), (A-40)+(B-27), (A-40)+(B-28), (A-40)+(B-29), (A-40)+(B-30), (A-40)+(B-31), (A-40)+(B-32), (A-40)+(B-33), (A-40)+(B-34), (A-40)+(B-35), (A-40)+(B-36), (A-40)+(B-37), (A-40)+(B-38), (A-40)+(B-39), (A-40)+(B-40), (A-40)+(B-41), (A-40)+(B-42), (A-40)+(B-43), (A-40)+(B-44), (A-40)+(B-45), (A-40)+(B-46), (A-40)+(B-47), (A-40)+(B-48), (A-40)+(B-49), (A-40)+(B-50), (A-40)+(B-51), (A-40)+(B-52), (A-40)+(B-53), (A-40)+(B-54), (A-40)+(B-55), (A-40)+(B-56), (A-40)+(B-57), (A-40)+(B-58), (A-40)+(B-59), (A-40)+(B-60), (A-40)+(B-61), (A-40)+(B-62), (A-40)+(B-63), (A-40)+(B-64), (A-40)+(B-65), (A-40)+(B-66), (A-40)+(B-67), (A-40)+(B-68), (A-40)+(B-69), (A-40)+(B-70), (A-40)+(B-71), (A-40)+(B-72), (A-40)+(B-73), (A-40)+(B-74), (A-40)+(B-75), (A-40)+(B-76), (A-40)+(B-77), (AI-1)+(B-78), (A-40)+(B-79), (A-40)+(B-80).

(A-41)+(B-1), (A-41)+(B-2), (A-41)+(B-3), (A-41)+(B-4), (A-41)+(B-5), (A-41)+(B-6), (A-41)+(B-7), (A-41)+(B-8), (A-41)+(B-9), (A-41)+(B-10), (A-41)+(B-11), (A-41)+(B-12), (A-41)+(B-13), (A-41)+(B-14), (A-41)+(B-15), (A-41)+(B-16), (A-41)+(B-17), (A-41)+(B-18), (A-41)+(B-19), (A-41)+(B-20), (A-41)+(B-21), (A-41)+(B-22), (A-41)+(B-23), (A-41)+(B-24), (A-41)+(B-25), (A-41)+(B-26), (A-41)+(B-27), (A-41)+(B-28), (A-41)+(B-29), (A-41)+(B-30), (A-41)+(B-31), (A-41)+(B-32), (A-41)+(B-33), (A-41)+(B-34), (A-41)+(B-35), (A-41)+(B-36), (A-41)+(B-37), (A-41)+(B-38), (A-41)+(B-39), (A-41)+(B-40), (A-41)+(B-41), (A-41)+(B-42), (A-41)+(B-43), (A-41)+(B-44), (A-41)+(B-45), (A-41)+(B-46), (A-41)+(B-47), (A-41)+(B-48), (A-41)+(B-49), (A-41)+(B-50), (A-41)+(B-51), (A-41)+(B-52), (A-41)+(B-53), (A-41)+(B-54), (A-41)+(B-55), (A-41)+(B-56), (A-41)+(B-57), (A-41)+(B-58), (A-41)+(B-59), (A-41)+(B-60), (A-41)+(B-61), (A-41)+(B-62), (A-41)+(B-63), (A-41)+(B-64), (A-41)+(B-65), (A-41)+(B-66), (A-41)+(B-67), (A-41)+(B-68), (A-41)+(B-69), (A-41)+(B-70), (A-41)+(B-71), (A-41)+(B-72), (A-41)+(B-73), (A-41)+(B-74), (A-41)+(B-75), (A-41)+(B-76), (A-41)+(B-77), (AI-1)+(B-78), (A-41)+(B-79), (A-41)+(B-80).

(A-42)+(B-1), (A-42)+(B-2), (A-42)+(B-3), (A-42)+(B-4), (A-42)+(B-5), (A-42)+(B-6), (A-42)+(B-7), (A-42)+(B-8), (A-42)+(B-9), (A-42)+(B-10), (A-42)+(B-11), (A-42)+(B-12), (A-42)+(B-13), (A-42)+(B-14), (A-42)+(B-15), (A-42)+(B-16), (A-42)+(B-17), (A-42)+(B-18), (A-42)+(B-19), (A-42)+(B-20), (A-42)+(B-21), (A-42)+(B-22), (A-42)+(B-23), (A-42)+(B-24), (A-42)+(B-25), (A-42)+(B-26), (A-42)+(B-27), (A-42)+(B-28), (A-42)+(B-29), (A-42)+(B-30), (A-42)+(B-31), (A-42)+(B-32), (A-42)+(B-33), (A-42)+(B-34), (A-42)+(B-35), (A-42)+(B-36), (A-42)+(B-37), (A-42)+(B-38), (A-42)+(B-39), (A-42)+(B-40), (A-42)+(B-41), (A-42)+(B-42), (A-42)+(B-43), (A-42)+(B-44), (A-42)+(B-45), (A-42)+(B-46), (A-42)+(B-47), (A-42)+(B-48), (A-42)+(B-49), (A-42)+(B-50), (A-42)+(B-51), (A-42)+(B-52), (A-42)+(B-53), (A-42)+(B-54), (A-42)+(B-55), (A-42)+(B-56), (A-42)+(B-57), (A-42)+(B-58), (A-42)+(B-59), (A-42)+(B-60), (A-42)+(B-61), (A-42)+(B-62), (A-42)+(B-63), (A-42)+(B-64), (A-42)+(B-65), (A-42)+(B-66), (A-42)+(B-67), (A-42)+(B-68), (A-42)+(B-69), (A-42)+(B-70), (A-42)+(B-71), (A-42)+(B-72), (A-42)+(B-73), (A-42)+(B-74), (A-42)+(B-75), (A-42)+(B-76), (A-42)+(B-77), (AI-1)+(B-78), (A-42)+(B-79), (A-42)+(B-80).

(A-43)+(B-1), (A-43)+(B-2), (A-43)+(B-3), (A-43)+(B-4), (A-43)+(B-5), (A-43)+(B-6), (A-43)+(B-7), (A-43)+(B-8), (A-43)+(B-9), (A-43)+(B-10), (A-43)+(B-11), (A-43)+(B-12), (A-43)+(B-13), (A-43)+(B-14), (A-43)+(B-15), (A-43)+(B-16), (A-43)+(B-17), (A-43)+(B-18), (A-43)+(B-19), (A-43)+(B-20), (A-43)+(B-21), (A-43)+(B-22), (A-43)+(B-23), (A-43)+(B-24), (A-43)+(B-25), (A-43)+(B-26), (A-43)+(B-27), (A-43)+(B-28), (A-43)+(B-29), (A-43)+(B-30), (A-43)+(B-31), (A-43)+(B-32), (A-43)+(B-33), (A-43)+(B-34), (A-43)+(B-35), (A-43)+(B-36), (A-43)+(B-37), (A-43)+(B-38), (A-43)+(B-39), (A-43)+(B-40), (A-43)+(B-41), (A-43)+(B-42), (A-43)+(B-43), (A-43)+(B-44), (A-43)+(B-45), (A-43)+(B-46), (A-43)+(B-47), (A-43)+(B-48), (A-43)+(B-49), (A-43)+(B-50), (A-43)+(B-51), (A-43)+(B-52), (A-43)+(B-53), (A-43)+(B-54), (A-43)+(B-55), (A-43)+(B-56), (A-43)+(B-57), (A-43)+(B-58), (A-43)+(B-59), (A-43)+(B-60), (A-43)+(B-61), (A-43)+(B-62), (A-43)+(B-63), (A-43)+(B-64), (A-43)+(B-65), (A-43)+(B-66), (A-43)+(B-67), (A-43)+(B-68), (A-43)+(B-69), (A-43)+(B-70), (A-43)+(B-71), (A-43)+(B-72), (A-43)+(B-73), (A-43)+(B-74), (A-43)+(B-75), (A-43)+(B-76), (A-43)+(B-77), (AI-1)+(B-78), (A-43)+(B-79), (A-43)+(B-80). (A-44)+(B-1), (A-44)+(B-2), (A-44)+(B-3), (A-44)+(B-4), (A-44)+(B-5), (A-44)+(B-6), (A-44)+(B-7), (A-44)+(B-8), (A-44)+(B-9), (A-44)+(B-10), (A-44)+(B-11), (A-44)+(B-12), (A-44)+(B-13), (A-44)+(B-14), (A-44)+(B-15), (A-44)+(B-16), (A-44)+(B-17), (A-44)+(B-18), (A-44)+(B-19), (A-44)+(B-20), (A-44)+(B-21), (A-44)+(B-22), (A-44)+(B-23), (A-44)+(B-24), (A-44)+(B-25), (A-44)+(B-26), (A-44)+(B-27), (A-44)+(B-28), (A-44)+(B-29), (A-44)+(B-30), (A-44)+(B-31), (A-44)+(B-32), (A-44)+(B-33), (A-44)+(B-34), (A-44)+(B-35), (A-44)+(B-36), (A-44)+(B-37), (A-44)+(B-38), (A-44)+(B-39), (A-44)+(B-40), (A-44)+(B-41), (A-44)+(B-42), (A-44)+(B-43), (A-44)+(B-44), (A-44)+(B-45), (A-44)+(B-46), (A-44)+(B-47), (A-44)+(B-48), (A-44)+(B-49), (A-44)+(B-50), (A-44)+(B-51), (A-44)+(B-52), (A-44)+(B-53), (A-44)+(B-54), (A-44)+(B-55), (A-44)+(B-56), (A-44)+(B-57), (A-44)+(B-58), (A-44)+(B-59), (A-44)+(B-60), (A-44)+(B-61), (A-44)+(B-62), (A-44)+(B-63), (A-44)+(B-64), (A-44)+(B-65), (A-44)+(B-66), (A-44)+(B-67), (A-44)+(B-68), (A-44)+(B-69), (A-44)+(B-70), (A-44)+(B-71), (A-44)+(B-72), (A-44)+(B-73), (A-44)+(B-74), (A-44)+(B-75), (A-44)+(B-76), (A-44)+(B-77), (AI-1)+(B-78), (A-44)+(B-79), (A-44)+(B-80).

(A-45)+(B-1), (A-45)+(B-2), (A-45)+(B-3), (A-45)+(B-4), (A-45)+(B-5), (A-45)+(B-6), (A-45)+(B-7), (A-45)+(B-8), (A-45)+(B-9), (A-45)+(B-10), (A-45)+(B-11), (A-45)+(B-12), (A-45)+(B-13), (A-45)+(B-14), (A-45)+(B-15), (A-45)+(B-16), (A-45)+(B-17), (A-45)+(B-18), (A-45)+(B-19), (A-45)+(B-20), (A-45)+(B-21), (A-45)+(B-22), (A-45)+(B-23), (A-45)+(B-24), (A-45)+(B-25), (A-45)+(B-26), (A-45)+(B-27), (A-45)+(B-28), (A-45)+(B-29), (A-45)+(B-30), (A-45)+(B-31), (A-45)+(B-32), (A-45)+(B-33), (A-45)+(B-34), (A-45)+(B-35), (A-45)+(B-36), (A-45)+(B-37), (A-45)+(B-38), (A-45)+(B-39), (A-45)+(B-40), (A-45)+(B-41), (A-45)+(B-42), (A-45)+(B-43), (A-45)+(B-44), (A-45)+(B-45), (A-45)+(B-46), (A-45)+(B-47), (A-45)+(B-48), (A-45)+(B-49), (A-45)+(B-50), (A-45)+(B-51), (A-45)+(B-52), (A-45)+(B-53), (A-45)+(B-54), (A-45)+(B-55), (A-45)+(B-56), (A-45)+(B-57), (A-45)+(B-58), (A-45)+(B-59), (A-45)+(B-60), (A-45)+(B-61), (A-45)+(B-62), (A-45)+(B-63), (A-45)+(B-64), (A-45)+(B-65), (A-45)+(B-66), (A-45)+(B-67), (A-45)+(B-68), (A-45)+(B-69), (A-45)+(B-70), (A-45)+(B-71), (A-45)+(B-72), (A-45)+(B-73), (A-45)+(B-74), (A-45)+(B-75), (A-45)+(B-76), (A-45)+(B-77), (AI-1)+(B-78), (A-45)+(B-79), (A-45)+(B-80).

(A-46)+(B-1), (A-46)+(B-2), (A-46)+(B-3), (A-46)+(B-4), (A-46)+(B-5), (A-46)+(B-6), (A-46)+(B-7), (A-46)+(B-8), (A-46)+(B-9), (A-46)+(B-10), (A-46)+(B-11), (A-46)+(B-12), (A-46)+(B-13), (A-46)+(B-14), (A-46)+(B-15), (A-46)+(B-16), (A-46)+(B-17), (A-46)+(B-18), (A-46)+(B-19), (A-46)+(B-20), (A-46)+(B-21), (A-46)+(B-22), (A-46)+(B-23), (A-46)+(B-24), (A-46)+(B-25), (A-46)+(B-26), (A-46)+(B-27), (A-46)+(B-28), (A-46)+(B-29), (A-46)+(B-30), (A-46)+(B-31), (A-46)+(B-32), (A-46)+(B-33), (A-46)+(B-34), (A-46)+(B-35), (A-46)+(B-36), (A-46)+(B-37), (A-46)+(B-38), (A-46)+(B-39), (A-46)+(B-40), (A-46)+(B-41), (A-46)+(B-42), (A-46)+(B-43), (A-46)+(B-44), (A-46)+(B-45), (A-46)+(B-46), (A-46)+(B-47), (A-46)+(B-48), (A-46)+(B-49), (A-46)+(B-50), (A-46)+(B-51), (A-46)+(B-52), (A-46)+(B-53), (A-46)+(B-54), (A-46)+(B-55), (A-46)+(B-56), (A-46)+(B-57), (A-46)+(B-58), (A-46)+(B-59), (A-46)+(B-60), (A-46)+(B-61), (A-46)+(B-62), (A-46)+(B-63), (A-46)+(B-64), (A-46)+(B-65), (A-46)+(B-66), (A-46)+(B-67), (A-46)+(B-68), (A-46)+(B-69), (A-46)+(B-70), (A-46)+(B-71), (A-46)+(B-72), (A-46)+(B-73), (A-46)+(B-74), (A-46)+(B-75), (A-46)+(B-76), (A-46)+(B-77), (AI-1)+(B-78), (A-46)+(B-79), (A-46)+(B-80).

(A-47)+(B-1), (A-47)+(B-2), (A-47)+(B-3), (A-47)+(B-4), (A-47)+(B-5), (A-47)+(B-6), (A-47)+(B-7), (A-47)+(B-8), (A-47)+(B-9), (A-47)+(B-10), (A-47)+(B-11), (A-47)+(B-12), (A-47)+(B-13), (A-47)+(B-14), (A-47)+(B-15), (A-47)+(B-16), (A-47)+(B-17), (A-47)+(B-18), (A-47)+(B-19), (A-47)+(B-20), (A-47)+(B-21), (A-47)+(B-22), (A-47)+(B-23), (A-47)+(B-24), (A-47)+(B-25), (A-47)+(B-26), (A-47)+(B-27), (A-47)+(B-28), (A-47)+(B-29), (A-47)+(B-30), (A-47)+(B-31), (A-47)+(B-32), (A-47)+(B-33), (A-47)+(B-34), (A-47)+(B-35), (A-47)+(B-36), (A-47)+(B-37), (A-47)+(B-38), (A-47)+(B-39), (A-47)+(B-40), (A-47)+(B-41), (A-47)+(B-42), (A-47)+(B-43), (A-47)+(B-44), (A-47)+(B-45), (A-47)+(B-46), (A-47)+(B-47), (A-47)+(B-48), (A-47)+(B-49), (A-47)+(B-50), (A-47)+(B-51), (A-47)+(B-52), (A-47)+(B-53), (A-47)+(B-54), (A-47)+(B-55), (A-47)+(B-56), (A-47)+(B-57), (A-47)+(B-58), (A-47)+(B-59), (A-47)+(B-60), (A-47)+(B-61), (A-47)+(B-62), (A-47)+(B-63), (A-47)+(B-64), (A-47)+(B-65), (A-47)+(B-66), (A-47)+(B-67), (A-47)+(B-68), (A-47)+(B-69), (A-47)+(B-70), (A-47)+(B-71), (A-47)+(B-72), (A-47)+(B-73), (A-47)+(B-74), (A-47)+(B-75), (A-47)+(B-76), (A-47)+(B-77), (AI-1)+(B-78), (A-47)+(B-79), (A-47)+(B-80).

(A-48)+(B-1), (A-48)+(B-2), (A-48)+(B-3), (A-48)+(B-4), (A-48)+(B-5), (A-48)+(B-6), (A-48)+(B-7), (A-48)+(B-8), (A-48)+(B-9), (A-48)+(B-10), (A-48)+(B-11), (A-48)+(B-12), (A-48)+(B-13), (A-48)+(B-14), (A-48)+(B-15), (A-48)+(B-16), (A-48)+(B-17), (A-48)+(B-18), (A-48)+(B-19), (A-48)+(B-20), (A-48)+(B-21), (A-48)+(B-22), (A-48)+(B-23), (A-48)+(B-24), (A-48)+(B-25), (A-48)+(B-26), (A-48)+(B-27), (A-48)+(B-28), (A-48)+(B-29), (A-48)+(B-30), (A-48)+(B-31), (A-48)+(B-32), (A-48)+(B-33), (A-48)+(B-34), (A-48)+(B-35), (A-48)+(B-36), (A-48)+(B-37), (A-48)+(B-38), (A-48)+(B-39), (A-48)+(B-40), (A-48)+(B-41), (A-48)+(B-42), (A-48)+(B-43), (A-48)+(B-44), (A-48)+(B-45), (A-48)+(B-46), (A-48)+(B-47), (A-48)+(B-48), (A-48)+(B-49), (A-48)+(B-50), (A-48)+(B-51), (A-48)+(B-52), (A-48)+(B-53), (A-48)+(B-54), (A-48)+(B-55), (A-48)+(B-56), (A-48)+(B-57), (A-48)+(B-58), (A-48)+(B-59), (A-48)+(B-60), (A-48)+(B-61), (A-48)+(B-62), (A-48)+(B-63), (A-48)+(B-64), (A-48)+(B-65), (A-48)+(B-66), (A-48)+(B-67), (A-48)+(B-68), (A-48)+(B-69), (A-48)+(B-70), (A-48)+(B-71), (A-48)+(B-72), (A-48)+(B-73), (A-48)+(B-74), (A-48)+(B-75), (A-48)+(B-76), (A-48)+(B-77), (AI-1)+(B-78), (A-48)+(B-79), (A-48)+(B-80).

(A-49)+(B-1), (A-49)+(B-2), (A-49)+(B-3), (A-49)+(B-4), (A-49)+(B-5), (A-49)+(B-6), (A-49)+(B-7), (A-49)+(B-8), (A-49)+(B-9), (A-49)+(B-10), (A-49)+(B-11), (A-49)+(B-12), (A-49)+(B-13), (A-49)+(B-14), (A-49)+(B-15), (A-49)+(B-16), (A-49)+(B-17), (A-49)+(B-18), (A-49)+(B-19), (A-49)+(B-20), (A-49)+(B-21), (A-49)+(B-22), (A-49)+(B-23), (A-49)+(B-24), (A-49)+(B-25), (A-49)+(B-26), (A-49)+(B-27), (A-49)+(B-28), (A-49)+(B-29), (A-49)+(B-30), (A-49)+(B-31), (A-49)+(B-32), (A-49)+(B-33), (A-49)+(B-34), (A-49)+(B-35), (A-49)+(B-36), (A-49)+(B-37), (A-49)+(B-38), (A-49)+(B-39), (A-49)+(B-40), (A-49)+(B-41), (A-49)+(B-42), (A-49)+(B-43), (A-49)+(B-44), (A-49)+(B-45), (A-49)+(B-46), (A-49)+(B-47), (A-49)+(B-48), (A-49)+(B-49), (A-49)+(B-50), (A-49)+(B-51), (A-49)+(B-52), (A-49)+(B-53), (A-49)+(B-54), (A-49)+(B-55), (A-49)+(B-56), (A-49)+(B-57), (A-49)+(B-58), (A-49)+(B-59), (A-49)+(B-60), (A-49)+(B-61), (A-49)+(B-62), (A-49)+(B-63), (A-49)+(B-64), (A-49)+(B-65), (A-49)+(B-66), (A-49)+(B-67), (A-49)+(B-68), (A-49)+(B-69), (A-49)+(B-70), (A-49)+(B-71), (A-49)+(B-72), (A-49)+(B-73), (A-49)+(B-74), (A-49)+(B-75), (A-49)+(B-76), (A-49)+(B-77), (AI-1)+(B-78), (A-49)+(B-79), (A-49)+(B-80).

(A-50)+(B-1), (A-50)+(B-2), (A-50)+(B-3), (A-50)+(B-4), (A-50)+(B-5), (A-50)+(B-6), (A-50)+(B-7), (A-50)+(B-8), (A-50)+(B-9), (A-50)+(B-10), (A-50)+(B-11), (A-50)+(B-12), (A-50)+(B-13), (A-50)+(B-14), (A-50)+(B-15), (A-50)+(B-16), (A-50)+(B-17), (A-50)+(B-18), (A-50)+(B-19), (A-50)+(B-20), (A-50)+(B-21), (A-50)+(B-22), (A-50)+(B-23), (A-50)+(B-24), (A-50)+(B-25), (A-50)+(B-26), (A-50)+(B-27), (A-50)+(B-28), (A-50)+(B-29), (A-50)+(B-30), (A-50)+(B-31), (A-50)+(B-32), (A-50)+(B-33), (A-50)+(B-34), (A-50)+(B-35), (A-50)+(B-36), (A-50)+(B-37), (A-50)+(B-38), (A-50)+(B-39), (A-50)+(B-40), (A-50)+(B-41), (A-50)+(B-42), (A-50)+(B-43), (A-50)+(B-44), (A-50)+(B-45), (A-50)+(B-46), (A-50)+(B-47), (A-50)+(B-48), (A-50)+(B-49), (A-50)+(B-50), (A-50)+(B-51), (A-50)+(B-52), (A-50)+(B-53), (A-50)+(B-54), (A-50)+(B-55), (A-50)+(B-56), (A-50)+(B-57), (A-50)+(B-58), (A-50)+(B-59), (A-50)+(B-60), (A-50)+(B-61), (A-50)+(B-62), (A-50)+(B-63), (A-50)+(B-64), (A-50)+(B-65), (A-50)+(B-66), (A-50)+(B-67), (A-50)+(B-68), (A-50)+(B-69), (A-50)+(B-70), (A-50)+(B-71), (A-50)+(B-72), (A-50)+(B-73), (A-50)+(B-74), (A-50)+(B-75), (A-50)+(B-76), (A-50)+(B-77), (AI-1)+(B-78), (A-50)+(B-79), (A-50)+(B-80).

(A-51)+(B-1), (A-51)+(B-2), (A-51)+(B-3), (A-51)+(B-4), (A-51)+(B-5), (A-51)+(B-6), (A-51)+(B-7), (A-51)+(B-8), (A-51)+(B-9), (A-51)+(B-10), (A-51)+(B-11), (A-51)+(B-12), (A-51)+(B-13), (A-51)+(B-14), (A-51)+(B-15), (A-51)+(B-16), (A-51)+(B-17), (A-51)+(B-18), (A-51)+(B-19), (A-51)+(B-20), (A-51)+(B-21), (A-51)+(B-22), (A-51)+(B-23), (A-51)+(B-24), (A-51)+(B-25), (A-51)+(B-26), (A-51)+(B-27), (A-51)+(B-28), (A-51)+(B-29), (A-51)+(B-30), (A-51)+(B-31), (A-51)+(B-32), (A-51)+(B-33), (A-51)+(B-34), (A-51)+(B-35), (A-51)+(B-36), (A-51)+(B-37), (A-51)+(B-38), (A-51)+(B-39), (A-51)+(B-40), (A-51)+(B-41), (A-51)+(B-42), (A-51)+(B-43), (A-51)+(B-44), (A-51)+(B-45), (A-51)+(B-46), (A-51)+(B-47), (A-51)+(B-48), (A-51)+(B-49), (A-51)+(B-50), (A-51)+(B-51), (A-51)+(B-52), (A-51)+(B-53), (A-51)+(B-54), (A-51)+(B-55), (A-51)+(B-56), (A-51)+(B-57), (A-51)+(B-58), (A-51)+(B-59), (A-51)+(B-60), (A-51)+(B-61), (A-51)+(B-62), (A-51)+(B-63), (A-51)+(B-64), (A-51)+(B-65), (A-51)+(B-66), (A-51)+(B-67), (A-51)+(B-68), (A-51)+(B-69), (A-51)+(B-70), (A-51)+(B-71), (A-51)+(B-72), (A-51)+(B-73), (A-51)+(B-74), (A-51)+(B-75), (A-51)+(B-76), (A-51)+(B-77), (AI-1)+(B-78), (A-51)+(B-79), (A-51)+(B-80).

(A-52)+(B-1), (A-52)+(B-2), (A-52)+(B-3), (A-52)+(B-4), (A-52)+(B-5), (A-52)+(B-6), (A-52)+(B-7), (A-52)+(B-8), (A-52)+(B-9), (A-52)+(B-10), (A-52)+(B-11), (A-52)+(B-12), (A-52)+(B-13), (A-52)+(B-14), (A-52)+(B-15), (A-52)+(B-16), (A-52)+(B-17), (A-52)+(B-18), (A-52)+(B-19), (A-52)+(B-20), (A-52)+(B-21), (A-52)+(B-22), (A-52)+(B-23), (A-52)+(B-24), (A-52)+(B-25), (A-52)+(B-26), (A-52)+(B-27), (A-52)+(B-28), (A-52)+(B-29), (A-52)+(B-30), (A-52)+(B-31), (A-52)+(B-32), (A-52)+(B-33), (A-52)+(B-34), (A-52)+(B-35), (A-52)+(B-36), (A-52)+(B-37), (A-52)+(B-38), (A-52)+(B-39), (A-52)+(B-40), (A-52)+(B-41), (A-52)+(B-42), (A-52)+(B-43), (A-52)+(B-44), (A-52)+(B-45), (A-52)+(B-46), (A-52)+(B-47), (A-52)+(B-48), (A-52)+(B-49), (A-52)+(B-50), (A-52)+(B-51), (A-52)+(B-52), (A-52)+(B-53), (A-52)+(B-54), (A-52)+(B-55), (A-52)+(B-56), (A-52)+(B-57), (A-52)+(B-58), (A-52)+(B-59), (A-52)+(B-60), (A-52)+(B-61), (A-52)+(B-62), (A-52)+(B-63), (A-52)+(B-64), (A-52)+(B-65), (A-52)+(B-66), (A-52)+(B-67), (A-52)+(B-68), (A-52)+(B-69), (A-52)+(B-70), (A-52)+(B-71), (A-52)+(B-72), (A-52)+(B-73), (A-52)+(B-74), (A-52)+(B-75), (A-52)+(B-76), (A-52)+(B-77), (AI-1)+(B-78), (A-52)+(B-79), (A-52)+(B-80).

(A-53)+(B-1), (A-53)+(B-2), (A-53)+(B-3), (A-53)+(B-4), (A-53)+(B-5), (A-53)+(B-6), (A-53)+(B-7), (A-53)+(B-8), (A-53)+(B-9), (A-53)+(B-10), (A-53)+(B-11), (A-53)+(B-12), (A-53)+(B-13), (A-53)+(B-14), (A-53)+(B-15), (A-53)+(B-16), (A-53)+(B-17), (A-53)+(B-18), (A-53)+(B-19), (A-53)+(B-20), (A-53)+(B-21), (A-53)+(B-22), (A-53)+(B-23), (A-53)+(B-24), (A-53)+(B-25), (A-53)+(B-26), (A-53)+(B-27), (A-53)+(B-28), (A-53)+(B-29), (A-53)+(B-30), (A-53)+(B-31), (A-53)+(B-32), (A-53)+(B-33), (A-53)+(B-34), (A-53)+(B-35), (A-53)+(B-36), (A-53)+(B-37), (A-53)+(B-38), (A-53)+(B-39), (A-53)+(B-40), (A-53)+(B-41), (A-53)+(B-42), (A-53)+(B-43), (A-53)+(B-44), (A-53)+(B-45), (A-53)+(B-46), (A-53)+(B-47), (A-53)+(B-48), (A-53)+(B-49), (A-53)+(B-50), (A-53)+(B-51), (A-53)+(B-52), (A-53)+(B-53), (A-53)+(B-54), (A-53)+(B-55), (A-53)+(B-56), (A-53)+(B-57), (A-53)+(B-58), (A-53)+(B-59), (A-53)+(B-60), (A-53)+(B-61), (A-53)+(B-62), (A-53)+(B-63), (A-53)+(B-64), (A-53)+(B-65), (A-53)+(B-66), (A-53)+(B-67), (A-53)+(B-68), (A-53)+(B-69), (A-53)+(B-70), (A-53)+(B-71), (A-53)+(B-72), (A-53)+(B-73), (A-53)+(B-74), (A-53)+(B-75), (A-53)+(B-76), (A-53)+(B-77), (AI-1)+(B-78), (A-53)+(B-79), (A-53)+(B-80).

(A-54)+(B-1), (A-54)+(B-2), (A-54)+(B-3), (A-54)+(B-4), (A-54)+(B-5), (A-54)+(B-6), (A-54)+(B-7), (A-54)+(B-8), (A-54)+(B-9), (A-54)+(B-10), (A-54)+(B-11), (A-54)+(B-12), (A-54)+(B-13), (A-54)+(B-14), (A-54)+(B-15), (A-54)+(B-16), (A-54)+(B-17), (A-54)+(B-18), (A-54)+(B-19), (A-54)+(B-20), (A-54)+(B-21), (A-54)+(B-22), (A-54)+(B-23), (A-54)+(B-24), (A-54)+(B-25), (A-54)+(B-26), (A-54)+(B-27), (A-54)+(B-28), (A-54)+(B-29), (A-54)+(B-30), (A-54)+(B-31), (A-54)+(B-32), (A-54)+(B-33), (A-54)+(B-34), (A-54)+(B-35), (A-54)+(B-36), (A-54)+(B-37), (A-54)+(B-38), (A-54)+(B-39), (A-54)+(B-40), (A-54)+(B-41), (A-54)+(B-42), (A-54)+(B-43), (A-54)+(B-44), (A-54)+(B-45), (A-54)+(B-46), (A-54)+(B-47), (A-54)+(B-48), (A-54)+(B-49), (A-54)+(B-50), (A-54)+(B-51), (A-54)+(B-52), (A-54)+(B-53), (A-54)+(B-54), (A-54)+(B-55), (A-54)+(B-56), (A-54)+(B-57), (A-54)+(B-58), (A-54)+(B-59), (A-54)+(B-60), (A-54)+(B-61), (A-54)+(B-62), (A-54)+(B-63), (A-54)+(B-64), (A-54)+(B-65), (A-54)+(B-66), (A-54)+(B-67), (A-54)+(B-68), (A-54)+(B-69), (A-54)+(B-70), (A-54)+(B-71), (A-54)+(B-72), (A-54)+(B-73), (A-54)+(B-74), (A-54)+(B-75), (A-54)+(B-76), (A-54)+(B-77), (AI-1)+(B-78), (A-54)+(B-79), (A-54)+(B-80).

(A-55)+(B-1), (A-55)+(B-2), (A-55)+(B-3), (A-55)+(B-4), (A-55)+(B-5), (A-55)+(B-6), (A-55)+(B-7), (A-55)+(B-8), (A-55)+(B-9), (A-55)+(B-10), (A-55)+(B-11), (A-55)+(B-12), (A-55)+(B-13), (A-55)+(B-14), (A-55)+(B-15), (A-55)+(B-16), (A-55)+(B-17), (A-55)+(B-18), (A-55)+(B-19), (A-55)+(B-20), (A-55)+(B-21), (A-55)+(B-22), (A-55)+(B-23), (A-55)+(B-24), (A-55)+(B-25), (A-55)+(B-26), (A-55)+(B-27), (A-55)+(B-28), (A-55)+(B-29), (A-55)+(B-30), (A-55)+(B-31), (A-55)+(B-32), (A-55)+(B-33), (A-55)+(B-34), (A-55)+(B-35), (A-55)+(B-36), (A-55)+(B-37), (A-55)+(B-38), (A-55)+(B-39), (A-55)+(B-40), (A-55)+(B-41), (A-55)+(B-42), (A-55)+(B-43), (A-55)+(B-44), (A-55)+(B-45), (A-55)+(B-46), (A-55)+(B-47), (A-55)+(B-48), (A-55)+(B-49), (A-55)+(B-50), (A-55)+(B-51), (A-55)+(B-52), (A-55)+(B-53), (A-55)+(B-54), (A-55)+(B-55), (A-55)+(B-56), (A-55)+(B-57), (A-55)+(B-58), (A-55)+(B-59), (A-55)+(B-60), (A-55)+(B-61), (A-55)+(B-62), (A-55)+(B-63), (A-55)+(B-64), (A-55)+(B-65), (A-55)+(B-66), (A-55)+(B-67), (A-55)+(B-68), (A-55)+(B-69), (A-55)+(B-70), (A-55)+(B-71), (A-55)+(B-72), (A-55)+(B-73), (A-55)+(B-74), (A-55)+(B-75), (A-55)+(B-76), (A-55)+(B-77), (AI-1)+(B-78), (A-55)+(B-79), (A-55)+(B-80).

(A-56)+(B-1), (A-56)+(B-2), (A-56)+(B-3), (A-56)+(B-4), (A-56)+(B-5), (A-56)+(B-6), (A-56)+(B-7), (A-56)+(B-8), (A-56)+(B-9), (A-56)+(B-10), (A-56)+(B-11), (A-56)+(B-12), (A-56)+(B-13), (A-56)+(B-14), (A-56)+(B-15), (A-56)+(B-16), (A-56)+(B-17), (A-56)+(B-18), (A-56)+(B-19), (A-56)+(B-20), (A-56)+(B-21), (A-56)+(B-22), (A-56)+(B-23), (A-56)+(B-24), (A-56)+(B-25), (A-56)+(B-26), (A-56)+(B-27), (A-56)+(B-28), (A-56)+(B-29), (A-56)+(B-30), (A-56)+(B-31), (A-56)+(B-32), (A-56)+(B-33), (A-56)+(B-34), (A-56)+(B-35), (A-56)+(B-36), (A-56)+(B-37), (A-56)+(B-38), (A-56)+(B-39), (A-56)+(B-40), (A-56)+(B-41), (A-56)+(B-42), (A-56)+(B-43), (A-56)+(B-44), (A-56)+(B-45), (A-56)+(B-46), (A-56)+(B-47), (A-56)+(B-48), (A-56)+(B-49), (A-56)+(B-50), (A-56)+(B-51), (A-56)+(B-52), (A-56)+(B-53), (A-56)+(B-54), (A-56)+(B-55), (A-56)+(B-56), (A-56)+(B-57), (A-56)+(B-58), (A-56)+(B-59), (A-56)+(B-60), (A-56)+(B-61), (A-56)+(B-62), (A-56)+(B-63), (A-56)+(B-64), (A-56)+(B-65), (A-56)+(B-66), (A-56)+(B-67), (A-56)+(B-68), (A-56)+(B-69), (A-56)+(B-70), (A-56)+(B-71), (A-56)+(B-72), (A-56)+(B-73), (A-56)+(B-74), (A-56)+(B-75), (A-56)+(B-76), (A-56)+(B-77), (AI-1)+(B-78), (A-56)+(B-79), (A-56)+(B-80).

(A-57)+(B-1), (A-57)+(B-2), (A-57)+(B-3), (A-57)+(B-4), (A-57)+(B-5), (A-57)+(B-6), (A-57)+(B-7), (A-57)+(B-8), (A-57)+(B-9), (A-57)+(B-10), (A-57)+(B-11), (A-57)+(B-12), (A-57)+(B-13), (A-57)+(B-14), (A-57)+(B-15), (A-57)+(B-16), (A-57)+(B-17), (A-57)+(B-18), (A-57)+(B-19), (A-57)+(B-20), (A-57)+(B-21), (A-57)+(B-22), (A-57)+(B-23), (A-57)+(B-24), (A-57)+(B-25), (A-57)+(B-26), (A-57)+(B-27), (A-57)+(B-28), (A-57)+(B-29), (A-57)+(B-30), (A-57)+(B-31), (A-57)+(B-32), (A-57)+(B-33), (A-57)+(B-34), (A-57)+(B-35), (A-57)+(B-36), (A-57)+(B-37), (A-57)+(B-38), (A-57)+(B-39), (A-57)+(B-40), (A-57)+(B-41), (A-57)+(B-42), (A-57)+(B-43), (A-57)+(B-44), (A-57)+(B-45), (A-57)+(B-46), (A-57)+(B-47), (A-57)+(B-48), (A-57)+(B-49), (A-57)+(B-50), (A-57)+(B-51), (A-57)+(B-52), (A-57)+(B-53), (A-57)+(B-54), (A-57)+(B-55), (A-57)+(B-56), (A-57)+(B-57), (A-57)+(B-58), (A-57)+(B-59), (A-57)+(B-60), (A-57)+(B-61), (A-57)+(B-62), (A-57)+(B-63), (A-57)+(B-64), (A-57)+(B-65), (A-57)+(B-66), (A-57)+(B-67), (A-57)+(B-68), (A-57)+(B-69), (A-57)+(B-70), (A-57)+(B-71), (A-57)+(B-72), (A-57)+(B-73), (A-57)+(B-74), (A-57)+(B-75), (A-57)+(B-76), (A-57)+(B-77), (AI-1)+(B-78), (A-57)+(B-79), (A-57)+(B-80).

(A-58)+(B-1), (A-58)+(B-2), (A-58)+(B-3), (A-58)+(B-4), (A-58)+(B-5), (A-58)+(B-6), (A-58)+(B-7), (A-58)+(B-8), (A-58)+(B-9), (A-58)+(B-10), (A-58)+(B-11), (A-58)+(B-12), (A-58)+(B-13), (A-58)+(B-14), (A-58)+(B-15), (A-58)+(B-16), (A-58)+(B-17), (A-58)+(B-18), (A-58)+(B-19), (A-58)+(B-20), (A-58)+(B-21), (A-58)+(B-22), (A-58)+(B-23), (A-58)+(B-24), (A-58)+(B-25), (A-58)+(B-26), (A-58)+(B-27), (A-58)+(B-28), (A-58)+(B-29), (A-58)+(B-30), (A-58)+(B-31), (A-58)+(B-32), (A-58)+(B-33), (A-58)+(B-34), (A-58)+(B-35), (A-58)+(B-36), (A-58)+(B-37), (A-58)+(B-38), (A-58)+(B-39), (A-58)+(B-40), (A-58)+(B-41), (A-58)+(B-42), (A-58)+(B-43), (A-58)+(B-44), (A-58)+(B-45), (A-58)+(B-46), (A-58)+(B-47), (A-58)+(B-48), (A-58)+(B-49), (A-58)+(B-50), (A-58)+(B-51), (A-58)+(B-52), (A-58)+(B-53), (A-58)+(B-54), (A-58)+(B-55), (A-58)+(B-56), (A-58)+(B-57), (A-58)+(B-58), (A-58)+(B-59), (A-58)+(B-60), (A-58)+(B-61), (A-58)+(B-62), (A-58)+(B-63), (A-58)+(B-64), (A-58)+(B-65), (A-58)+(B-66), (A-58)+(B-67), (A-58)+(B-68), (A-58)+(B-69), (A-58)+(B-70), (A-58)+(B-71), (A-58)+(B-72), (A-58)+(B-73), (A-58)+(B-74), (A-58)+(B-75), (A-58)+(B-76), (A-58)+(B-77), (AI-1)+(B-78), (A-58)+(B-79), (A-58)+(B-80).

(A-59)+(B-1), (A-59)+(B-2), (A-59)+(B-3), (A-59)+(B-4), (A-59)+(B-5), (A-59)+(B-6), (A-59)+(B-7), (A-59)+(B-8), (A-59)+(B-9), (A-59)+(B-10), (A-59)+(B-11), (A-59)+(B-12), (A-59)+(B-13), (A-59)+(B-14), (A-59)+(B-15), (A-59)+(B-16), (A-59)+(B-17), (A-59)+(B-18), (A-59)+(B-19), (A-59)+(B-20), (A-59)+(B-21), (A-59)+(B-22), (A-59)+(B-23), (A-59)+(B-24), (A-59)+(B-25), (A-59)+(B-26), (A-59)+(B-27), (A-59)+(B-28), (A-59)+(B-29), (A-59)+(B-30), (A-59)+(B-31), (A-59)+(B-32), (A-59)+(B-33), (A-59)+(B-34), (A-59)+(B-35), (A-59)+(B-36), (A-59)+(B-37), (A-59)+(B-38), (A-59)+(B-39), (A-59)+(B-40), (A-59)+(B-41), (A-59)+(B-42), (A-59)+(B-43), (A-59)+(B-44), (A-59)+(B-45), (A-59)+(B-46), (A-59)+(B-47), (A-59)+(B-48), (A-59)+(B-49), (A-59)+(B-50), (A-59)+(B-51), (A-59)+(B-52), (A-59)+(B-53), (A-59)+(B-54), (A-59)+(B-55), (A-59)+(B-56), (A-59)+(B-57), (A-59)+(B-58), (A-59)+(B-59), (A-59)+(B-60), (A-59)+(B-61), (A-59)+(B-62), (A-59)+(B-63), (A-59)+(B-64), (A-59)+(B-65), (A-59)+(B-66), (A-59)+(B-67), (A-59)+(B-68), (A-59)+(B-69), (A-59)+(B-70), (A-59)+(B-71), (A-59)+(B-72), (A-59)+(B-73), (A-59)+(B-74), (A-59)+(B-75), (A-59)+(B-76), (A-59)+(B-77), (AI-1)+(B-78), (A-59)+(B-79), (A-59)+(B-80).

(A-60)+(B-1), (A-60)+(B-2), (A-60)+(B-3), (A-60)+(B-4), (A-60)+(B-5), (A-60)+(B-6), (A-60)+(B-7), (A-60)+(B-8), (A-60)+(B-9), (A-60)+(B-10), (A-60)+(B-11), (A-60)+(B-12), (A-60)+(B-13), (A-60)+(B-14), (A-60)+(B-15), (A-60)+(B-16), (A-60)+(B-17), (A-60)+(B-18), (A-60)+(B-19), (A-60)+(B-20), (A-60)+(B-21), (A-60)+(B-22), (A-60)+(B-23), (A-60)+(B-24), (A-60)+(B-25), (A-60)+(B-26), (A-60)+(B-27), (A-60)+(B-28), (A-60)+(B-29), (A-60)+(B-30), (A-60)+(B-31), (A-60)+(B-32), (A-60)+(B-33), (A-60)+(B-34), (A-60)+(B-35), (A-60)+(B-36), (A-60)+(B-37), (A-60)+(B-38), (A-60)+(B-39), (A-60)+(B-40), (A-60)+(B-41), (A-60)+(B-42), (A-60)+(B-43), (A-60)+(B-44), (A-60)+(B-45), (A-60)+(B-46), (A-60)+(B-47), (A-60)+(B-48), (A-60)+(B-49), (A-60)+(B-50), (A-60)+(B-51), (A-60)+(B-52), (A-60)+(B-53), (A-60)+(B-54), (A-60)+(B-55), (A-60)+(B-56), (A-60)+(B-57), (A-60)+(B-58), (A-60)+(B-59), (A-60)+(B-60), (A-60)+(B-61), (A-60)+(B-62), (A-60)+(B-63), (A-60)+(B-64), (A-60)+(B-65), (A-60)+(B-66), (A-60)+(B-67), (A-60)+(B-68), (A-60)+(B-69), (A-60)+(B-70), (A-60)+(B-71), (A-60)+(B-72), (A-60)+(B-73), (A-60)+(B-74), (A-60)+(B-75), (A-60)+(B-76), (A-60)+(B-77), (AI-1)+(B-78), (A-60)+(B-79), (A-60)+(B-80).

(A-61)+(B-1), (A-61)+(B-2), (A-61)+(B-3), (A-61)+(B-4), (A-61)+(B-5), (A-61)+(B-6), (A-61)+(B-7), (A-61)+(B-8), (A-61)+(B-9), (A-61)+(B-10), (A-61)+(B-11), (A-61)+(B-12), (A-61)+(B-13), (A-61)+(B-14), (A-61)+(B-15), (A-61)+(B-16), (A-61)+(B-17), (A-61)+(B-18), (A-61)+(B-19), (A-61)+(B-20), (A-61)+(B-21), (A-61)+(B-22), (A-61)+(B-23), (A-61)+(B-24), (A-61)+(B-25), (A-61)+(B-26), (A-61)+(B-27), (A-61)+(B-28), (A-61)+(B-29), (A-61)+(B-30), (A-61)+(B-31), (A-61)+(B-32), (A-61)+(B-33), (A-61)+(B-34), (A-61)+(B-35), (A-61)+(B-36), (A-61)+(B-37), (A-61)+(B-38), (A-61)+(B-39), (A-61)+(B-40), (A-61)+(B-41), (A-61)+(B-42), (A-61)+(B-43), (A-61)+(B-44), (A-61)+(B-45), (A-61)+(B-46), (A-61)+(B-47), (A-61)+(B-48), (A-61)+(B-49), (A-61)+(B-50), (A-61)+(B-51), (A-61)+(B-52), (A-61)+(B-53), (A-61)+(B-54), (A-61)+(B-55), (A-61)+(B-56), (A-61)+(B-57), (A-61)+(B-58), (A-61)+(B-59), (A-61)+(B-60), (A-61)+(B-61), (A-61)+(B-62), (A-61)+(B-63), (A-61)+(B-64), (A-61)+(B-65), (A-61)+(B-66), (A-61)+(B-67), (A-61)+(B-68), (A-61)+(B-69), (A-61)+(B-70), (A-61)+(B-71), (A-61)+(B-72), (A-61)+(B-73), (A-61)+(B-74), (A-61)+(B-75), (A-61)+(B-76), (A-61)+(B-77), (AI-1)+(B-78), (A-61)+(B-79), (A-61)+(B-80).

(A-62)+(B-1), (A-62)+(B-2), (A-62)+(B-3), (A-62)+(B-4), (A-62)+(B-5), (A-62)+(B-6), (A-62)+(B-7), (A-62)+(B-8), (A-62)+(B-9), (A-62)+(B-10), (A-62)+(B-11), (A-62)+(B-12), (A-62)+(B-13), (A-62)+(B-14), (A-62)+(B-15), (A-62)+(B-16), (A-62)+(B-17), (A-62)+(B-18), (A-62)+(B-19), (A-62)+(B-20), (A-62)+(B-21), (A-62)+(B-22), (A-62)+(B-23), (A-62)+(B-24), (A-62)+(B-25), (A-62)+(B-26), (A-62)+(B-27), (A-62)+(B-28), (A-62)+(B-29), (A-62)+(B-30), (A-62)+(B-31), (A-62)+(B-32), (A-62)+(B-33), (A-62)+(B-34), (A-62)+(B-35), (A-62)+(B-36), (A-62)+(B-37), (A-62)+(B-38), (A-62)+(B-39), (A-62)+(B-40), (A-62)+(B-41), (A-62)+(B-42), (A-62)+(B-43), (A-62)+(B-44), (A-62)+(B-45), (A-62)+(B-46), (A-62)+(B-47), (A-62)+(B-48), (A-62)+(B-49), (A-62)+(B-50), (A-62)+(B-51), (A-62)+(B-52), (A-62)+(B-53), (A-62)+(B-54), (A-62)+(B-55), (A-62)+(B-56), (A-62)+(B-57), (A-62)+(B-58), (A-62)+(B-59), (A-62)+(B-60), (A-62)+(B-61), (A-62)+(B-62), (A-62)+(B-63), (A-62)+(B-64), (A-62)+(B-65), (A-62)+(B-66), (A-62)+(B-67), (A-62)+(B-68), (A-62)+(B-69), (A-62)+(B-70), (A-62)+(B-71), (A-62)+(B-72), (A-62)+(B-73), (A-62)+(B-74), (A-62)+(B-75), (A-62)+(B-76), (A-62)+(B-77), (AI-1)+(B-78), (A-62)+(B-79), (A-62)+(B-80).

(A-63)+(B-1), (A-63)+(B-2), (A-63)+(B-3), (A-63)+(B-4), (A-63)+(B-5), (A-63)+(B-6), (A-63)+(B-7), (A-63)+(B-8), (A-63)+(B-9), (A-63)+(B-10), (A-63)+(B-11), (A-63)+(B-12), (A-63)+(B-13), (A-63)+(B-14), (A-63)+(B-15), (A-63)+(B-16), (A-63)+(B-17), (A-63)+(B-18), (A-63)+(B-19), (A-63)+(B-20), (A-63)+(B-21), (A-63)+(B-22), (A-63)+(B-23), (A-63)+(B-24), (A-63)+(B-25), (A-63)+(B-26), (A-63)+(B-27), (A-63)+(B-28), (A-63)+(B-29), (A-63)+(B-30), (A-63)+(B-31), (A-63)+(B-32), (A-63)+(B-33), (A-63)+(B-34), (A-63)+(B-35), (A-63)+(B-36), (A-63)+(B-37), (A-63)+(B-38), (A-63)+(B-39), (A-63)+(B-40), (A-63)+(B-41), (A-63)+(B-42), (A-63)+(B-43), (A-63)+(B-44), (A-63)+(B-45), (A-63)+(B-46), (A-63)+(B-47), (A-63)+(B-48), (A-63)+(B-49), (A-63)+(B-50), (A-63)+(B-51), (A-63)+(B-52), (A-63)+(B-53), (A-63)+(B-54), (A-63)+(B-55), (A-63)+(B-56), (A-63)+(B-57), (A-63)+(B-58), (A-63)+(B-59), (A-63)+(B-60), (A-63)+(B-61), (A-63)+(B-62), (A-63)+(B-63), (A-63)+(B-64), (A-63)+(B-65), (A-63)+(B-66), (A-63)+(B-67), (A-63)+(B-68), (A-63)+(B-69), (A-63)+(B-70), (A-63)+(B-71), (A-63)+(B-72), (A-63)+(B-73), (A-63)+(B-74), (A-63)+(B-75), (A-63)+(B-76), (A-63)+(B-77), (AI-1)+(B-78), (A-63)+(B-79), (A-63)+(B-80).

(A-64)+(B-1), (A-64)+(B-2), (A-64)+(B-3), (A-64)+(B-4), (A-64)+(B-5), (A-64)+(B-6), (A-64)+(B-7), (A-64)+(B-8), (A-64)+(B-9), (A-64)+(B-10), (A-64)+(B-11), (A-64)+(B-12), (A-64)+(B-13), (A-64)+(B-14), (A-64)+(B-15), (A-64)+(B-16), (A-64)+(B-17), (A-64)+(B-18), (A-64)+(B-19), (A-64)+(B-20), (A-64)+(B-21), (A-64)+(B-22), (A-64)+(B-23), (A-64)+(B-24), (A-64)+(B-25), (A-64)+(B-26), (A-64)+(B-27), (A-64)+(B-28), (A-64)+(B-29), (A-64)+(B-30), (A-64)+(B-31), (A-64)+(B-32), (A-64)+(B-33), (A-64)+(B-34), (A-64)+(B-35), (A-64)+(B-36), (A-64)+(B-37), (A-64)+(B-38), (A-64)+(B-39), (A-64)+(B-40), (A-64)+(B-41), (A-64)+(B-42), (A-64)+(B-43), (A-64)+(B-44), (A-64)+(B-45), (A-64)+(B-46), (A-64)+(B-47), (A-64)+(B-48), (A-64)+(B-49), (A-64)+(B-50), (A-64)+(B-51), (A-64)+(B-52), (A-64)+(B-53), (A-64)+(B-54), (A-64)+(B-55), (A-64)+(B-56), (A-64)+(B-57), (A-64)+(B-58), (A-64)+(B-59), (A-64)+(B-60), (A-64)+(B-61), (A-64)+(B-62), (A-64)+(B-63), (A-64)+(B-64), (A-64)+(B-65), (A-64)+(B-66), (A-64)+(B-67), (A-64)+(B-68), (A-64)+(B-69), (A-64)+(B-70), (A-64)+(B-71), (A-64)+(B-72), (A-64)+(B-73), (A-64)+(B-74), (A-64)+(B-75), (A-64)+(B-76), (A-64)+(B-77), (AI-1)+(B-78), (A-64)+(B-79), (A-64)+(B-80).

(A-65)+(B-1), (A-65)+(B-2), (A-65)+(B-3), (A-65)+(B-4), (A-65)+(B-5), (A-65)+(B-6), (A-65)+(B-7), (A-65)+(B-8), (A-65)+(B-9), (A-65)+(B-10), (A-65)+(B-11), (A-65)+(B-12), (A-65)+(B-13), (A-65)+(B-14), (A-65)+(B-15), (A-65)+(B-16), (A-65)+(B-17), (A-65)+(B-18), (A-65)+(B-19), (A-65)+(B-20), (A-65)+(B-21), (A-65)+(B-22), (A-65)+(B-23), (A-65)+(B-24), (A-65)+(B-25), (A-65)+(B-26), (A-65)+(B-27), (A-65)+(B-28), (A-65)+(B-29), (A-65)+(B-30), (A-65)+(B-31), (A-65)+(B-32), (A-65)+(B-33), (A-65)+(B-34), (A-65)+(B-35), (A-65)+(B-36), (A-65)+(B-37), (A-65)+(B-38), (A-65)+(B-39), (A-65)+(B-40), (A-65)+(B-41), (A-65)+(B-42), (A-65)+(B-43), (A-65)+(B-44), (A-65)+(B-45), (A-65)+(B-46), (A-65)+(B-47), (A-65)+(B-48), (A-65)+(B-49), (A-65)+(B-50), (A-65)+(B-51), (A-65)+(B-52), (A-65)+(B-53), (A-65)+(B-54), (A-65)+(B-55), (A-65)+(B-56), (A-65)+(B-57), (A-65)+(B-58), (A-65)+(B-59), (A-65)+(B-60), (A-65)+(B-61), (A-65)+(B-62), (A-65)+(B-63), (A-65)+(B-64), (A-65)+(B-65), (A-65)+(B-66), (A-65)+(B-67), (A-65)+(B-68), (A-65)+(B-69), (A-65)+(B-70), (A-65)+(B-71), (A-65)+(B-72), (A-65)+(B-73), (A-65)+(B-74), (A-65)+(B-75), (A-65)+(B-76), (A-65)+(B-77), (AI-1)+(B-78), (A-65)+(B-79), (A-65)+(B-80).

(A-66)+(B-1), (A-66)+(B-2), (A-66)+(B-3), (A-66)+(B-4), (A-66)+(B-5), (A-66)+(B-6), (A-66)+(B-7), (A-66)+(B-8), (A-66)+(B-9), (A-66)+(B-10), (A-66)+(B-11), (A-66)+(B-12), (A-66)+(B-13), (A-66)+(B-14), (A-66)+(B-15), (A-66)+(B-16), (A-66)+(B-17), (A-66)+(B-18), (A-66)+(B-19), (A-66)+(B-20), (A-66)+(B-21), (A-66)+(B-22), (A-66)+(B-23), (A-66)+(B-24), (A-66)+(B-25), (A-66)+(B-26), (A-66)+(B-27), (A-66)+(B-28), (A-66)+(B-29), (A-66)+(B-30), (A-66)+(B-31), (A-66)+(B-32), (A-66)+(B-33), (A-66)+(B-34), (A-66)+(B-35), (A-66)+(B-36), (A-66)+(B-37), (A-66)+(B-38), (A-66)+(B-39), (A-66)+(B-40), (A-66)+(B-41), (A-66)+(B-42), (A-66)+(B-43), (A-66)+(B-44), (A-66)+(B-45), (A-66)+(B-46), (A-66)+(B-47), (A-66)+(B-48), (A-66)+(B-49), (A-66)+(B-50), (A-66)+(B-51), (A-66)+(B-52), (A-66)+(B-53), (A-66)+(B-54), (A-66)+(B-55), (A-66)+(B-56), (A-66)+(B-57), (A-66)+(B-58), (A-66)+(B-59), (A-66)+(B-60), (A-66)+(B-61), (A-66)+(B-62), (A-66)+(B-63), (A-66)+(B-64), (A-66)+(B-65), (A-66)+(B-66), (A-66)+(B-67), (A-66)+(B-68), (A-66)+(B-69), (A-66)+(B-70), (A-66)+(B-71), (A-66)+(B-72), (A-66)+(B-73), (A-66)+(B-74), (A-66)+(B-75), (A-66)+(B-76), (A-66)+(B-77), (AI-1)+(B-78), (A-66)+(B-79), (A-66)+(B-80).

(A-67)+(B-1), (A-67)+(B-2), (A-67)+(B-3), (A-67)+(B-4), (A-67)+(B-5), (A-67)+(B-6), (A-67)+(B-7), (A-67)+(B-8), (A-67)+(B-9), (A-67)+(B-10), (A-67)+(B-11), (A-67)+(B-12), (A-67)+(B-13), (A-67)+(B-14), (A-67)+(B-15), (A-67)+(B-16), (A-67)+(B-17), (A-67)+(B-18), (A-67)+(B-19), (A-67)+(B-20), (A-67)+(B-21), (A-67)+(B-22), (A-67)+(B-23), (A-67)+(B-24), (A-67)+(B-25), (A-67)+(B-26), (A-67)+(B-27), (A-67)+(B-28), (A-67)+(B-29), (A-67)+(B-30), (A-67)+(B-31), (A-67)+(B-32), (A-67)+(B-33), (A-67)+(B-34), (A-67)+(B-35), (A-67)+(B-36), (A-67)+(B-37), (A-67)+(B-38), (A-67)+(B-39), (A-67)+(B-40), (A-67)+(B-41), (A-67)+(B-42), (A-67)+(B-43), (A-67)+(B-44), (A-67)+(B-45), (A-67)+(B-46), (A-67)+(B-47), (A-67)+(B-48), (A-67)+(B-49), (A-67)+(B-50), (A-67)+(B-51), (A-67)+(B-52), (A-67)+(B-53), (A-67)+(B-54), (A-67)+(B-55), (A-67)+(B-56), (A-67)+(B-57), (A-67)+(B-58), (A-67)+(B-59), (A-67)+(B-60), (A-67)+(B-61), (A-67)+(B-62), (A-67)+(B-63), (A-67)+(B-64), (A-67)+(B-65), (A-67)+(B-66), (A-67)+(B-67), (A-67)+(B-68), (A-67)+(B-69), (A-67)+(B-70), (A-67)+(B-71), (A-67)+(B-72), (A-67)+(B-73), (A-67)+(B-74), (A-67)+(B-75), (A-67)+(B-76), (A-67)+(B-77), (AI-1)+(B-78), (A-67)+(B-79), (A-67)+(B-80).

(A-68)+(B-1), (A-68)+(B-2), (A-68)+(B-3), (A-68)+(B-4), (A-68)+(B-5), (A-68)+(B-6), (A-68)+(B-7), (A-68)+(B-8), (A-68)+(B-9), (A-68)+(B-10), (A-68)+(B-11), (A-68)+(B-12), (A-68)+(B-13), (A-68)+(B-14), (A-68)+(B-15), (A-68)+(B-16), (A-68)+(B-17), (A-68)+(B-18), (A-68)+(B-19), (A-68)+(B-20), (A-68)+(B-21), (A-68)+(B-22), (A-68)+(B-23), (A-68)+(B-24), (A-68)+(B-25), (A-68)+(B-26), (A-68)+(B-27), (A-68)+(B-28), (A-68)+(B-29), (A-68)+(B-30), (A-68)+(B-31), (A-68)+(B-32), (A-68)+(B-33), (A-68)+(B-34), (A-68)+(B-35), (A-68)+(B-36), (A-68)+(B-37), (A-68)+(B-38), (A-68)+(B-39), (A-68)+(B-40), (A-68)+(B-41), (A-68)+(B-42), (A-68)+(B-43), (A-68)+(B-44), (A-68)+(B-45), (A-68)+(B-46), (A-68)+(B-47), (A-68)+(B-48), (A-68)+(B-49), (A-68)+(B-50), (A-68)+(B-51), (A-68)+(B-52), (A-68)+(B-53), (A-68)+(B-54), (A-68)+(B-55), (A-68)+(B-56), (A-68)+(B-57), (A-68)+(B-58), (A-68)+(B-59), (A-68)+(B-60), (A-68)+(B-61), (A-68)+(B-62), (A-68)+(B-63), (A-68)+(B-64), (A-68)+(B-65), (A-68)+(B-66), (A-68)+(B-67), (A-68)+(B-68), (A-68)+(B-69), (A-68)+(B-70), (A-68)+(B-71), (A-68)+(B-72), (A-68)+(B-73), (A-68)+(B-74), (A-68)+(B-75), (A-68)+(B-76), (A-68)+(B-77), (AI-1)+(B-78), (A-68)+(B-79), (A-68)+(B-80).

(A-69)+(B-1), (A-69)+(B-2), (A-69)+(B-3), (A-69)+(B-4), (A-69)+(B-5), (A-69)+(B-6), (A-69)+(B-7), (A-69)+(B-8), (A-69)+(B-9), (A-69)+(B-10), (A-69)+(B-11), (A-69)+(B-12), (A-69)+(B-13), (A-69)+(B-14), (A-69)+(B-15), (A-69)+(B-16), (A-69)+(B-17), (A-69)+(B-18), (A-69)+(B-19), (A-69)+(B-20), (A-69)+(B-21), (A-69)+(B-22), (A-69)+(B-23), (A-69)+(B-24), (A-69)+(B-25), (A-69)+(B-26), (A-69)+(B-27), (A-69)+(B-28), (A-69)+(B-29), (A-69)+(B-30), (A-69)+(B-31), (A-69)+(B-32), (A-69)+(B-33), (A-69)+(B-34), (A-69)+(B-35), (A-69)+(B-36), (A-69)+(B-37), (A-69)+(B-38), (A-69)+(B-39), (A-69)+(B-40), (A-69)+(B-41), (A-69)+(B-42), (A-69)+(B-43), (A-69)+(B-44), (A-69)+(B-45), (A-69)+(B-46), (A-69)+(B-47), (A-69)+(B-48), (A-69)+(B-49), (A-69)+(B-50), (A-69)+(B-51), (A-69)+(B-52), (A-69)+(B-53), (A-69)+(B-54), (A-69)+(B-55), (A-69)+(B-56), (A-69)+(B-57), (A-69)+(B-58), (A-69)+(B-59), (A-69)+(B-60), (A-69)+(B-61), (A-69)+(B-62), (A-69)+(B-63), (A-69)+(B-64), (A-69)+(B-65), (A-69)+(B-66), (A-69)+(B-67), (A-69)+(B-68), (A-69)+(B-69), (A-69)+(B-70), (A-69)+(B-71), (A-69)+(B-72), (A-69)+(B-73), (A-69)+(B-74), (A-69)+(B-75), (A-69)+(B-76), (A-69)+(B-77), (AI-1)+(B-78), (A-69)+(B-79), (A-69)+(B-80).

(A-70)+(B-1), (A-70)+(B-2), (A-70)+(B-3), (A-70)+(B-4), (A-70)+(B-5), (A-70)+(B-6), (A-70)+(B-7), (A-70)+(B-8), (A-70)+(B-9), (A-70)+(B-10), (A-70)+(B-11), (A-70)+(B-12), (A-70)+(B-13), (A-70)+(B-14), (A-70)+(B-15), (A-70)+(B-16), (A-70)+(B-17), (A-70)+(B-18), (A-70)+(B-19), (A-70)+(B-20), (A-70)+(B-21), (A-70)+(B-22), (A-70)+(B-23), (A-70)+(B-24), (A-70)+(B-25), (A-70)+(B-26), (A-70)+(B-27), (A-70)+(B-28), (A-70)+(B-29), (A-70)+(B-30), (A-70)+(B-31), (A-70)+(B-32), (A-70)+(B-33), (A-70)+(B-34), (A-70)+(B-35), (A-70)+(B-36), (A-70)+(B-37), (A-70)+(B-38), (A-70)+(B-39), (A-70)+(B-40), (A-70)+(B-41), (A-70)+(B-42), (A-70)+(B-43), (A-70)+(B-44), (A-70)+(B-45), (A-70)+(B-46), (A-70)+(B-47), (A-70)+(B-48), (A-70)+(B-49), (A-70)+(B-50), (A-70)+(B-51), (A-70)+(B-52), (A-70)+(B-53), (A-70)+(B-54), (A-70)+(B-55), (A-70)+(B-56), (A-70)+(B-57), (A-70)+(B-58), (A-70)+(B-59), (A-70)+(B-60), (A-70)+(B-61), (A-70)+(B-62), (A-70)+(B-63), (A-70)+(B-64), (A-70)+(B-65), (A-70)+(B-66), (A-70)+(B-67), (A-70)+(B-68), (A-70)+(B-69), (A-70)+(B-70), (A-70)+(B-71), (A-70)+(B-72), (A-70)+(B-73), (A-70)+(B-74), (A-70)+(B-75), (A-70)+(B-76), (A-70)+(B-77), (AI-1)+(B-78), (A-70)+(B-79), (A-70)+(B-80).

(A-71)+(B-1), (A-71)+(B-2), (A-71)+(B-3), (A-71)+(B-4), (A-71)+(B-5), (A-71)+(B-6), (A-71)+(B-7), (A-71)+(B-8), (A-71)+(B-9), (A-71)+(B-10), (A-71)+(B-11), (A-71)+(B-12), (A-71)+(B-13), (A-71)+(B-14), (A-71)+(B-15), (A-71)+(B-16), (A-71)+(B-17), (A-71)+(B-18), (A-71)+(B-19), (A-71)+(B-20), (A-71)+(B-21), (A-71)+(B-22), (A-71)+(B-23), (A-71)+(B-24), (A-71)+(B-25), (A-71)+(B-26), (A-71)+(B-27), (A-71)+(B-28), (A-71)+(B-29), (A-71)+(B-30), (A-71)+(B-31), (A-71)+(B-32), (A-71)+(B-33), (A-71)+(B-34), (A-71)+(B-35), (A-71)+(B-36), (A-71)+(B-37), (A-71)+(B-38), (A-71)+(B-39), (A-71)+(B-40), (A-71)+(B-41), (A-71)+(B-42), (A-71)+(B-43), (A-71)+(B-44), (A-71)+(B-45), (A-71)+(B-46), (A-71)+(B-47), (A-71)+(B-48), (A-71)+(B-49), (A-71)+(B-50), (A-71)+(B-51), (A-71)+(B-52), (A-71)+(B-53), (A-71)+(B-54), (A-71)+(B-55), (A-71)+(B-56), (A-71)+(B-57), (A-71)+(B-58), (A-71)+(B-59), (A-71)+(B-60), (A-71)+(B-61), (A-71)+(B-62), (A-71)+(B-63), (A-71)+(B-64), (A-71)+(B-65), (A-71)+(B-66), (A-71)+(B-67), (A-71)+(B-68), (A-71)+(B-69), (A-71)+(B-70), (A-71)+(B-71), (A-71)+(B-72), (A-71)+(B-73), (A-71)+(B-74), (A-71)+(B-75), (A-71)+(B-76), (A-71)+(B-77), (AI-1)+(B-78), (A-71)+(B-79), (A-71)+(B-80).

(A-72)+(B-1), (A-72)+(B-2), (A-72)+(B-3), (A-72)+(B-4), (A-72)+(B-5), (A-72)+(B-6), (A-72)+(B-7), (A-72)+(B-8), (A-72)+(B-9), (A-72)+(B-10), (A-72)+(B-11), (A-72)+(B-12), (A-72)+(B-13), (A-72)+(B-14), (A-72)+(B-15), (A-72)+(B-16), (A-72)+(B-17), (A-72)+(B-18), (A-72)+(B-19), (A-72)+(B-20), (A-72)+(B-21), (A-72)+(B-22), (A-72)+(B-23), (A-72)+(B-24), (A-72)+(B-25), (A-72)+(B-26), (A-72)+(B-27), (A-72)+(B-28), (A-72)+(B-29), (A-72)+(B-30), (A-72)+(B-31), (A-72)+(B-32), (A-72)+(B-33), (A-72)+(B-34), (A-72)+(B-35), (A-72)+(B-36), (A-72)+(B-37), (A-72)+(B-38), (A-72)+(B-39), (A-72)+(B-40), (A-72)+(B-41), (A-72)+(B-42), (A-72)+(B-43), (A-72)+(B-44), (A-72)+(B-45), (A-72)+(B-46), (A-72)+(B-47), (A-72)+(B-48), (A-72)+(B-49), (A-72)+(B-50), (A-72)+(B-51), (A-72)+(B-52), (A-72)+(B-53), (A-72)+(B-54), (A-72)+(B-55), (A-72)+(B-56), (A-72)+(B-57), (A-72)+(B-58), (A-72)+(B-59), (A-72)+(B-60), (A-72)+(B-61), (A-72)+(B-62), (A-72)+(B-63), (A-72)+(B-64), (A-72)+(B-65), (A-72)+(B-66), (A-72)+(B-67), (A-72)+(B-68), (A-72)+(B-69), (A-72)+(B-70), (A-72)+(B-71), (A-72)+(B-72), (A-72)+(B-73), (A-72)+(B-74), (A-72)+(B-75), (A-72)+(B-76), (A-72)+(B-77), (AI-1)+(B-78), (A-72)+(B-79), (A-72)+(B-80).

(A-73)+(B-1), (A-73)+(B-2), (A-73)+(B-3), (A-73)+(B-4), (A-73)+(B-5), (A-73)+(B-6), (A-73)+(B-7), (A-73)+(B-8), (A-73)+(B-9), (A-73)+(B-10), (A-73)+(B-11), (A-73)+(B-12), (A-73)+(B-13), (A-73)+(B-14), (A-73)+(B-15), (A-73)+(B-16), (A-73)+(B-17), (A-73)+(B-18), (A-73)+(B-19), (A-73)+(B-20), (A-73)+(B-21), (A-73)+(B-22), (A-73)+(B-23), (A-73)+(B-24), (A-73)+(B-25), (A-73)+(B-26), (A-73)+(B-27), (A-73)+(B-28), (A-73)+(B-29), (A-73)+(B-30), (A-73)+(B-31), (A-73)+(B-32), (A-73)+(B-33), (A-73)+(B-34), (A-73)+(B-35), (A-73)+(B-36), (A-73)+(B-37), (A-73)+(B-38), (A-73)+(B-39), (A-73)+(B-40), (A-73)+(B-41), (A-73)+(B-42), (A-73)+(B-43), (A-73)+(B-44), (A-73)+(B-45), (A-73)+(B-46), (A-73)+(B-47), (A-73)+(B-48), (A-73)+(B-49), (A-73)+(B-50), (A-73)+(B-51), (A-73)+(B-52), (A-73)+(B-53), (A-73)+(B-54), (A-73)+(B-55), (A-73)+(B-56), (A-73)+(B-57), (A-73)+(B-58), (A-73)+(B-59), (A-73)+(B-60), (A-73)+(B-61), (A-73)+(B-62), (A-73)+(B-63), (A-73)+(B-64), (A-73)+(B-65), (A-73)+(B-66), (A-73)+(B-67), (A-73)+(B-68), (A-73)+(B-69), (A-73)+(B-70), (A-73)+(B-71), (A-73)+(B-72), (A-73)+(B-73), (A-73)+(B-74), (A-73)+(B-75), (A-73)+(B-76), (A-73)+(B-77), (AI-1)+(B-78), (A-73)+(B-79), (A-73)+(B-80).

(A-74)+(B-1), (A-74)+(B-2), (A-74)+(B-3), (A-74)+(B-4), (A-74)+(B-5), (A-74)+(B-6), (A-74)+(B-7), (A-74)+(B-8), (A-74)+(B-9), (A-74)+(B-10), (A-74)+(B-11), (A-74)+(B-12), (A-74)+(B-13), (A-74)+(B-14), (A-74)+(B-15), (A-74)+(B-16), (A-74)+(B-17), (A-74)+(B-18), (A-74)+(B-19), (A-74)+(B-20), (A-74)+(B-21), (A-74)+(B-22), (A-74)+(B-23), (A-74)+(B-24), (A-74)+(B-25), (A-74)+(B-26), (A-74)+(B-27), (A-74)+(B-28), (A-74)+(B-29), (A-74)+(B-30), (A-74)+(B-31), (A-74)+(B-32), (A-74)+(B-33), (A-74)+(B-34), (A-74)+(B-35), (A-74)+(B-36), (A-74)+(B-37), (A-74)+(B-38), (A-74)+(B-39), (A-74)+(B-40), (A-74)+(B-41), (A-74)+(B-42), (A-74)+(B-43), (A-74)+(B-44), (A-74)+(B-45), (A-74)+(B-46), (A-74)+(B-47), (A-74)+(B-48), (A-74)+(B-49), (A-74)+(B-50), (A-74)+(B-51), (A-74)+(B-52), (A-74)+(B-53), (A-74)+(B-54), (A-74)+(B-55), (A-74)+(B-56), (A-74)+(B-57), (A-74)+(B-58), (A-74)+(B-59), (A-74)+(B-60), (A-74)+(B-61), (A-74)+(B-62), (A-74)+(B-63), (A-74)+(B-64), (A-74)+(B-65), (A-74)+(B-66), (A-74)+(B-67), (A-74)+(B-68), (A-74)+(B-69), (A-74)+(B-70), (A-74)+(B-71), (A-74)+(B-72), (A-74)+(B-73), (A-74)+(B-74), (A-74)+(B-75), (A-74)+(B-76), (A-74)+(B-77), (AI-1)+(B-78), (A-74)+(B-79), (A-74)+(B-80).

(A-75)+(B-1), (A-75)+(B-2), (A-75)+(B-3), (A-75)+(B-4), (A-75)+(B-5), (A-75)+(B-6), (A-75)+(B-7), (A-75)+(B-8), (A-75)+(B-9), (A-75)+(B-10), (A-75)+(B-11), (A-75)+(B-12), (A-75)+(B-13), (A-75)+(B-14), (A-75)+(B-15), (A-75)+(B-16), (A-75)+(B-17), (A-75)+(B-18), (A-75)+(B-19), (A-75)+(B-20), (A-75)+(B-21), (A-75)+(B-22), (A-75)+(B-23), (A-75)+(B-24), (A-75)+(B-25), (A-75)+(B-26), (A-75)+(B-27), (A-75)+(B-28), (A-75)+(B-29), (A-75)+(B-30), (A-75)+(B-31), (A-75)+(B-32), (A-75)+(B-33), (A-75)+(B-34), (A-75)+(B-35), (A-75)+(B-36), (A-75)+(B-37), (A-75)+(B-38), (A-75)+(B-39), (A-75)+(B-40), (A-75)+(B-41), (A-75)+(B-42), (A-75)+(B-43), (A-75)+(B-44), (A-75)+(B-45), (A-75)+(B-46), (A-75)+(B-47), (A-75)+(B-48), (A-75)+(B-49), (A-75)+(B-50), (A-75)+(B-51), (A-75)+(B-52), (A-75)+(B-53), (A-75)+(B-54), (A-75)+(B-55), (A-75)+(B-56), (A-75)+(B-57), (A-75)+(B-58), (A-75)+(B-59), (A-75)+(B-60), (A-75)+(B-61), (A-75)+(B-62), (A-75)+(B-63), (A-75)+(B-64), (A-75)+(B-65), (A-75)+(B-66), (A-75)+(B-67), (A-75)+(B-68), (A-75)+(B-69), (A-75)+(B-70), (A-75)+(B-71), (A-75)+(B-72), (A-75)+(B-73), (A-75)+(B-74), (A-75)+(B-75), (A-75)+(B-76), (A-75)+(B-77), (AI-1)+(B-78), (A-75)+(B-79), (A-75)+(B-80).

(A-76)+(B-1), (A-76)+(B-2), (A-76)+(B-3), (A-76)+(B-4), (A-76)+(B-5), (A-76)+(B-6), (A-76)+(B-7), (A-76)+(B-8), (A-76)+(B-9), (A-76)+(B-10), (A-76)+(B-11), (A-76)+(B-12), (A-76)+(B-13), (A-76)+(B-14), (A-76)+(B-15), (A-76)+(B-16), (A-76)+(B-17), (A-76)+(B-18), (A-76)+(B-19), (A-76)+(B-20), (A-76)+(B-21), (A-76)+(B-22), (A-76)+(B-23), (A-76)+(B-24), (A-76)+(B-25), (A-76)+(B-26), (A-76)+(B-27), (A-76)+(B-28), (A-76)+(B-29), (A-76)+(B-30), (A-76)+(B-31), (A-76)+(B-32), (A-76)+(B-33), (A-76)+(B-34), (A-76)+(B-35), (A-76)+(B-36), (A-76)+(B-37), (A-76)+(B-38), (A-76)+(B-39), (A-76)+(B-40), (A-76)+(B-41), (A-76)+(B-42), (A-76)+(B-43), (A-76)+(B-44), (A-76)+(B-45), (A-76)+(B-46), (A-76)+(B-47), (A-76)+(B-48), (A-76)+(B-49), (A-76)+(B-50), (A-76)+(B-51), (A-76)+(B-52), (A-76)+(B-53), (A-76)+(B-54), (A-76)+(B-55), (A-76)+(B-56), (A-76)+(B-57), (A-76)+(B-58), (A-76)+(B-59), (A-76)+(B-60), (A-76)+(B-61), (A-76)+(B-62), (A-76)+(B-63), (A-76)+(B-64), (A-76)+(B-65), (A-76)+(B-66), (A-76)+(B-67), (A-76)+(B-68), (A-76)+(B-69), (A-76)+(B-70), (A-76)+(B-71), (A-76)+(B-72), (A-76)+(B-73), (A-76)+(B-74), (A-76)+(B-75), (A-76)+(B-76), (A-76)+(B-77), (AI-1)+(B-78), (A-76)+(B-79), (A-76)+(B-80).

(A-77)+(B-1), (A-77)+(B-2), (A-77)+(B-3), (A-77)+(B-4), (A-77)+(B-5), (A-77)+(B-6), (A-77)+(B-7), (A-77)+(B-8), (A-77)+(B-9), (A-77)+(B-10), (A-77)+(B-11), (A-77)+(B-12), (A-77)+(B-13), (A-77)+(B-14), (A-77)+(B-15), (A-77)+(B-16), (A-77)+(B-17), (A-77)+(B-18), (A-77)+(B-19), (A-77)+(B-20), (A-77)+(B-21), (A-77)+(B-22), (A-77)+(B-23), (A-77)+(B-24), (A-77)+(B-25), (A-77)+(B-26), (A-77)+(B-27), (A-77)+(B-28), (A-77)+(B-29), (A-77)+(B-30), (A-77)+(B-31), (A-77)+(B-32), (A-77)+(B-33), (A-77)+(B-34), (A-77)+(B-35), (A-77)+(B-36), (A-77)+(B-37), (A-77)+(B-38), (A-77)+(B-39), (A-77)+(B-40), (A-77)+(B-41), (A-77)+(B-42), (A-77)+(B-43), (A-77)+(B-44), (A-77)+(B-45), (A-77)+(B-46), (A-77)+(B-47), (A-77)+(B-48), (A-77)+(B-49), (A-77)+(B-50), (A-77)+(B-51), (A-77)+(B-52), (A-77)+(B-53), (A-77)+(B-54), (A-77)+(B-55), (A-77)+(B-56), (A-77)+(B-57), (A-77)+(B-58), (A-77)+(B-59), (A-77)+(B-60), (A-77)+(B-61), (A-77)+(B-62), (A-77)+(B-63), (A-77)+(B-64), (A-77)+(B-65), (A-77)+(B-66), (A-77)+(B-67), (A-77)+(B-68), (A-77)+(B-69), (A-77)+(B-70), (A-77)+(B-71), (A-77)+(B-72), (A-77)+(B-73), (A-77)+(B-74), (A-77)+(B-75), (A-77)+(B-76), (A-77)+(B-77), (AI-1)+(B-78), (A-77)+(B-79), (A-77)+(B-80).

(A-78)+(B-1), (A-78)+(B-2), (A-78)+(B-3), (A-78)+(B-4), (A-78)+(B-5), (A-78)+(B-6), (A-78)+(B-7), (A-78)+(B-8), (A-78)+(B-9), (A-78)+(B-10), (A-78)+(B-11), (A-78)+(B-12), (A-78)+(B-13), (A-78)+(B-14), (A-78)+(B-15), (A-78)+(B-16), (A-78)+(B-17), (A-78)+(B-18), (A-78)+(B-19), (A-78)+(B-20), (A-78)+(B-21), (A-78)+(B-22), (A-78)+(B-23), (A-78)+(B-24), (A-78)+(B-25), (A-78)+(B-26), (A-78)+(B-27), (A-78)+(B-28), (A-78)+(B-29), (A-78)+(B-30), (A-78)+(B-31), (A-78)+(B-32), (A-78)+(B-33), (A-78)+(B-34), (A-78)+(B-35), (A-78)+(B-36), (A-78)+(B-37), (A-78)+(B-38), (A-78)+(B-39), (A-78)+(B-40), (A-78)+(B-41), (A-78)+(B-42), (A-78)+(B-43), (A-78)+(B-44), (A-78)+(B-45), (A-78)+(B-46), (A-78)+(B-47), (A-78)+(B-48), (A-78)+(B-49), (A-78)+(B-50), (A-78)+(B-51), (A-78)+(B-52), (A-78)+(B-53), (A-78)+(B-54), (A-78)+(B-55), (A-78)+(B-56), (A-78)+(B-57), (A-78)+(B-58), (A-78)+(B-59), (A-78)+(B-60), (A-78)+(B-61), (A-78)+(B-62), (A-78)+(B-63), (A-78)+(B-64), (A-78)+(B-65), (A-78)+(B-66), (A-78)+(B-67), (A-78)+(B-68), (A-78)+(B-69), (A-78)+(B-70), (A-78)+(B-71), (A-78)+(B-72), (A-78)+(B-73), (A-78)+(B-74), (A-78)+(B-75), (A-78)+(B-76), (A-78)+(B-77), (AI-1)+(B-78), (A-78)+(B-79), (A-78)+(B-80).

(A-79)+(B-1), (A-79)+(B-2), (A-79)+(B-3), (A-79)+(B-4), (A-79)+(B-5), (A-79)+(B-6), (A-79)+(B-7), (A-79)+(B-8), (A-79)+(B-9), (A-79)+(B-10), (A-79)+(B-11), (A-79)+(B-12), (A-79)+(B-13), (A-79)+(B-14), (A-79)+(B-15), (A-79)+(B-16), (A-79)+(B-17), (A-79)+(B-18), (A-79)+(B-19), (A-79)+(B-20), (A-79)+(B-21), (A-79)+(B-22), (A-79)+(B-23), (A-79)+(B-24), (A-79)+(B-25), (A-79)+(B-26), (A-79)+(B-27), (A-79)+(B-28), (A-79)+(B-29), (A-79)+(B-30), (A-79)+(B-31), (A-79)+(B-32), (A-79)+(B-33), (A-79)+(B-34), (A-79)+(B-35), (A-79)+(B-36), (A-79)+(B-37), (A-79)+(B-38), (A-79)+(B-39), (A-79)+(B-40), (A-79)+(B-41), (A-79)+(B-42), (A-79)+(B-43), (A-79)+(B-44), (A-79)+(B-45), (A-79)+(B-46), (A-79)+(B-47), (A-79)+(B-48), (A-79)+(B-49), (A-79)+(B-50), (A-79)+(B-51), (A-79)+(B-52), (A-79)+(B-53), (A-79)+(B-54), (A-79)+(B-55), (A-79)+(B-56), (A-79)+(B-57), (A-79)+(B-58), (A-79)+(B-59), (A-79)+(B-60), (A-79)+(B-61), (A-79)+(B-62), (A-79)+(B-63), (A-79)+(B-64), (A-79)+(B-65), (A-79)+(B-66), (A-79)+(B-67), (A-79)+(B-68), (A-79)+(B-69), (A-79)+(B-70), (A-79)+(B-71), (A-79)+(B-72), (A-79)+(B-73), (A-79)+(B-74), (A-79)+(B-75), (A-79)+(B-76), (A-79)+(B-77), (AI-1)+(B-78), (A-79)+(B-79), (A-79)+(B-80).

(A-80)+(B-1), (A-80)+(B-2), (A-80)+(B-3), (A-80)+(B-4), (A-80)+(B-5), (A-80)+(B-6), (A-80)+(B-7), (A-80)+(B-8), (A-80)+(B-9), (A-80)+(B-10), (A-80)+(B-11), (A-80)+(B-12), (A-80)+(B-13), (A-80)+(B-14), (A-80)+(B-15), (A-80)+(B-16), (A-80)+(B-17), (A-80)+(B-18), (A-80)+(B-19), (A-80)+(B-20), (A-80)+(B-21), (A-80)+(B-22), (A-80)+(B-23), (A-80)+(B-24), (A-80)+(B-25), (A-80)+(B-26), (A-80)+(B-27), (A-80)+(B-28), (A-80)+(B-29), (A-80)+(B-30), (A-80)+(B-31), (A-80)+(B-32), (A-80)+(B-33), (A-80)+(B-34), (A-80)+(B-35), (A-80)+(B-36), (A-80)+(B-37), (A-80)+(B-38), (A-80)+(B-39), (A-80)+(B-40), (A-80)+(B-41), (A-80)+(B-42), (A-80)+(B-43), (A-80)+(B-44), (A-80)+(B-45), (A-80)+(B-46), (A-80)+(B-47), (A-80)+(B-48), (A-80)+(B-49), (A-80)+(B-50), (A-80)+(B-51), (A-80)+(B-52), (A-80)+(B-53), (A-80)+(B-54), (A-80)+(B-55), (A-80)+(B-56), (A-80)+(B-57), (A-80)+(B-58), (A-80)+(B-59), (A-80)+(B-60), (A-80)+(B-61), (A-80)+(B-62), (A-80)+(B-63), (A-80)+(B-64), (A-80)+(B-65), (A-80)+(B-66), (A-80)+(B-67), (A-80)+(B-68), (A-80)+(B-69), (A-80)+(B-70), (A-80)+(B-71), (A-80)+(B-72), (A-80)+(B-73), (A-80)+(B-74), (A-80)+(B-75), (A-80)+(B-76), (A-80)+(B-77), (AI-1)+(B-78), (A-80)+(B-79), (A-80)+(B-80).

(A-81)+(B-1), (A-81)+(B-2), (A-81)+(B-3), (A-81)+(B-4), (A-81)+(B-5), (A-81)+(B-6), (A-81)+(B-7), (A-81)+(B-8), (A-81)+(B-9), (A-81)+(B-10), (A-81)+(B-11), (A-81)+(B-12), (A-81)+(B-13), (A-81)+(B-14), (A-81)+(B-15), (A-81)+(B-16), (A-81)+(B-17), (A-81)+(B-18), (A-81)+(B-19), (A-81)+(B-20), (A-81)+(B-21), (A-81)+(B-22), (A-81)+(B-23), (A-81)+(B-24), (A-81)+(B-25), (A-81)+(B-26), (A-81)+(B-27), (A-81)+(B-28), (A-81)+(B-29), (A-81)+(B-30), (A-81)+(B-31), (A-81)+(B-32), (A-81)+(B-33), (A-81)+(B-34), (A-81)+(B-35), (A-81)+(B-36), (A-81)+(B-37), (A-81)+(B-38), (A-81)+(B-39), (A-81)+(B-40), (A-81)+(B-41), (A-81)+(B-42), (A-81)+(B-43), (A-81)+(B-44), (A-81)+(B-45), (A-81)+(B-46), (A-81)+(B-47), (A-81)+(B-48), (A-81)+(B-49), (A-81)+(B-50), (A-81)+(B-51), (A-81)+(B-52), (A-81)+(B-53), (A-81)+(B-54), (A-81)+(B-55), (A-81)+(B-56), (A-81)+(B-57), (A-81)+(B-58), (A-81)+(B-59), (A-81)+(B-60), (A-81)+(B-61), (A-81)+(B-62), (A-81)+(B-63), (A-81)+(B-64), (A-81)+(B-65), (A-81)+(B-66), (A-81)+(B-67), (A-81)+(B-68), (A-81)+(B-69), (A-81)+(B-70), (A-81)+(B-71), (A-81)+(B-72), (A-81)+(B-73), (A-81)+(B-74), (A-81)+(B-75), (A-81)+(B-76), (A-81)+(B-77), (AI-1)+(B-78), (A-81)+(B-79), (A-81)+(B-80).

(A-82)+(B-1), (A-82)+(B-2), (A-82)+(B-3), (A-82)+(B-4), (A-82)+(B-5), (A-82)+(B-6), (A-82)+(B-7), (A-82)+(B-8), (A-82)+(B-9), (A-82)+(B-10), (A-82)+(B-11), (A-82)+(B-12), (A-82)+(B-13), (A-82)+(B-14), (A-82)+(B-15), (A-82)+(B-16), (A-82)+(B-17), (A-82)+(B-18), (A-82)+(B-19), (A-82)+(B-20), (A-82)+(B-21), (A-82)+(B-22), (A-82)+(B-23), (A-82)+(B-24), (A-82)+(B-25), (A-82)+(B-26), (A-82)+(B-27), (A-82)+(B-28), (A-82)+(B-29), (A-82)+(B-30), (A-82)+(B-31), (A-82)+(B-32), (A-82)+(B-33), (A-82)+(B-34), (A-82)+(B-35), (A-82)+(B-36), (A-82)+(B-37), (A-82)+(B-38), (A-82)+(B-39), (A-82)+(B-40), (A-82)+(B-41), (A-82)+(B-42), (A-82)+(B-43), (A-82)+(B-44), (A-82)+(B-45), (A-82)+(B-46), (A-82)+(B-47), (A-82)+(B-48), (A-82)+(B-49), (A-82)+(B-50), (A-82)+(B-51), (A-82)+(B-52), (A-82)+(B-53), (A-82)+(B-54), (A-82)+(B-55), (A-82)+(B-56), (A-82)+(B-57), (A-82)+(B-58), (A-82)+(B-59), (A-82)+(B-60), (A-82)+(B-61), (A-82)+(B-62), (A-82)+(B-63), (A-82)+(B-64), (A-82)+(B-65), (A-82)+(B-66), (A-82)+(B-67), (A-82)+(B-68), (A-82)+(B-69), (A-82)+(B-70), (A-82)+(B-71), (A-82)+(B-72), (A-82)+(B-73), (A-82)+(B-74), (A-82)+(B-75), (A-82)+(B-76), (A-82)+(B-77), (AI-1)+(B-78), (A-82)+(B-79), (A-82)+(B-80).

(A-83)+(B-1), (A-83)+(B-2), (A-83)+(B-3), (A-83)+(B-4), (A-83)+(B-5), (A-83)+(B-6), (A-83)+(B-7), (A-83)+(B-8), (A-83)+(B-9), (A-83)+(B-10), (A-83)+(B-11), (A-83)+(B-12), (A-83)+(B-13), (A-83)+(B-14), (A-83)+(B-15), (A-83)+(B-16), (A-83)+(B-17), (A-83)+(B-18), (A-83)+(B-19), (A-83)+(B-20), (A-83)+(B-21), (A-83)+(B-22), (A-83)+(B-23), (A-83)+(B-24), (A-83)+(B-25), (A-83)+(B-26), (A-83)+(B-27), (A-83)+(B-28), (A-83)+(B-29), (A-83)+(B-30), (A-83)+(B-31), (A-83)+(B-32), (A-83)+(B-33), (A-83)+(B-34), (A-83)+(B-35), (A-83)+(B-36), (A-83)+(B-37), (A-83)+(B-38), (A-83)+(B-39), (A-83)+(B-40), (A-83)+(B-41), (A-83)+(B-42), (A-83)+(B-43), (A-83)+(B-44), (A-83)+(B-45), (A-83)+(B-46), (A-83)+(B-47), (A-83)+(B-48), (A-83)+(B-49), (A-83)+(B-50), (A-83)+(B-51), (A-83)+(B-52), (A-83)+(B-53), (A-83)+(B-54), (A-83)+(B-55), (A-83)+(B-56), (A-83)+(B-57), (A-83)+(B-58), (A-83)+(B-59), (A-83)+(B-60), (A-83)+(B-61), (A-83)+(B-62), (A-83)+(B-63), (A-83)+(B-64), (A-83)+(B-65), (A-83)+(B-66), (A-83)+(B-67), (A-83)+(B-68), (A-83)+(B-69), (A-83)+(B-70), (A-83)+(B-71), (A-83)+(B-72), (A-83)+(B-73), (A-83)+(B-74), (A-83)+(B-75), (A-83)+(B-76), (A-83)+(B-77), (AI-1)+(B-78), (A-83)+(B-79), (A-83)+(B-80).

(A-84)+(B-1), (A-84)+(B-2), (A-84)+(B-3), (A-84)+(B-4), (A-84)+(B-5), (A-84)+(B-6), (A-84)+(B-7), (A-84)+(B-8), (A-84)+(B-9), (A-84)+(B-10), (A-84)+(B-11), (A-84)+(B-12), (A-84)+(B-13), (A-84)+(B-14), (A-84)+(B-15), (A-84)+(B-16), (A-84)+(B-17), (A-84)+(B-18), (A-84)+(B-19), (A-84)+(B-20), (A-84)+(B-21), (A-84)+(B-22), (A-84)+(B-23), (A-84)+(B-24), (A-84)+(B-25), (A-84)+(B-26), (A-84)+(B-27), (A-84)+(B-28), (A-84)+(B-29), (A-84)+(B-30), (A-84)+(B-31), (A-84)+(B-32), (A-84)+(B-33), (A-84)+(B-34), (A-84)+(B-35), (A-84)+(B-36), (A-84)+(B-37), (A-84)+(B-38), (A-84)+(B-39), (A-84)+(B-40), (A-84)+(B-41), (A-84)+(B-42), (A-84)+(B-43), (A-84)+(B-44), (A-84)+(B-45), (A-84)+(B-46), (A-84)+(B-47), (A-84)+(B-48), (A-84)+(B-49), (A-84)+(B-50), (A-84)+(B-51), (A-84)+(B-52), (A-84)+(B-53), (A-84)+(B-54), (A-84)+(B-55), (A-84)+(B-56), (A-84)+(B-57), (A-84)+(B-58), (A-84)+(B-59), (A-84)+(B-60), (A-84)+(B-61), (A-84)+(B-62), (A-84)+(B-63), (A-84)+(B-64), (A-84)+(B-65), (A-84)+(B-66), (A-84)+(B-67), (A-84)+(B-68), (A-84)+(B-69), (A-84)+(B-70), (A-84)+(B-71), (A-84)+(B-72), (A-84)+(B-73), (A-84)+(B-74), (A-84)+(B-75), (A-84)+(B-76), (A-84)+(B-77), (AI-1)+(B-78), (A-84)+(B-79), (A-84)+(B-80).

(A-85)+(B-1), (A-85)+(B-2), (A-85)+(B-3), (A-85)+(B-4), (A-85)+(B-5), (A-85)+(B-6), (A-85)+(B-7), (A-85)+(B-8), (A-85)+(B-9), (A-85)+(B-10), (A-85)+(B-11), (A-85)+(B-12), (A-85)+(B-13), (A-85)+(B-14), (A-85)+(B-15), (A-85)+(B-16), (A-85)+(B-17), (A-85)+(B-18), (A-85)+(B-19), (A-85)+(B-20), (A-85)+(B-21), (A-85)+(B-22), (A-85)+(B-23), (A-85)+(B-24), (A-85)+(B-25), (A-85)+(B-26), (A-85)+(B-27), (A-85)+(B-28), (A-85)+(B-29), (A-85)+(B-30), (A-85)+(B-31), (A-85)+(B-32), (A-85)+(B-33), (A-85)+(B-34), (A-85)+(B-35), (A-85)+(B-36), (A-85)+(B-37), (A-85)+(B-38), (A-85)+(B-39), (A-85)+(B-40), (A-85)+(B-41), (A-85)+(B-42), (A-85)+(B-43), (A-85)+(B-44), (A-85)+(B-45), (A-85)+(B-46), (A-85)+(B-47), (A-85)+(B-48), (A-85)+(B-49), (A-85)+(B-50), (A-85)+(B-51), (A-85)+(B-52), (A-85)+(B-53), (A-85)+(B-54), (A-85)+(B-55), (A-85)+(B-56), (A-85)+(B-57), (A-85)+(B-58), (A-85)+(B-59), (A-85)+(B-60), (A-85)+(B-61), (A-85)+(B-62), (A-85)+(B-63), (A-85)+(B-64), (A-85)+(B-65), (A-85)+(B-66), (A-85)+(B-67), (A-85)+(B-68), (A-85)+(B-69), (A-85)+(B-70), (A-85)+(B-71), (A-85)+(B-72), (A-85)+(B-73), (A-85)+(B-74), (A-85)+(B-75), (A-85)+(B-76), (A-85)+(B-77), (AI-1)+(B-78), (A-85)+(B-79), (A-85)+(B-80).

(A-86)+(B-1), (A-86)+(B-2), (A-86)+(B-3), (A-86)+(B-4), (A-86)+(B-5), (A-86)+(B-6), (A-86)+(B-7), (A-86)+(B-8), (A-86)+(B-9), (A-86)+(B-10), (A-86)+(B-11), (A-86)+(B-12), (A-86)+(B-13), (A-86)+(B-14), (A-86)+(B-15), (A-86)+(B-16), (A-86)+(B-17), (A-86)+(B-18), (A-86)+(B-19), (A-86)+(B-20), (A-86)+(B-21), (A-86)+(B-22), (A-86)+(B-23), (A-86)+(B-24), (A-86)+(B-25), (A-86)+(B-26), (A-86)+(B-27), (A-86)+(B-28), (A-86)+(B-29), (A-86)+(B-30), (A-86)+(B-31), (A-86)+(B-32), (A-86)+(B-33), (A-86)+(B-34), (A-86)+(B-35), (A-86)+(B-36), (A-86)+(B-37), (A-86)+(B-38), (A-86)+(B-39), (A-86)+(B-40), (A-86)+(B-41), (A-86)+(B-42), (A-86)+(B-43), (A-86)+(B-44), (A-86)+(B-45), (A-86)+(B-46), (A-86)+(B-47), (A-86)+(B-48), (A-86)+(B-49), (A-86)+(B-50), (A-86)+(B-51), (A-86)+(B-52), (A-86)+(B-53), (A-86)+(B-54), (A-86)+(B-55), (A-86)+(B-56), (A-86)+(B-57), (A-86)+(B-58), (A-86)+(B-59), (A-86)+(B-60), (A-86)+(B-61), (A-86)+(B-62), (A-86)+(B-63), (A-86)+(B-64), (A-86)+(B-65), (A-86)+(B-66), (A-86)+(B-67), (A-86)+(B-68), (A-86)+(B-69), (A-86)+(B-70), (A-86)+(B-71), (A-86)+(B-72), (A-86)+(B-73), (A-86)+(B-74), (A-86)+(B-75), (A-86)+(B-76), (A-86)+(B-77), (AI-1)+(B-78), (A-86)+(B-79), (A-86)+(B-80).

(A-87)+(B-1), (A-87)+(B-2), (A-87)+(B-3), (A-87)+(B-4), (A-87)+(B-5), (A-87)+(B-6), (A-87)+(B-7), (A-87)+(B-8), (A-87)+(B-9), (A-87)+(B-10), (A-87)+(B-11), (A-87)+(B-12), (A-87)+(B-13), (A-87)+(B-14), (A-87)+(B-15), (A-87)+(B-16), (A-87)+(B-17), (A-87)+(B-18), (A-87)+(B-19), (A-87)+(B-20), (A-87)+(B-21), (A-87)+(B-22), (A-87)+(B-23), (A-87)+(B-24), (A-87)+(B-25), (A-87)+(B-26), (A-87)+(B-27), (A-87)+(B-28), (A-87)+(B-29), (A-87)+(B-30), (A-87)+(B-31), (A-87)+(B-32), (A-87)+(B-33), (A-87)+(B-34), (A-87)+(B-35), (A-87)+(B-36), (A-87)+(B-37), (A-87)+(B-38), (A-87)+(B-39), (A-87)+(B-40), (A-87)+(B-41), (A-87)+(B-42), (A-87)+(B-43), (A-87)+(B-44), (A-87)+(B-45), (A-87)+(B-46), (A-87)+(B-47), (A-87)+(B-48), (A-87)+(B-49), (A-87)+(B-50), (A-87)+(B-51), (A-87)+(B-52), (A-87)+(B-53), (A-87)+(B-54), (A-87)+(B-55), (A-87)+(B-56), (A-87)+(B-57), (A-87)+(B-58), (A-87)+(B-59), (A-87)+(B-60), (A-87)+(B-61), (A-87)+(B-62), (A-87)+(B-63), (A-87)+(B-64), (A-87)+(B-65), (A-87)+(B-66), (A-87)+(B-67), (A-87)+(B-68), (A-87)+(B-69), (A-87)+(B-70), (A-87)+(B-71), (A-87)+(B-72), (A-87)+(B-73), (A-87)+(B-74), (A-87)+(B-75), (A-87)+(B-76), (A-87)+(B-77), (AI-1)+(B-78), (A-87)+(B-79), (A-87)+(B-80).

(A-88)+(B-1), (A-88)+(B-2), (A-88)+(B-3), (A-88)+(B-4), (A-88)+(B-5), (A-88)+(B-6), (A-88)+(B-7), (A-88)+(B-8), (A-88)+(B-9), (A-88)+(B-10), (A-88)+(B-11), (A-88)+(B-12), (A-88)+(B-13), (A-88)+(B-14), (A-88)+(B-15), (A-88)+(B-16), (A-88)+(B-17), (A-88)+(B-18), (A-88)+(B-19), (A-88)+(B-20), (A-88)+(B-21), (A-88)+(B-22), (A-88)+(B-23), (A-88)+(B-24), (A-88)+(B-25), (A-88)+(B-26), (A-88)+(B-27), (A-88)+(B-28), (A-88)+(B-29), (A-88)+(B-30), (A-88)+(B-31), (A-88)+(B-32), (A-88)+(B-33), (A-88)+(B-34), (A-88)+(B-35), (A-88)+(B-36), (A-88)+(B-37), (A-88)+(B-38), (A-88)+(B-39), (A-88)+(B-40), (A-88)+(B-41), (A-88)+(B-42), (A-88)+(B-43), (A-88)+(B-44), (A-88)+(B-45), (A-88)+(B-46), (A-88)+(B-47), (A-88)+(B-48), (A-88)+(B-49), (A-88)+(B-50), (A-88)+(B-51), (A-88)+(B-52), (A-88)+(B-53), (A-88)+(B-54), (A-88)+(B-55), (A-88)+(B-56), (A-88)+(B-57), (A-88)+(B-58), (A-88)+(B-59), (A-88)+(B-60), (A-88)+(B-61), (A-88)+(B-62), (A-88)+(B-63), (A-88)+(B-64), (A-88)+(B-65), (A-88)+(B-66), (A-88)+(B-67), (A-88)+(B-68), (A-88)+(B-69), (A-88)+(B-70), (A-88)+(B-71), (A-88)+(B-72), (A-88)+(B-73), (A-88)+(B-74), (A-88)+(B-75), (A-88)+(B-76), (A-88)+(B-77), (AI-1)+(B-78), (A-88)+(B-79), (A-88)+(B-80).

(A-89)+(B-1), (A-89)+(B-2), (A-89)+(B-3), (A-89)+(B-4), (A-89)+(B-5), (A-89)+(B-6), (A-89)+(B-7), (A-89)+(B-8), (A-89)+(B-9), (A-89)+(B-10), (A-89)+(B-11), (A-89)+(B-12), (A-89)+(B-13), (A-89)+(B-14), (A-89)+(B-15), (A-89)+(B-16), (A-89)+(B-17), (A-89)+(B-18), (A-89)+(B-19), (A-89)+(B-20), (A-89)+(B-21), (A-89)+(B-22), (A-89)+(B-23), (A-89)+(B-24), (A-89)+(B-25), (A-89)+(B-26), (A-89)+(B-27), (A-89)+(B-28), (A-89)+(B-29), (A-89)+(B-30), (A-89)+(B-31), (A-89)+(B-32), (A-89)+(B-33), (A-89)+(B-34), (A-89)+(B-35), (A-89)+(B-36), (A-89)+(B-37), (A-89)+(B-38), (A-89)+(B-39), (A-89)+(B-40), (A-89)+(B-41), (A-89)+(B-42), (A-89)+(B-43), (A-89)+(B-44), (A-89)+(B-45), (A-89)+(B-46), (A-89)+(B-47), (A-89)+(B-48), (A-89)+(B-49), (A-89)+(B-50), (A-89)+(B-51), (A-89)+(B-52), (A-89)+(B-53), (A-89)+(B-54), (A-89)+(B-55), (A-89)+(B-56), (A-89)+(B-57), (A-89)+(B-58), (A-89)+(B-59), (A-89)+(B-60), (A-89)+(B-61), (A-89)+(B-62), (A-89)+(B-63), (A-89)+(B-64), (A-89)+(B-65), (A-89)+(B-66), (A-89)+(B-67), (A-89)+(B-68), (A-89)+(B-69), (A-89)+(B-70), (A-89)+(B-71), (A-89)+(B-72), (A-89)+(B-73), (A-89)+(B-74), (A-89)+(B-75), (A-89)+(B-76), (A-89)+(B-77), (AI-1)+(B-78), (A-89)+(B-79), (A-89)+(B-80).

(A-90)+(B-1), (A-90)+(B-2), (A-90)+(B-3), (A-90)+(B-4), (A-90)+(B-5), (A-90)+(B-6), (A-90)+(B-7), (A-90)+(B-8), (A-90)+(B-9), (A-90)+(B-10), (A-90)+(B-11), (A-90)+(B-12), (A-90)+(B-13), (A-90)+(B-14), (A-90)+(B-15), (A-90)+(B-16), (A-90)+(B-17), (A-90)+(B-18), (A-90)+(B-19), (A-90)+(B-20), (A-90)+(B-21), (A-90)+(B-22), (A-90)+(B-23), (A-90)+(B-24), (A-90)+(B-25), (A-90)+(B-26), (A-90)+(B-27), (A-90)+(B-28), (A-90)+(B-29), (A-90)+(B-30), (A-90)+(B-31), (A-90)+(B-32), (A-90)+(B-33), (A-90)+(B-34), (A-90)+(B-35), (A-90)+(B-36), (A-90)+(B-37), (A-90)+(B-38), (A-90)+(B-39), (A-90)+(B-40), (A-90)+(B-41), (A-90)+(B-42), (A-90)+(B-43), (A-90)+(B-44), (A-90)+(B-45), (A-90)+(B-46), (A-90)+(B-47), (A-90)+(B-48), (A-90)+(B-49), (A-90)+(B-50), (A-90)+(B-51), (A-90)+(B-52), (A-90)+(B-53), (A-90)+(B-54), (A-90)+(B-55), (A-90)+(B-56), (A-90)+(B-57), (A-90)+(B-58), (A-90)+(B-59), (A-90)+(B-60), (A-90)+(B-61), (A-90)+(B-62), (A-90)+(B-63), (A-90)+(B-64), (A-90)+(B-65), (A-90)+(B-66), (A-90)+(B-67), (A-90)+(B-68), (A-90)+(B-69), (A-90)+(B-70), (A-90)+(B-71), (A-90)+(B-72), (A-90)+(B-73), (A-90)+(B-74), (A-90)+(B-75), (A-90)+(B-76), (A-90)+(B-77), (AI-1)+(B-78), (A-90)+(B-79), (A-90)+(B-80).

(A-91)+(B-1), (A-91)+(B-2), (A-91)+(B-3), (A-91)+(B-4), (A-91)+(B-5), (A-91)+(B-6), (A-91)+(B-7), (A-91)+(B-8), (A-91)+(B-9), (A-91)+(B-10), (A-91)+(B-11), (A-91)+(B-12), (A-91)+(B-13), (A-91)+(B-14), (A-91)+(B-15), (A-91)+(B-16), (A-91)+(B-17), (A-91)+(B-18), (A-91)+(B-19), (A-91)+(B-20), (A-91)+(B-21), (A-91)+(B-22), (A-91)+(B-23), (A-91)+(B-24), (A-91)+(B-25), (A-91)+(B-26), (A-91)+(B-27), (A-91)+(B-28), (A-91)+(B-29), (A-91)+(B-30), (A-91)+(B-31), (A-91)+(B-32), (A-91)+(B-33), (A-91)+(B-34), (A-91)+(B-35), (A-91)+(B-36), (A-91)+(B-37), (A-91)+(B-38), (A-91)+(B-39), (A-91)+(B-40), (A-91)+(B-41), (A-91)+(B-42), (A-91)+(B-43), (A-91)+(B-44), (A-91)+(B-45), (A-91)+(B-46), (A-91)+(B-47), (A-91)+(B-48), (A-91)+(B-49), (A-91)+(B-50), (A-91)+(B-51), (A-91)+(B-52), (A-91)+(B-53), (A-91)+(B-54), (A-91)+(B-55), (A-91)+(B-56), (A-91)+(B-57), (A-91)+(B-58), (A-91)+(B-59), (A-91)+(B-60), (A-91)+(B-61), (A-91)+(B-62), (A-91)+(B-63), (A-91)+(B-64), (A-91)+(B-65), (A-91)+(B-66), (A-91)+(B-67), (A-91)+(B-68), (A-91)+(B-69), (A-91)+(B-70), (A-91)+(B-71), (A-91)+(B-72), (A-91)+(B-73), (A-91)+(B-74), (A-91)+(B-75), (A-91)+(B-76), (A-91)+(B-77), (AI-1)+(B-78), (A-91)+(B-79), (A-91)+(B-80).

(A-92)+(B-1), (A-92)+(B-2), (A-92)+(B-3), (A-92)+(B-4), (A-92)+(B-5), (A-92)+(B-6), (A-92)+(B-7), (A-92)+(B-8), (A-92)+(B-9), (A-92)+(B-10), (A-92)+(B-11), (A-92)+(B-12), (A-92)+(B-13), (A-92)+(B-14), (A-92)+(B-15), (A-92)+(B-16), (A-92)+(B-17), (A-92)+(B-18), (A-92)+(B-19), (A-92)+(B-20), (A-92)+(B-21), (A-92)+(B-22), (A-92)+(B-23), (A-92)+(B-24), (A-92)+(B-25), (A-92)+(B-26), (A-92)+(B-27), (A-92)+(B-28), (A-92)+(B-29), (A-92)+(B-30), (A-92)+(B-31), (A-92)+(B-32), (A-92)+(B-33), (A-92)+(B-34), (A-92)+(B-35), (A-92)+(B-36), (A-92)+(B-37), (A-92)+(B-38), (A-92)+(B-39), (A-92)+(B-40), (A-92)+(B-41), (A-92)+(B-42), (A-92)+(B-43), (A-92)+(B-44), (A-92)+(B-45), (A-92)+(B-46), (A-92)+(B-47), (A-92)+(B-48), (A-92)+(B-49), (A-92)+(B-50), (A-92)+(B-51), (A-92)+(B-52), (A-92)+(B-53), (A-92)+(B-54), (A-92)+(B-55), (A-92)+(B-56), (A-92)+(B-57), (A-92)+(B-58), (A-92)+(B-59), (A-92)+(B-60), (A-92)+(B-61), (A-92)+(B-62), (A-92)+(B-63), (A-92)+(B-64), (A-92)+(B-65), (A-92)+(B-66), (A-92)+(B-67), (A-92)+(B-68), (A-92)+(B-69), (A-92)+(B-70), (A-92)+(B-71), (A-92)+(B-72), (A-92)+(B-73), (A-92)+(B-74), (A-92)+(B-75), (A-92)+(B-76), (A-92)+(B-77), (AI-1)+(B-78), (A-92)+(B-79), (A-92)+(B-80).

(A-93)+(B-1), (A-93)+(B-2), (A-93)+(B-3), (A-93)+(B-4), (A-93)+(B-5), (A-93)+(B-6), (A-93)+(B-7), (A-93)+(B-8), (A-93)+(B-9), (A-93)+(B-10), (A-93)+(B-11), (A-93)+(B-12), (A-93)+(B-13), (A-93)+(B-14), (A-93)+(B-15), (A-93)+(B-16), (A-93)+(B-17), (A-93)+(B-18), (A-93)+(B-19), (A-93)+(B-20), (A-93)+(B-21), (A-93)+(B-22), (A-93)+(B-23), (A-93)+(B-24), (A-93)+(B-25), (A-93)+(B-26), (A-93)+(B-27), (A-93)+(B-28), (A-93)+(B-29), (A-93)+(B-30), (A-93)+(B-31), (A-93)+(B-32), (A-93)+(B-33), (A-93)+(B-34), (A-93)+(B-35), (A-93)+(B-36), (A-93)+(B-37), (A-93)+(B-38), (A-93)+(B-39), (A-93)+(B-40), (A-93)+(B-41), (A-93)+(B-42), (A-93)+(B-43), (A-93)+(B-44), (A-93)+(B-45), (A-93)+(B-46), (A-93)+(B-47), (A-93)+(B-48), (A-93)+(B-49), (A-93)+(B-50), (A-93)+(B-51), (A-93)+(B-52), (A-93)+(B-53), (A-93)+(B-54), (A-93)+(B-55), (A-93)+(B-56), (A-93)+(B-57), (A-93)+(B-58), (A-93)+(B-59), (A-93)+(B-60), (A-93)+(B-61), (A-93)+(B-62), (A-93)+(B-63), (A-93)+(B-64), (A-93)+(B-65), (A-93)+(B-66), (A-93)+(B-67), (A-93)+(B-68), (A-93)+(B-69), (A-93)+(B-70), (A-93)+(B-71), (A-93)+(B-72), (A-93)+(B-73), (A-93)+(B-74), (A-93)+(B-75), (A-93)+(B-76), (A-93)+(B-77), (AI-1)+(B-78), (A-93)+(B-79), (A-93)+(B-80).

(A-94)+(B-1), (A-94)+(B-2), (A-94)+(B-3), (A-94)+(B-4), (A-94)+(B-5), (A-94)+(B-6), (A-94)+(B-7), (A-94)+(B-8), (A-94)+(B-9), (A-94)+(B-10), (A-94)+(B-11), (A-94)+(B-12), (A-94)+(B-13), (A-94)+(B-14), (A-94)+(B-15), (A-94)+(B-16), (A-94)+(B-17), (A-94)+(B-18), (A-94)+(B-19), (A-94)+(B-20), (A-94)+(B-21), (A-94)+(B-22), (A-94)+(B-23), (A-94)+(B-24), (A-94)+(B-25), (A-94)+(B-26), (A-94)+(B-27), (A-94)+(B-28), (A-94)+(B-29), (A-94)+(B-30), (A-94)+(B-31), (A-94)+(B-32), (A-94)+(B-33), (A-94)+(B-34), (A-94)+(B-35), (A-94)+(B-36), (A-94)+(B-37), (A-94)+(B-38), (A-94)+(B-39), (A-94)+(B-40), (A-94)+(B-41), (A-94)+(B-42), (A-94)+(B-43), (A-94)+(B-44), (A-94)+(B-45), (A-94)+(B-46), (A-94)+(B-47), (A-94)+(B-48), (A-94)+(B-49), (A-94)+(B-50), (A-94)+(B-51), (A-94)+(B-52), (A-94)+(B-53), (A-94)+(B-54), (A-94)+(B-55), (A-94)+(B-56), (A-94)+(B-57), (A-94)+(B-58), (A-94)+(B-59), (A-94)+(B-60), (A-94)+(B-61), (A-94)+(B-62), (A-94)+(B-63), (A-94)+(B-64), (A-94)+(B-65), (A-94)+(B-66), (A-94)+(B-67), (A-94)+(B-68), (A-94)+(B-69), (A-94)+(B-70), (A-94)+(B-71), (A-94)+(B-72), (A-94)+(B-73), (A-94)+(B-74), (A-94)+(B-75), (A-94)+(B-76), (A-94)+(B-77), (AI-1)+(B-78), (A-94)+(B-79), (A-94)+(B-80).

(A-95)+(B-1), (A-95)+(B-2), (A-95)+(B-3), (A-95)+(B-4), (A-95)+(B-5), (A-95)+(B-6), (A-95)+(B-7), (A-95)+(B-8), (A-95)+(B-9), (A-95)+(B-10), (A-95)+(B-11), (A-95)+(B-12), (A-95)+(B-13), (A-95)+(B-14), (A-95)+(B-15), (A-95)+(B-16), (A-95)+(B-17), (A-95)+(B-18), (A-95)+(B-19), (A-95)+(B-20), (A-95)+(B-21), (A-95)+(B-22), (A-95)+(B-23), (A-95)+(B-24), (A-95)+(B-25), (A-95)+(B-26), (A-95)+(B-27), (A-95)+(B-28), (A-95)+(B-29), (A-95)+(B-30), (A-95)+(B-31), (A-95)+(B-32), (A-95)+(B-33), (A-95)+(B-34), (A-95)+(B-35), (A-95)+(B-36), (A-95)+(B-37), (A-95)+(B-38), (A-95)+(B-39), (A-95)+(B-40), (A-95)+(B-41), (A-95)+(B-42), (A-95)+(B-43), (A-95)+(B-44), (A-95)+(B-45), (A-95)+(B-46), (A-95)+(B-47), (A-95)+(B-48), (A-95)+(B-49), (A-95)+(B-50), (A-95)+(B-51), (A-95)+(B-52), (A-95)+(B-53), (A-95)+(B-54), (A-95)+(B-55), (A-95)+(B-56), (A-95)+(B-57), (A-95)+(B-58), (A-95)+(B-59), (A-95)+(B-60), (A-95)+(B-61), (A-95)+(B-62), (A-95)+(B-63), (A-95)+(B-64), (A-95)+(B-65), (A-95)+(B-66), (A-95)+(B-67), (A-95)+(B-68), (A-95)+(B-69), (A-95)+(B-70), (A-95)+(B-71), (A-95)+(B-72), (A-95)+(B-73), (A-95)+(B-74), (A-95)+(B-75), (A-95)+(B-76), (A-95)+(B-77), (AI-1)+(B-78), (A-95)+(B-79), (A-95)+(B-80).

(A-96)+(B-1), (A-96)+(B-2), (A-96)+(B-3), (A-96)+(B-4), (A-96)+(B-5), (A-96)+(B-6), (A-96)+(B-7), (A-96)+(B-8), (A-96)+(B-9), (A-96)+(B-10), (A-96)+(B-11), (A-96)+(B-12), (A-96)+(B-13), (A-96)+(B-14), (A-96)+(B-15), (A-96)+(B-16), (A-96)+(B-17), (A-96)+(B-18), (A-96)+(B-19), (A-96)+(B-20), (A-96)+(B-21), (A-96)+(B-22), (A-96)+(B-23), (A-96)+(B-24), (A-96)+(B-25), (A-96)+(B-26), (A-96)+(B-27), (A-96)+(B-28), (A-96)+(B-29), (A-96)+(B-30), (A-96)+(B-31), (A-96)+(B-32), (A-96)+(B-33), (A-96)+(B-34), (A-96)+(B-35), (A-96)+(B-36), (A-96)+(B-37), (A-96)+(B-38), (A-96)+(B-39), (A-96)+(B-40), (A-96)+(B-41), (A-96)+(B-42), (A-96)+(B-43), (A-96)+(B-44), (A-96)+(B-45), (A-96)+(B-46), (A-96)+(B-47), (A-96)+(B-48), (A-96)+(B-49), (A-96)+(B-50), (A-96)+(B-51), (A-96)+(B-52), (A-96)+(B-53), (A-96)+(B-54), (A-96)+(B-55), (A-96)+(B-56), (A-96)+(B-57), (A-96)+(B-58), (A-96)+(B-59), (A-96)+(B-60), (A-96)+(B-61), (A-96)+(B-62), (A-96)+(B-63), (A-96)+(B-64), (A-96)+(B-65), (A-96)+(B-66), (A-96)+(B-67), (A-96)+(B-68), (A-96)+(B-69), (A-96)+(B-70), (A-96)+(B-71), (A-96)+(B-72), (A-96)+(B-73), (A-96)+(B-74), (A-96)+(B-75), (A-96)+(B-76), (A-96)+(B-77), (AI-1)+(B-78), (A-96)+(B-79), (A-96)+(B-80).

(A-97)+(B-1), (A-97)+(B-2), (A-97)+(B-3), (A-97)+(B-4), (A-97)+(B-5), (A-97)+(B-6), (A-97)+(B-7), (A-97)+(B-8), (A-97)+(B-9), (A-97)+(B-10), (A-97)+(B-11), (A-97)+(B-12), (A-97)+(B-13), (A-97)+(B-14), (A-97)+(B-15), (A-97)+(B-16), (A-97)+(B-17), (A-97)+(B-18), (A-97)+(B-19), (A-97)+(B-20), (A-97)+(B-21), (A-97)+(B-22), (A-97)+(B-23), (A-97)+(B-24), (A-97)+(B-25), (A-97)+(B-26), (A-97)+(B-27), (A-97)+(B-28), (A-97)+(B-29), (A-97)+(B-30), (A-97)+(B-31), (A-97)+(B-32), (A-97)+(B-33), (A-97)+(B-34), (A-97)+(B-35), (A-97)+(B-36), (A-97)+(B-37), (A-97)+(B-38), (A-97)+(B-39), (A-97)+(B-40), (A-97)+(B-41), (A-97)+(B-42), (A-97)+(B-43), (A-97)+(B-44), (A-97)+(B-45), (A-97)+(B-46), (A-97)+(B-47), (A-97)+(B-48), (A-97)+(B-49), (A-97)+(B-50), (A-97)+(B-51), (A-97)+(B-52), (A-97)+(B-53), (A-97)+(B-54), (A-97)+(B-55), (A-97)+(B-56), (A-97)+(B-57), (A-97)+(B-58), (A-97)+(B-59), (A-97)+(B-60), (A-97)+(B-61), (A-97)+(B-62), (A-97)+(B-63), (A-97)+(B-64), (A-97)+(B-65), (A-97)+(B-66), (A-97)+(B-67), (A-97)+(B-68), (A-97)+(B-69), (A-97)+(B-70), (A-97)+(B-71), (A-97)+(B-72), (A-97)+(B-73), (A-97)+(B-74), (A-97)+(B-75), (A-97)+(B-76), (A-97)+(B-77), (AI-1)+(B-78), (A-97)+(B-79), (A-97)+(B-80).

(A-98)+(B-1), (A-98)+(B-2), (A-98)+(B-3), (A-98)+(B-4), (A-98)+(B-5), (A-98)+(B-6), (A-98)+(B-7), (A-98)+(B-8), (A-98)+(B-9), (A-98)+(B-10), (A-98)+(B-11), (A-98)+(B-12), (A-98)+(B-13), (A-98)+(B-14), (A-98)+(B-15), (A-98)+(B-16), (A-98)+(B-17), (A-98)+(B-18), (A-98)+(B-19), (A-98)+(B-20), (A-98)+(B-21), (A-98)+(B-22), (A-98)+(B-23), (A-98)+(B-24), (A-98)+(B-25), (A-98)+(B-26), (A-98)+(B-27), (A-98)+(B-28), (A-98)+(B-29), (A-98)+(B-30), (A-98)+(B-31), (A-98)+(B-32), (A-98)+(B-33), (A-98)+(B-34), (A-98)+(B-35), (A-98)+(B-36), (A-98)+(B-37), (A-98)+(B-38), (A-98)+(B-39), (A-98)+(B-40), (A-98)+(B-41), (A-98)+(B-42), (A-98)+(B-43), (A-98)+(B-44), (A-98)+(B-45), (A-98)+(B-46), (A-98)+(B-47), (A-98)+(B-48), (A-98)+(B-49), (A-98)+(B-50), (A-98)+(B-51), (A-98)+(B-52), (A-98)+(B-53), (A-98)+(B-54), (A-98)+(B-55), (A-98)+(B-56), (A-98)+(B-57), (A-98)+(B-58), (A-98)+(B-59), (A-98)+(B-60), (A-98)+(B-61), (A-98)+(B-62), (A-98)+(B-63), (A-98)+(B-64), (A-98)+(B-65), (A-98)+(B-66), (A-98)+(B-67), (A-98)+(B-68), (A-98)+(B-69), (A-98)+(B-70), (A-98)+(B-71), (A-98)+(B-72), (A-98)+(B-73), (A-98)+(B-74), (A-98)+(B-75), (A-98)+(B-76), (A-98)+(B-77), (AI-1)+(B-78), (A-98)+(B-79), (A-98)+(B-80).

(A-99)+(B-1), (A-99)+(B-2), (A-99)+(B-3), (A-99)+(B-4), (A-99)+(B-5), (A-99)+(B-6), (A-99)+(B-7), (A-99)+(B-8), (A-99)+(B-9), (A-99)+(B-10), (A-99)+(B-11), (A-99)+(B-12), (A-99)+(B-13), (A-99)+(B-14), (A-99)+(B-15), (A-99)+(B-16), (A-99)+(B-17), (A-99)+(B-18), (A-99)+(B-19), (A-99)+(B-20), (A-99)+(B-21), (A-99)+(B-22), (A-99)+(B-23), (A-99)+(B-24), (A-99)+(B-25), (A-99)+(B-26), (A-99)+(B-27), (A-99)+(B-28), (A-99)+(B-29), (A-99)+(B-30), (A-99)+(B-31), (A-99)+(B-32), (A-99)+(B-33), (A-99)+(B-34), (A-99)+(B-35), (A-99)+(B-36), (A-99)+(B-37), (A-99)+(B-38), (A-99)+(B-39), (A-99)+(B-40), (A-99)+(B-41), (A-99)+(B-42), (A-99)+(B-43), (A-99)+(B-44), (A-99)+(B-45), (A-99)+(B-46), (A-99)+(B-47), (A-99)+(B-48), (A-99)+(B-49), (A-99)+(B-50), (A-99)+(B-51), (A-99)+(B-52), (A-99)+(B-53), (A-99)+(B-54), (A-99)+(B-55), (A-99)+(B-56), (A-99)+(B-57), (A-99)+(B-58), (A-99)+(B-59), (A-99)+(B-60), (A-99)+(B-61), (A-99)+(B-62), (A-99)+(B-63), (A-99)+(B-64), (A-99)+(B-65), (A-99)+(B-66), (A-99)+(B-67), (A-99)+(B-68), (A-99)+(B-69), (A-99)+(B-70), (A-99)+(B-71), (A-99)+(B-72), (A-99)+(B-73), (A-99)+(B-74), (A-99)+(B-75), (A-99)+(B-76), (A-99)+(B-77), (AI-1)+(B-78), (A-99)+(B-79), (A-99)+(B-80).

(A-100)+(B-1), (A-100)+(B-2), (A-100)+(B-3), (A-100)+(B-4), (A-100)+(B-5), (A-100)+(B-6), (A-100)+(B-7), (A-100)+(B-8), (A-100)+(B-9), (A-100)+(B-10), (A-100)+(B-11), (A-100)+(B-12), (A-100)+(B-13), (A-100)+(B-14), (A-100)+(B-15), (A-100)+(B-16), (A-100)+(B-17), (A-100)+(B-18), (A-100)+(B-19), (A-100)+(B-20), (A-100)+(B-21), (A-100)+(B-22), (A-100)+(B-23), (A-100)+(B-24), (A-100)+(B-25), (A-100)+(B-26), (A-100)+(B-27), (A-100)+(B-28), (A-100)+(B-29), (A-100)+(B-30), (A-100)+(B-31), (A-100)+(B-32), (A-100)+(B-33), (A-100)+(B-34), (A-100)+(B-35), (A-100)+(B-36), (A-100)+(B-37), (A-100)+(B-38), (A-100)+(B-39), (A-100)+(B-40), (A-100)+(B-41), (A-100)+(B-42), (A-100)+(B-43), (A-100)+(B-44), (A-100)+(B-45), (A-100)+(B-46), (A-100)+(B-47), (A-100)+(B-48), (A-100)+(B-49), (A-100)+(B-50), (A-100)+(B-51), (A-100)+(B-52), (A-100)+(B-53), (A-100)+(B-54), (A-100)+(B-55), (A-100)+(B-56), (A-100)+(B-57), (A-100)+(B-58), (A-100)+(B-59), (A-100)+(B-60), (A-100)+(B-61), (A-100)+(B-62), (A-100)+(B-63), (A-100)+(B-64), (A-100)+(B-65), (A-100)+(B-66), (A-100)+(B-67), (A-100)+(B-68), (A-100)+(B-69), (A-100)+(B-70), (A-100)+(B-71), (A-100)+(B-72), (A-100)+(B-73), (A-100)+(B-74), (A-100)+(B-75), (A-100)+(B-76), (A-100)+(B-77), (AI-1)+(B-78), (A-100)+(B-79), (A-100)+(B-80).

(A-101)+(B-1), (A-101)+(B-2), (A-101)+(B-3), (A-101)+(B-4), (A-101)+(B-5), (A-101)+(B-6), (A-101)+(B-7), (A-101)+(B-8), (A-101)+(B-9), (A-101)+(B-10), (A-101)+(B-11), (A-101)+(B-12), (A-101)+(B-13), (A-101)+(B-14), (A-101)+(B-15), (A-101)+(B-16), (A-101)+(B-17), (A-101)+(B-18), (A-101)+(B-19), (A-101)+(B-20), (A-101)+(B-21), (A-101)+(B-22), (A-101)+(B-23), (A-101)+(B-24), (A-101)+(B-25), (A-101)+(B-26), (A-101)+(B-27), (A-101)+(B-28), (A-101)+(B-29), (A-101)+(B-30), (A-101)+(B-31), (A-101)+(B-32), (A-101)+(B-33), (A-101)+(B-34), (A-101)+(B-35), (A-101)+(B-36), (A-101)+(B-37), (A-101)+(B-38), (A-101)+(B-39), (A-101)+(B-40), (A-101)+(B-41), (A-101)+(B-42), (A-101)+(B-43), (A-101)+(B-44), (A-101)+(B-45), (A-101)+(B-46), (A-101)+(B-47), (A-101)+(B-48), (A-101)+(B-49), (A-101)+(B-50), (A-101)+(B-51), (A-101)+(B-52), (A-101)+(B-53), (A-101)+(B-54), (A-101)+(B-55), (A-101)+(B-56), (A-101)+(B-57), (A-101)+(B-58), (A-101)+(B-59), (A-101)+(B-60), (A-101)+(B-61), (A-101)+(B-62), (A-101)+(B-63), (A-101)+(B-64), (A-101)+(B-65), (A-101)+(B-66), (A-101)+(B-67), (A-101)+(B-68), (A-101)+(B-69), (A-101)+(B-70), (A-101)+(B-71), (A-101)+(B-72), (A-101)+(B-73), (A-101)+(B-74), (A-101)+(B-75), (A-101)+(B-76), (A-101)+(B-77), (AI-1)+(B-78), (A-101)+(B-79), (A-101)+(B-80).

(A-102)+(B-1), (A-102)+(B-2), (A-102)+(B-3), (A-102)+(B-4), (A-102)+(B-5), (A-102)+(B-6), (A-102)+(B-7), (A-102)+(B-8), (A-102)+(B-9), (A-102)+(B-10), (A-102)+(B-11), (A-102)+(B-12), (A-102)+(B-13), (A-102)+(B-14), (A-102)+(B-15), (A-102)+(B-16), (A-102)+(B-17), (A-102)+(B-18), (A-102)+(B-19), (A-102)+(B-20), (A-102)+(B-21), (A-102)+(B-22), (A-102)+(B-23), (A-102)+(B-24), (A-102)+(B-25), (A-102)+(B-26), (A-102)+(B-27), (A-102)+(B-28), (A-102)+(B-29), (A-102)+(B-30), (A-102)+(B-31), (A-102)+(B-32), (A-102)+(B-33), (A-102)+(B-34), (A-102)+(B-35), (A-102)+(B-36), (A-102)+(B-37), (A-102)+(B-38), (A-102)+(B-39), (A-102)+(B-40), (A-102)+(B-41), (A-102)+(B-42), (A-102)+(B-43), (A-102)+(B-44), (A-102)+(B-45), (A-102)+(B-46), (A-102)+(B-47), (A-102)+(B-48), (A-102)+(B-49), (A-102)+(B-50), (A-102)+(B-51), (A-102)+(B-52), (A-102)+(B-53), (A-102)+(B-54), (A-102)+(B-55), (A-102)+(B-56), (A-102)+(B-57), (A-102)+(B-58), (A-102)+(B-59), (A-102)+(B-60), (A-102)+(B-61), (A-102)+(B-62), (A-102)+(B-63), (A-102)+(B-64), (A-102)+(B-65), (A-102)+(B-66), (A-102)+(B-67), (A-102)+(B-68), (A-102)+(B-69), (A-102)+(B-70), (A-102)+(B-71), (A-102)+(B-72), (A-102)+(B-73), (A-102)+(B-74), (A-102)+(B-75), (A-102)+(B-76), (A-102)+(B-77), (AI-1)+(B-78), (A-102)+(B-79), (A-102)+(B-80).

(A-103)+(B-1), (A-103)+(B-2), (A-103)+(B-3), (A-103)+(B-4), (A-103)+(B-5), (A-103)+(B-6), (A-103)+(B-7), (A-103)+(B-8), (A-103)+(B-9), (A-103)+(B-10), (A-103)+(B-11), (A-103)+(B-12), (A-103)+(B-13), (A-103)+(B-14), (A-103)+(B-15), (A-103)+(B-16), (A-103)+(B-17), (A-103)+(B-18), (A-103)+(B-19), (A-103)+(B-20), (A-103)+(B-21), (A-103)+(B-22), (A-103)+(B-23), (A-103)+(B-24), (A-103)+(B-25), (A-103)+(B-26), (A-103)+(B-27), (A-103)+(B-28), (A-103)+(B-29), (A-103)+(B-30), (A-103)+(B-31), (A-103)+(B-32), (A-103)+(B-33), (A-103)+(B-34), (A-103)+(B-35), (A-103)+(B-36), (A-103)+(B-37), (A-103)+(B-38), (A-103)+(B-39), (A-103)+(B-40), (A-103)+(B-41), (A-103)+(B-42), (A-103)+(B-43), (A-103)+(B-44), (A-103)+(B-45), (A-103)+(B-46), (A-103)+(B-47), (A-103)+(B-48), (A-103)+(B-49), (A-103)+(B-50), (A-103)+(B-51), (A-103)+(B-52), (A-103)+(B-53), (A-103)+(B-54), (A-103)+(B-55), (A-103)+(B-56), (A-103)+(B-57), (A-103)+(B-58), (A-103)+(B-59), (A-103)+(B-60), (A-103)+(B-61), (A-103)+(B-62), (A-103)+(B-63), (A-103)+(B-64), (A-103)+(B-65), (A-103)+(B-66), (A-103)+(B-67), (A-103)+(B-68), (A-103)+(B-69), (A-103)+(B-70), (A-103)+(B-71), (A-103)+(B-72), (A-103)+(B-73), (A-103)+(B-74), (A-103)+(B-75), (A-103)+(B-76), (A-103)+(B-77), (AI-1)+(B-78), (A-103)+(B-79), (A-103)+(B-80).

(A-104)+(B-1), (A-104)+(B-2), (A-104)+(B-3), (A-104)+(B-4), (A-104)+(B-5), (A-104)+(B-6), (A-104)+(B-7), (A-104)+(B-8), (A-104)+(B-9), (A-104)+(B-10), (A-104)+(B-11), (A-104)+(B-12), (A-104)+(B-13), (A-104)+(B-14), (A-104)+(B-15), (A-104)+(B-16), (A-104)+(B-17), (A-104)+(B-18), (A-104)+(B-19), (A-104)+(B-20), (A-104)+(B-21), (A-104)+(B-22), (A-104)+(B-23), (A-104)+(B-24), (A-104)+(B-25), (A-104)+(B-26), (A-104)+(B-27), (A-104)+(B-28), (A-104)+(B-29), (A-104)+(B-30), (A-104)+(B-31), (A-104)+(B-32), (A-104)+(B-33), (A-104)+(B-34), (A-104)+(B-35), (A-104)+(B-36), (A-104)+(B-37), (A-104)+(B-38), (A-104)+(B-39), (A-104)+(B-40), (A-104)+(B-41), (A-104)+(B-42), (A-104)+(B-43), (A-104)+(B-44), (A-104)+(B-45), (A-104)+(B-46), (A-104)+(B-47), (A-104)+(B-48), (A-104)+(B-49), (A-104)+(B-50), (A-104)+(B-51), (A-104)+(B-52), (A-104)+(B-53), (A-104)+(B-54), (A-104)+(B-55), (A-104)+(B-56), (A-104)+(B-57), (A-104)+(B-58), (A-104)+(B-59), (A-104)+(B-60), (A-104)+(B-61), (A-104)+(B-62), (A-104)+(B-63), (A-104)+(B-64), (A-104)+(B-65), (A-104)+(B-66), (A-104)+(B-67), (A-104)+(B-68), (A-104)+(B-69), (A-104)+(B-70), (A-104)+(B-71), (A-104)+(B-72), (A-104)+(B-73), (A-104)+(B-74), (A-104)+(B-75), (A-104)+(B-76), (A-104)+(B-77), (AI-1)+(B-78), (A-104)+(B-79), (A-104)+(B-80).

(A-105)+(B-1), (A-105)+(B-2), (A-105)+(B-3), (A-105)+(B-4), (A-105)+(B-5), (A-105)+(B-6), (A-105)+(B-7), (A-105)+(B-8), (A-105)+(B-9), (A-105)+(B-10), (A-105)+(B-11), (A-105)+(B-12), (A-105)+(B-13), (A-105)+(B-14), (A-105)+(B-15), (A-105)+(B-16), (A-105)+(B-17), (A-105)+(B-18), (A-105)+(B-19), (A-105)+(B-20), (A-105)+(B-21), (A-105)+(B-22), (A-105)+(B-23), (A-105)+(B-24), (A-105)+(B-25), (A-105)+(B-26), (A-105)+(B-27), (A-105)+(B-28), (A-105)+(B-29), (A-105)+(B-30), (A-105)+(B-31), (A-105)+(B-32), (A-105)+(B-33), (A-105)+(B-34), (A-105)+(B-35), (A-105)+(B-36), (A-105)+(B-37), (A-105)+(B-38), (A-105)+(B-39), (A-105)+(B-40), (A-105)+(B-41), (A-105)+(B-42), (A-105)+(B-43), (A-105)+(B-44), (A-105)+(B-45), (A-105)+(B-46), (A-105)+(B-47), (A-105)+(B-48), (A-105)+(B-49), (A-105)+(B-50), (A-105)+(B-51), (A-105)+(B-52), (A-105)+(B-53), (A-105)+(B-54), (A-105)+(B-55), (A-105)+(B-56), (A-105)+(B-57), (A-105)+(B-58), (A-105)+(B-59), (A-105)+(B-60), (A-105)+(B-61), (A-105)+(B-62), (A-105)+(B-63), (A-105)+(B-64), (A-105)+(B-65), (A-105)+(B-66), (A-105)+(B-67), (A-105)+(B-68), (A-105)+(B-69), (A-105)+(B-70), (A-105)+(B-71), (A-105)+(B-72), (A-105)+(B-73), (A-105)+(B-74), (A-105)+(B-75), (A-105)+(B-76), (A-105)+(B-77), (AI-1)+(B-78), (A-105)+(B-79), (A-105)+(B-80).

(A-106)+(B-1), (A-106)+(B-2), (A-106)+(B-3), (A-106)+(B-4), (A-106)+(B-5), (A-106)+(B-6), (A-106)+(B-7), (A-106)+(B-8), (A-106)+(B-9), (A-106)+(B-10), (A-106)+(B-11), (A-106)+(B-12), (A-106)+(B-13), (A-106)+(B-14), (A-106)+(B-15), (A-106)+(B-16), (A-106)+(B-17), (A-106)+(B-18), (A-106)+(B-19), (A-106)+(B-20), (A-106)+(B-21), (A-106)+(B-22), (A-106)+(B-23), (A-106)+(B-24), (A-106)+(B-25), (A-106)+(B-26), (A-106)+(B-27), (A-106)+(B-28), (A-106)+(B-29), (A-106)+(B-30), (A-106)+(B-31), (A-106)+(B-32), (A-106)+(B-33), (A-106)+(B-34), (A-106)+(B-35), (A-106)+(B-36), (A-106)+(B-37), (A-106)+(B-38), (A-106)+(B-39), (A-106)+(B-40), (A-106)+(B-41), (A-106)+(B-42), (A-106)+(B-43), (A-106)+(B-44), (A-106)+(B-45), (A-106)+(B-46), (A-106)+(B-47), (A-106)+(B-48), (A-106)+(B-49), (A-106)+(B-50), (A-106)+(B-51), (A-106)+(B-52), (A-106)+(B-53), (A-106)+(B-54), (A-106)+(B-55), (A-106)+(B-56), (A-106)+(B-57), (A-106)+(B-58), (A-106)+(B-59), (A-106)+(B-60), (A-106)+(B-61), (A-106)+(B-62), (A-106)+(B-63), (A-106)+(B-64), (A-106)+(B-65), (A-106)+(B-66), (A-106)+(B-67), (A-106)+(B-68), (A-106)+(B-69), (A-106)+(B-70), (A-106)+(B-71), (A-106)+(B-72), (A-106)+(B-73), (A-106)+(B-74), (A-106)+(B-75), (A-106)+(B-76), (A-106)+(B-77), (AI-1)+(B-78), (A-106)+(B-79), (A-106)+(B-80).

(A-107)+(B-1), (A-107)+(B-2), (A-107)+(B-3), (A-107)+(B-4), (A-107)+(B-5), (A-107)+(B-6), (A-107)+(B-7), (A-107)+(B-8), (A-107)+(B-9), (A-107)+(B-10), (A-107)+(B-11), (A-107)+(B-12), (A-107)+(B-13), (A-107)+(B-14), (A-107)+(B-15), (A-107)+(B-16), (A-107)+(B-17), (A-107)+(B-18), (A-107)+(B-19), (A-107)+(B-20), (A-107)+(B-21), (A-107)+(B-22), (A-107)+(B-23), (A-107)+(B-24), (A-107)+(B-25), (A-107)+(B-26), (A-107)+(B-27), (A-107)+(B-28), (A-107)+(B-29), (A-107)+(B-30), (A-107)+(B-31), (A-107)+(B-32), (A-107)+(B-33), (A-107)+(B-34), (A-107)+(B-35), (A-107)+(B-36), (A-107)+(B-37), (A-107)+(B-38), (A-107)+(B-39), (A-107)+(B-40), (A-107)+(B-41), (A-107)+(B-42), (A-107)+(B-43), (A-107)+(B-44), (A-107)+(B-45), (A-107)+(B-46), (A-107)+(B-47), (A-107)+(B-48), (A-107)+(B-49), (A-107)+(B-50), (A-107)+(B-51), (A-107)+(B-52), (A-107)+(B-53), (A-107)+(B-54), (A-107)+(B-55), (A-107)+(B-56), (A-107)+(B-57), (A-107)+(B-58), (A-107)+(B-59), (A-107)+(B-60), (A-107)+(B-61), (A-107)+(B-62), (A-107)+(B-63), (A-107)+(B-64), (A-107)+(B-65), (A-107)+(B-66), (A-107)+(B-67), (A-107)+(B-68), (A-107)+(B-69), (A-107)+(B-70), (A-107)+(B-71), (A-107)+(B-72), (A-107)+(B-73), (A-107)+(B-74), (A-107)+(B-75), (A-107)+(B-76), (A-107)+(B-77), (AI-1)+(B-78), (A-107)+(B-79), (A-107)+(B-80).

(A-108)+(B-1), (A-108)+(B-2), (A-108)+(B-3), (A-108)+(B-4), (A-108)+(B-5), (A-108)+(B-6), (A-108)+(B-7), (A-108)+(B-8), (A-108)+(B-9), (A-108)+(B-10), (A-108)+(B-11), (A-108)+(B-12), (A-108)+(B-13), (A-108)+(B-14), (A-108)+(B-15), (A-108)+(B-16), (A-108)+(B-17), (A-108)+(B-18), (A-108)+(B-19), (A-108)+(B-20), (A-108)+(B-21), (A-108)+(B-22), (A-108)+(B-23), (A-108)+(B-24), (A-108)+(B-25), (A-108)+(B-26), (A-108)+(B-27), (A-108)+(B-28), (A-108)+(B-29), (A-108)+(B-30), (A-108)+(B-31), (A-108)+(B-32), (A-108)+(B-33), (A-108)+(B-34), (A-108)+(B-35), (A-108)+(B-36), (A-108)+(B-37), (A-108)+(B-38), (A-108)+(B-39), (A-108)+(B-40), (A-108)+(B-41), (A-108)+(B-42), (A-108)+(B-43), (A-108)+(B-44), (A-108)+(B-45), (A-108)+(B-46), (A-108)+(B-47), (A-108)+(B-48), (A-108)+(B-49), (A-108)+(B-50), (A-108)+(B-51), (A-108)+(B-52), (A-108)+(B-53), (A-108)+(B-54), (A-108)+(B-55), (A-108)+(B-56), (A-108)+(B-57), (A-108)+(B-58), (A-108)+(B-59), (A-108)+(B-60), (A-108)+(B-61), (A-108)+(B-62), (A-108)+(B-63), (A-108)+(B-64), (A-108)+(B-65), (A-108)+(B-66), (A-108)+(B-67), (A-108)+(B-68), (A-108)+(B-69), (A-108)+(B-70), (A-108)+(B-71), (A-108)+(B-72), (A-108)+(B-73), (A-108)+(B-74), (A-108)+(B-75), (A-108)+(B-76), (A-108)+(B-77), (AI-1)+(B-78), (A-108)+(B-79), (A-108)+(B-80).

(A-109)+(B-1), (A-109)+(B-2), (A-109)+(B-3), (A-109)+(B-4), (A-109)+(B-5), (A-109)+(B-6), (A-109)+(B-7), (A-109)+(B-8), (A-109)+(B-9), (A-109)+(B-10), (A-109)+(B-11), (A-109)+(B-12), (A-109)+(B-13), (A-109)+(B-14), (A-109)+(B-15), (A-109)+(B-16), (A-109)+(B-17), (A-109)+(B-18), (A-109)+(B-19), (A-109)+(B-20), (A-109)+(B-21), (A-109)+(B-22), (A-109)+(B-23), (A-109)+(B-24), (A-109)+(B-25), (A-109)+(B-26), (A-109)+(B-27), (A-109)+(B-28), (A-109)+(B-29), (A-109)+(B-30), (A-109)+(B-31), (A-109)+(B-32), (A-109)+(B-33), (A-109)+(B-34), (A-109)+(B-35), (A-109)+(B-36), (A-109)+(B-37), (A-109)+(B-38), (A-109)+(B-39), (A-109)+(B-40), (A-109)+(B-41), (A-109)+(B-42), (A-109)+(B-43), (A-109)+(B-44), (A-109)+(B-45), (A-109)+(B-46), (A-109)+(B-47), (A-109)+(B-48), (A-109)+(B-49), (A-109)+(B-50), (A-109)+(B-51), (A-109)+(B-52), (A-109)+(B-53), (A-109)+(B-54), (A-109)+(B-55), (A-109)+(B-56), (A-109)+(B-57), (A-109)+(B-58), (A-109)+(B-59), (A-109)+(B-60), (A-109)+(B-61), (A-109)+(B-62), (A-109)+(B-63), (A-109)+(B-64), (A-109)+(B-65), (A-109)+(B-66), (A-109)+(B-67), (A-109)+(B-68), (A-109)+(B-69), (A-109)+(B-70), (A-109)+(B-71), (A-109)+(B-72), (A-109)+(B-73), (A-109)+(B-74), (A-109)+(B-75), (A-109)+(B-76), (A-109)+(B-77), (AI-1)+(B-78), (A-109)+(B-79), (A-109)+(B-80).

(A-110)+(B-1), (A-110)+(B-2), (A-110)+(B-3), (A-110)+(B-4), (A-110)+(B-5), (A-110)+(B-6), (A-110)+(B-7), (A-110)+(B-8), (A-110)+(B-9), (A-110)+(B-10), (A-110)+(B-11), (A-110)+(B-12), (A-110)+(B-13), (A-110)+(B-14), (A-110)+(B-15), (A-110)+(B-16), (A-110)+(B-17), (A-110)+(B-18), (A-110)+(B-19), (A-110)+(B-20), (A-110)+(B-21), (A-110)+(B-22), (A-110)+(B-23), (A-110)+(B-24), (A-110)+(B-25), (A-110)+(B-26), (A-110)+(B-27), (A-110)+(B-28), (A-110)+(B-29), (A-10)+(B-30), (A-110)+(B-31), (A-110)+(B-32), (A-110)+(B-33), (A-110)+(B-34), (A-110)+(B-35), (A-110)+(B-36), (A-110)+(B-37), (A-110)+(B-38), (A-110)+(B-39), (A-110)+(B-40), (A-110)+(B-41), (A-110)+(B-42), (A-110)+(B-43), (A-110)+(B-44), (A-110)+(B-45), (A-110)+(B-46), (A-110)+(B-47), (A-110)+(B-48), (A-110)+(B-49), (A-110)+(B-50), (A-110)+(B-51), (A-110)+(B-52), (A-110)+(B-53), (A-110)+(B-54), (A-110)+(B-55), (A-110)+(B-56), (A-110)+(B-57), (A-110)+(B-58), (A-110)+(B-59), (A-110)+(B-60), (A-110)+(B-61), (A-110)+(B-62), (A-110)+(B-63), (A-110)+(B-64), (A-110)+(B-65), (A-110)+(B-66), (A-110)+(B-67), (A-110)+(B-68), (A-110)+(B-69), (A-110)+(B-70), (A-110)+(B-71), (A-110)+(B-72), (A-110)+(B-73), (A-110)+(B-74), (A-110)+(B-75), (A-110)+(B-76), (A-110)+(B-77), (AI-1)+(B-78), (A-110)+(B-79), (A-110)+(B-80).

(A-111)+(B-1), (A-111)+(B-2), (A-111)+(B-3), (A-111)+(B-4), (A-111)+(B-5), (A-111)+(B-6), (A-111)+(B-7), (A-111)+(B-8), (A-111)+(B-9), (A-111)+(B-10), (A-111)+(B-11), (A-111)+(B-12), (A-111)+(B-13), (A-111)+(B-14), (A-111)+(B-15), (A-111)+(B-16), (A-111)+(B-17), (A-111)+(B-18), (A-111)+(B-19), (A-111)+(B-20), (A-111)+(B-21), (A-111)+(B-22), (A-111)+(B-23), (A-111)+(B-24), (A-111)+(B-25), (A-111)+(B-26), (A-111)+(B-27), (A-111)+(B-28), (A-111)+(B-29), (A-111)+(B-30), (A-111)+(B-31), (A-111)+(B-32), (A-111)+(B-33), (A-111)+(B-34), (A-111)+(B-35), (A-111)+(B-36), (A-111)+(B-37), (A-111)+(B-38), (A-111)+(B-39), (A-111)+(B-40), (A-111)+(B-41), (A-111)+(B-42), (A-111)+(B-43), (A-111)+(B-44), (A-111)+(B-45), (A-111)+(B-46), (A-111)+(B-47), (A-111)+(B-48), (A-111)+(B-49), (A-111)+(B-50), (A-111)+(B-51), (A-111)+(B-52), (A-111)+(B-53), (A-111)+(B-54), (A-111)+(B-55), (A-111)+(B-56), (A-111)+(B-57), (A-111)+(B-58), (A-111)+(B-59), (A-111)+(B-60), (A-111)+(B-61), (A-111)+(B-62), (A-111)+(B-63), (A-111)+(B-64), (A-111)+(B-65), (A-111)+(B-66), (A-111)+(B-67), (A-111)+(B-68), (A-111)+(B-69), (A-111)+(B-70), (A-111)+(B-71), (A-111)+(B-72), (A-111)+(B-73), (A-111)+(B-74), (A-111)+(B-75), (A-111)+(B-76), (A-111)+(B-77), (AI-1)+(B-78), (A-111)+(B-79), (A-111)+(B-80).

(A-112)+(B-1), (A-112)+(B-2), (A-112)+(B-3), (A-112)+(B-4), (A-112)+(B-5), (A-112)+(B-6), (A-112)+(B-7), (A-112)+(B-8), (A-112)+(B-9), (A-112)+(B-10), (A-112)+(B-11), (A-112)+(B-12), (A-112)+(B-13), (A-112)+(B-14), (A-112)+(B-15), (A-112)+(B-16), (A-112)+(B-17), (A-112)+(B-18), (A-112)+(B-19), (A-112)+(B-20), (A-112)+(B-21), (A-112)+(B-22), (A-112)+(B-23), (A-112)+(B-24), (A-112)+(B-25), (A-112)+(B-26), (A-112)+(B-27), (A-112)+(B-28), (A-112)+(B-29), (A-112)+(B-30), (A-112)+(B-31), (A-112)+(B-32), (A-112)+(B-33), (A-112)+(B-34), (A-112)+(B-35), (A-112)+(B-36), (A-112)+(B-37), (A-112)+(B-38), (A-112)+(B-39), (A-112)+(B-40), (A-112)+(B-41), (A-112)+(B-42), (A-112)+(B-43), (A-112)+(B-44), (A-112)+(B-45), (A-112)+(B-46), (A-112)+(B-47), (A-112)+(B-48), (A-112)+(B-49), (A-112)+(B-50), (A-112)+(B-51), (A-112)+(B-52), (A-112)+(B-53), (A-112)+(B-54), (A-112)+(B-55), (A-112)+(B-56), (A-112)+(B-57), (A-112)+(B-58), (A-112)+(B-59), (A-112)+(B-60), (A-112)+(B-61), (A-112)+(B-62), (A-112)+(B-63), (A-112)+(B-64), (A-112)+(B-65), (A-112)+(B-66), (A-112)+(B-67), (A-112)+(B-68), (A-112)+(B-69), (A-112)+(B-70), (A-112)+(B-71), (A-112)+(B-72), (A-112)+(B-73), (A-112)+(B-74), (A-112)+(B-75), (A-112)+(B-76), (A-112)+(B-77), (AI-1)+(B-78), (A-112)+(B-79), (A-112)+(B-80).

(A-113)+(B-1), (A-113)+(B-2), (A-113)+(B-3), (A-113)+(B-4), (A-113)+(B-5), (A-113)+(B-6), (A-113)+(B-7), (A-113)+(B-8), (A-113)+(B-9), (A-113)+(B-10), (A-113)+(B-11), (A-113)+(B-12), (A-113)+(B-13), (A-113)+(B-14), (A-113)+(B-15), (A-113)+(B-16), (A-113)+(B-17), (A-113)+(B-18), (A-113)+(B-19), (A-113)+(B-20), (A-113)+(B-21), (A-113)+(B-22), (A-113)+(B-23), (A-113)+(B-24), (A-113)+(B-25), (A-113)+(B-26), (A-113)+(B-27), (A-113)+(B-28), (A-113)+(B-29), (A-113)+(B-30), (A-113)+(B-31), (A-113)+(B-32), (A-113)+(B-33), (A-113)+(B-34), (A-113)+(B-35), (A-113)+(B-36), (A-113)+(B-37), (A-113)+(B-38), (A-113)+(B-39), (A-113)+(B-40), (A-113)+(B-41), (A-113)+(B-42), (A-113)+(B-43), (A-113)+(B-44), (A-113)+(B-45), (A-113)+(B-46), (A-113)+(B-47), (A-113)+(B-48), (A-113)+(B-49), (A-113)+(B-50), (A-113)+(B-51), (A-113)+(B-52), (A-113)+(B-53), (A-113)+(B-54), (A-113)+(B-55), (A-113)+(B-56), (A-113)+(B-57), (A-113)+(B-58), (A-113)+(B-59), (A-113)+(B-60), (A-113)+(B-61), (A-113)+(B-62), (A-113)+(B-63), (A-113)+(B-64), (A-113)+(B-65), (A-113)+(B-66), (A-113)+(B-67), (A-113)+(B-68), (A-113)+(B-69), (A-113)+(B-70), (A-113)+(B-71), (A-113)+(B-72), (A-113)+(B-73), (A-113)+(B-74), (A-113)+(B-75), (A-113)+(B-76), (A-113)+(B-77), (AI-1)+(B-78), (A-113)+(B-79), (A-113)+(B-80).

(A-114)+(B-1), (A-114)+(B-2), (A-114)+(B-3), (A-114)+(B-4), (A-114)+(B-5), (A-114)+(B-6), (A-114)+(B-7), (A-114)+(B-8), (A-114)+(B-9), (A-114)+(B-10), (A-114)+(B-11), (A-114)+(B-12), (A-114)+(B-13), (A-114)+(B-14), (A-114)+(B-15), (A-114)+(B-16), (A-114)+(B-17), (A-114)+(B-18), (A-114)+(B-19), (A-114)+(B-20), (A-114)+(B-21), (A-114)+(B-22), (A-114)+(B-23), (A-114)+(B-24), (A-114)+(B-25), (A-114)+(B-26), (A-114)+(B-27), (A-114)+(B-28), (A-114)+(B-29), (A-114)+(B-30), (A-114)+(B-31), (A-114)+(B-32), (A-114)+(B-33), (A-114)+(B-34), (A-114)+(B-35), (A-114)+(B-36), (A-114)+(B-37), (A-114)+(B-38), (A-114)+(B-39), (A-114)+(B-40), (A-114)+(B-41), (A-114)+(B-42), (A-114)+(B-43), (A-114)+(B-44), (A-114)+(B-45), (A-114)+(B-46), (A-114)+(B-47), (A-114)+(B-48), (A-114)+(B-49), (A-114)+(B-50), (A-114)+(B-51), (A-114)+(B-52), (A-114)+(B-53), (A-114)+(B-54), (A-114)+(B-55), (A-114)+(B-56), (A-114)+(B-57), (A-114)+(B-58), (A-114)+(B-59), (A-114)+(B-60), (A-114)+(B-61), (A-114)+(B-62), (A-114)+(B-63), (A-114)+(B-64), (A-114)+(B-65), (A-114)+(B-66), (A-114)+(B-67), (A-114)+(B-68), (A-114)+(B-69), (A-114)+(B-70), (A-114)+(B-71), (A-114)+(B-72), (A-114)+(B-73), (A-114)+(B-74), (A-114)+(B-75), (A-114)+(B-76), (A-114)+(B-77), (AI-1)+(B-78), (A-114)+(B-79), (A-114)+(B-80).

(A-115)+(B-1), (A-115)+(B-2), (A-115)+(B-3), (A-115)+(B-4), (A-115)+(B-5), (A-115)+(B-6), (A-115)+(B-7), (A-115)+(B-8), (A-115)+(B-9), (A-115)+(B-10), (A-115)+(B-11), (A-115)+(B-12), (A-115)+(B-13), (A-115)+(B-14), (A-115)+(B-15), (A-115)+(B-16), (A-115)+(B-17), (A-115)+(B-18), (A-115)+(B-19), (A-115)+(B-20), (A-115)+(B-21), (A-115)+(B-22), (A-115)+(B-23), (A-115)+(B-24), (A-115)+(B-25), (A-115)+(B-26), (A-115)+(B-27), (A-115)+(B-28), (A-115)+(B-29), (A-115)+(B-30), (A-115)+(B-31), (A-115)+(B-32), (A-115)+(B-33), (A-115)+(B-34), (A-115)+(B-35), (A-115)+(B-36), (A-115)+(B-37), (A-115)+(B-38), (A-115)+(B-39), (A-115)+(B-40), (A-115)+(B-41), (A-115)+(B-42), (A-115)+(B-43), (A-115)+(B-44), (A-115)+(B-45), (A-115)+(B-46), (A-115)+(B-47), (A-115)+(B-48), (A-115)+(B-49), (A-115)+(B-50), (A-115)+(B-51), (A-115)+(B-52), (A-115)+(B-53), (A-115)+(B-54), (A-115)+(B-55), (A-115)+(B-56), (A-115)+(B-57), (A-115)+(B-58), (A-115)+(B-59), (A-115)+(B-60), (A-115)+(B-61), (A-115)+(B-62), (A-115)+(B-63), (A-115)+(B-64), (A-115)+(B-65), (A-115)+(B-66), (A-115)+(B-67), (A-115)+(B-68), (A-115)+(B-69), (A-115)+(B-70), (A-115)+(B-71), (A-115)+(B-72), (A-115)+(B-73), (A-115)+(B-74), (A-115)+(B-75), (A-115)+(B-76), (A-115)+(B-77), (AI-1)+(B-78), (A-115)+(B-79), (A-115)+(B-80).

(A-116)+(B-1), (A-116)+(B-2), (A-116)+(B-3), (A-116)+(B-4), (A-116)+(B-5), (A-116)+(B-6), (A-116)+(B-7), (A-116)+(B-8), (A-116)+(B-9), (A-116)+(B-10), (A-116)+(B-11), (A-116)+(B-12), (A-116)+(B-13), (A-116)+(B-14), (A-116)+(B-15), (A-116)+(B-16), (A-116)+(B-17), (A-116)+(B-18), (A-116)+(B-19), (A-116)+(B-20), (A-116)+(B-21), (A-116)+(B-22), (A-116)+(B-23), (A-116)+(B-24), (A-116)+(B-25), (A-116)+(B-26), (A-116)+(B-27), (A-116)+(B-28), (A-116)+(B-29), (A-116)+(B-30), (A-116)+(B-31), (A-116)+(B-32), (A-116)+(B-33), (A-116)+(B-34), (A-116)+(B-35), (A-116)+(B-36), (A-116)+(B-37), (A-116)+(B-38), (A-116)+(B-39), (A-116)+(B-40), (A-116)+(B-41), (A-116)+(B-42), (A-116)+(B-43), (A-116)+(B-44), (A-116)+(B-45), (A-116)+(B-46), (A-116)+(B-47), (A-116)+(B-48), (A-116)+(B-49), (A-116)+(B-50), (A-116)+(B-51), (A-116)+(B-52), (A-116)+(B-53), (A-116)+(B-54), (A-116)+(B-55), (A-116)+(B-56), (A-116)+(B-57), (A-116)+(B-58), (A-116)+(B-59), (A-116)+(B-60), (A-116)+(B-61), (A-116)+(B-62), (A-116)+(B-63), (A-116)+(B-64), (A-116)+(B-65), (A-116)+(B-66), (A-116)+(B-67), (A-116)+(B-68), (A-116)+(B-69), (A-116)+(B-70), (A-116)+(B-71), (A-116)+(B-72), (A-116)+(B-73), (A-116)+(B-74), (A-116)+(B-75), (A-116)+(B-76), (A-116)+(B-77), (AI-1)+(B-78), (A-116)+(B-79), (A-116)+(B-80).

(A-117)+(B-1), (A-117)+(B-2), (A-117)+(B-3), (A-117)+(B-4), (A-117)+(B-5), (A-117)+(B-6), (A-117)+(B-7), (A-117)+(B-8), (A-117)+(B-9), (A-117)+(B-10), (A-117)+(B-11), (A-117)+(B-12), (A-117)+(B-13), (A-117)+(B-14), (A-117)+(B-15), (A-117)+(B-16), (A-117)+(B-17), (A-117)+(B-18), (A-117)+(B-19), (A-117)+(B-20), (A-117)+(B-21), (A-117)+(B-22), (A-117)+(B-23), (A-117)+(B-24), (A-117)+(B-25), (A-117)+(B-26), (A-117)+(B-27), (A-117)+(B-28), (A-117)+(B-29), (A-117)+(B-30), (A-117)+(B-31), (A-117)+(B-32), (A-117)+(B-33), (A-117)+(B-34), (A-117)+(B-35), (A-117)+(B-36), (A-117)+(B-37), (A-117)+(B-38), (A-117)+(B-39), (A-117)+(B-40), (A-117)+(B-41), (A-117)+(B-42), (A-117)+(B-43), (A-117)+(B-44), (A-117)+(B-45), (A-117)+(B-46), (A-117)+(B-47), (A-117)+(B-48), (A-117)+(B-49), (A-117)+(B-50), (A-117)+(B-51), (A-117)+(B-52), (A-117)+(B-53), (A-117)+(B-54), (A-117)+(B-55), (A-117)+(B-56), (A-117)+(B-57), (A-117)+(B-58), (A-117)+(B-59), (A-117)+(B-60), (A-117)+(B-61), (A-117)+(B-62), (A-117)+(B-63), (A-117)+(B-64), (A-117)+(B-65), (A-117)+(B-66), (A-117)+(B-67), (A-117)+(B-68), (A-117)+(B-69), (A-117)+(B-70), (A-117)+(B-71), (A-117)+(B-72), (A-117)+(B-73), (A-117)+(B-74), (A-117)+(B-75), (A-117)+(B-76), (A-117)+(B-77), (AI-1)+(B-78), (A-117)+(B-79), (A-117)+(B-80).

(A-118)+(B-1), (A-118)+(B-2), (A-118)+(B-3), (A-118)+(B-4), (A-118)+(B-5), (A-118)+(B-6), (A-118)+(B-7), (A-118)+(B-8), (A-118)+(B-9), (A-118)+(B-10), (A-118)+(B-11), (A-118)+(B-12), (A-118)+(B-13), (A-118)+(B-14), (A-118)+(B-15), (A-118)+(B-16), (A-118)+(B-17), (A-118)+(B-18), (A-118)+(B-19), (A-118)+(B-20), (A-118)+(B-21), (A-118)+(B-22), (A-118)+(B-23), (A-118)+(B-24), (A-118)+(B-25), (A-118)+(B-26), (A-118)+(B-27), (A-118)+(B-28), (A-118)+(B-29), (A-118)+(B-30), (A-118)+(B-31), (A-118)+(B-32), (A-118)+(B-33), (A-118)+(B-34), (A-118)+(B-35), (A-118)+(B-36), (A-118)+(B-37), (A-118)+(B-38), (A-118)+(B-39), (A-118)+(B-40), (A-118)+(B-41), (A-118)+(B-42), (A-118)+(B-43), (A-118)+(B-44), (A-118)+(B-45), (A-118)+(B-46), (A-118)+(B-47), (A-118)+(B-48), (A-118)+(B-49), (A-118)+(B-50), (A-118)+(B-51), (A-118)+(B-52), (A-118)+(B-53), (A-118)+(B-54), (A-118)+(B-55), (A-118)+(B-56), (A-118)+(B-57), (A-118)+(B-58), (A-118)+(B-59), (A-118)+(B-60), (A-118)+(B-61), (A-118)+(B-62), (A-118)+(B-63), (A-118)+(B-64), (A-118)+(B-65), (A-118)+(B-66), (A-118)+(B-67), (A-118)+(B-68), (A-118)+(B-69), (A-118)+(B-70), (A-118)+(B-71), (A-118)+(B-72), (A-118)+(B-73), (A-118)+(B-74), (A-118)+(B-75), (A-118)+(B-76), (A-118)+(B-77), (AI-1)+(B-78), (A-118)+(B-79), (A-118)+(B-80).

(A-119)+(B-1), (A-119)+(B-2), (A-119)+(B-3), (A-119)+(B-4), (A-119)+(B-5), (A-119)+(B-6), (A-119)+(B-7), (A-119)+(B-8), (A-119)+(B-9), (A-119)+(B-10), (A-119)+(B-11), (A-119)+(B-12), (A-119)+(B-13), (A-119)+(B-14), (A-119)+(B-15), (A-119)+(B-16), (A-119)+(B-17), (A-119)+(B-18), (A-119)+(B-19), (A-119)+(B-20), (A-119)+(B-21), (A-119)+(B-22), (A-119)+(B-23), (A-119)+(B-24), (A-119)+(B-25), (A-119)+(B-26), (A-119)+(B-27), (A-119)+(B-28), (A-119)+(B-29), (A-119)+(B-30), (A-119)+(B-31), (A-119)+(B-32), (A-119)+(B-33), (A-119)+(B-34), (A-119)+(B-35), (A-119)+(B-36), (A-119)+(B-37), (A-119)+(B-38), (A-119)+(B-39), (A-119)+(B-40), (A-119)+(B-41), (A-119)+(B-42), (A-119)+(B-43), (A-119)+(B-44), (A-119)+(B-45), (A-119)+(B-46), (A-119)+(B-47), (A-119)+(B-48), (A-119)+(B-49), (A-119)+(B-50), (A-119)+(B-51), (A-119)+(B-52), (A-119)+(B-53), (A-119)+(B-54), (A-119)+(B-55), (A-119)+(B-56), (A-119)+(B-57), (A-119)+(B-58), (A-119)+(B-59), (A-119)+(B-60), (A-119)+(B-61), (A-119)+(B-62), (A-119)+(B-63), (A-119)+(B-64), (A-119)+(B-65), (A-119)+(B-66), (A-119)+(B-67), (A-119)+(B-68), (A-119)+(B-69), (A-119)+(B-70), (A-119)+(B-71), (A-119)+(B-72), (A-119)+(B-73), (A-119)+(B-74), (A-119)+(B-75), (A-119)+(B-76), (A-119)+(B-77), (AI-1)+(B-78), (A-119)+(B-79), (A-119)+(B-80).

(A-120)+(B-1), (A-120)+(B-2), (A-120)+(B-3), (A-120)+(B-4), (A-120)+(B-5), (A-120)+(B-6), (A-120)+(B-7), (A-120)+(B-8), (A-120)+(B-9), (A-120)+(B-10), (A-120)+(B-11), (A-120)+(B-12), (A-120)+(B-13), (A-120)+(B-14), (A-120)+(B-15), (A-120)+(B-16), (A-120)+(B-17), (A-120)+(B-18), (A-120)+(B-19), (A-120)+(B-20), (A-120)+(B-21), (A-120)+(B-22), (A-120)+(B-23), (A-120)+(B-24), (A-120)+(B-25), (A-120)+(B-26), (A-120)+(B-27), (A-120)+(B-28), (A-120)+(B-29), (A-120)+(B-30), (A-120)+(B-31), (A-120)+(B-32), (A-120)+(B-33), (A-120)+(B-34), (A-120)+(B-35), (A-120)+(B-36), (A-120)+(B-37), (A-120)+(B-38), (A-120)+(B-39), (A-120)+(B-40), (A-120)+(B-41), (A-120)+(B-42), (A-120)+(B-43), (A-120)+(B-44), (A-120)+(B-45), (A-120)+(B-46), (A-120)+(B-47), (A-120)+(B-48), (A-120)+(B-49), (A-120)+(B-50), (A-120)+(B-51), (A-120)+(B-52), (A-120)+(B-53), (A-120)+(B-54), (A-120)+(B-55), (A-120)+(B-56), (A-120)+(B-57), (A-120)+(B-58), (A-120)+(B-59), (A-120)+(B-60), (A-120)+(B-61), (A-120)+(B-62), (A-120)+(B-63), (A-120)+(B-64), (A-120)+(B-65), (A-120)+(B-66), (A-120)+(B-67), (A-120)+(B-68), (A-120)+(B-69), (A-120)+(B-70), (A-120)+(B-71), (A-120)+(B-72), (A-120)+(B-73), (A-120)+(B-74), (A-120)+(B-75), (A-120)+(B-76), (A-120)+(B-77), (AI-1)+(B-78), (A-120)+(B-79), (A-120)+(B-80).

(A-121)+(B-1), (A-121)+(B-2), (A-121)+(B-3), (A-121)+(B-4), (A-121)+(B-5), (A-121)+(B-6), (A-121)+(B-7), (A-121)+(B-8), (A-121)+(B-9), (A-121)+(B-10), (A-121)+(B-11), (A-121)+(B-12), (A-121)+(B-13), (A-121)+(B-14), (A-121)+(B-15), (A-121)+(B-16), (A-121)+(B-17), (A-121)+(B-18), (A-121)+(B-19), (A-121)+(B-20), (A-121)+(B-21), (A-121)+(B-22), (A-121)+(B-23), (A-121)+(B-24), (A-121)+(B-25), (A-121)+(B-26), (A-121)+(B-27), (A-121)+(B-28), (A-121)+(B-29), (A-121)+(B-30), (A-121)+(B-31), (A-121)+(B-32), (A-121)+(B-33), (A-121)+(B-34), (A-121)+(B-35), (A-121)+(B-36), (A-121)+(B-37), (A-121)+(B-38), (A-121)+(B-39), (A-121)+(B-40), (A-121)+(B-41), (A-121)+(B-42), (A-121)+(B-43), (A-121)+(B-44), (A-121)+(B-45), (A-121)+(B-46), (A-121)+(B-47), (A-121)+(B-48), (A-121)+(B-49), (A-121)+(B-50), (A-121)+(B-51), (A-121)+(B-52), (A-121)+(B-53), (A-121)+(B-54), (A-121)+(B-55), (A-121)+(B-56), (A-121)+(B-57), (A-121)+(B-58), (A-121)+(B-59), (A-121)+(B-60), (A-121)+(B-61), (A-121)+(B-62), (A-121)+(B-63), (A-121)+(B-64), (A-121)+(B-65), (A-121)+(B-66), (A-121)+(B-67), (A-121)+(B-68), (A-121)+(B-69), (A-121)+(B-70), (A-121)+(B-71), (A-121)+(B-72), (A-121)+(B-73), (A-121)+(B-74), (A-121)+(B-75), (A-121)+(B-76), (A-121)+(B-77), (AI-1)+(B-78), (A-121)+(B-79), (A-121)+(B-80).

(A-122)+(B-1), (A-122)+(B-2), (A-122)+(B-3), (A-122)+(B-4), (A-122)+(B-5), (A-122)+(B-6), (A-122)+(B-7), (A-122)+(B-8), (A-122)+(B-9), (A-122)+(B-10), (A-122)+(B-11), (A-122)+(B-12), (A-122)+(B-13), (A-122)+(B-14), (A-122)+(B-15), (A-122)+(B-16), (A-122)+(B-17), (A-122)+(B-18), (A-122)+(B-19), (A-122)+(B-20), (A-122)+(B-21), (A-122)+(B-22), (A-122)+(B-23), (A-122)+(B-24), (A-122)+(B-25), (A-122)+(B-26), (A-122)+(B-27), (A-122)+(B-28), (A-122)+(B-29), (A-122)+(B-30), (A-122)+(B-31), (A-122)+(B-32), (A-122)+(B-33), (A-122)+(B-34), (A-122)+(B-35), (A-122)+(B-36), (A-122)+(B-37), (A-122)+(B-38), (A-122)+(B-39), (A-122)+(B-40), (A-122)+(B-41), (A-122)+(B-42), (A-122)+(B-43), (A-122)+(B-44), (A-122)+(B-45), (A-122)+(B-46), (A-122)+(B-47), (A-122)+(B-48), (A-122)+(B-49), (A-122)+(B-50), (A-122)+(B-51), (A-122)+(B-52), (A-122)+(B-53), (A-122)+(B-54), (A-122)+(B-55), (A-122)+(B-56), (A-122)+(B-57), (A-122)+(B-58), (A-122)+(B-59), (A-122)+(B-60), (A-122)+(B-61), (A-122)+(B-62), (A-122)+(B-63), (A-122)+(B-64), (A-122)+(B-65), (A-122)+(B-66), (A-122)+(B-67), (A-122)+(B-68), (A-122)+(B-69), (A-122)+(B-70), (A-122)+(B-71), (A-122)+(B-72), (A-122)+(B-73), (A-122)+(B-74), (A-122)+(B-75), (A-122)+(B-76), (A-122)+(B-77), (AI-1)+(B-78), (A-122)+(B-79), (A-122)+(B-80).

(A-123)+(B-1), (A-123)+(B-2), (A-123)+(B-3), (A-123)+(B-4), (A-123)+(B-5), (A-123)+(B-6), (A-123)+(B-7), (A-123)+(B-8), (A-123)+(B-9), (A-123)+(B-10), (A-123)+(B-11), (A-123)+(B-12), (A-123)+(B-13), (A-123)+(B-14), (A-123)+(B-15), (A-123)+(B-16), (A-123)+(B-17), (A-123)+(B-18), (A-123)+(B-19), (A-123)+(B-20), (A-123)+(B-21), (A-123)+(B-22), (A-123)+(B-23), (A-123)+(B-24), (A-123)+(B-25), (A-123)+(B-26), (A-123)+(B-27), (A-123)+(B-28), (A-123)+(B-29), (A-123)+(B-30), (A-123)+(B-31), (A-123)+(B-32), (A-123)+(B-33), (A-123)+(B-34), (A-123)+(B-35), (A-123)+(B-36), (A-123)+(B-37), (A-123)+(B-38), (A-123)+(B-39), (A-123)+(B-40), (A-123)+(B-41), (A-123)+(B-42), (A-123)+(B-43), (A-123)+(B-44), (A-123)+(B-45), (A-123)+(B-46), (A-123)+(B-47), (A-123)+(B-48), (A-123)+(B-49), (A-123)+(B-50), (A-123)+(B-51), (A-123)+(B-52), (A-123)+(B-53), (A-123)+(B-54), (A-123)+(B-55), (A-123)+(B-56), (A-123)+(B-57), (A-123)+(B-58), (A-123)+(B-59), (A-123)+(B-60), (A-123)+(B-61), (A-123)+(B-62), (A-123)+(B-63), (A-123)+(B-64), (A-123)+(B-65), (A-123)+(B-66), (A-123)+(B-67), (A-123)+(B-68), (A-123)+(B-69), (A-123)+(B-70), (A-123)+(B-71), (A-123)+(B-72), (A-123)+(B-73), (A-123)+(B-74), (A-123)+(B-75), (A-123)+(B-76), (A-123)+(B-77), (AI-1)+(B-78), (A-123)+(B-79), (A-123)+(B-80).

(A-124)+(B-1), (A-124)+(B-2), (A-124)+(B-3), (A-124)+(B-4), (A-124)+(B-5), (A-124)+(B-6), (A-124)+(B-7), (A-124)+(B-8), (A-124)+(B-9), (A-124)+(B-10), (A-124)+(B-11), (A-124)+(B-12), (A-124)+(B-13), (A-124)+(B-14), (A-124)+(B-15), (A-124)+(B-16), (A-124)+(B-17), (A-124)+(B-18), (A-124)+(B-19), (A-124)+(B-20), (A-124)+(B-21), (A-124)+(B-22), (A-124)+(B-23), (A-124)+(B-24), (A-124)+(B-25), (A-124)+(B-26), (A-124)+(B-27), (A-124)+(B-28), (A-124)+(B-29), (A-124)+(B-30), (A-124)+(B-31), (A-124)+(B-32), (A-124)+(B-33), (A-124)+(B-34), (A-124)+(B-35), (A-124)+(B-36), (A-124)+(B-37), (A-124)+(B-38), (A-124)+(B-39), (A-124)+(B-40), (A-124)+(B-41), (A-124)+(B-42), (A-124)+(B-43), (A-124)+(B-44), (A-124)+(B-45), (A-124)+(B-46), (A-124)+(B-47), (A-124)+(B-48), (A-124)+(B-49), (A-124)+(B-50), (A-124)+(B-51), (A-124)+(B-52), (A-124)+(B-53), (A-124)+(B-54), (A-124)+(B-55), (A-124)+(B-56), (A-124)+(B-57), (A-124)+(B-58), (A-124)+(B-59), (A-124)+(B-60), (A-124)+(B-61), (A-124)+(B-62), (A-124)+(B-63), (A-124)+(B-64), (A-124)+(B-65), (A-124)+(B-66), (A-124)+(B-67), (A-124)+(B-68), (A-124)+(B-69), (A-124)+(B-70), (A-124)+(B-71), (A-124)+(B-72), (A-124)+(B-73), (A-124)+(B-74), (A-124)+(B-75), (A-124)+(B-76), (A-124)+(B-77), (AI-1)+(B-78), (A-124)+(B-79), (A-124)+(B-80).

(A-125)+(B-1), (A-125)+(B-2), (A-125)+(B-3), (A-125)+(B-4), (A-125)+(B-5), (A-125)+(B-6), (A-125)+(B-7), (A-125)+(B-8), (A-125)+(B-9), (A-125)+(B-10), (A-125)+(B-11), (A-125)+(B-12), (A-125)+(B-13), (A-125)+(B-14), (A-125)+(B-15), (A-125)+(B-16), (A-125)+(B-17), (A-125)+(B-18), (A-125)+(B-19), (A-125)+(B-20), (A-125)+(B-21), (A-125)+(B-22), (A-125)+(B-23), (A-125)+(B-24), (A-125)+(B-25), (A-125)+(B-26), (A-125)+(B-27), (A-125)+(B-28), (A-125)+(B-29), (A-125)+(B-30), (A-125)+(B-31), (A-125)+(B-32), (A-125)+(B-33), (A-125)+(B-34), (A-125)+(B-35), (A-125)+(B-36), (A-125)+(B-37), (A-125)+(B-38), (A-125)+(B-39), (A-125)+(B-40), (A-125)+(B-41), (A-125)+(B-42), (A-125)+(B-43), (A-125)+(B-44), (A-125)+(B-45), (A-125)+(B-46), (A-125)+(B-47), (A-125)+(B-48), (A-125)+(B-49), (A-125)+(B-50), (A-125)+(B-51), (A-125)+(B-52), (A-125)+(B-53), (A-125)+(B-54), (A-125)+(B-55), (A-125)+(B-56), (A-125)+(B-57), (A-125)+(B-58), (A-125)+(B-59), (A-125)+(B-60), (A-125)+(B-61), (A-125)+(B-62), (A-125)+(B-63), (A-125)+(B-64), (A-125)+(B-65), (A-125)+(B-66), (A-125)+(B-67), (A-125)+(B-68), (A-125)+(B-69), (A-125)+(B-70), (A-125)+(B-71), (A-125)+(B-72), (A-125)+(B-73), (A-125)+(B-74), (A-125)+(B-75), (A-125)+(B-76), (A-125)+(B-77), (AI-1)+(B-78), (A-125)+(B-79), (A-125)+(B-80).

(A-126)+(B-1), (A-126)+(B-2), (A-126)+(B-3), (A-126)+(B-4), (A-126)+(B-5), (A-126)+(B-6), (A-126)+(B-7), (A-126)+(B-8), (A-126)+(B-9), (A-126)+(B-10), (A-126)+(B-11), (A-126)+(B-12), (A-126)+(B-13), (A-126)+(B-14), (A-126)+(B-15), (A-126)+(B-16), (A-126)+(B-17), (A-126)+(B-18), (A-126)+(B-19), (A-126)+(B-20), (A-126)+(B-21), (A-126)+(B-22), (A-126)+(B-23), (A-126)+(B-24), (A-126)+(B-25), (A-126)+(B-26), (A-126)+(B-27), (A-126)+(B-28), (A-126)+(B-29), (A-126)+(B-30), (A-126)+(B-31), (A-126)+(B-32), (A-126)+(B-33), (A-126)+(B-34), (A-126)+(B-35), (A-126)+(B-36), (A-126)+(B-37), (A-126)+(B-38), (A-126)+(B-39), (A-126)+(B-40), (A-126)+(B-41), (A-126)+(B-42), (A-126)+(B-43), (A-126)+(B-44), (A-126)+(B-45), (A-126)+(B-46), (A-126)+(B-47), (A-126)+(B-48), (A-126)+(B-49), (A-126)+(B-50), (A-126)+(B-51), (A-126)+(B-52), (A-126)+(B-53), (A-126)+(B-54), (A-126)+(B-55), (A-126)+(B-56), (A-126)+(B-57), (A-126)+(B-58), (A-126)+(B-59), (A-126)+(B-60), (A-126)+(B-61), (A-126)+(B-62), (A-126)+(B-63), (A-126)+(B-64), (A-126)+(B-65), (A-126)+(B-66), (A-126)+(B-67), (A-126)+(B-68), (A-126)+(B-69), (A-126)+(B-70), (A-126)+(B-71), (A-126)+(B-72), (A-126)+(B-73), (A-126)+(B-74), (A-126)+(B-75), (A-126)+(B-76), (A-126)+(B-77), (AI-1)+(B-78), (A-126)+(B-79), (A-126)+(B-80).

(A-127)+(B-1), (A-127)+(B-2), (A-127)+(B-3), (A-127)+(B-4), (A-127)+(B-5), (A-127)+(B-6), (A-127)+(B-7), (A-127)+(B-8), (A-127)+(B-9), (A-127)+(B-10), (A-127)+(B-11), (A-127)+(B-12), (A-127)+(B-13), (A-127)+(B-14), (A-127)+(B-15), (A-127)+(B-16), (A-127)+(B-17), (A-127)+(B-18), (A-127)+(B-19), (A-127)+(B-20), (A-127)+(B-21), (A-127)+(B-22), (A-127)+(B-23), (A-127)+(B-24), (A-127)+(B-25), (A-127)+(B-26), (A-127)+(B-27), (A-127)+(B-28), (A-127)+(B-29), (A-127)+(B-30), (A-127)+(B-31), (A-127)+(B-32), (A-127)+(B-33), (A-127)+(B-34), (A-127)+(B-35), (A-127)+(B-36), (A-127)+(B-37), (A-127)+(B-38), (A-127)+(B-39), (A-127)+(B-40), (A-127)+(B-41), (A-127)+(B-42), (A-127)+(B-43), (A-127)+(B-44), (A-127)+(B-45), (A-127)+(B-46), (A-127)+(B-47), (A-127)+(B-48), (A-127)+(B-49), (A-127)+(B-50), (A-127)+(B-51), (A-127)+(B-52), (A-127)+(B-53), (A-127)+(B-54), (A-127)+(B-55), (A-127)+(B-56), (A-127)+(B-57), (A-127)+(B-58), (A-127)+(B-59), (A-127)+(B-60), (A-127)+(B-61), (A-127)+(B-62), (A-127)+(B-63), (A-127)+(B-64), (A-127)+(B-65), (A-127)+(B-66), (A-127)+(B-67), (A-127)+(B-68), (A-127)+(B-69), (A-127)+(B-70), (A-127)+(B-71), (A-127)+(B-72), (A-127)+(B-73), (A-127)+(B-74), (A-127)+(B-75), (A-127)+(B-76), (A-127)+(B-77), (AI-1)+(B-78), (A-127)+(B-79), (A-127)+(B-80).

(A-128)+(B-1), (A-128)+(B-2), (A-128)+(B-3), (A-128)+(B-4), (A-128)+(B-5), (A-128)+(B-6), (A-128)+(B-7), (A-128)+(B-8), (A-128)+(B-9), (A-128)+(B-10), (A-128)+(B-11), (A-128)+(B-12), (A-128)+(B-13), (A-128)+(B-14), (A-128)+(B-15), (A-128)+(B-16), (A-128)+(B-17), (A-128)+(B-18), (A-128)+(B-19), (A-128)+(B-20), (A-128)+(B-21), (A-128)+(B-22), (A-128)+(B-23), (A-128)+(B-24), (A-128)+(B-25), (A-128)+(B-26), (A-128)+(B-27), (A-128)+(B-28), (A-128)+(B-29), (A-128)+(B-30), (A-128)+(B-31), (A-128)+(B-32), (A-128)+(B-33), (A-128)+(B-34), (A-128)+(B-35), (A-128)+(B-36), (A-128)+(B-37), (A-128)+(B-38), (A-128)+(B-39), (A-128)+(B-40), (A-128)+(B-41), (A-128)+(B-42), (A-128)+(B-43), (A-128)+(B-44), (A-128)+(B-45), (A-128)+(B-46), (A-128)+(B-47), (A-128)+(B-48), (A-128)+(B-49), (A-128)+(B-50), (A-128)+(B-51), (A-128)+(B-52), (A-128)+(B-53), (A-128)+(B-54), (A-128)+(B-55), (A-128)+(B-56), (A-128)+(B-57), (A-128)+(B-58), (A-128)+(B-59), (A-128)+(B-60), (A-128)+(B-61), (A-128)+(B-62), (A-128)+(B-63), (A-128)+(B-64), (A-128)+(B-65), (A-128)+(B-66), (A-128)+(B-67), (A-128)+(B-68), (A-128)+(B-69), (A-128)+(B-70), (A-128)+(B-71), (A-128)+(B-72), (A-128)+(B-73), (A-128)+(B-74), (A-128)+(B-75), (A-128)+(B-76), (A-128)+(B-77), (AI-1)+(B-78), (A-128)+(B-79), (A-128)+(B-80).

(A-129)+(B-1), (A-129)+(B-2), (A-129)+(B-3), (A-129)+(B-4), (A-129)+(B-5), (A-129)+(B-6), (A-129)+(B-7), (A-129)+(B-8), (A-129)+(B-9), (A-129)+(B-10), (A-129)+(B-11), (A-129)+(B-12), (A-129)+(B-13), (A-129)+(B-14), (A-129)+(B-15), (A-129)+(B-16), (A-129)+(B-17), (A-129)+(B-18), (A-129)+(B-19), (A-129)+(B-20), (A-129)+(B-21), (A-129)+(B-22), (A-129)+(B-23), (A-129)+(B-24), (A-129)+(B-25), (A-129)+(B-26), (A-129)+(B-27), (A-129)+(B-28), (A-129)+(B-29), (A-129)+(B-30), (A-129)+(B-31), (A-129)+(B-32), (A-129)+(B-33), (A-129)+(B-34), (A-129)+(B-35), (A-129)+(B-36), (A-129)+(B-37), (A-129)+(B-38), (A-129)+(B-39), (A-129)+(B-40), (A-129)+(B-41), (A-129)+(B-42), (A-129)+(B-43), (A-129)+(B-44), (A-129)+(B-45), (A-129)+(B-46), (A-129)+(B-47), (A-129)+(B-48), (A-129)+(B-49), (A-129)+(B-50), (A-129)+(B-51), (A-129)+(B-52), (A-129)+(B-53), (A-129)+(B-54), (A-129)+(B-55), (A-129)+(B-56), (A-129)+(B-57), (A-129)+(B-58), (A-129)+(B-59), (A-129)+(B-60), (A-129)+(B-61), (A-129)+(B-62), (A-129)+(B-63), (A-129)+(B-64), (A-129)+(B-65), (A-129)+(B-66), (A-129)+(B-67), (A-129)+(B-68), (A-129)+(B-69), (A-129)+(B-70), (A-129)+(B-71), (A-129)+(B-72), (A-129)+(B-73), (A-129)+(B-74), (A-129)+(B-75), (A-129)+(B-76), (A-129)+(B-77), (AI-1)+(B-78), (A-129)+(B-79), (A-129)+(B-80).

(A-130)+(B-1), (A-130)+(B-2), (A-130)+(B-3), (A-130)+(B-4), (A-130)+(B-5), (A-130)+(B-6), (A-130)+(B-7), (A-130)+(B-8), (A-130)+(B-9), (A-130)+(B-10), (A-130)+(B-11), (A-130)+(B-12), (A-130)+(B-13), (A-130)+(B-14), (A-130)+(B-15), (A-130)+(B-16), (A-130)+(B-17), (A-130)+(B-18), (A-130)+(B-19), (A-130)+(B-20), (A-130)+(B-21), (A-130)+(B-22), (A-130)+(B-23), (A-130)+(B-24), (A-130)+(B-25), (A-130)+(B-26), (A-130)+(B-27), (A-130)+(B-28), (A-130)+(B-29), (A-130)+(B-30), (A-130)+(B-31), (A-130)+(B-32), (A-130)+(B-33), (A-130)+(B-34), (A-130)+(B-35), (A-130)+(B-36), (A-130)+(B-37), (A-130)+(B-38), (A-130)+(B-39), (A-130)+(B-40), (A-130)+(B-41), (A-130)+(B-42), (A-130)+(B-43), (A-130)+(B-44), (A-130)+(B-45), (A-130)+(B-46), (A-130)+(B-47), (A-130)+(B-48), (A-130)+(B-49), (A-130)+(B-50), (A-130)+(B-51), (A-130)+(B-52), (A-130)+(B-53), (A-130)+(B-54), (A-130)+(B-55), (A-130)+(B-56), (A-130)+(B-57), (A-130)+(B-58), (A-130)+(B-59), (A-130)+(B-60), (A-130)+(B-61), (A-130)+(B-62), (A-130)+(B-63), (A-130)+(B-64), (A-130)+(B-65), (A-130)+(B-66), (A-130)+(B-67), (A-130)+(B-68), (A-130)+(B-69), (A-130)+(B-70), (A-130)+(B-71), (A-130)+(B-72), (A-130)+(B-73), (A-130)+(B-74), (A-130)+(B-75), (A-130)+(B-76), (A-130)+(B-77), (AI-1)+(B-78), (A-130)+(B-79), (A-130)+(B-80).

(A-131)+(B-1), (A-131)+(B-2), (A-131)+(B-3), (A-131)+(B-4), (A-131)+(B-5), (A-131)+(B-6), (A-131)+(B-7), (A-131)+(B-8), (A-131)+(B-9), (A-131)+(B-10), (A-131)+(B-11), (A-131)+(B-12), (A-131)+(B-13), (A-131)+(B-14), (A-131)+(B-15), (A-131)+(B-16), (A-131)+(B-17), (A-131)+(B-18), (A-131)+(B-19), (A-131)+(B-20), (A-131)+(B-21), (A-131)+(B-22), (A-131)+(B-23), (A-131)+(B-24), (A-131)+(B-25), (A-131)+(B-26), (A-131)+(B-27), (A-131)+(B-28), (A-131)+(B-29), (A-131)+(B-30), (A-131)+(B-31), (A-131)+(B-32), (A-131)+(B-33), (A-131)+(B-34), (A-131)+(B-35), (A-131)+(B-36), (A-131)+(B-37), (A-131)+(B-38), (A-131)+(B-39), (A-131)+(B-40), (A-131)+(B-41), (A-131)+(B-42), (A-131)+(B-43), (A-131)+(B-44), (A-131)+(B-45), (A-131)+(B-46), (A-131)+(B-47), (A-131)+(B-48), (A-131)+(B-49), (A-131)+(B-50), (A-131)+(B-51), (A-131)+(B-52), (A-131)+(B-53), (A-131)+(B-54), (A-131)+(B-55), (A-131)+(B-56), (A-131)+(B-57), (A-131)+(B-58), (A-131)+(B-59), (A-131)+(B-60), (A-131)+(B-61), (A-131)+(B-62), (A-131)+(B-63), (A-131)+(B-64), (A-131)+(B-65), (A-131)+(B-66), (A-131)+(B-67), (A-131)+(B-68), (A-131)+(B-69), (A-131)+(B-70), (A-131)+(B-71), (A-131)+(B-72), (A-131)+(B-73), (A-131)+(B-74), (A-131)+(B-75), (A-131)+(B-76), (A-131)+(B-77), (AI-1)+(B-78), (A-131)+(B-79), (A-131)+(B-80).

(A-132)+(B-1), (A-132)+(B-2), (A-132)+(B-3), (A-132)+(B-4), (A-132)+(B-5), (A-132)+(B-6), (A-132)+(B-7), (A-132)+(B-8), (A-132)+(B-9), (A-132)+(B-10), (A-132)+(B-11), (A-132)+(B-12), (A-132)+(B-13), (A-132)+(B-14), (A-132)+(B-15), (A-132)+(B-16), (A-132)+(B-17), (A-132)+(B-18), (A-132)+(B-19), (A-132)+(B-20), (A-132)+(B-21), (A-132)+(B-22), (A-132)+(B-23), (A-132)+(B-24), (A-132)+(B-25), (A-132)+(B-26), (A-132)+(B-27), (A-132)+(B-28), (A-132)+(B-29), (A-132)+(B-30), (A-132)+(B-31), (A-132)+(B-32), (A-132)+(B-33), (A-132)+(B-34), (A-132)+(B-35), (A-132)+(B-36), (A-132)+(B-37), (A-132)+(B-38), (A-132)+(B-39), (A-132)+(B-40), (A-132)+(B-41), (A-132)+(B-42), (A-132)+(B-43), (A-132)+(B-44), (A-132)+(B-45), (A-132)+(B-46), (A-132)+(B-47), (A-132)+(B-48), (A-132)+(B-49), (A-132)+(B-50), (A-132)+(B-51), (A-132)+(B-52), (A-132)+(B-53), (A-132)+(B-54), (A-132)+(B-55), (A-132)+(B-56), (A-132)+(B-57), (A-132)+(B-58), (A-132)+(B-59), (A-132)+(B-60), (A-132)+(B-61), (A-132)+(B-62), (A-132)+(B-63), (A-132)+(B-64), (A-132)+(B-65), (A-132)+(B-66), (A-132)+(B-67), (A-132)+(B-68), (A-132)+(B-69), (A-132)+(B-70), (A-132)+(B-71), (A-132)+(B-72), (A-132)+(B-73), (A-132)+(B-74), (A-132)+(B-75), (A-132)+(B-76), (A-132)+(B-77), (AI-1)+(B-78), (A-132)+(B-79), (A-132)+(B-80).

(A-133)+(B-1), (A-133)+(B-2), (A-133)+(B-3), (A-133)+(B-4), (A-133)+(B-5), (A-133)+(B-6), (A-133)+(B-7), (A-133)+(B-8), (A-133)+(B-9), (A-133)+(B-10), (A-133)+(B-11), (A-133)+(B-12), (A-133)+(B-13), (A-133)+(B-14), (A-133)+(B-15), (A-133)+(B-16), (A-133)+(B-17), (A-133)+(B-18), (A-133)+(B-19), (A-133)+(B-20), (A-133)+(B-21), (A-133)+(B-22), (A-133)+(B-23), (A-133)+(B-24), (A-133)+(B-25), (A-133)+(B-26), (A-133)+(B-27), (A-133)+(B-28), (A-133)+(B-29), (A-133)+(B-30), (A-133)+(B-31), (A-133)+(B-32), (A-133)+(B-33), (A-133)+(B-34), (A-133)+(B-35), (A-133)+(B-36), (A-133)+(B-37), (A-133)+(B-38), (A-133)+(B-39), (A-133)+(B-40), (A-133)+(B-41), (A-133)+(B-42), (A-133)+(B-43), (A-133)+(B-44), (A-133)+(B-45), (A-133)+(B-46), (A-133)+(B-47), (A-133)+(B-48), (A-133)+(B-49), (A-133)+(B-50), (A-133)+(B-51), (A-133)+(B-52), (A-133)+(B-53), (A-133)+(B-54), (A-133)+(B-55), (A-133)+(B-56), (A-133)+(B-57), (A-133)+(B-58), (A-133)+(B-59), (A-133)+(B-60), (A-133)+(B-61), (A-133)+(B-62), (A-133)+(B-63), (A-133)+(B-64), (A-133)+(B-65), (A-133)+(B-66), (A-133)+(B-67), (A-133)+(B-68), (A-133)+(B-69), (A-133)+(B-70), (A-133)+(B-71), (A-133)+(B-72), (A-133)+(B-73), (A-133)+(B-74), (A-133)+(B-75), (A-133)+(B-76), (A-133)+(B-77), (AI-1)+(B-78), (A-133)+(B-79), (A-133)+(B-80).

(A-134)+(B-1), (A-134)+(B-2), (A-134)+(B-3), (A-134)+(B-4), (A-134)+(B-5), (A-134)+(B-6), (A-134)+(B-7), (A-134)+(B-8), (A-134)+(B-9), (A-134)+(B-10), (A-134)+(B-11), (A-134)+(B-12), (A-134)+(B-13), (A-134)+(B-14), (A-134)+(B-15), (A-134)+(B-16), (A-134)+(B-17), (A-134)+(B-18), (A-134)+(B-19), (A-134)+(B-20), (A-134)+(B-21), (A-134)+(B-22), (A-134)+(B-23), (A-134)+(B-24), (A-134)+(B-25), (A-134)+(B-26), (A-134)+(B-27), (A-134)+(B-28), (A-134)+(B-29), (A-134)+(B-30), (A-134)+(B-31), (A-134)+(B-32), (A-134)+(B-33), (A-134)+(B-34), (A-134)+(B-35), (A-134)+(B-36), (A-134)+(B-37), (A-134)+(B-38), (A-134)+(B-39), (A-134)+(B-40), (A-134)+(B-41), (A-134)+(B-42), (A-134)+(B-43), (A-134)+(B-44), (A-134)+(B-45), (A-134)+(B-46), (A-134)+(B-47), (A-134)+(B-48), (A-134)+(B-49), (A-134)+(B-50), (A-134)+(B-51), (A-134)+(B-52), (A-134)+(B-53), (A-134)+(B-54), (A-134)+(B-55), (A-134)+(B-56), (A-134)+(B-57), (A-134)+(B-58), (A-134)+(B-59), (A-134)+(B-60), (A-134)+(B-61), (A-134)+(B-62), (A-134)+(B-63), (A-134)+(B-64), (A-134)+(B-65), (A-134)+(B-66), (A-134)+(B-67), (A-134)+(B-68), (A-134)+(B-69), (A-134)+(B-70), (A-134)+(B-71), (A-134)+(B-72), (A-134)+(B-73), (A-134)+(B-74), (A-134)+(B-75), (A-134)+(B-76), (A-134)+(B-77), (AI-1)+(B-78), (A-134)+(B-79), (A-134)+(B-80).

(A-135)+(B-1), (A-135)+(B-2), (A-135)+(B-3), (A-135)+(B-4), (A-135)+(B-5), (A-135)+(B-6), (A-135)+(B-7), (A-135)+(B-8), (A-135)+(B-9), (A-135)+(B-10), (A-135)+(B-11), (A-135)+(B-12), (A-135)+(B-13), (A-135)+(B-14), (A-135)+(B-15), (A-135)+(B-16), (A-135)+(B-17), (A-135)+(B-18), (A-135)+(B-19), (A-135)+(B-20), (A-135)+(B-21), (A-135)+(B-22), (A-135)+(B-23), (A-135)+(B-24), (A-135)+(B-25), (A-135)+(B-26), (A-135)+(B-27), (A-135)+(B-28), (A-135)+(B-29), (A-135)+(B-30), (A-135)+(B-31), (A-135)+(B-32), (A-135)+(B-33), (A-135)+(B-34), (A-135)+(B-35), (A-135)+(B-36), (A-135)+(B-37), (A-135)+(B-38), (A-135)+(B-39), (A-135)+(B-40), (A-135)+(B-41), (A-135)+(B-42), (A-135)+(B-43), (A-135)+(B-44), (A-135)+(B-45), (A-135)+(B-46), (A-135)+(B-47), (A-135)+(B-48), (A-135)+(B-49), (A-135)+(B-50), (A-135)+(B-51), (A-135)+(B-52), (A-135)+(B-53), (A-135)+(B-54), (A-135)+(B-55), (A-135)+(B-56), (A-135)+(B-57), (A-135)+(B-58), (A-135)+(B-59), (A-135)+(B-60), (A-135)+(B-61), (A-135)+(B-62), (A-135)+(B-63), (A-135)+(B-64), (A-135)+(B-65), (A-135)+(B-66), (A-135)+(B-67), (A-135)+(B-68), (A-135)+(B-69), (A-135)+(B-70), (A-135)+(B-71), (A-135)+(B-72), (A-135)+(B-73), (A-135)+(B-74), (A-135)+(B-75), (A-135)+(B-76), (A-135)+(B-77), (AI-1)+(B-78), (A-135)+(B-79), (A-135)+(B-80).

(A-136)+(B-1), (A-136)+(B-2), (A-136)+(B-3), (A-136)+(B-4), (A-136)+(B-5), (A-136)+(B-6), (A-136)+(B-7), (A-136)+(B-8), (A-136)+(B-9), (A-136)+(B-10), (A-136)+(B-11), (A-136)+(B-12), (A-136)+(B-13), (A-136)+(B-14), (A-136)+(B-15), (A-136)+(B-16), (A-136)+(B-17), (A-136)+(B-18), (A-136)+(B-19), (A-136)+(B-20), (A-136)+(B-21), (A-136)+(B-22), (A-136)+(B-23), (A-136)+(B-24), (A-136)+(B-25), (A-136)+(B-26), (A-136)+(B-27), (A-136)+(B-28), (A-136)+(B-29), (A-136)+(B-30), (A-136)+(B-31), (A-136)+(B-32), (A-136)+(B-33), (A-136)+(B-34), (A-136)+(B-35), (A-136)+(B-36), (A-136)+(B-37), (A-136)+(B-38), (A-136)+(B-39), (A-136)+(B-40), (A-136)+(B-41), (A-136)+(B-42), (A-136)+(B-43), (A-136)+(B-44), (A-136)+(B-45), (A-136)+(B-46), (A-136)+(B-47), (A-136)+(B-48), (A-136)+(B-49), (A-136)+(B-50), (A-136)+(B-51), (A-136)+(B-52), (A-136)+(B-53), (A-136)+(B-54), (A-136)+(B-55), (A-136)+(B-56), (A-136)+(B-57), (A-136)+(B-58), (A-136)+(B-59), (A-136)+(B-60), (A-136)+(B-61), (A-136)+(B-62), (A-136)+(B-63), (A-136)+(B-64), (A-136)+(B-65), (A-136)+(B-66), (A-136)+(B-67), (A-136)+(B-68), (A-136)+(B-69), (A-136)+(B-70), (A-136)+(B-71), (A-136)+(B-72), (A-136)+(B-73), (A-136)+(B-74), (A-136)+(B-75), (A-136)+(B-76), (A-136)+(B-77), (AI-1)+(B-78), (A-136)+(B-79), (A-136)+(B-80).

(A-137)+(B-1), (A-137)+(B-2), (A-137)+(B-3), (A-137)+(B-4), (A-137)+(B-5), (A-137)+(B-6), (A-137)+(B-7), (A-137)+(B-8), (A-137)+(B-9), (A-137)+(B-10), (A-137)+(B-11), (A-137)+(B-12), (A-137)+(B-13), (A-137)+(B-14), (A-137)+(B-15), (A-137)+(B-16), (A-137)+(B-17), (A-137)+(B-18), (A-137)+(B-19), (A-137)+(B-20), (A-137)+(B-21), (A-137)+(B-22), (A-137)+(B-23), (A-137)+(B-24), (A-137)+(B-25), (A-137)+(B-26), (A-137)+(B-27), (A-137)+(B-28), (A-137)+(B-29), (A-137)+(B-30), (A-137)+(B-31), (A-137)+(B-32), (A-137)+(B-33), (A-137)+(B-34), (A-137)+(B-35), (A-137)+(B-36), (A-137)+(B-37), (A-137)+(B-38), (A-137)+(B-39), (A-137)+(B-40), (A-137)+(B-41), (A-137)+(B-42), (A-137)+(B-43), (A-137)+(B-44), (A-137)+(B-45), (A-137)+(B-46), (A-137)+(B-47), (A-137)+(B-48), (A-137)+(B-49), (A-137)+(B-50), (A-137)+(B-51), (A-137)+(B-52), (A-137)+(B-53), (A-137)+(B-54), (A-137)+(B-55), (A-137)+(B-56), (A-137)+(B-57), (A-137)+(B-58), (A-137)+(B-59), (A-137)+(B-60), (A-137)+(B-61), (A-137)+(B-62), (A-137)+(B-63), (A-137)+(B-64), (A-137)+(B-65), (A-137)+(B-66), (A-137)+(B-67), (A-137)+(B-68), (A-137)+(B-69), (A-137)+(B-70), (A-137)+(B-71), (A-137)+(B-72), (A-137)+(B-73), (A-137)+(B-74), (A-137)+(B-75), (A-137)+(B-76), (A-137)+(B-77), (AI-1)+(B-78), (A-137)+(B-79), (A-137)+(B-80).

(A-138)+(B-1), (A-138)+(B-2), (A-138)+(B-3), (A-138)+(B-4), (A-138)+(B-5), (A-138)+(B-6), (A-138)+(B-7), (A-138)+(B-8), (A-138)+(B-9), (A-138)+(B-10), (A-138)+(B-11), (A-138)+(B-12), (A-138)+(B-13), (A-138)+(B-14), (A-138)+(B-15), (A-138)+(B-16), (A-138)+(B-17), (A-138)+(B-18), (A-138)+(B-19), (A-138)+(B-20), (A-138)+(B-21), (A-138)+(B-22), (A-138)+(B-23), (A-138)+(B-24), (A-138)+(B-25), (A-138)+(B-26), (A-138)+(B-27), (A-138)+(B-28), (A-138)+(B-29), (A-138)+(B-30), (A-138)+(B-31), (A-138)+(B-32), (A-138)+(B-33), (A-138)+(B-34), (A-138)+(B-35), (A-138)+(B-36), (A-138)+(B-37), (A-138)+(B-38), (A-138)+(B-39), (A-138)+(B-40), (A-138)+(B-41), (A-138)+(B-42), (A-138)+(B-43), (A-138)+(B-44), (A-138)+(B-45), (A-138)+(B-46), (A-138)+(B-47), (A-138)+(B-48), (A-138)+(B-49), (A-138)+(B-50), (A-138)+(B-51), (A-138)+(B-52), (A-138)+(B-53), (A-138)+(B-54), (A-138)+(B-55), (A-138)+(B-56), (A-138)+(B-57), (A-138)+(B-58), (A-138)+(B-59), (A-138)+(B-60), (A-138)+(B-61), (A-138)+(B-62), (A-138)+(B-63), (A-138)+(B-64), (A-138)+(B-65), (A-138)+(B-66), (A-138)+(B-67), (A-138)+(B-68), (A-138)+(B-69), (A-138)+(B-70), (A-138)+(B-71), (A-138)+(B-72), (A-138)+(B-73), (A-138)+(B-74), (A-138)+(B-75), (A-138)+(B-76), (A-138)+(B-77), (AI-1)+(B-78), (A-138)+(B-79), (A-138)+(B-80).

(A-139)+(B-1), (A-139)+(B-2), (A-139)+(B-3), (A-139)+(B-4), (A-139)+(B-5), (A-139)+(B-6), (A-139)+(B-7), (A-139)+(B-8), (A-139)+(B-9), (A-139)+(B-10), (A-139)+(B-11), (A-139)+(B-12), (A-139)+(B-13), (A-139)+(B-14), (A-139)+(B-15), (A-139)+(B-16), (A-139)+(B-17), (A-139)+(B-18), (A-139)+(B-19), (A-139)+(B-20), (A-139)+(B-21), (A-139)+(B-22), (A-139)+(B-23), (A-139)+(B-24), (A-139)+(B-25), (A-139)+(B-26), (A-139)+(B-27), (A-139)+(B-28), (A-139)+(B-29), (A-139)+(B-30), (A-139)+(B-31), (A-139)+(B-32), (A-139)+(B-33), (A-139)+(B-34), (A-139)+(B-35), (A-139)+(B-36), (A-139)+(B-37), (A-139)+(B-38), (A-139)+(B-39), (A-139)+(B-40), (A-139)+(B-41), (A-139)+(B-42), (A-139)+(B-43), (A-139)+(B-44), (A-139)+(B-45), (A-139)+(B-46), (A-139)+(B-47), (A-139)+(B-48), (A-139)+(B-49), (A-139)+(B-50), (A-139)+(B-51), (A-139)+(B-52), (A-139)+(B-53), (A-139)+(B-54), (A-139)+(B-55), (A-139)+(B-56), (A-139)+(B-57), (A-139)+(B-58), (A-139)+(B-59), (A-139)+(B-60), (A-139)+(B-61), (A-139)+(B-62), (A-139)+(B-63), (A-139)+(B-64), (A-139)+(B-65), (A-139)+(B-66), (A-139)+(B-67), (A-139)+(B-68), (A-139)+(B-69), (A-139)+(B-70), (A-139)+(B-71), (A-139)+(B-72), (A-139)+(B-73), (A-139)+(B-74), (A-139)+(B-75), (A-139)+(B-76), (A-139)+(B-77), (AI-1)+(B-78), (A-139)+(B-79), (A-139)+(B-80).

(A-140)+(B-1), (A-140)+(B-2), (A-140)+(B-3), (A-140)+(B-4), (A-140)+(B-5), (A-140)+(B-6), (A-140)+(B-7), (A-140)+(B-8), (A-140)+(B-9), (A-140)+(B-10), (A-140)+(B-11), (A-140)+(B-12), (A-140)+(B-13), (A-140)+(B-14), (A-140)+(B-15), (A-140)+(B-16), (A-140)+(B-17), (A-140)+(B-18), (A-140)+(B-19), (A-140)+(B-20), (A-140)+(B-21), (A-140)+(B-22), (A-140)+(B-23), (A-140)+(B-24), (A-140)+(B-25), (A-140)+(B-26), (A-140)+(B-27), (A-140)+(B-28), (A-140)+(B-29), (A-140)+(B-30), (A-140)+(B-31), (A-140)+(B-32), (A-140)+(B-33), (A-140)+(B-34), (A-140)+(B-35), (A-140)+(B-36), (A-140)+(B-37), (A-140)+(B-38), (A-140)+(B-39), (A-140)+(B-40), (A-140)+(B-41), (A-140)+(B-42), (A-140)+(B-43), (A-140)+(B-44), (A-140)+(B-45), (A-140)+(B-46), (A-140)+(B-47), (A-140)+(B-48), (A-140)+(B-49), (A-140)+(B-50), (A-140)+(B-51), (A-140)+(B-52), (A-140)+(B-53), (A-140)+(B-54), (A-140)+(B-55), (A-140)+(B-56), (A-140)+(B-57), (A-140)+(B-58), (A-140)+(B-59), (A-140)+(B-60), (A-140)+(B-61), (A-140)+(B-62), (A-140)+(B-63), (A-140)+(B-64), (A-140)+(B-65), (A-140)+(B-66), (A-140)+(B-67), (A-140)+(B-68), (A-140)+(B-69), (A-140)+(B-70), (A-140)+(B-71), (A-140)+(B-72), (A-140)+(B-73), (A-140)+(B-74), (A-140)+(B-75), (A-140)+(B-76), (A-140)+(B-77), (AI-1)+(B-78), (A-140)+(B-79), (A-140)+(B-80).

(A-141)+(B-1), (A-141)+(B-2), (A-141)+(B-3), (A-141)+(B-4), (A-141)+(B-5), (A-141)+(B-6), (A-141)+(B-7), (A-141)+(B-8), (A-141)+(B-9), (A-141)+(B-10), (A-141)+(B-11), (A-141)+(B-12), (A-141)+(B-13), (A-141)+(B-14), (A-141)+(B-15), (A-141)+(B-16), (A-141)+(B-17), (A-141)+(B-18), (A-141)+(B-19), (A-141)+(B-20), (A-141)+(B-21), (A-141)+(B-22), (A-141)+(B-23), (A-141)+(B-24), (A-141)+(B-25), (A-141)+(B-26), (A-141)+(B-27), (A-141)+(B-28), (A-141)+(B-29), (A-141)+(B-30), (A-141)+(B-31), (A-141)+(B-32), (A-141)+(B-33), (A-141)+(B-34), (A-141)+(B-35), (A-141)+(B-36), (A-141)+(B-37), (A-141)+(B-38), (A-141)+(B-39), (A-141)+(B-40), (A-141)+(B-41), (A-141)+(B-42), (A-141)+(B-43), (A-141)+(B-44), (A-141)+(B-45), (A-141)+(B-46), (A-141)+(B-47), (A-141)+(B-48), (A-141)+(B-49), (A-141)+(B-50), (A-141)+(B-51), (A-141)+(B-52), (A-141)+(B-53), (A-141)+(B-54), (A-141)+(B-55), (A-141)+(B-56), (A-141)+(B-57), (A-141)+(B-58), (A-141)+(B-59), (A-141)+(B-60), (A-141)+(B-61), (A-141)+(B-62), (A-141)+(B-63), (A-141)+(B-64), (A-141)+(B-65), (A-141)+(B-66), (A-141)+(B-67), (A-141)+(B-68), (A-141)+(B-69), (A-141)+(B-70), (A-141)+(B-71), (A-141)+(B-72), (A-141)+(B-73), (A-141)+(B-74), (A-141)+(B-75), (A-141)+(B-76), (A-141)+(B-77), (AI-1)+(B-78), (A-141)+(B-79), (A-141)+(B-80).

(A-142)+(B-1), (A-142)+(B-2), (A-142)+(B-3), (A-142)+(B-4), (A-142)+(B-5), (A-142)+(B-6), (A-142)+(B-7), (A-142)+(B-8), (A-142)+(B-9), (A-142)+(B-10), (A-142)+(B-11), (A-142)+(B-12), (A-142)+(B-13), (A-142)+(B-14), (A-142)+(B-15), (A-142)+(B-16), (A-142)+(B-17), (A-142)+(B-18), (A-142)+(B-19), (A-142)+(B-20), (A-142)+(B-21), (A-142)+(B-22), (A-142)+(B-23), (A-142)+(B-24), (A-142)+(B-25), (A-142)+(B-26), (A-142)+(B-27), (A-142)+(B-28), (A-142)+(B-29), (A-142)+(B-30), (A-142)+(B-31), (A-142)+(B-32), (A-142)+(B-33), (A-142)+(B-34), (A-142)+(B-35), (A-142)+(B-36), (A-142)+(B-37), (A-142)+(B-38), (A-142)+(B-39), (A-142)+(B-40), (A-142)+(B-41), (A-142)+(B-42), (A-142)+(B-43), (A-142)+(B-44), (A-142)+(B-45), (A-142)+(B-46), (A-142)+(B-47), (A-142)+(B-48), (A-142)+(B-49), (A-142)+(B-50), (A-142)+(B-51), (A-142)+(B-52), (A-142)+(B-53), (A-142)+(B-54), (A-142)+(B-55), (A-142)+(B-56), (A-142)+(B-57), (A-142)+(B-58), (A-142)+(B-59), (A-142)+(B-60), (A-142)+(B-61), (A-142)+(B-62), (A-142)+(B-63), (A-142)+(B-64), (A-142)+(B-65), (A-142)+(B-66), (A-142)+(B-67), (A-142)+(B-68), (A-142)+(B-69), (A-142)+(B-70), (A-142)+(B-71), (A-142)+(B-72), (A-142)+(B-73), (A-142)+(B-74), (A-142)+(B-75), (A-142)+(B-76), (A-142)+(B-77), (AI-1)+(B-78), (A-142)+(B-79), (A-142)+(B-80).

(A-143)+(B-1), (A-143)+(B-2), (A-143)+(B-3), (A-143)+(B-4), (A-143)+(B-5), (A-143)+(B-6), (A-143)+(B-7), (A-143)+(B-8), (A-143)+(B-9), (A-143)+(B-10), (A-143)+(B-11), (A-143)+(B-12), (A-143)+(B-13), (A-143)+(B-14), (A-143)+(B-15), (A-143)+(B-16), (A-143)+(B-17), (A-143)+(B-18), (A-143)+(B-19), (A-143)+(B-20), (A-143)+(B-21), (A-143)+(B-22), (A-143)+(B-23), (A-143)+(B-24), (A-143)+(B-25), (A-143)+(B-26), (A-143)+(B-27), (A-143)+(B-28), (A-143)+(B-29), (A-143)+(B-30), (A-143)+(B-31), (A-143)+(B-32), (A-143)+(B-33), (A-143)+(B-34), (A-143)+(B-35), (A-143)+(B-36), (A-143)+(B-37), (A-143)+(B-38), (A-143)+(B-39), (A-143)+(B-40), (A-143)+(B-41), (A-143)+(B-42), (A-143)+(B-43), (A-143)+(B-44), (A-143)+(B-45), (A-143)+(B-46), (A-143)+(B-47), (A-143)+(B-48), (A-143)+(B-49), (A-143)+(B-50), (A-143)+(B-51), (A-143)+(B-52), (A-143)+(B-53), (A-143)+(B-54), (A-143)+(B-55), (A-143)+(B-56), (A-143)+(B-57), (A-143)+(B-58), (A-143)+(B-59), (A-143)+(B-60), (A-143)+(B-61), (A-143)+(B-62), (A-143)+(B-63), (A-143)+(B-64), (A-143)+(B-65), (A-143)+(B-66), (A-143)+(B-67), (A-143)+(B-68), (A-143)+(B-69), (A-143)+(B-70), (A-143)+(B-71), (A-143)+(B-72), (A-143)+(B-73), (A-143)+(B-74), (A-143)+(B-75), (A-143)+(B-76), (A-143)+(B-77), (AI-1)+(B-78), (A-143)+(B-79), (A-143)+(B-80).

(A-144)+(B-1), (A-144)+(B-2), (A-144)+(B-3), (A-144)+(B-4), (A-144)+(B-5), (A-144)+(B-6), (A-144)+(B-7), (A-144)+(B-8), (A-144)+(B-9), (A-144)+(B-10), (A-144)+(B-11), (A-144)+(B-12), (A-144)+(B-13), (A-144)+(B-14), (A-144)+(B-15), (A-144)+(B-16), (A-144)+(B-17), (A-144)+(B-18), (A-144)+(B-19), (A-144)+(B-20), (A-144)+(B-21), (A-144)+(B-22), (A-144)+(B-23), (A-144)+(B-24), (A-144)+(B-25), (A-144)+(B-26), (A-144)+(B-27), (A-144)+(B-28), (A-144)+(B-29), (A-144)+(B-30), (A-144)+(B-31), (A-144)+(B-32), (A-144)+(B-33), (A-144)+(B-34), (A-144)+(B-35), (A-144)+(B-36), (A-144)+(B-37), (A-144)+(B-38), (A-144)+(B-39), (A-144)+(B-40), (A-144)+(B-41), (A-144)+(B-42), (A-144)+(B-43), (A-144)+(B-44), (A-144)+(B-45), (A-144)+(B-46), (A-144)+(B-47), (A-144)+(B-48), (A-144)+(B-49), (A-144)+(B-50), (A-144)+(B-51), (A-144)+(B-52), (A-144)+(B-53), (A-144)+(B-54), (A-144)+(B-55), (A-144)+(B-56), (A-144)+(B-57), (A-144)+(B-58), (A-144)+(B-59), (A-144)+(B-60), (A-144)+(B-61), (A-144)+(B-62), (A-144)+(B-63), (A-144)+(B-64), (A-144)+(B-65), (A-144)+(B-66), (A-144)+(B-67), (A-144)+(B-68), (A-144)+(B-69), (A-144)+(B-70), (A-144)+(B-71), (A-144)+(B-72), (A-144)+(B-73), (A-144)+(B-74), (A-144)+(B-75), (A-144)+(B-76), (A-144)+(B-77), (AI-1)+(B-78), (A-144)+(B-79), (A-144)+(B-80).

(A-145)+(B-1), (A-145)+(B-2), (A-145)+(B-3), (A-145)+(B-4), (A-145)+(B-5), (A-145)+(B-6), (A-145)+(B-7), (A-145)+(B-8), (A-145)+(B-9), (A-145)+(B-10), (A-145)+(B-11), (A-145)+(B-12), (A-145)+(B-13), (A-145)+(B-14), (A-145)+(B-15), (A-145)+(B-16), (A-145)+(B-17), (A-145)+(B-18), (A-145)+(B-19), (A-145)+(B-20), (A-145)+(B-21), (A-145)+(B-22), (A-145)+(B-23), (A-145)+(B-24), (A-145)+(B-25), (A-145)+(B-26), (A-145)+(B-27), (A-145)+(B-28), (A-145)+(B-29), (A-145)+(B-30), (A-145)+(B-31), (A-145)+(B-32), (A-145)+(B-33), (A-145)+(B-34), (A-145)+(B-35), (A-145)+(B-36), (A-145)+(B-37), (A-145)+(B-38), (A-145)+(B-39), (A-145)+(B-40), (A-145)+(B-41), (A-145)+(B-42), (A-145)+(B-43), (A-145)+(B-44), (A-145)+(B-45), (A-145)+(B-46), (A-145)+(B-47), (A-145)+(B-48), (A-145)+(B-49), (A-145)+(B-50), (A-145)+(B-51), (A-145)+(B-52), (A-145)+(B-53), (A-145)+(B-54), (A-145)+(B-55), (A-145)+(B-56), (A-145)+(B-57), (A-145)+(B-58), (A-145)+(B-59), (A-145)+(B-60), (A-145)+(B-61), (A-145)+(B-62), (A-145)+(B-63), (A-145)+(B-64), (A-145)+(B-65), (A-145)+(B-66), (A-145)+(B-67), (A-145)+(B-68), (A-145)+(B-69), (A-145)+(B-70), (A-145)+(B-71), (A-145)+(B-72), (A-145)+(B-73), (A-145)+(B-74), (A-145)+(B-75), (A-145)+(B-76), (A-145)+(B-77), (AI-1)+(B-78), (A-145)+(B-79), (A-145)+(B-80).

Furthermore, the herbicide combinations according to the invention can comprise various agrochemically active compounds, for example from the group of the safeners, fungicides, insecticides, herbicides which differ structurally from the herbicides (A) and (B) and plant growth regulators, or from the group of the formulation auxiliaries and additives customary in crop protection. Additives are, for example, fertilizers and colorants.

Thus, suitable further herbicides are, for example, the following herbicides different from the herbicides (A) and (B), as described, for example, in Weed Research 26, 441-445 (1986), or “The Pesticide Manual”, 13th edition, The British Crop Protection Council, 2003, and the literature cited therein. Here, the herbicides are referred to either by the “common name” according to the International Organization for Standardization (ISO) or by the chemical name, if appropriate together with a customary code number and in each case include all application forms, such as acids, salts, esters and isomers, such as stereoisomers and optical isomers. One and in some cases a plurality of application forms are mentioned: acetochlor; acifluorfen(-sodium); aclonifen; AKH 7088, i.e. [[[1-[5-[2-chloro-4-(trifluoromethyl)phenoxy]-2-nitrophenyl]-2-methoxyethylidene]amino]oxy]acetic acid and methyl [[[1-[5-[2-chloro-4-(trifluoromethyl)phenoxy]-2-nitrophenyl]-2-methoxyethylidene]amino]oxy]acetate; acrolein; alachlor; alloxydim(-sodium); ametryn; amicarbazone, amidochlor, amidosulfuron; aminopyralid, amitrol; AMS, i.e. ammonium sulfamate; anilofos; asulam; atraton; atrazine; azafenidin, azimsulfuron (DPX-A8947); aziprotryn; barban; BAS 516H, i.e. 5-fluoro-2-phenyl-4H-3,1-benzoxazin-4-one; BCPC; beflubutamid, benazolin(-ethyl); benfluralin; benfuresate; bensulfuron(-methyl); bensulide; bentazone; benzfendizone; benzobicyclon, benzofenap; benzofluor; benzoylprop(-ethyl); benzthiazuron; bifenox; bialaphos; bifenox; bispyribac(-sodium), borax; bromacil; bromobutide; bromofenoxim; bromoxynil; bromuron; buminafos; busoxinone; butachlor; butafenacil, butamifos; butenachlor; buthidazole; butralin; butroxydim, butylate; cacodylic acid; calcium chlorate; cafenstrole (CH-900); carbetamide; carfentrazone(-ethyl); caloxydim, CDAA, i.e. 2-chloro-N,N-di-2-propenylacetamide; CDEC, i.e. 2-chlorallyl diethyldithiocarbamate; chlorflurenol (-methyl); chlomethoxyfen; clethodim; clomeprop; chloramben; chlorazifop-butyl, chlormesulon; chlorbromuron; chlorbufam; chlorfenac; chlorflurecol-methyl; chloridazon; chlorimuron(-ethyl); chloroacetic acid; chlornitrofen; chlorotoluron; chloroxuron; chlorpropham; chlorsulfuron; chlorthal(-dimethyl); chlorthiamid; chlortoluron, cinidon(-methyl and -ethyl), cinmethylin; cinosulfuron; cisanilide; clefoxydim, clethodim; clodinafop and its ester derivatives (for example clodinafop-propargyl); clomazone; clomeprop; cloproxydim; clopyralid; clopyrasulfuron(-methyl); cloransulam(-methyl), cresol; cumyluron (JC 940); cyanamide; cyanazine; cycloate; cyclosulfamuron (AC 104); cycloxydim; cycluron; cyhalofop and its ester derivatives (for example the butyl ester, DEH-112); cyperquat; cyprazine; cyprazole; daimuron; 2,4-D, 2,4-DB, 3,4-DA, 3,4-DB, 2,4-DEB, dalapon; dazomed; desmedipham; desmetryn; di-allate; dicamba; dichlobenil; ortho-dichlorobenzene; para-dichlorobenzene; dichlorprop; dichlorprop-P; diclofop and its esters, such as diclofop-methyl; diclosulam, diethatyl(-ethyl); difenoxuron; difenzoquat; difenzoquat-methylsulphate; diflufenican; diflufenzopyr, dimefuron; dimepiperate, dimethachlor; dimethametryn; dimethenamid (SAN-582H); dimethenamid-P; dimethazone, dimexyflam, dimethipin; dimethylarsinic acid; dimetrasulfuron, dinitramine; dinoseb; dinoterb; diphenamid; dipropetryn; diquat; diquat-dibromide; dithiopyr; diuron; DNOC; 3,4-DP; DSMA; EBEP; eglinazine-ethyl; EL77, i.e. 5-cyano-1-(1,1-dimethylethyl)-N-methyl-1H-pyrazole-4-carboxamide; endothal; epoprodan, EPTC; esprocarb; ethalfluralin; ethametsulfuron(-methyl); ethidimuron; ethiozin; ethofumesate; ethoxyfen and its esters (for example the ethyl ester, HN-252); ethoxysulfuron, etobenzanid (HW 52); F5231, i.e. N-[2-chloro-4-fluoro-5-[4-(3-fluoropropyl)-4,5-dihydro-5-oxo-1H-tetrazol-1-yl]phenyl]ethane-sulfonamide; fenoprop; fenoxan, fenoxapropand fenoxaprop-P and also their esters, for example fenoxaprop-P-ethyl and fenoxaprop-ethyl; fenoxydim; fentrazamide, fenuron; ferrous sulphate; flamprop(-methyl odr -isopropyl or -isopropyl-L); flazasulfuron; floazulate, florasulam, fluazifop and fluazifop-P and their esters, for example fluazifop-butyl and fluazifop-P-butyl; fluazolate; flucarbazone(-sodium), flucetosulfuron; fluchloralin; flufenacet; flufenpyr(-ethyl); flumetsulam; flumeturon; flumiclorac(-pentyl), flumioxazin (S-482); flumipropyn; fluometuron, fluorochloridone, fluorodifen; fluoroglycofen(-ethyl); flupoxam (KNW-739); flupropacil (UBIC-4243); flupropanate, flupyrsulfuron(-methyl or -sodium), flurenol(-butyl), fluridone; fluorochloridone; fluoroxypyr(-meptyl); flurprimidol; flurtamone; fluthiacet(-methyl) (KIH-9201); fluthiamide; fomesafen; foramsulfuron; fosamine; furyloxyfen; glufosinate(-ammonium); glyphosate(-isopropylammonium); halosafen; halosulfuron(-methyl) and its esters (for example the methyl ester, NC-319); haloxyfop and its esters; haloxyfop-P(═R-haloxyfop) and its esters; HC-252; hexazinone; imazamethabenz(-methyl); imazapyr; imazaquin and salts, such as the ammonium salt; imazamethapyr, imazamox, imazapic, imazethamethapyr; imazethapyr; imazosulfuron; indanofan, iodomethane; iodosulfuron(methylsodium); ioxynil; isocarbamid; isopropalin; isoproturon; isouron; isoxaben; isoxachlortole, isoxaflutole, isoxapyrifop; karbutilate; lactofen; lenacil; linuron; MAA; MAMA; MCPA; MCPA-2-ethylhexyl; MCPA-thioethyl; MCPB; mecoprop; mecoprop-P; mefenacet; mefluidid; mesosulfuron(-methyl); mesotrione, metamifop; metamitron; metazachlor; methabenzthiazuron; metham; methazole; methoxyphenone; methylarsonic acid; methyldymron; methyl isothiocyanate; metabenzuron, metamifop; methobenzuron; metobromuron; (alpha-)metolachlor; S— metolachlor; metosulam (XRD 511); metoxuron; metribuzin; metsulfuron-methyl; MK-616; MH; molinate; monalide; monocarbamide dihydrogensulfate; monolinuron; monuron; MSMA; MT 128, i.e. 6-chloro-N-(3-chloro-2-propenyl)-5-methyl-N-phenyl-3-pyridazinamine; MT 5950, i.e. N-[3-chloro-4-(1-methylethyl)phenyl]-2-methylpentanamide; naproanilide; napropamide; naptalam; NC 310, i.e. 4-(2,4-dichlorobenzoyl)-1-methyl-5-benzyloxypyrazole; neburon; nicosulfuron; nipyraclophen; nitralin; nitrofen; nitrofluorfen; nonanoic acid; norflurazon; oleic acid (fatty acid); orbencarb; orthosulfamuron; oryzalin; oxadiargyl (RP-020630); oxadiazon; oxasulfuron, oxaziclomefone, oxyfluorfen; paraquat; paraquat-dichloride; pebulate; pelargonic acid, pendimethalin; penoxsulam; pentachlorophenol; pentanochlor; pentoxazone, perfluidone; phenisopham; phenmedipham(ethyl); pethoxamid; picloram; picolinafen, pinoxaden, piperophos; piributicarb; pirifenop-butyl; pretilachlor; primisulfuron(-methyl); potassium arsenite; potassium azide; procarbazone-(sodium), procyazine; prodiamine; profluazol; profluralin; profoxydim; proglinazine(-ethyl); prometon; prometryn; propachlor; propanil; propaquizafop and its esters; propazine; propham; propisochlor; propoxycarbazone(-sodium) (BAY MKH 6561); propyzamide; prosulfalin; prosulfocarb; prosulfuron (CGA-152005); prynachlor; pyraclonil; pyraflufen(-ethyl), pyrasulfotole; pyrazolinate; pyrazon; pyrazosulfuron(-ethyl); pyrazoxyfen; pyribambenz-isopropyl; pyribenzoxim, pyributicarb, pyridafol, pyridate; pyriftalid; pyrimidobac(-methyl), pyrimisulfan, pyrithiobac(-sodium) (KIH-2031); pyroxasulfone; pyroxofop and its esters (for example the propargyl ester); pyroxsulam (triflosulam); quinclorac; quinmerac; quinoclamine, quinofop and its ester derivatives, quizalofop and quizalofop-P and their ester derivatives, for example quizalofop-ethyl; quizalofop-P-tefuryl and -ethyl; renriduron; rimsulfuron (DPX-E 9636); S 275, i.e. 2-[4-chloro-2-fluoro-5-(2-propynyloxy)phenyl]-4,5,6,7-tetrahydro-2H-indazole; secbumeton; sethoxydim; siduron; simazine; simetryn; SN 106279, i.e. 2-[[7-[2-chloro-4-(trifluoromethyl)phenoxy]-2-naphthalenyl]oxy]propanoic acid and methyl 2-[[7-[2-chloro-4-(trifluoromethyl)phenoxy]-2-naphthalenyl]oxy]propanoate; SMA; sodium arsenite; sodium azide; sodium chlorate; sulcotrione, sulfentrazon (FMC-97285, F-6285); sulfazuron; sulfometuron(-methyl); sulfosate (ICI-A0224); sulfosulfuron, 2,3,6-TBA; TCA(sodium); tebutam (GCP-5544); tebuthiuron; tefuryltrione, tembotrione, tepraloxydim, terbacil; terbucarb; terbuchlor; terbumeton; terbuthylazine; terbutryn; TFH 450, i.e. N,N-diethyl-3-[(2-ethyl-6-methylphenyl)sulfonyl]-1H-1,2,4-triazole-1-carboxamide; thenylchlor (NSK-850); thiafluamide, thiazafluoron; thiazopyr (Mon-13200); thidiazimin (SN-24085); thiencarbazone-methyl, thifensulfuron(-methyl); thiobencarb; tiocarbazil; tralkoxydim; tri-allate; triasulfuron; triaziflam, triazofenamide; tribenuron(-methyl); tricamba; triclopyr; tridiphane; trietazine; trifloxysulfuron(sodium); trifluralin; triflusulfuron and esters (for example the methyl ester, DPX-66037); trihydroxytriazine; trimeturon; tritosulfuron; topramezone; tsitodef; vernolate; [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetic acid ethyl ester;

WL 110547, i.e. 5-phenoxy-1-[3-(trifluoromethyl)phenyl]-1H-tetrazole; UBH-509; D-489; LS 82-556; KPP-300; NC-324; NC-330; KH-218; DPX-N8189; SC-0774; DOWCO-535; DK-8910; V-53482; PP-600; MBH-001; ET-751; KIH-6127, KIH-2023 and SYP-249, SYN-523.

The combinations according to the invention (=herbicidal compositions) have outstanding herbicidal activity against a broad spectrum of economically important monocotyledonous and dicotyledonous harmful plants such as weeds, including species which are resistant to herbicidally active compounds such as glyphosate, glufosinate, atrazine or imidazolinone herbicides. The active compounds also act efficiently on perennial weeds which produce shoots from rhizomes, rootstocks or other perennial organs and which are difficult to control. The substances can be applied, for example, by the pre-sowing, the pre-emergence or the post-emergence method, for example jointly or separately. Preferred is, for example, the application by the post-emergence method, in particular to the emerged harmful plants.

Specifically, examples which may be mentioned are some representatives of the monocotyledonous and dicotyledonous weed flora which can be controlled by the compounds according to the invention, without the enumeration being a restriction to certain species.

The compositions act efficiently against, from amongst the monocotyledonous weed species, for example Avena spp., Alopecurus spp., Brachiaria spp., Digitaria spp., Lolium spp., Echinochloa spp., Panicum spp., Phalaris spp., Poa spp., Setaria spp. and also Cyperus species from the annual group and, from amongst the perennial species, Agropyron, Cynodon, Imperata and Sorghum and also perennial Cyperus species.

In the case of the dicotyledonous weed species, the spectrum of action extends to species such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., amongst the annuals, and Convolvulus, Cirsium, Rumex and Artemisia in the case of the perennial weeds.

If the compounds according to the invention are applied to the soil surface before germination, then the weed seedlings are either prevented completely from emerging, or the weeds grow until they have reached the cotyledon stage but then their growth stops, and, eventually, after three to four weeks have elapsed, they die completely.

If the active compounds are applied post-emergence to the green parts of the plants, growth likewise stops drastically a very short time after the treatment and the weed plants remain at the growth stage of the point of time of application, or they die completely after a certain time, so that in this manner competition by the weeds, which is harmful to the crop plants, is eliminated at a very early point in time and in a sustained manner.

The herbicidal compositions according to the invention are distinguished by a rapidly commencing and long-lasting herbicidal action. As a rule, the rainfastness of the active compounds in the combinations according to the invention is advantageous. A particular advantage is that the dosages of the compounds (A) and (B), which are used in the combinations and are effective, can be adjusted to such a low quantity that their soil action is optimally low. Not only does this allow them to be employed in sensitive crops in the first place, but groundwater contaminations are also virtually avoided. The active compound combinations according to the invention allow the application rate of the active compounds required to be reduced considerably.

When herbicides of group (A) and those of group (B) are used jointly, superadditive (=synergistic) effects are preferably observed. This means that the effect in the combinations exceeds the expected total of the effects of the individual herbicides employed. The synergistic effects allow the application rate to be reduced, a broader spectrum of broad-leaved weeds and weed grasses to be controlled, the herbicidal action to take place more rapidly, the duration of action to be longer, the harmful plants to be controlled better while using only one, or few, applications, and the application period which is possible to be extended. To some extent, using the compositions also reduces the amount of harmful ingredients, such as nitrogen or oleic acid, and their introduction into the soil.

The abovementioned properties and advantages are required for weed control practice to keep agricultural crops free from undesired competing plants and thus to safeguard and/or increase the yields from the qualitative and quantitative point of view. These novel combinations markedly exceed the technical state of the art with a view to the properties described.

By virtue of their herbicidal and plant-growth-regulatory properties, the compositions according to the invention can be employed for controlling harmful plants in known crop plants or still to be developed tolerant or genetically modified crop plants. These transgenic plants are distinguished as a rule by particular, advantageous properties, such as, in addition to resistances to compositions according to the invention, for example resistances to plant diseases or causative agents of plant diseases such as particular insects or microorganisms such as fungi, bacteria or viruses. Other particular properties relate, for example, to the harvested material with regard to quantity, quality, storability, composition and specific constituents. Thus, for example, transgenic plants are known whose starch content is increased or whose starch quality is altered, or those where the harvested material has a different fatty acid composition.

Conventional methods of generating novel plants which have modified properties in comparison to plants occurring to date consist, for example, in traditional breeding methods and the generation of mutants. Alternatively, novel plants with altered properties can be generated with the aid of recombinant methods (see, for example, EP-A-0221044, EP-A-0131624). For example, the following have been described in several cases:
the modification, by recombinant technology, of crop plants with the aim of modifying the starch synthesized in the plants (for example WO 92/11376, WO 92/14827, WO 91/19806),
transgenic crop plants which exhibit resistances to other herbicides, for example to sulfonylureas (EP-A-0257993, U.S. Pat. No. 5,013,659),
transgenic crop plants with the capability of producing Bacillus thuringiensis toxins (Bt toxins), which make the plants resistant to certain pests (EP-A-0142924, EP-A-0193259),
transgenic crop plants with a modified fatty acid composition (WO 91/13972).

A large number of techniques in molecular biology are known in principle with the aid of which novel transgenic plants with modified properties can be generated; see, for example, Sambrook et al., 1989, Molecular Cloning, A Laboratory Manual, 2^{nd} Edition, Cold Spring Harbor Laboratory Press, Cold Spring Harbor, N.Y.; or Winnacker “Gene und Klone”, VCH Weinheim 2^{nd} Edition 1996 or Christou, “Trends in Plant Science” 1 (1996) 423-431).

To carry out such recombinant manipulations, nucleic acid molecules which allow mutagenesis or sequence changes by recombination of DNA sequences can be introduced into plasmids. For example, the abovementioned standard methods allow base exchanges to be carried out, subsequences to be removed, or natural or synthetic sequences to be added. To connect the DNA fragments to each other, adapters or linkers may be added to the fragments.

For example, the generation of plant cells with a reduced activity of a gene product can be achieved by expressing at least one corresponding antisense RNA, a sense RNA for achieving a cosuppression effect or by expressing at least one suitably constructed ribosome which specifically cleaves transcripts of the above-mentioned gene product.

To this end, it is possible to use DNA molecules which encompass the entire coding sequence of a gene product inclusive of any flanking sequences which may be present, and also DNA molecules which only encompass portions of the coding sequence, it being necessary for these portions to be long enough to have an antisense effect in the cells. The use of DNA sequences which have a high degree of homology to the coding sequences of a gene product, but are not completely identical to them, is also possible. When expressing nucleic acid molecules in plants, the protein synthesized can be localized in any desired compartment of the plant cell. However, to achieve localization in a particular compartment, it is possible, for example, to link the coding region with DNA sequences which ensure localization in a particular compartment. Such sequences are known to those skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106).

The transgenic plant cells can be regenerated by known techniques to give rise to entire plants. In principle, the transgenic plants can be plants of any desired plant species, i.e. not only monocotyledonous, but also dicotyledonous, plants. Thus, transgenic plants can be obtained whose properties are altered by overexpression, suppression or inhibition of homologous (=natural) genes or gene sequences or the expression of heterologous (=foreign) genes or gene sequences.

The present invention furthermore provides a process for controlling unwanted plants (for example for the non-selective control of harmful plants or for the selective control of harmful plants in crop plants such as leguminous plants), preferably in crop plants, which comprises applying the herbicides (A) and (B) of the herbicide combination according to the invention to the plants (for example harmful plants, such as monocotyledonous or dicotyledonous weeds or unwanted crop plants), the seed (for example grains, seeds or vegetative propagation organs, such as tubers or shoot parts with buds) or to the area in which the plants grow (for example the area under cultivation), for example together or separately. One or more herbicides (A) may be applied before, after or simultaneously with the herbicide(s) (B) to the plants, the seed or the area in which the plants grow (for example the area under cultivation).

Unwanted plants are to be understood as meaning all plants which grow in locations where they are unwanted. This can, for example, be harmful plants (for example monocotyledonous or dicotyledonous weeds or unwanted crop plants), including, for example, those which are resistant to certain herbicidally active compounds, such as glyphosate, atrazine, glufosinate or imidazolinone herbicides.

The herbicidal combinations according to the invention are employed non-selectively for controlling unwanted vegetation, for example in permanent crops and plantation crops (for example pome fruit and stone fruit, berry fruit, grapevine, Hevea, bananas, sugar cane, coffee, tea, citrus fruits, nut plantations, roses, palm plantations and forest plantations), on roadsides, squares, industrial plants, airports or railway tracks, or for the burn-down application, for example in crop plants such as farm crops, for example monocotyledonous farm crops, such as cereals (for example wheat, barley, rye, oats), rice, corn, millet, or dicotyledonous farm crops, such as sugar beet, oilseed rape, cotton, sunflowers and leguminous plants, for example of the genera Glycine (for example Glycine max. (soybean), such as non-transgenic Glycine max. (for example conventional cultivars, such as STS cultivars) or transgenic Glycine max. (for example RR-soybean or LL-soybean) and crossbreeds thereof), Phaseolus, Pisum, Vicia and Arachis, or vegetable crops from various botanical groups, such as potato, leek, cabbage, carrot, tomato, onion. The application is preferably carried out to the emerged harmful plants (for example weeds or unwanted crop plants), in particular prior to the emergence of (wanted) crop plants.

Another preferred use in the non-selective field is the burn-down application in crop plants where at least one of the components of the herbicide combination according to the invention, in particular the herbicides (A), if appropriate in combination with the herbicides (B), is applied prior to the emergence of the crop plants to the emerged harmful plants (for example weeds or unwanted crop plants); preference is given here to the application to the emerged harmful plants prior to sowing of the crop plants or during sowing of the crop plants.

The invention also provides the use of the herbicide combinations according to the invention for controlling unwanted vegetation, preferably in crop plants. The herbicide combinations according to the invention can be prepared by known processes, for example as mixed formulations of the individual components, if appropriate with further active compounds, additives and/or customary formulation auxiliaries, which combinations are then applied in a customary manner diluted with water, or as tank mixes by joint dilution of the components, formulated separately or formulated partially separately, with water. Also possible is the split application of the separately formulated or partially separately formulated individual components. It is also possible to apply the herbicides or the herbicide combinations in a plurality of portions (sequential application) using, for example, pre-emergence applications followed by post-emergence applications or using early post-emergence applications followed by medium or late post-emergence applications. Preference is given here to the joint or almost simultaneous application of the active compounds of the combination in question.

The herbicides (A) and (B) can be converted jointly or separately into customary formulations, such as solutions, emulsions suspensions, powders, foams, pastes, granules, aerosols, natural and synthetic materials impregnated with active compound and microencapsulations in polymeric materials. The formulations may comprise the customary auxiliaries and additives.

These formulations are produced in a known manner, for example by mixing the active compounds with extenders, that is liquid solvents, pressurized liquefied gases and/or solid carriers, if appropriate with the use of surfactants, that is emulsifiers and/or dispersants, and/or foam formers.

If the extender used is water, it is also possible to use, for example, organic solvents as auxiliary solvents. Suitable liquid solvents are essentially: aromatics, such as xylene, toluene, alkylnaphthalenes, chlorinated aromatics or chlorinated aliphatic hydrocarbons, such as chlorobenzenes, chloroethylenes, or methylene chloride, aliphatic hydrocarbons, such as cyclohexane or paraffins, for example mineral oil fractions, mineral and vegetable oils, alcohols, such as butanol or glycol, and ethers and esters thereof, ketones, such as acetone, methyl ethyl ketone, methyl isobutyl ketone or cyclohexanone, strongly polar solvents, such as dimethylformamide or dimethyl sulfoxide, and also water. Suitable solid carriers are: for example ammonium salts and ground natural minerals, such as kaolins, clays, talc, chalk, quartz, attapulgite, montmorillonite or diatomaceous earth, and ground synthetic minerals, such as finely divided silica, alumina and silicates; suitable solid carriers for granules are: for example crushed and fractionated natural rocks, such as calcite, marble, pumice, sepiolite and dolomite, and also synthetic granules of inorganic and organic meals, and granules of organic material, such as sawdust, coconut shells, corn cobs and tobacco stalks; suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates and also protein hydrolysates; suitable dispersants are: for example lignosulfite waste liquors and methylcellulose.

Tackifiers such as carboxymethylcellulose and natural and synthetic polymers in the form of powders, granules or latices, such as gum arabic, polyvinyl alcohol and polyvinyl acetate, and also natural phospholipids, such as cephalins and lecithins and synthetic phospholipids, can be used in the formulations. Other possible additives are mineral and vegetable oils.

It is possible to use colorants such as inorganic pigments, for example iron oxide, titanium oxide and Prussian Blue, and organic dyes, such as alizarin dyes, azo dyes and metal phthalocyanine dyes, and trace nutrients, such as salts of iron, manganese, boron, copper, cobalt, molybdenum and zinc.

The formulations generally comprise between 0.1 and 95% by weight of active compound, preferably between 0.5 and 90% by weight.

The herbicides (A) and (B) can be used as such or in their formulations, including as a mixture with other agrochemically active compounds, such as known herbicides, for controlling unwanted vegetation, for example for controlling weeds or for controlling unwanted crop plants, ready mixes and tank mixes being possible.

Also possible are mixtures with other known active compounds, such as fungicides, insecticides, acaricides, nematicides, safeners, bird repellents, plant nutrients and soil conditioners.

The herbicides (A) and (B) can be applied as such, in the form of their formulations or the use forms prepared therefrom by further dilution, such as ready-to-use solutions, suspensions, emulsions, powders, pastes and granules. Application is effected in a customary manner, for example by watering, spraying, atomizing, broadcasting.

The active compounds can be applied to the plants (for example harmful plants, such as monocotyledonous or dicotyledonous weeds or unwanted crop plants), the seed (for example grains, seeds or vegetative propagation organs, such as tubers or shoot parts with buds) or the area under cultivation (for example the soil), preferably to the green plants and parts of plants and, if appropriate, additionally the soil. One possible use is the joint application of the active compounds in the form of tank mixers, where the optimally formulated concentrated formulations of the individual active compounds are, together, mixed in a tank with water, and the spray liquor obtained is applied.

A joint herbicidal formulation of the combination according to the invention of herbicides (A) and (B) has the advantage that it is easier to apply, since the amounts of the components are already in an optimum ratio. Moreover, the auxiliaries in the formulation can be adjusted optimally to one another.

### BIOLOGICAL EXAMPLES

### 1. Pre-emergence Action against Weeds

Seeds or rhizome pieces of monocotyledonous and dicotyledonous weed plants were placed in sandy loam soil in cardboard pots and covered with soil. The active compounds (A) and (B), formulated as wettable powders or emulsion concentrates, were then applied to the surface of the covering soil as aqueous suspensions or emulsions in different dosages at a water application rate of 600 to 800 l/ha (converted).

After the treatment, the pots were placed in the greenhouse and kept under good growth conditions for the weeds. Visual scoring of the plant damage or emergence damage was carried out after the test plants had emerged after a test period of 3 to 4 weeks, in comparison to untreated controls. The results show that the tested herbicide combinations have good herbicidal pre-emergence activity against a broad spectrum of weed grasses and broad-leaved weeds. The herbicide combinations of compounds of Table A with compounds of Table B have very good synergistic herbicidal activity against harmful plants such as Sinapis alba, Chrysanthemum segetum, Avena sativa, Stellaria media, Echinochloa crus-galli, Lolium multiflorum, Setaria viridis, Abutilon theophrasti, Amaranthus retroflexus and Panicum miliaceum when applied by the pre-emergence method at an application rate of 100 g or less of active substance per hectare (AS/ha).

### 2. Post-emergence Action against Weeds

### a) Example 1

Seeds or rhizome pieces of monocotyledonous and dicotyledonous weeds were placed in sandy loam soil in plastic pots, covered with soil and cultivated in the greenhouse under good growth conditions. Three weeks after sowing, the test plants were treated at the two-to-four-leaf stage. The compounds according to the invention, formulated as sprayable powders or as emulsion concentrates, were sprayed onto the green parts of the plants in various dosages at a water application rate of 600 to 800 l/ha (converted). After the test plants had been left to stand in the greenhouse for about 3 to 4 weeks under optimum growth conditions, the effect of the preparations was scored visually in comparison to untreated controls.

In general, the herbicide combinations according to the invention also have good herbicidal post-emergence activity against a broad spectrum of economically important weed grasses and broad-leaved weeds. The herbicide combinations of compounds of Table A with compounds of Table B have very good synergistic herbicidal activity against harmful plants such as Sinapis alba, Echinochloa crus-galli, Digitaria sanguinalis, Lolium multiflorum, Chrysanthemum segetum, Setaria viridis, Polygonum convolvulus, Abutilon theophrasti, Amaranthus retroflexus, Panicum miliaceum and Avena sativa when applied by the post-emergence method at an application rate of 100 g or less of active substance per hectare (AS/ha).

### b) Example 2

The plant species listed below were sown in Jiffy pots and cultivated in a greenhouse at a day/night rhythm of 22° C./14° C. At the 2-4-leaf stage, the plants were then treated with an aqueous solution of the compounds in question at the stated dosages. After four weeks, the results were scored visually using the following scheme:

0=no damage
100=complete damage
AS/ha=active substance/hectare

| | | Damage |
|---|---|---|
| Compound | g of AS/ha | DIGSA |
| B-22 | 25 | 55 |
| B-22 | 13 | 24 |
| A-9 | 8 | 8 |
| (B-22) + (A-9) | 25 + 8 | 68 |

DIGSA = Digitaria sanguinalis

The scores for Digitaria sanguinalis are evidence that, when one of the 2,4-diamino-s-triazines mentioned is combined with one of the N-azinyl-N′-pyridyl-sulfonylureas mentioned, surprising effects may occur which are considerable above the expected level of the individual components and the expected additive effects. It is thus an unexpected synergism.

This evidence is corroberated by the scores for Setaria viridis (SETVI):

| | | Damage |
|---|---|---|
| Compound | g of AS/ha | SETVI |
| B-44 | 25 | 5 |
| B-44 | 13 | 3 |
| A-9 | 4 | 63 |
| (B-44) + (A-9) | 25 + 4 | 75 |
| (B-44) + (A-9) | 13 + 4 | 73 |

This effect is also confirmed for Polygonum convolvulus (POLCO):

| | | Damage |
|---|---|---|
| Compound | g of AS/ha | POLCO |
| B-47 | 25 | 0 |
| B-47 | 13 | 0 |
| A-9 | 4 | 48 |
| A-9 | 8 | 56 |
| (B-47) + (A-9) | 25 + 4 | 62 |
| (B-47) + (A-9) | 25 + 8 | 72 |
| (B-47) + (A-9) | 13 + 4 | 60 |
| (B-47) + (A-9) | 13 + 8 | 61 |

### c) Example 3

The plant species listed below were sown in Jiffy pots and cultivated in a greenhouse at a day/night rhythm of 22° C./14° C. At the 2-4-leaf stage, the plants were then treated with an aqueous solution of the compounds in question at the stated dosages. After four weeks, the results were scored visually using the following scheme:

0=no damage
100=complete damage
AS/ha=active substance/hectare

| | | Damage |
|---|---|---|
| Compound | g of AS/ha | POLCO |
| B-47 | 25 | 0 |
| B-47 | 13 | 0 |
| A-12 | 2 | 81 |
| A-12 | 4 | 90 |
| (B-47) + (A-12) | 25 + 4 | 96 |

The example shows that the mixture achieves very good control of Polygonum convolvulus (POLCO) which can not be explained by additive effects alone. The same principle also applies to Abutilon theophrasti (ABUTH), as shown in the table below:

| | | Damage |
|---|---|---|
| Compound | g of AS/ha | ABUTH |
| B-47 | 25 | 15 |
| B-47 | 13 | 5 |
| A-12 | 2 | 75 |
| A-12 | 4 | 78 |
| (B-47) + (A-12) | 13 + 4 | 95 |

1. A herbicide combination comprising components (A) and (B), wherein
(A) is one or more herbicides selected from the group consisting of the compounds of the formula (I) or salts thereof 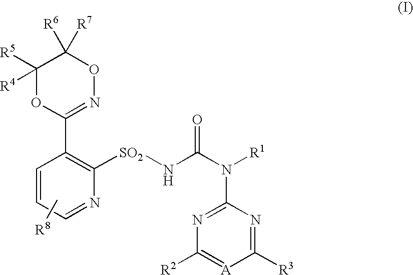
in which
A is nitrogen or a CR¹¹ group,
where
R¹¹ is hydrogen, alkyl, halogen or haloalkyl,
R¹ is hydrogen or an optionally substituted radical selected from the group consisting of alkyl, alkoxy, alkoxyalkyl, alkenyl, alkynyl, cycloalkyl, cycloalkylalkyl, aralkyl and aryl,
R² is hydrogen, halogen or is in each case optionally halogen-substituted alkyl, alkoxy, alkylthio, alkylamino or dialkylamino having in each case 1 to 6 carbon atoms,
R³ is hydrogen, halogen or is in each case optionally halogen-substituted alkyl, alkoxy, alkylthio, alkylamino or dialkylamino having in each case 1 to 6 carbon atoms,
R⁴-R⁷ independently of one another are hydrogen, halogen, cyano, thiocyanato or are in each case optionally halogen-substituted alkyl, alkoxy, alkylthio, alkylsulfinyl, alkylsulfonyl, alkylamino, alkylcarbonyl, alkoxycarbonyl, alkylaminocarbonyl having in each case 1 to 3 carbon atoms,
R⁸ is hydrogen, halogen, cyano, thiocyanato or is in each case optionally halogen-substituted alkyl, alkoxy, alkylthio, alkylsulfinyl, alkylsulfonyl, alkylamino, alkylcarbonyl, alkoxycarbonyl, alkylaminocarbonyl having in each case 1 to 3 carbon atoms,
where in the radicals mentioned above, the alkyl and alkylene groups may in each case contain 1 to 6 carbon atoms, the alkenyl and alkynyl groups may in each case contain 2 to 6 carbon atoms, the cycloalkyl groups may in each case contain 3 to 6 carbon atoms and the aryl groups may in each case contain 6 or 10 carbon atoms; and
(B) is one or more herbicides selected from the group consisting of the 2,4-diamino-s-triazines which are N-substituted at an amino group with a (hetero)aryl(hetero)alkyl group.

2. The herbicide combination as claimed in claim 1
in which
A is nitrogen or a CH group,
R¹ is hydrogen, methyl, ethyl, methoxy, methoxymethyl or ethoxy,
R² is hydrogen, chlorine, methyl, ethyl, trifluoromethyl, methoxy, ethoxy, difluoromethoxy, methylthio, methylamino or dimethylamino,
R³ is hydrogen, chlorine, methyl, ethyl, trifluoromethyl, methoxy, ethoxy, difluoromethoxy, methylthio, methylamino or dimethylamino,
R⁴-R⁷ independently of one another are hydrogen, fluorine, chlorine, cyano, or are in each case optionally chlorine- or fluorine-substituted methyl, methylthio, methylsulfinyl, methylsulfonyl, methoxycarbonyl and ethoxycarbonyl,
R⁸ is hydrogen, fluorine, chlorine, bromine, cyano or is in each case optionally chlorine- or fluorine-substituted methyl, methoxy, ethoxy, methylthio, ethylthio, methylsulfinyl, ethylsulfinyl, methylsulfonyl, ethylsulfonyl, methyl- or dimethylamino.

3. The herbicide combination as claimed in claim 1 which comprises, as component (B), one or more herbicides selected from the group consisting of the 2,4-diamino-s-triazines consisting of compounds having the formulae (II), (III), (IV) and (V) and salts thereof
T1. compounds of the formula (II) and salts thereof, 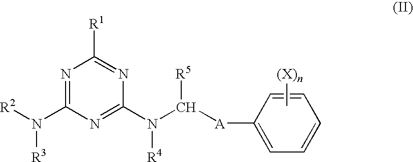
in which
R¹ is (C₁-C₆)-alkyl which is unsubstituted or substituted by one or more radicals from the group consisting of halogen, cyano, nitro, thiocyanato, (C₁-C₄)-alkoxy, (C₁-C₄)-alkylthio, (C₁-C₄)-alkylsulfinyl, (C₁-C₄)-alkylsulfonyl, (C₂-C₄)-alkenyl, (C₂-C₄)-alkynyl, phenyl, which is unsubstituted or substituted, and heterocyclyl having 3 to 6 ring atoms and 1 to 3 ring heteroatoms from the group consisting of N, O and S, where the ring is unsubstituted or substituted,
R² and R³ are each independently of one another hydrogen, amino or alkylamino or dialkylamino having in each case 1 to 6 carbon atoms in the alkyl radical, an acyclic or cyclic hydrocarbon radical or hydrocarbonoxy radical having in each case 1 to 10 carbon atoms or a heterocyclyl radical, heterocyclyloxy radical or heterocyclylamino radical having in each case 3 to 6 ring atoms and 1 to 3 ring heteroatoms from the group consisting of N, O and S, where each of the five last-mentioned radicals is unsubstituted or substituted, or an acyl radical, or
R² and R³ together with the nitrogen atom of the group NR²R³ are a heterocyclic radical having 3 to 6 ring atoms and 1 to 4 ring heteroatoms, where in addition to the nitrogen atom any further ring heteroatoms are selected from the group consisting of N, O and S and where the radical is unsubstituted or substituted,
R⁴ is hydrogen, amino, alkylamino or dialkylamino having in each case 1 to 6 carbon atoms in the alkyl radical, an acyclic or cyclic hydrocarbon radical or hydrocarbonoxy radical having in each case 1 to 10 carbon atoms, or a heterocyclyl radical, heterocyclyloxy radical or heterocyclylamino radical having in each case 3 to 6 ring atoms and 1 to 3 ring heteroatoms from the group consisting of N, O and S, where each of the five last-mentioned radicals is unsubstituted or substituted, or an acyl radical,
R⁵ is hydrogen, halogen, nitro, cyano, thiocyanato or a radical of the formula -B¹-Y¹, where B¹ and Y¹ are as defined below,
A is an alkylene radical having 1 to 5 straight-chain carbon atoms or alkenylene or alkynylene having in each case 2 to 5 straight-chain carbon atoms, where each of the three last-mentioned diradicals is unsubstituted or substituted by one or more radicals from the group consisting of halogen, nitro, cyano, thiocyanato and a radical of the formula —B²-Y²,
(X)ₙ are n substituents X, where each X independently of the others is halogen, (C₁-C₆)-alkyl, (C₂-C₆)-alkenyl, (C₂-C₆)-alkynyl, (C₁-C₆)-alkoxy, (C₂-C₆)-alkenyloxy, (C₂-C₆)-alkynyloxy, [(C₁-C₄)-alkyl]-carbonyl, [(C₁-C₄)-alkoxy]-carbonyl or [(C₁-C₄)-alkylthio]-carbonyl, where the hydrocarbon-containing parts in the 9 last-mentioned radicals are unsubstituted or substituted, or a radical of the formula —B^{o}—R^{o}, where B^{o} is as defined below and R^{o} is an aromatic, saturated or partially saturated carbocyclic or heterocyclic radical, where the cyclic radical is substituted or unsubstituted,
or two adjacent radicals X together are a fused-on cyclus having 4 to 6 ring atoms which is carbocyclic or contains ring heteroatoms from the group consisting of O, S and N and which is unsubstituted or substituted by one or more radicals from the group consisting of halogen, (C₁-C₄)-alkyl and oxo,
n is 0, 1, 2, 3, 4 or 5,
B^{o}, B¹, B² are each independently of one another a direct bond or a divalent group of the formula —O—, —S(O)ₚ—, —S(O)ₚ—O—, —O—S(O)ₚ—, —CO—, —O—CO—, —CO—O—, —NR′—, —O—NR′—, —NR′—O—, —NR′—CO—, —CO—NR′—, where p=0, 1 or 2 and R′ is hydrogen, alkyl having 1 to 6 carbon atoms, phenyl, benzyl, cycloalkyl having 3 to 6 carbon atoms or alkanoyl having 1 to 6 carbon atoms,
Y¹, Y² are each independently of one another H or an acyclic hydrocarbon radical having, for example, in each case 1 to 20 carbon atoms or a cyclic hydrocarbon radical having 3 to 8 carbon atoms or a heterocyclic radical having 3 to 9 ring atoms and 1 to 3 ring heteroatoms from the group consisting of N, O and S, where each of the three last-mentioned radicals is unsubstituted or substituted;
T2. compounds of the formula (III) or salts thereof, 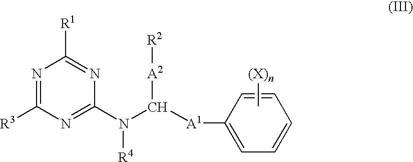
in which
R¹ is aryl which is unsubstituted or substituted, or (C₃-C₉)-cycloalkyl which is unsubstituted or substituted, or heterocyclyl which is substituted or unsubstituted, or
(C₁-C₆)-alkyl, (C₂-C₆)-alkenyl or (C₂-C₆)-alkynyl,
where each of the 3 last-mentioned radicals is unsubstituted or substituted by one or more radicals from the group consisting of halogen, hydroxy, cyano, nitro, thiocyanato, (C₁-C₄)-alkoxy, (C₁-C₄)-haloalkoxy, (C₂-C₄)-alkenyloxy, (C₂-C₄)-haloalkenyloxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl and (C₃-C₉)-cycloalkyl which is unsubstituted or substituted, and phenyl which is unsubstituted or substituted, and heterocyclyl which is unsubstituted or substituted, and radicals of the formulae R′—C(═Z′)—, R′—C(═Z′)—Z—,
R′—Z—C(═Z′)—, R′R″N—C(═Z′)—, R′—Z—C(═Z′)—O—, R′R″N—C(═Z′)—Z—, R′—C(═Z′)-NR″- and R′R″N—C(═Z′)-NR′″—, in which R′, R″ and R′″ are each independently of one another (C₁-C₆)-alkyl, aryl, aryl-(C₁-C₆)alkyl, (C₃-C₉)-cycloalkyl or (C₃-C₉)-cycloalkyl-(C₁-C₆)alkyl, where each of the 5 last-mentioned radicals is unsubstituted or substituted and in which Z and Z′ independently of one another each an oxygen or sulfur atom,
R² is (C₃-C₉)-cycloalkyl which is unsubstituted or substituted, (C₄-C₉)-cycloalkenyl which is unsubstituted or substituted, heterocyclyl which is unsubstituted or substituted, or phenyl which is unsubstituted or substituted, or
R³ is a radical of the formula —N(B¹-D′)(B²-D²) or —NR′—N(B¹-D¹)(B²-D²), in which in each case B1, B2, D¹ and D² are as defined below and R′ is hydrogen, (C₁-C₆)-alkyl or [(C₁-C₄)-alkyl]-carbonyl,
R⁴ is a radical of the formula —B³-D³, where B³ and D³ are as defined below,
A¹ is straight-chain alkylene having 1 to 5 carbon atoms or straight-chain alkenylene or alkynylene having in each case 2 to 5 carbon atoms, where each of the three last-mentioned diradicals is unsubstituted or substituted by one or more radicals from the group consisting of halogen, nitro, cyano, thiocyanato and radicals of the formula —B⁴-D⁴, where B⁴ and D⁴ are as defined below,
A² is a direct bond or straight-chain alkylene having 1 to 4 carbon atoms or straight-chain alkenylene or alkynylene having in each case 2 to 5 carbon atoms, where each of the three last-mentioned diradicals is unsubstituted or substituted by one or more radicals from the group consisting of halogen, nitro, cyano, thiocyanato and radicals of the formula —B5-D 5, or a divalent radical of the formula VI¹, VI², VI³, VI⁴ or VI⁵,
—CR⁶R⁷W*-CR⁸R⁹- (VI¹)
—CR¹⁰R¹¹-W*-CR¹²R¹³—CR¹⁴R¹⁵— (VI²)
—CR¹⁶R¹⁷—CR¹⁸R¹⁹W*-CR²⁰R²¹— (VI³)
CR²²R²³—CR²⁴R²⁵-W*- (VI⁴)
—CR²⁶R²⁷-W*- (VI⁵)
where each of the radicals R⁶ to R²⁷ in each case independently of the others is hydrogen, halogen, nitro, cyano, thiocyanato or a radical of the formula —B⁶-D⁶, W* is in each case an oxygen atom, a sulfur atom or a group of the formula N(B⁷-D⁷) and
B⁵, B⁶, B⁷, D⁵, D⁶ and D⁷ are as defined below,
B¹, B², B³ and B⁷ are each independently of one another a direct bond or a divalent group of the formula —C(═Z*)—, —C(═Z*)—Z**—, —C(═Z*)-NH— or —C(═Z*)-NR*—, where Z*=an oxygen or sulfur atom, Z**=an oxygen or sulfur atom and R*=(C₁-C₆)-alkyl, aryl, aryl-(C₁-C₆)alkyl, (C₃-C₉)-cycloalkyl or (C₃-C₉)-cycloalkyl-(C₁-C₆)alkyl, where each of the 5 last-mentioned radicals is unsubstituted or substituted,
B⁴, B⁵ and B⁶ are each independently of one another a direct bond or a divalent group of the formula —O—, —S(O)ₚ—, —S(O)ₚ—O—, —O—S(O)ₚ—, —CO—, —O—CO—, —CO—O—, —S—CO—, —CO—S—, —S—CS—, —CS—S—, —O—CO—O—, —NR^{O}—, —O—NR^{O}—, —NR^{O}—O—, —NR^{O}—CO—, —CO—NR^{O}—, —O—CO—NR^{O}— or —NR^{O}—CO—O—, where p is the integer 0, 1 or 2 and R^{O} is hydrogen, (C₁-C₆)-alkyl, aryl, aryl-(C₁-C₆)alkyl, (C₃-C₉)-cycloalkyl or (C₃-C₉)-cycloalkyl-(C₁-C₆)alkyl, where each of the 5 last-mentioned radicals is unsubstituted or substituted,
D¹, D², D³, D⁴, D⁵, D⁶ and D⁷ are each independently of one another hydrogen, (C₁-C₆)-alkyl, aryl, aryl-(C₁-C₆)alkyl, (C₃-C₉)-cycloalkyl or (C₃-C₉)-cycloalkyl-(C₁-C₆)alkyl, where each of the 5 last-mentioned radicals is unsubstituted or substituted, or in each case two radicals D⁵ of two groups B⁵-D⁵ attached to a carbon atom are linked to one another forming an alkylene group which has 2 to 4 carbon atoms and is unsubstituted or substituted by one or more radicals from the group consisting of (C₁-C₄)alkyl and (C₁-C₄)alkoxy,
(X)ₙ are n substituents X, where each X independently of the others is halogen, hydroxy, amino, nitro, formyl, carboxy, cyano, thiocyanato, aminocarbonyl or (C₁-C₆)-alkyl, (C₁-C₆)-alkoxy, (C₁-C₆)-alkylthio, mono(C₁-C₆)alkylamino, di(C₁-C₄)alkylamino, (C₂-C₆)-alkenyl, (C₂-C₆)-alkynyl, [(C₁-C₆)-alkyl]carbonyl, [(C₁-C₆)-alkoxy]carbonyl, mono(C₁-C₆)alkylamino-carbonyl di(C₁-C₄)alkylamino-carbonyl, N—(C₁-C₆)-alkanoyl-amino or N—(C₁-C₄)-alkanoyl-N—(C₁-C₄)alkyl-amino, where each of the 13 last-mentioned radicals is unsubstituted or substituted, preferably unsubstituted or substituted by one or more radicals from the group consisting of halogen, hydroxy, amino, nitro, formyl, carboxy, cyano, thiocyanato, (C₁-C₄)-alkoxy, (C₁-C₄)-haloalkoxy, (C₁-C₄)-alkylthio, (C₁-C₄)-haloalkylthio, mono(C₁-C₄)alkylamino, di(C₁-C₄)alkylamino, (C₃-C₉)-cycloalkyl, (C₃-C₉)-cycloalkyl-amino, [(C₁-C₄)-alkyl]carbonyl, [(C₁-C₄)-alkoxy]carbonyl, aminocarbonyl, mono(C₁-C₄)alkylamino-carbonyl, di(C₁-C₄)alkylamino-carbonyl, phenyl, phenoxy, phenylthio, phenylcarbonyl, heterocyclyl, heterocyclyloxy, heterocyclylthio and heterocyclylamino, where each of the 8 last-mentioned radicals is unsubstituted or has one or more substituents from the group consisting of halogen, nitro, cyano, (C₁-C₄)-alkyl, (C₁-C₄)-alkoxy, (C₁-C₄)-alkylthio, (C₁-C₄)-haloalkyl, (C₁-C₄)-haloalkoxy, formyl, (C₁-C₄)-alkyl-carbony and (C₁-C₄)-alkoxy-carbonyl,
or (C₃-C₉)-cycloalkyl, (C₃-C₉)-cycloalkoxy, (C₃-C₉)-cycloalkylamino, phenyl, phenoxy, phenylthio, phenylcarbonyl, heterocyclyl, heterocyclyloxy, heterocyclylthio or heterocyclylamino, where each of the 11 last-mentioned radicals is unsubstituted or substituted, or two adjacent radicals X together are a fused-on cycle having 4 to 6 ring atoms which is carbocyclic or contains ring heteroatoms from the group consisting of O, S and N and which is unsubstituted or substituted by one or more radicals from the group consisting of halogen, (C₁-C₄)-alkyl and oxo,
n 0, 1, 3, 4 or 5 and
“heterocyclyl” in the radicals mentioned above is independently of the others in each case a heterocyclic radical having 3 to 7 ring atoms and 1 to 3 heteroatoms from the group consisting of N, O and S,
T3. compounds of the formula (IV) or salts thereof, 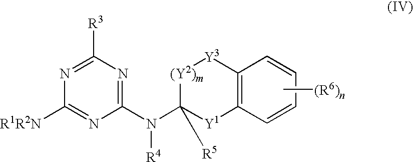
in which
R¹ and R² are each independently of one another hydrogen, amino, alkylamino or dialkylamino having in each case 1 to 6 carbon atoms in the alkyl radical, an acyclic or cyclic hydrocarbon radical or hydrocarbonoxy radical having in each case 1 to 10 carbon atoms or a heterocyclyl radical, heterocyclyloxy radical, heterocyclylthio radical or heterocyclylamino radical having in each case 3 to 6 ring atoms and 1 to 3 ring heteroatoms from the group consisting of N, O and S, where each of the five last-mentioned radicals is unsubstituted or substituted, or an acyl radical or
R¹ and R² together with the nitrogen atom of the group NR¹R² are a heterocyclic radical having 3 to 6 ring atoms and 1 to 4 ring heteroatoms, where in addition to the nitrogen atom any further ring heteroatoms are selected from the group consisting of N, O and S and where the radical unsubstituted or substituted,
R³ is halogen, cyano, thiocyanato, nitro or a radical of the formula —Z¹—R⁷,
R⁴ is hydrogen, amino, alkylamino or dialkylamino having in each case 1 to 6 carbon atoms in the alkyl radical, an acyclic or cyclic hydrocarbon radical or hydrocarbonoxy radical having in each case 1 to 10 carbon atoms or a heterocyclyl radical, heterocyclyloxy radical or heterocyclylamino radical having in each case 3 to 6 ring atoms and 1 to 3 ring heteroatoms from the group consisting of N, O and S, where each of the five last-mentioned radicals is unsubstituted or substituted, or an acyl radical,
R⁵ is halogen, cyano, thiocyanato, nitro or a radical of the formula —Z²—R⁸,
R⁶, if n=1, or the radicals R⁶ each independently of one another, if n is greater than 1, is/are halogen, cyano, thiocyanato, nitro or a group of the formula —Z³—R⁹,
R⁷, R⁸, R⁹ are each independently of one another
hydrogen or an acyclic hydrocarbon radical, where carbon atoms in the chain may be replaced by heteroatoms from the group consisting of N, O and S, or
a cyclic hydrocarbon radical or
a heterocyclic radical,
where each of the last-mentioned 3 radicals is unsubstituted or substituted,
Z¹, Z², Z³ are each independently of one another
a direct bond or
a divalent group of the formula —O—, —S(O)ₚ—, —S(O)ₚ—O—, —O—S(O)ₚ—, —CO—, —CS—, —S—CO—, —CO—S—, —O—CS—, —CS—O—, —S—CS—, —CS—S—, —OCO—, —CO—O—, —NR′—, —O—NR′—, —NR′—O—, —NR′—CO— or —CO—NR′—, where
p=0, 1 or 2 and R′ is hydrogen, alkyl having 1 to 6 carbon atoms, phenyl, benzyl, cycloalkyl having 3 to 6 carbon atoms or alkanoyl having 1 to 6 carbon atoms,
Y¹, Y², Y³ and further groups Y², if m is 2, 3 or 4, each independently of one another are
a divalent group of the formula CR^{a}R^{b}, where R^{a} and R^{b} are identical or different and are each a radical selected from the group consisting of the radicals possible for R⁷ to R⁹, or
a divalent group of the formula —O—, —CO—, —C(═NR*)—, —S(O)_{q}—, —NR*— or —N(O)—, where q=0, 1 or 2 and R* is hydrogen or alkyl having 1 to 4 carbon atoms, or
Y¹ or Y³ is a direct bond,
where two oxygen atoms of the groups Y² and Y³ are not adjacent,
m is 1, 2, 3 or 4,
n is 0, 1, 2, 3 or 4;
T4. substituted 2,4-diamino-1,3,5-triazines of formula (V), 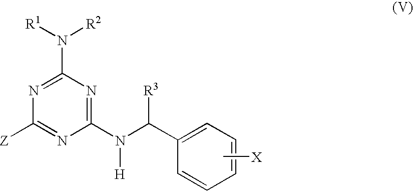
in which
R¹ is hydrogen or is optionally hydroxyl-, cyano-, halogen- or C₁-C₄-alkoxy-substituted alkyl having 1 to 6 carbon atoms,
R² is hydrogen, is formyl, is in each case optionally cyano-, halogen- or C₁-C₄-alkoxy-substituted alkyl, alkylcarbonyl, alkoxycarbonyl or alkylsulfonyl having in each case 1 to 6 carbon atoms in the alkyl groups, or is in each case optionally cyano-, halo-C₁-C₄-alkyl-, C₁-C₄-alkoxy-, halo-C₁-C₄-alkoxy- or C₁-C₄-alkoxy-carbonyl-substituted phenylcarbonyl, naphthylcarbonyl, phenylsulfonyl or naphthylsulfonyl,
R³ is optionally cyano-, halogen- or C₁-C₄-alkoxy-substituted alkyl having 1 to 6 carbon atoms or is optionally cyano-, halogen- or C₁-C₄-alkyl-substituted cycloalkyl having 3 to 6 carbon atoms,
X is a substituent from the group below:
hydroxyl, cyano, nitro, halogen, in each case optionally hydroxyl-, cyano- or halogen-substituted alkyl or alkoxy having in each case 1 to 6 carbon atoms, in each case optionally halogen-substituted alkylcarbonyl, alkoxycarbonyl, alkylthio, alkylsulfinyl or alkylsulfonyl having in each case 1 to 6 carbon atoms in the alkyl groups, in each case optionally hydroxyl-, cyano-, nitro-, halogen-, C₁-C₄-alkyl-, C₁-C₄-haloalkyl-, C₁-C₄-alkoxy- or C₁-C₄-haloalkoxy-substituted phenyl or phenoxy, and
Z is hydrogen, hydroxy, halogen, is in each case optionally hydroxyl-, cyano-, nitro-, halogen-, C₁-C₄-alkoxy-, C₁-C₄-alkyl-carbonyl-, C₁-C₄-alkoxy-carbonyl-, C₁-C₄-alkylthio-, C₁-C₄-alkylsulfinyl- or C₁-C₄-alkylsulfonyl-substituted alkyl, alkoxy, alkylcarbonyl, alkoxycarbonyl, alkylthio, alkylsulfinyl or alkylsulfonyl having in each case 1 to 6 carbon atoms in the alkyl groups, is in each case optionally halogen-substituted alkenyl or alkynyl having in each case 2 to 6 carbon atoms or is optionally cyano-, halogen- or C₁-C₄-alkyl-substituted cycloalkyl having 3 to 6 carbon atoms.

4. The herbicide combination as claimed in claim 3 which comprises, as component (B), one or more herbicides from the group of the 2,4-diamino-s-triazines consisting of compounds having the formulae (II) to (V) which are substituted in position 6 of the triazine ring by radicals from the group consisting of hydrogen, (C₁-C₆)-alkyl, (C₁-C₆)-haloalkyl, (C₃-C₆)-cycloalkyl and (C₃-C₆)-cycloalkyl-(C₁-C₄)-alkyl, preferably (C₁-C₄)-alkyl and (C₁-C₄)-haloalkyl.

5. The herbicide combination as claimed in claim 1 which comprises an effective amount of components (A) and (B) and optionally one or more further components selected from the group consisting of agrochemically active compounds of a different type, additives customary in crop protection and formulation auxiliaries.

6. A method for the non-selective control of unwanted vegetation which comprises applying the herbicides (A) and (B) of the herbicide combination, as defined in one or more of claim 1 to, jointly or separately to an area.

7. The method as claimed in claim 6 for the non-selective control of unwanted vegetation in plantation crops, in forest plant rearings, on roadsides, on squares and industrial sites, airfields or railway installations, or for burn-down applications.

8. A herbicide combination as defined in claim 1 for the non-selective control of unwanted vegetation in plantation crops, in forest plant rearings, on roadsides, on squares and industrial sites, airfields or railway installations, or for burn-down applications.

9. A method of claim 6 wherein said herbicides are applied to an area on which plants grow.
